(19) United States
(12) Patent Application Publication
(10) Pub. No.: US 2006/0193739 A1
(43) Pub. Date: Aug. 31, 2006

(54) Retro mechanical post mechanical and bi-mechanical traction engines

(76) Inventor: Normand Beaudoin, St Hippolyte (CA)

Correspondence Address: Normand Beaudoin, 1 a ) 5 Avenue, St Hippolyte, QC, J8A 1C2, CA

(21) Appl. No.: 10/514,403

(22) PCT Filed: May 16, 2003
(86) PCT No.: PCT/CA03/00713

§ 371 Date: Feb. 23, 2006

(30) Foreign Application Priority Data
May 17, 2002 (CA) 2385608
May 27, 2002 (CA) 2386353
May 27, 2002 (CA) 2386355
May 27, 2002 (CA) 2386350
May 27, 2002 (CA) 2386349
Sep. 19, 2002 (CA) 2401687
Sep. 19, 2002 (CA) 2401678
Nov. 5, 2002 (CA) 2407284
Nov. 26, 2002 (CA) 2410787
Nov. 26, 2002 (CA) 2410789
Dec. 5, 2002 (CA) 2410848
Jan. 30, 2003 (CA) 2417138
Mar. 12, 2003 (CA) 2421097

(51) Int. Cl. F04C 15/00; F01C 1/02; F02B 53/10

(52) U.S. Cl. 418/1; 123/205; 418/61.2

(57) ABSTRACT

The invention aims at generalizing in the form of a single traction engine and hence in the form of a single invention, any traction engine with closed compression chambers. It will be shown that, both in their shapes and in their support methods, prior art traction engines, as well as those already disclosed by the present applicants can all be included in unified manner, to be then physically represented in several embodiments whereof the construction and combination principles will be here disclosed. Among these machines, are included for example retro-rotary traction engines, namely triangular motors, polyturbines, differential semi-turbines, machines with rotor cylinder, standard, Slinky, machines with peripheral cylinders and several others. Therefore, the invention aims at demonstrating in unified manner the main types of machines, mechanical types of support of compression parts, types of shapes of compression parts. Finally some particular features will be defined, such as the use of multiple-cam and interlocked eccentric gear assemblies, as well as some specific types of techniques for balancing the support and certain types of gas management enabled by said types of machines.

The current document has for object to generalize all closed compression chamber motor machines as a single motor machine and consequentially, as a single invention. It will be demonstrated, from the form point of view as well as their support methods point of view, that the motor machines existing before our work, as well as the ones already presented through these works, can all be understood in a unified way, to further allow the materialization of multiple variations which we will dictate the formation and combination rules. Amongst these machines, we'll note, for example, that understanding retro-rotary motor machines will allow the understanding of triangular engines, poly turbines, differential semi turbines, rotary cylinder machines, standard, Slinky, with peripheral cylinders and many more. The current invention's goal will be to demonstrate in a unified manner the principal machine types, mechanical support types of compressive parts and geometric types of compressive parts. Finally, we'll define certain particularities, such as the use of eccentric, polycammed and overlapping gears, as well as a few types of specific support balancing techniques and certain types of gas management possible by these types of machines.

### DISCLOSURE

With the current invention, we intend to show that all closed chamber motor machines, realized as a motor, compressor, pump, collecting machine, can be heard under a global and unique definition which allows, in a very general manner, to specify the function of compressive parts, in relation to the motor function.

We'll also show more abundantly that all motor parts of a motor machine can be controlled by a united mechanical corpus, and that all geometrical shapes of the compressive area, could be motivated correctly by the said mechanical corpus.

Through the current disclosure, we'll show consequentially the variation rules of this unified definition, and we'll show, once again, consequentially, that the former art of machines, such as piston and rotary engines, are but particular cases in this general definition.

For the purpose of this disclosure, we'll allow the intervention of both these types of machines, as well as a previously released set of patents and patent applications, of the said inventor, and to which a portion will be submitted firstly. As we'll see, the group of machines we could possibly achieve is of much larger potential, but will remain synthetic. The group of patents and patent applications of the said inventor, previous to the present one in question, is necessary to the proper understanding of the current invention. I'm submitting this list at the end of the current disclosure and separating these patent applications, in order of priority.

The group of applications taking the priority demand of the current and necessary to the proper exposition of the current are the following:

Brief Recapitulation of Basic Motor Machines, Previous to Our Own Work

By observing the previous works in motor machinery, and if we set aside reaction engines, we can further distinguish two main categories of motor machines, which we can designate in the further manner:
a) Rectilinear movement compressive machines
b) Compressive machines, other than 5rectilinear, circular, and non-circular

In a general manner, the machines in which compressive parts have an alternative rectilinear movement are machines in which the compressive parts are realized with the aid of cylindrical pistons, whereas the machines in which the compressive part movement is non-rectilinear are either paddle machines or multi-paddle machines, which we have already named paddle structured. On a final remark, we'll note that our differential type machines, in their most simple form, are realized with the help of paddles, these paddles having a perfectly circular motion, but corrected in speed, which will produce the motor action.

These two main types of machines are already known for their fundamental variants which are, for piston driven motor machines:
a) standard piston machines (FIG. 1a)
b) orbital piston disposition machines (FIG. 1b)
   and as for paddles machines
a) post rotary paddle machines (FIG. 1c,d), normally referred to as Wankle engines.
   And finally, paddle structured machines
a) paddle structured machines (FIG. 1e) which the first compressive parts were invented by Wilson (1978) gb1521869a
   Recapitulation of Our Previous Works

Our previous works have shoed that we could conceive in different manners the compressive parts of a piston driven engine, by inserting the pistons in what we have named a rotor cylinder (FIG. 2a). In this original conception, respecting the general definition mentioned above, we have shoed that we could obtain the differential of the compressive parts by the difference of two compressive parts acting in combination, by opposition to convention motors, whether standard or orbital, in which the cylinders are fixed.

In another manner, in our first works relative to motor machines—paddle machines in particular—we have demonstrated that we could produce machines in which the pistons were actually rocker arm pistons with alternative movement, mounted the machine's rotary core. (FIG. 2b) Or even paddles mounted, in a rotarily-sliding manner, in the core and the cylinder of the machine (FIG. 2c).

Finally, in our most recent works, we have demonstrated that we could conceive a new generation of machines which we have named retrorotary, which the most elementary image was the triangular boomerang engine (FIG. 3a). We'll find the details of the first realizations of these machines in our patent titled “Poly inductive energetic machine”.

Always prior to the present situation, we have also made evident that the poly turbine machine types—which the first to have presented paddles organized in this paddle structured manner was Wilson (1978)—were birotary machines, which has allowed to demonstrate diverse, pertinent mechanisation methods of compressive parts, which have turned out to be greatly misunderstood in motorology (FIG. 3b). We'll find the detail of these first adequate support structures in our patent application titled Anti Suppressive and Energetic Poly Turbine.

Always prior to the present situation, we have demonstrated that the poly inductive methods allowed us to switch the compressive parts between each other, this time in their speed and not in the shape of their course, in such a manner as to realize compressions and dilatations necessary for combustion and expansion (FIG. 3c)

Finally, we have also shoed that the fundamental machines, as much post rotary, as retro rotary or even bi rotary, were but the most elementary generation of figures for each of these categories, for which we have given the formation rules of the relation of the number of sides which hold the paddles in relation to that of the sides of the cylinders (FIG. 4)

Lastly, please note that we have named, once again, prior to the present context, many mechanical support methods of the compressive parts of these machines, methods which we have separated, as we will demonstrate here more specifically in methods by exterior observation and methods by interior observation.

We can itemize the methods already exposed in our previous patents and patent application in the following manner:

a) The methods exposed by ourselves beforehand, which are the following:
post rotary mono induction
retro rotary mono induction
post rotary poly induction
retro rotary poly induction
semi transmission
by hoop gears

b) The methods already exposed by ourselves in our patent applications, specifically those holding a priority demand of the following manner, as well as the methods exposed currently which are the following:
anterior hoop gears
posterior hoop gears
internal juxtaposed gears
internal superposed gears
intermediate gears
posterior intermediate gears
intermediate hoop gears
spur gears
central active gears
hoop paddle gears
gear like structures
by eccentric gears

The objectives of the current invention are, on one part, to show that by adding new technical solutions allowing support for the compressive parts of post, retro and bi rotary machines to those already elaborated by ourselves, before the current project, we'll obtain a complete mechanical corpus, which not only will allow the realization, by diverse mechanical means, of a same machine, but in addition, allow afterwards to support all types of compressive parts of all machines with closed compressive parts, whether they be paddle or piston.

The unification of the mechanical corpus will allow us not only to seize all the mechanization possibilities of the same machine, but also to show, in a unified manner, that all the possible variants of compressive parts of motor machines can be motivated by this same corpus, and to be considered as variants of a single and identical motor machine.

The specifications and generalizations divulged to the current demand will show even, from the mechanical point of view, that there is no fundamental difference between piston and paddle machines and that they both emerge from a same mechanical corpus and are for this reason unified under the general idea of a motor machine. Another objective of the current invention is to specify that this general idea of the machine will subdivide into different categories, which also divide into variants and so forth, forming a vast group of sub machines, all emerging from a single machine. One final idea of the current invention is to show that diverse realizations of compressive part types can be produced and mechanized always through the same mechanical corpus and can be, for these reasons, part of the current generalization and unification.

In fact, the objective of the current invention is to show that the compressive parts of all machines, whether they function by rotor cylinder, sliding paddle, poly rectilinear machines said Slikke, simple or poly cammed peripheral rectilinear machines, poly cammed semi turbine type machines, anti turbine type machines, central explosion machines, pure hybrid machines, poly rotary type machines, can all, since they can be supported by identical mechanical structures, can be considered poly inductive machines (FIG. 5)

Similarly, machines issued from the composition or combination of these machines, act in the same manner, like for example, traction driven semi turbines and poly turbines, meta turbine type machines, poly inductive rotor cylinder, auto pumped machines, peripheral rotary machines (FIG. 6)

Having showed the group of support methods of machines, the group of machines, the final object of the current invention will be evidently to show that all these support methods apply to all these machines, which guarantee the homogeneousness of the current not only of the current invention, but also from the group of works on our object of study.

Fundamental Differences Between Rectilinear Compressive Part Motor Machines and Non Rectilinear Compressive Part Machines

Lets note firsthand that what distinguishes and characterizes piston machines and paddle machines is in fact a geometric difference, the first characterized by a movement of the compressive part in a alternative and rectilinear manner and the second by a non rectilinear movement. After distinguishing this, it seems evident to mention the two following pertinent points:
a) the rectilinear-alternative manner must be heard as the limit figure of retro rotary figures, or even bi rotary and by this, the mechanical realization of a rectilinear can, as we will demonstrate abundantly in the current work, correctly be produced by all the methods forming the mechanical corpus demonstrated here and allowing to correctly support all compressive part of all internal combustion machines. This argument allows to decree that the piston driven machines and paddle driven ones emerge from a same general machine idea.
b) The most standard realization of motor machines with rectilinear compressive action are those produced, for reasons of ease of segmentation, by pistons, whereas the motor machines with non rectilinear compressive parts are produced by paddles. (FIG. 8)
   Piston Type compressive Part Machines

The piston-type compressive part motor machine characterize themselves generally by an interstice between the piston and the crankpin or the eccentric of the crankshaft. The main function of this interstice, or ligatural part, is not only to unify mechanically these two parts but also to carry out the geometric correction between the dynamic rectiligno-alternative movement of the piston and the circular motion of the crankshaft. This part, which we'll name interstice or ligatural, is generally realized, in motors and compressors of the type, as a free rod form.

A second characteristic of these types of machines consist in which we could call the orientation of the compressive part is also free, mechanically speaking. In fact, the orientation of the piston is obtained by its insertion, inside the cylinder by a sliding manner. As for its positional aspect, it is partially assured by the sliding of the piston in the cylinder. In fact, without this sliding, the orientation and the positioning of the piston would be very much random in relation to the circular action of the crankshaft. The sliding action of the piston inside the cylinder then realizes, without undue friction, an essential participation of the mechanical movement, and which allows an appreciated economy of pieces, once built with a single piston. In fact, the possibility, in this type of machine, to equally partition the pressure of each side of the compressive area, the piston, has contributed to allow a simply real simply partial mechanization of it, which has allowed to minimize the number of fabrication pieces, in proportion to those machines in which we must assure the totality of the positional and orientation movement.

The non-rectilinear compressive part machines are generally characterized by the two following assertions;
a) These machines, contrary to the first, do not comprise ligatural parts between the eccentrics or the crank pins of these and the compressive parts, and consequentially a part of the difference of the circular movement of the crankshaft and noncircular movement of the paddle is off-set on the orientation aspect of the extremities of the paddle, which has for consequence the realization of these machines with an irregular cylinder, lie we have already demonstrated by diverse forms.
b) For these reasons, these machines are generally realized with the aid of paddle, or paddle structures, since the cylinders are irregular

In fact, the compressive parts of the non-rectilinear compressive part machines, being the paddles, are generally attached directly in a rotary manner to the eccentric of the crankshaft. This direct coupling has for main effect to deport the movement differences of the mechanical and compressive parts on the orientation aspect of the said parts, which by consequence, forces the realization of these machines with an irregular shaped cylinder, this form absorbing this difference in question.

To the contrary of what's happening in rectilinear compressive part machines, the actions of the extremeties of the paddles are irregular and unequal in relation to each other.

To adequately realize these machines we must, as a general rule, realize not only a positional control of the compressive part, but also an orientation control. This can be realized by using a cylinder as an internal eccentric. With concern to realize the machine without friction in the gasified areas, many mechanics can be, as we have demonstrated and which we will demonstrate once again, used with excellent results.

Base Definition

The two general groups of motor machines which we have briefly précised allows us to enounce here a base definition which will remain invariable not only for these two groups, but also for any motor machines with closed expansion chambers.

In fact, we can define a motor machine as being a machine having the property to transform a non-circular movement, or even circular yet irregular movement of the compressive parts, to a regular circular motion of the motor parts.

Given that the basic examples of this definition are in fact
a) conventional piston engines
b) paddle based engines, being conventional rotary engines, and the triangular Boomerang engine

We can determine two main classes of motor machines, according to whether they're driven by rectilinear action of compressive parts, being piston driven, or by semi-rotary action, being paddle or paddle structure driven. It is important to note that the preceding definition is not limited to these units of this past art, but is rather a general definition which will allow the correct designating, under a same designation, of all motor machines with closed cylinders.

Comprehension of the Definition

Such a definition implies that we have necessarily constructed a mechanical modification method of the irregular movement in form or in speed, of the regular rotation movement of the motor parts.

The base rule of all machines will remain the same. Therefore, in piston machines, standard and orbital type, the alternative rectilinear movement of the piston is transformed into circular movement. In another manner, in the case of said rotor cylinder machines, in which the pistons are vertical, horizontal, or horizontalo-peripherial, the rectilinear alternative movement of the piston is also in part circular and differentiates as well, of another manner of perfectly regular and circular movement of the crankshaft (FIG. 7de). In the case of post and retro rotary machines, the movement of the compressive parts is dynamically irregular and differentiates itself of the circular crankshaft movement geometrically.

As we have stated, the particularity of piston machines is to produce a mechanical control of the piston which an important part is produced by the cylindrated parts. In fact, in these machines, the cylinder participates to the aspect of positional control and orientation control of the pistons, and this all by realizing a minimal level of friction, which cannot be the case in paddle machines. But, this doesn't prevent the base definition which has just been given, but simply allows us to understand the particular case of these machines, offering the possibility to realize them by passing by mechanical support methods that are exact and autonomous, without disastrous consequences. As we will see further, if we want to totally mechanically support the piston, and this without any cylindrical help, we'll see that the piston machines, of simple belonging, are in fact, machines requiring important technologies.

Base Mechanical Methods of Piston Machines

In the matter that relates to piston driven compressive part machines, we'll enounce that we can index six mechanical coupling methods to couple the irregular compression parts to the regular parts of motorization, and that we can name them in the following manner:
a) by linking free rod
b) by sliding
c) by inflection
d) by oscillating cylinder
e) by retro rotary mechanical induction
f) by bi rotary induction

The most known of these methods is that which we have named “by linking free rod”. In conventional piston motors, a rod links the purely rectilinear alternative movements of the pistons to the circular movements of the crankshaft's crankpin (FIG. 9a)

In a second manner to realize the coupling of the differential movements of the pistons and of the crankshaft is realized by what we'll call the sliding correction (FIG. 9b) we'll find abundantly this preceded, for example in the jumping saws.

In a third manner to realize the corrections of the two figure forms realized by the compressive parts and that of the crankshaft will be said to be by inflection. (FIG. 9c) In this case, the movement figure differences will be absorbed by the inflection of the uniting piece. Such a method, more difficultly applicable in motor machines demanding a more considerable effort, but could also be applied with success in motor machines with a much weaker output.

In a fourth manner to realize the adequate coupling of compressive parts to mechanical parts (FIG. 9d) will be the method by mechanical mono induction, which for the moment we will mention but the retro rotary mono induction method. We have demonstrated this method in our patent titled Energetic poly induction machines.

In this method, we'll mount on the crankpin of a crankshaft an eccentric mounted with an induction gear, this gear being coupled to a support gear, of internal type support, and twice it's size, the internal support being mounted firmly on the inside of the machine. This arrangement will allow to realize a movement perfectly rectilinear and alternative of the induction eccentric, to which will be connected the piston, or pistons. Another manner exists, said to be that of bi rotation. This method, which allows like the first, to control the positional aspect of the piston, doesn't allow the control of the orientation aspect, which still needs the runner through the cylinder (FIG. 9e).

A final method allows us to correct the differences of the movement between the action of the piston and the action of the crankshaft, which will be to allow the alternative oscillation of the cylinder in which works the piston (FIG. 9f).

Up to now, we have demonstrated;
a) how diverse methods to combine irregular and rectilinear alternative movements, of the compressive parts of piston types to the circular movement of the crank pins or eccentrics of the crankshaft. We have hence been able to, by a general definition, give the main distinction criteria of piston machines and paddle machines.
b) WE have then demonstrated, more precisely for piston machines, that there exists diverse ligatural methods allowing the transfer of alternative rectilinear movements of the pistons to the circular movement of the crankshaft. We'll demonstrate more abundantly further that all these methods apply to all types of piston engines, whether they be orbital, rotor cylinder, vertical or horizontal and so forth (FIG. 10)
c) Finally, we have demonstrated that different geometries of piston machines were possible, geometries which bring differences between the formation of alternative movements of the pistons in different piston machines.

These unifications and differentiations allow us, already at this stage to enounce many variants, specific according to the ligatural methods used, and if the geometry is more specific of their compressive parts, answer to the general definition which we have brought forwards at the beginning of this exposition.

We are now in measure to compose a first table. It is to be noted that we have placed an X on the units consisting of public property, to the furthest extent of our knowledge. These units aren't presented in such a manner as to conform to homogeneousness, but rather, they have been subtracted from our claims, of all presentation to which intellectual property in this matter.

TABLE I
Motor Machines

| Compressive parts with rectilinear | | Compressive parts with | |
|---|---|---|---|
| movement | | non-rectilinear movement | |
| Standard pistons | Orbital Pistons | Paddle | Paddle structure |

| | | | | |
|---|---|---|---|---|
| Ligatural | Linking Rod | X | | |
| Methods | | | | |
| | Inflection Rod | X | Inflection Paddle | X |
| | Oscilating Cylinder | X | | |
| | Mechanical Induction | X | Mechanical Induction | X |

Base Support Methods for Simple Paddle Machines

The following matters will have for goal to clarify the relation that the paddle type machines establish between the elements and by consequence that which distinguishes them geometrically from piston machines. The following argument must be held as being the foundation of our conception. In basic paddle machines, the ligatural methods such as the corrective rod are subtracted and consequentially, the compressive part, conceived as a paddle, is mounted with a very determined rotary coordination and directly on the crankpin of the crank shaft. Consequentially, a part of the differences between the movement of the crankshaft and that of the paddle is realized as a combination form of the paddle's rotation, in both positional and orientation manners.

Consequentially, since the cylinder absorbs, by it's specific form, in part the differences between the movement of the paddle and that of the crankshaft.

The two main combination methods between these elements are

a) The runner (FIG. 11)

b) Mechanical induction, which the base method is mono induction (FIG. 12)

The Runner

Like before, the runner can be used as a ligatural method of two movements of the compressive marts and motor parts of the machine.

It is noticeable that the ligatural methods presented in the first pages of this exposé, as for example the runner, are also applicable to paddle machines, which confirms the homogeneousness of all machines. However, even if paddle machines can accept ligatural methods, such as running parts, when they're produced for uses which don't require much effort, it remains that when machines realized in goal of an appreciable effort, we must aim to produce mechanics which assure a total control of the paddle, as much positional as orientation. The reason being, as we have already mentioned, that the opposite parts of the surfaces of compressive parts are submitted to different actions which cannot result of an equal push, as it is the case in piston machines.

Mechanical Induction

We demonstrate abundantly in the following exposé that many adequate support methods for the paddle machines' paddles are possible, and it forms a complete mechanical corpus, not only applicable to these machines, but to all motor machines.

For the moment, in this part of our expose, we will be sure to mention that the motor machine's paddles can be totally controlled and motivated as much positional as orientation, as it appears in the previous art of Wankle engines, or even in our triangular motors, being motivated by post rotary mono induction, and the second by retro rotary mono induction. These examples lead us directly to the focus of our next object, which will rest upon the general classes of paddle machines.

The General Geometric Classes of Paddle Machines

Simple paddle machine forms a) post rotary
b) retro rotary
   Definition of Terms

As we have already mentioned, the paddle driven motor machines are specific by the direct attachment of the compressive parts to the motor parts, which leads to a swerving of the movement differentiations between the compressive parts and the mechanical parts towards the exterior of the system, and consequentially the obligation to realize these machines with irregular cylinders, reminiscent, although rounded, to base geometrical shapes.

The following explanations will have as goal to demonstrate that machines with non rectilinear compressive part movement, meaning paddle machines, can be differentiated and classified as retro rotary machines, post rotary machines or bi rotary machines depending on certain geometrical and mechanical criteria.

To ease the comprehension, we'll begin the exposition by the differences that we'll find firstly on a mechanical level during their realizations in their most elementary form, in other words, by the bias of a mechanic said to be by mono induction.

A first version of the post inductive type of motor machines, in which the compressive parts are supported by post rotary mono induction is given to us in the well known Rotary Engine, also known as the Wankle Engine, named after his inventor. In this type of machine, a triangular paddle, armed with an internal gear, is mounted on the crankshaft eccentric in such a way so that the paddle's gear, which we'll name induction gear be coupled to an external type gear, set up rigidly in the side of the machine and which we will name support gear.

Furthermore, in our relative works to triangular engines, said Boomerang engines, we have also emitted the possibility that these engines could be realized by a mono inductive method, comprising, as previously, of an induction gear and a support gear. However, we'll note a fundamental difference between these two types of mono induction by the types of gears used. In fact, in the Wankle engine, the induction gear is of internal type and the support gear is of external type, but in the Boomerang engine, the induction gear is of internal type and the support gear is internal (FIG. 12). We'll observe further that the important mechanical and geometrical effects of these differences.

We'll note that in the group of our works, we constantly use the expressions induction gears and support gears, these nomenclatures relating them as much as possible to their immediate functions, being for the first to induct the movement of the compressive part, and for the second, to serve as support to the action of the second. In our works on the mechanical structures allowing effective support of the paddles of our motor machines, we frequently use gears mounted in a planetary manner, in relation to a second type of gears which serve as a support point. In the group of our works, for a better comprehension, we name the gears fixed directly on the paddle and which lead it in its movement, the induction gears. These induction gears are supported in their movement by fixed gears which we'll name support gears. In addition, we'll refer to the lexicon which we have produced at the end of this disclosure.

Dynamico Mechanical Differences of Post and Retro Rotary Machines

Post Rotary Machines

As we have previously stated, the differences of the gear types used for the realization of the machines will have as consequence the creation of totally different and specific machine classes. We'll name a machine, post rotary machine once the action of the paddle, or the swabbed part, observed by an outside observer, acts in a post rotary sense, in other words, in the same direction of the rotation of the eccentric. (FIG. 13)

From a fundamental mechanical point of view, in other words, mono inductive mechanics, this action, reduced, but in the same sense, is obtained, as we have seen, by using an external type support gear, and by coupling the said gear to the internal induction gear of the paddle.

Retro Rotary Machines

The triangular engine, also known as Boomerang, for the imagery that it realizes during the movement of its paddle, is the most representative of retro rotary engines. The geometric shape of this machine is rather known as being realized by a binary type paddle, turning in a cylinder for a quasi triangular shape. To obtain the movement of this motor machine, once realized in a mono inductive manner as well, we'll mount rotarily a paddle provided with an inductive gear on the crankshaft's eccentric, in such a manner that this induction gear is to be coupled to a support gear set up rigidly in the side of the engine. We have armed the paddle, this time being a paddle of binary form, of an external type gear.

In this type of machine, when mounted mono inductively, the type of gear to use is contrary to that of post rotary machines. In fact, in this type of machine, the support gear is of internal type whereas the induction gear is of external type. This coupling of the gears produces a strong retro rotation of the paddle. The produced result, which defines retro rotary machines in general, is that, when examined by an outside observer, the paddle of this type of machines realizes a rotation in the opposite direction of that of the crankshaft. This is why we call this type of machine, retro rotary machine.

We'll show further that in the current expose like transforming base shapes of machines, and in addition, by which methods we can come to support post rotary type machines by mechanical structures having to normally support retro rotary machines.

Bi Rotary Machines

A bi rotary machine defines itself as a machine in which the paddles or paddle structures are supported by post and retro rotary mechanics in combination.

The most relevant example of this type of machine is given to us by poly turbines. It is therefore important to mention that the poly turbines must be considered as bi rotary machines since, always from the outside observer point of view, the paddle is driven in part in the same direction of the motor part, and in part in the opposite direction (FIG. 13c). We'll suppose that, mechanically, mounted on the forks of a crankshaft two axes on which are regiment related to two induction gears mounted on support gears.

We'll couple the first to an external type support gear, in such a manner as to realize a post rotation, and the second on an internal type support gear in a manner to realize a retro rotation. Two crank pins directly or indirectly connected to the induction gears receive two rods which in turn are at their extremity, connected one to the other. The resulting, during the rotation of the group, of the course realized by the attachment point will be a bi rotary course. If the induction gears and the support gears are realized by reason of one on two, the form realized will be elliptic, and consequentially, we could connect to this attachment point, if it is produced in a redoubled manner, the two opposite points of the paddle structure.

As we will demonstrate more abundantly in the current exposé, many other support methods are possible, and this first method is not the most mechanically simplified. We have however preferred to resent this one first, since by this juxtaposed and contrary double mono induction, we can more easily put in focus the bi rotary aspect of the mechanic. From the point of view of an outside observer, one of the two secondary crankshaft's crankpins acts in the direction of the paddle, and the second acts 'in the opposite direction.

The inventor of the first types of pistonnated parts, which we have named poly turbines, was Wilson (1978), who didn't have a conscience of differences between post, retro and bi rotary mechanical structures, and this is why he was stubborn in realizing the first mechanical version support methods for these engines, which are by nature bi mechanical, thinking that their nature was simply post mechanical. The result was an incapacity to realize the anticipated cylinder forms, a large amount of parts and pieces, negative or even ridiculous couplings, and in addition, a large amount of friction between the parts.

It would be too tiresome to comment totally the realization difficulties that the inventor had to surpass.

We'll simply simplify the proposition by stating that this type of machine is, by nature a bi rotary engine, in other words, in which the form obtained is realized by the contest of two types of rotation. This is also the case, at the limit, of piston engines, when we preoccupy ourselves with but the positional aspect of the piston. These motors, which become rectilinear rod engines, constitute the limit figure between bi rotary and retro rotary figures.

We could conclude, from a mechanical point of view, the fundamental differences between motor machines said to be post rotary, retro rotary and bi rotary, in which the first define themselves as machines in which the paddle has it's orientation course in the same direction as it's positional course, or even in the same direction of that of it's eccentric, whereas inversely, retro rotary machines define themselves as machines in which the paddle's orientation course is in opposite direction of it's positional course, or even in opposite direction of the crank pin or support eccentric. As for bi rotary machines, as they use a combination of both mechanics, the paddle, or paddle structure of this machine is, at the same time, in the same direction and in the opposite of its support mechanic.

Geometric differences Between These Types of Machines

We'll construct more intuitively an idea of the matter which follows by imagining the paddles of post and retro rotary machines as planetary objects of a support mechanic, the first turning in the sense of the mechanic, and the second in the opposite. This will help us grasp intuitively that the form of these paddles are not round, but binary, triangular, or other, but the resulting form will be totally different depending on the direction or the counter direction of its rotation.

This leads us to define a second fundamental difference between these three types of machines, which is rather geometrical. We have determined in a precise manner these differences by what we have named the rule of determination of the relations of the number of sides of the paddles in relation to that of the machines (FIG. 14).

In fact, we'll observe that, in the post rotary class of machines, the number of paddle sides is always superior to that of the cylinder (FIG. 15a). For example, in the Wankle engine, the triangular paddle, therefore three sided, is mounted in a double arc cylinder, therefore two sided. Oppositely, in retro rotary machines, the rule says that the number of sides of the paddles of these machines is always inferior to that of the cylinder. (FIG. 15b). The triangular Boomerang engine type of motor machine, the paddle is of binary type, in other words, two sided, and evolves dynamically in a three sided cylinder, which explains the nomenclature of this engine. As for poly turbine type engines, in other words, paddle structured, they characterize themselves by the fact that they always have a number of paddle sides double to the number of sides in the cylinder (FIG. 15c). The poly turbine furnishes us with a good image of this rule.

As for differential semi turbines, the number of their paddles is completely variable (FIG. 15d)

Generalizations of Geometric Considerations

We have presented, up to now, the three main types of poly inductive machines and how to differentiate them with ease.

The following matters will have as goal to demonstrate that the already exposed machines are not isolated machines, but rather machines comprising a part within a series of machines which we could name the post rotary, retro rotary and bi rotary series.

In our previous patent applications, we have demonstrated that post rotary series are definable, other than their aspects relate to the direction of the rotation of the paddle and the crank shaft, as geometric figures obeying to the rule of which number of paddle sides is always superior to that of their cylinder (FIG. 15). Therefore, a two sided paddle, in this type of machine, will be realizable in a one sided cylindrical environment, or even an arc, folded on itself A three sided paddle, will conceive it's rotation within a double arced cylindrical environment. We'll find in this particular figure the geometry of the Wankle engine. A four sided paddle, which will turn in a three sided cylinder, this figure having already been exposed by Wankle himself A five sided paddle in a four sided cylindrical environment, and a six sided paddle in a five sided cylinder, and so forth.

We can now observe that triangular paddle engines are not isolated machines, but rather elements of a more general machine class.

The side determination rule demonstrates, this time from the geometric point of view, the main difference, not only with triangular engines, but also retro rotary engines in general towards post and bi rotary engines. In fact, as we have done before, we can conclude that this rule will produce more units of this machine type. For all these machines the rule, that the number of paddle sides is always inferior by one to that of the cylinder, remains invariable. For example, for a hypothetical one sided paddle, the cylinder will have two sides, understood as two arcs folded as a quasi circle. For a two sided paddle, we have seen a three sided environment, which is the geometry of the triangular Boomerang engine. As we have done previously, we can follow up by saying that a three sided paddle can saunter in a four sided cylinder, which, we'll remark, is much different of the cylindrical environment of a post rotary. We can realize with a retro rotary machine with triangular paddle twice as much explosion by rotation than for a post rotary triangular paddle machine (FIG. 15).

A four sided paddle will turn in a cylindrical universe of five sides, and so forth.

Finally, we have also showed the generalizations of geometric ratios of paddle structure engines, in other words, poly turbine type rotary machines. In these machines, the number of paddle sides is always twice as much as the sides of the cylinder.

The limit figure is the rectilinear engine, in which the number of sides is of one and two. The four sided paddle structured poly turbine is the most probable though. It is realizable in a two sided cylindrical universe, of almost elliptical proportions. The six sided paddle structure is realizable in a quasi triangular cylindrical universe and so forth. During the determination of the machines, we hold a supplemental determination factor. In fact, starting from this rule, we'll understand better that a machine, with a triangular paddle for example, could be totally different, and even contrary, depending on the type of mechanic used and depending on which type of cylinder geometry is used (FIG. 15).

Thus, in addition to the mechanical differences relative to the direction of turning of the paddles and crankshafts, the ratio of sides of the paddle and cylinder are of a great importance to demonstrate the nature of a given type of machine.

We must additionally note a final type of difference, issued from these last, which will be that of the coupling. In fact, we can note that in these machines, since the crankshaft acts in opposite direction of the paddle, retro rotary machines, whereas the parts act in the same direction for post rotary machines, the high dead time will but much more restraint in retro rotary machines than in piston machines and post rotary (FIG. 14).

The Two Main Exterior Support Methods of Compressive Parts

As we have previously mentioned, in that which relates to paddle machines, we can identify two large base paddle support methods, according to whether they are by runner or by a purely mechanical support method. The obvious deprivation of support methods including runners is that of friction, not only on the pieces or the runner and the runner, but also, in the case of paddle machines, on the surface of the cylinder, serving as both a cylinder as well as the eccentric support for the alternatively rectilinear action of the paddle.

This is why we have developed many support methods of the compressive parts, purely mechanically, in other words, allowing a paddle action completely independent mechanically from the surface of the cylinder.

Exterior Examiner and Interior Examiner

As we have previously demonstrated, we can determine the rotary type more easily, by stating, from an exterior examiner's point of view, the relation of the direction of the rotation of the paddles and mechanical parts supporting them and directing them. Wheras the post rotary machines, the paddles go, although at a somewhat reduced speed, in the same direction as the mechanical parts, in the retro rotary machine types, the paddles move, as we have demonstrated, in the opposite direction of mechanical parts supporting them; in the bi rotary type of engine, the support mechanics of the paddle structures are distributed between these two support types, being the origin of the name's meaning

We can index into two the support mechanics allowing to mechanically realize the observations resulting of this exterior observation.

Mono Inductive Method

The mono inductive mechanic, which we have commented previously, is currently used in Wankle engines. But on the other hand, as previously exposed, by changing the induction and support gears' types, we can realize totally different machines with this method, retro actively used. We'll find in our previously released patent applications, the retro rotary actualizations, in which they result, of which is the Boomerang engine (FIG. 16)

Poly Inductive Method

In our patent, titled Poly induction engine, we have also demonstrated that we could obtain much better performances, as much relatively to the coupling to the material resistance of the engine by using a method by which the paddle was doubly supported.

The base idea of this method consists of demonstrating and determining that the course of points situated between the corners of the paddles and its center realizes a double arc form, in the direction of the cylinder, whereas the course of points located between the middle of each side of the paddle and the center followed a course, also as a double arc, but this time, this form being vertically realized (FIG. 17). We needed to then demonstrate that a link uniting the two fastening points of the mechanics realizing the paddle forms. We have realize this mechanic with the aid of two planetary gears mounted with crank pins, and by cautiously positioning the crankpins in such a manner so that their course was opposite, and consequentially could unite the support methods, to two, to the already precise points of the paddle (FIG. 18a).

It would be cautious to consult our previous patents and patent applications to this effect. For the current circumstances, it is only necessary to recapitulate and to pursue the comprehension of which this method is also a method issued from the observation of on observer situated outside the machine. In fact, even in this method, we see very clearly that once applied to a post inductive machine, this method allows to realize, in said post inductive machines, a post rotary movement of the gears and induction cams, whereas in the retro rotary machines, the gears and induction eccentrics are lead retroactively in the direction of the paddle (FIG. 18b).

Methods Issued From the Observation of an Interior Observer

As we will demonstrate more abundantly further, the location of observation of elements allows us to modify totally the idea which we have made links between the elements and allow us, in direct deduction, to realize different support mechanics and for many, even more pertinent and general. To be more precise, at hand are mechanization methods issued from the observation of an interior examine, positioned on the crankshaft of the machine, a method which we will name relative mechanization methods, in comparison to the first, which we will call absolute mechanization methods.

In our previous works, and even in the current disclosure, we have displayed and we will showcase a group of part support methods for post retro and bi rotary machines, which we could classify in the following manner, in which the first part is issued from our previous works and the second being issued from our current works:

First part, our previous works
a) semi transmission method
b) hoop gear method
c) anterior hoop method
d) posterior hoop method
e) internal juxtaposed gear method
f) internal superposed gear method

Second part, being the current work
g) intermediate gear method
h) intermediate hoop gear method
i) paddle hoop gear method
j) spur gear method
k) central post active gear method
l) gear structure method
m) eccentric gear methods
n) by retro or post active centro-peripherial support
o) by hoop gear and anterior internal gear
p) by hoop gear and posterior internal gear

It is understood that we have not created these methods one after the other. But, after having put many forwards, we have finally understood the essential difference of these methods as a whole, in comparison to the two previously exposed methods. This difference, contrarily to those already exposed, is in the fact that these methods seem to have in common to all run from the observation of the course of the elements, realized by an interior observer, more specifically, situated on the paddle or crankshaft.

In fact, whether it be in a post rotary machine, or in a retro rotary machine, when we observe the movement of the paddle from a location situated on the crankshaft, we'll observe that, in all cases, the paddle realizes a movement opposite to that of the crankshaft, and that which characterizes, from this point of view, the retro rotary machines and post rotary, is a difference of degree, in other words, simply, a difference of the speed of the retro rotation of the paddle in relation to the crankshaft in a post rotary machine, and the rotation of the paddle in relation to the crankshaft in a post rotary machine (FIG. 19)

What distinguishes itself in this statement is of the greatest importance and can be summed up as the two ideas which follow. Firstly, in the previous methods, issued from exterior observation, it would appear as though each of the elements, crankshaft and paddle synchronize themselves with the side of the machine, and as if this synchronization resulted in the desired movement of the paddle. In fact, we'll note in both these methods that the crankshaft doesn't have any effect on orientation with the paddle. In the methods issued from interior observation, since we'll always observe the retro rotation of the paddle in relation to that of the crankshaft, we'll attempt to organize these two movements one in relation to the other, even if we must continue to do so indirectly. In fact, we'll be able to organize the govern not as the first mechanics did, by coordinating the two movements of the paddle and the crankshaft from a same point of the machine, but rather as by coordinating the whole, piece by piece, by intermediate of a point of the machine, of the aspects, not only the position, but also the orientation of the crankshaft and the paddle.

A second statement emanates also from these demonstrations and is demonstrates that these mechanical support methods which will be issued from the observation said by interior, will be applicable as much to retro rotary machines, than post rotary, the differences between them remain geometric, and must simply be calibrated on the mechanical level.

In Depth Description of Each of These Methods

As we have mentioned, some of these methods have already been commented in our previous works, and others are original to priority demands of the current disclosure as well as the current disclosure itself.

However, much like in the current disclosure, we will also show that we can combine them between each other to obtain new types of cylinders for a same machine, or even for new machine types. It is important for us to recapitulate all, independently from the fact that have, or have not been previously disclosed. This is why we will produce here an extensive precis of them, taking caution to note, for previously disclosed methods, the patents and patent applications from which they originated.

Semi Transmission Method

The most obvious example of this coordination is given in the method by semi transmission, which we have amply commented in our previous works.

In this support method (FIG. 20), the paddle is activated by, the movement of the eccentric, and the retro movement of its induction gear, simultaneously, which is obtained by the retro movement of the support gear. The observation from the interior observatory allowed us to state that, as we have already mentioned, the paddle, whether it is in a post rotary or a retro rotary engine, must move in opposite direction of the crankshaft. We'll produce a small semi transmission allowing to inverse the work of the crankshaft to that of the support gear, and afterwards the induction gear, rigidly fixed to the paddle. This support gear doesn't have, in this new version a fixed and absolute position, but rather a position determined by the consequence of the position of the crankshaft. The crankshaft has not only an effect on the paddle's position, but also on its orientation.

It is therefore important to draw a first conclusion from the preceding assertion, as well as the first application method, which we will be able to formulate that, when using the same methods, including, contrarily to the first, the same support and induction gears, could be used in retro and post rotary machines, since we'll simply need to calibrate the gears in such a way as to diminish or increase at this point the retro rotation speed of the paddle in relation to that of the crankshaft, in such a manner so that for an exterior observer, we'll conserve the premises of the first methods, to know the opposite movements, or in the same direction of the paddle and crankshaft which oppose these types of machine.

This statement is also one of the most important since it allows, by realizing motor machine supports with retro rotary prominence methods, to realize, retro rotary machine qualities in post rotary machines, and oppositely, to realize post rotary machine qualities, which we have demonstrated more in detail in our works relative to hoop gear support methods.

Hoop Gear Method

The hoop gear method has also been disclosed in our previous works, and the current has for main objective to specify that its application covers post, retro and bi rotary machine groups.

In this type of support mechanic (FIG. 21) a support gear is mounted rigidly in the machine. A crankshaft, upon which is mounted a clank pin, and in addition to a method, such as a basin or an axe, allowing to receive in a rotary manner the gear which we have named hoop gear. The paddle is provided with an external type induction gear, and is mounted on the crankshaft's crank pin.

The hoop gear is mounted in a rotary manner on the crankshaft's sleeve in such a way to couple indirectly the support and induction gears. The movement of the crankshaft leads the retro rotation of the hoop gear, the retro rotation which is transmitted, by it's exterior face, to the induction gear and to the paddle. This method assures extreme paddle fluidity, and will have as main quality to allow an attack of the paddle, provided with an external type induction gear, from the exterior, from the top. This will considerably limit the after effects, neutralizing the power of the engine, when mounted in a conventional manner.

By Hoop Gear to Anterior Coupling

The method said by hoop gear to anterior coupling is a method similar to the method said by hoop gear, but which the particularity is that the hoop gear doesn't command directly the paddle's gears. In this method (FIG. 22), the paddle is rather provided with an internal type induction gear, by opposition to the external type gear in the original method. In the current method, a second axe is set up on the crankshaft's sleeve and is provided with a single or doubled gear, which we have named linking gears. The action of the hoop gear is transmitted to one of these linking gears which, in turn, directly or by the doubled gear, command the retro rotary orientation action of the paddle.

In the current case, the set up of the axe supporting the linking support gears will be in part located between the center of the paddle and the center of the crankshaft, and consequentially the paddle will be attacked by its anterior side, which is where the term anterior coupling has been derived from.

By Hoop Gear to Posterior Coupling

The method by hoop gear to posterior coupling is a method similar to the previous method, except that in what concerns the support axe of the linking gears is in part prolonged to the exterior of the crankshaft (FIG. 22b)

Method by Internal Juxtaposed Gears

The method by internal juxtaposed gears, which we will find the extensive commentary in our patent applications annexed, consists to set up rigidly, in the side of the machine, an internal type gear (FIG. 23). We'll then mount in the machine a crankshaft, of preference provided with an eccentric rather than a crank pin.

We'll then set up on this eccentric a gear, or a group of linking gears, the support axe of this gear being connected rigidly to the eccentric, being the gear. This linking gear will be in part coupled to a support gear as well as to the paddle's induction gear. The paddle, provided this time around, with an internal type gear, will be mounted in a rotary manner on this eccentric, in such a way so that it's gear is coupled to one of the linking gears.

Method by Internal Superposed Gears

In the method by internal superposed gears (FIG. 24), which we'll find the more extensive description on our previous application, we'll be able to state that we can profit of an increased displacement of the center of the paddle. In this method, as in the previous, an internal type support gear is set up in a rigid manner in the side of the machine. A crankshaft, mounted with a crankpin is mounted in a rotary manner in the machine. A gear or group of liking gears is mounted in a rotary manner on the sleeve of the crankshaft, to a point situated between the center of the crankshaft, and the sleeve in such a manner to connect the induction gears and the internal type support gears.

The paddle is mounted in a rotary manner on the crankshaft's crankpin, and is provided with an internal gear, connected by its closest part to the center of the machine to the linking gear.

Internal Gear Method

In this set up method, we make obvious that the double post rotation of the elements results in a retro rotation of the compressive part. The retro rotation, , as we have already shown, is in relation the crankshaft always present in machines post retro and bi rotary.

In this method (FIG. 25), an external type support gear is set up rigidly in the side of the machine. A crankshaft is then, mounted in a rotary manner, and this crankshaft has the particularity to receive, in a rotary manner on it's sleeve, an external type gear, this gear being coupled to the support gear. This gear can be also provided with an axe, mounted in a rotary manner to the sleeve of the crankshaft, or even, to be mounted in a rotary manner on an axe, the said being set up rigidly on the sleeve on the crankshaft. On this crankshaft's crank pin will be set up, in a rotary manner, the paddle, this paddle being provided with an external type induction gear, this gear, in turn, being coupled to the intermediate gear.

We see very clearly that the post rotation of the crankshaft will lead to the post rotation of the intermediate gear, which in turn, leads the retro rotation of the paddle's orientation. As we have already pointed out, wince this method puts in perspective the paddle and the crankshaft, and is issued from an interior observation, it applies itself as well to post retro or bi rotary machines, depending on the stressing of the retro speed which we have produced on the paddle by the calibrating of the gears.

Method by Intermediate Hoop Gear

The method said by intermediate hoop gear (FIG. 26) is a method in which we use a single gear, being both internal and external, which we'll name for this reason, intermediate hoop. This gear, said intermediate hoop gear, couples as hoop gear, the support gears either to hoop gears, or either to linking gears, but this time by attacking one of the other exteriorly and the other interiorly. This type of gear then produces a post rotary action on the induction or linking gears, depending on the case.

Spur Gear Method

In this method, as is in the preceding method, we set up in the machine a support gear in a rigid manner and a crankshaft, in a rotary manner. This time, however, we'll produce an elongation of the crankshaft, by the part before its main sleeve, and the crankpin (FIG. 27). We then mount in a rotary manner the paddle, provided with it's external type induction gear.

We then set up an axe, in a rotary manner, in the elongation mentioned, and we'll mount on this axe, two gears, which we'll name linking gears, the first of these gears being coupled to the support gear and the second, to the induction gear.

The rotation of the crankshaft will lead a post rotation of the linking gears which will, in turn, lead to the retro rotation of the paddle's orientation.

Method by Post active Central Gears

In the method said by active central gears, a central support gear is set up in a post rotary manner in the machine's body, in which there is also a crankshaft is also set up in a rotary manner (FIG. 28). These two elements are arranged with the aid of a method such means in such a manner that the active support gear has a speed superior to that of the crankshaft. This relation could be obtained by a small semi transmission, consisting of a crankshaft gear, and an support gear's axe's gear, and an acceleration gear, mounted in a rotary manner in the side of the machine in such a manner to couple the two previous gears.

The paddle, provided with an external type induction gear, will then be mounted on the crankshaft's crankpin in such a manner so that its gear is coupled to the post active support gear. The action of the retro rotary orientation of the paddle will then be produced in course of rotation.

Method by Post Active Gear With Double Linking Gear

In this method (FIG. 29) we'll also be able to activate the central active support gear by a set of two linking gears mounted on the crankshaft's spur, this set of external type gears being coupled on one part to the central active support gear, and on another, to an internal type support gear, set up in a fixed manner in the machine's center.

Method by Paddle Hoop Gear

This paddle hoop gear method consists of supporting the paddle simply by gears, with a minimal amount of two (FIG. 30). In this method, an internal type paddle gear is included rigidly inside the paddle. Although somewhat realizable with a single free gear, it is preferable to realize the machine with two of them, or more. Two free gears are mounted on an axe set up on the crankshaft. A second gear, serving both a supportive purpose, as well as a directional purpose, will be mounted in a rotary manner on the crankshaft's crankpin and is also coupled to the hoop gear. The paddle is therefore supported by these three gears, but its orientation is directed by the induction gear, this gear being, as usual, coupled to a support gear.

Method by Gear Like Structures

In this gear like structure method, we'll suppose, out of preference, four dynamic support gears mounted in a rotary manner on or by the axes set up rigidly inside the machine. The center of rotation of these gears will be off-center, which is why we'll qualify them as eccentric (FIG. 31)

A paddle, provided with an internal type support gear will then be set up by this gear, on the post active support gear group.

The resulting action of the paddle will be the desired movement. This realization is interesting since it allows the realization of the machine with deep centers. However, many motorization methods will be possible, for example, by providing the paddle with an extrusion by which it is mounted on the crankshaft's eccentric, or even by mounting each eccentric gear with a non eccentric one, these gears being connected to a central gear, activating the central axe.

By eccentric Gear

In the current set up, we'll provide each piston with a fixed axe, preferably three, these three axes being preferably mounted on symmetrical lines, like for example, those crossing the paddle of each point to the center, or even those crossing each center sideways towards the center (FIG. 32).

These specific gears, said eccentric gears will be mounted on these axes in such a manner to be coupled as well as applied on a support gear set up rigidly in the side of the machine.

Consequentially, the movement of the paddle will be assured. To prevent the separation, or the uncoupling of the induction gears to the support gear, we'll be able to add a linking plate, connecting the centers, the reattachment points, or even any other point, from the moment they're symmetrical. We'll even be able to connect the gears by an internal hoop gear pivoting eccentrically during the course of rotation.

Consequentially, the three following motorizations will be possible, by either, firstly, an eccentric placed in the center of the paddle, this eccentric having a strongly diminished friction. A second manner will be to use the gear's centers, which will transmit their centered action to a central axe. Finally, we'll be able to use off-centered supports, or the hoop gear, these final pieces being provided with an internal gear activating an exit axe.

To adequately complete the machine, we'll use a means to link, between them, the eccentric gears. They could be held between themselves by a linking plate. If this linking plate is connected in a central manner, it could also serve as a motorization method.

By Retro or Post Active Centro-Peripherial Support

In this method (FIG. 33), it is the main goal to demonstrate that we'll be able to support all paddle by two points, in which the first will be central, and the second will be peripherally determined, the mechanics of both these connecting points of the paddle being inter connected by gears or other methods. A first example of this new support method will consist of building the machine from a conventional eccentric, provided with a gear, as well as a single poly inductive block, including an induction and induction cam support gear.

The induction eccentric, which will govern the paddle orientation, will be activated in a conventional manner. As for the master, central eccentric, which governs the positional aspect of the paddle, will be activated by a method, for example by the mediation of an intermediate hoop gear, by the induction gear. In another manner, it will be activated by the support of a hoop or intermediate gear, to a second induction gear, the second being coupled to the support gear. Finally, the use of this knowledge will allow us to produce poly turbines or other paddle machines. We'll note that these poly inductive support methods proposed will allow not only the support of the paddle points, but also the opposite sides.

Method by Deported Attack Gear

Another support method has for objective to deport the attack point on the paddle on the side towards the center, in such a manner to, as much for retro rotary machines as for post rotary machines, allow us to profit from the retro rotary effect on the paddle as well as it's lever effect. This method is a hybrid one, concluded from internal superposed gear methods as well as internal juxtaposed gears (FIG. 33).

To do this, we'll use a support mechanic formed of a group of gears, a fixed support gear and crankshaft support gear. A first variant of this manner of doing will consist of using a fixed support type gear of internal type set up in the side of the machine and the secondary support gear of the central eccentric, will be an external type gear, mounted in a rotary manner to it's extremity, in such a manner as to couple the fixed support gear and the paddle's induction gear. The induction gear of the paddle will be an internal type induction gear mounted rigidly on the paddle. In the second variant, the fixed and induction type support gears and will rather be external. This guidance solution recalls the hoop method and intermediate gear method. However, by this solution, we have successfully deported the induction gears'attack point in such a manner as to increase the lever effect. This solution thus comprises of a few supplementary gears, but in the cases where the power is necessary and we can allow this augmentation, this method will strongly be valid and pertinent.

Such a fitting of gears will allow to off-set the orientation's attack point on the paddle of the opposite side of it's retro rotation, which will allow to increase significantly, either by the length of the central eccentric, it's reach of on the paddle of the opposite side of it's retro rotation, which will allow to increase significantly, either by the length of the central eccentric, it's reach of flow and lever. This method brings much aid as much for post rotary machines, as for retro rotary ones.

Main Deductions of the Support Methods as a Whole

We must deduce from the final methods the following statement, one of the most important, which consists of noting that, when machines are supported by mechanics issued from exterior observation, being mechanics said by mono and poly induction, post and retro rotary machines are completely opposite one another.

In adition, when the machine are observed from mechanics issued from the observation of an interior observatory, situated either on the crankshaft or the paddle, these machines caracterise themselves by differences, rather than similarities. This statement is one of the most pivotal since it allows us to state that all mechanics issued from this type of observation apply as well to retro rotary machines as to post rotary machines, which allows us to consider a certain generalization within the machines. We now have fifteen parts support methods to add to those already commented.

We can now, at this point produce a new, more complete table of the variants of all motor machines, including the final parts of the current disclosure. We'll add the mainly the differentials realized in the current section, being:
Firstly, that the paddle machines subdivide into post, retro and bi rotary machines.
Secondly, that the support methods subdivide into two main classes, depending if they were issued from interior observation or exterior observation.

Thirdly, that a set of support methods pat enough to adequately support the paddles can be indexed.

TABLE 2
Motor Machines

| Compressive parts with rectilinear | | Compressive parts with | |
|---|---|---|---|
| movement | | non-rectilinear movement | |
| Standard pistons | Orbital Pistons | Paddle | Paddle structure |

| | | | | |
|---|---|---|---|---|
| Ligatural | Linking Rod | X | | |
| Methods | | | | |
| | Inflection Rod | X | Inflection Paddle | X |
| | Oscilating Cylinder | X | | |
| | Mechanical Induction | X | Mechanical Induction | X |

| | | | | |
|---|---|---|---|---|
| | | Retro | Post | Bi |
| | | mechanical | mechanical | mechanical |
| Number of | Boomerang | 3 | | |
| cylinder sides | | | | |
| | | | 2 | |
| | Polyturbine | | | 2 |

Types of ligatures by mechanical induction
Post rotary mono induction
Retro rotary mono induction
Post rotary poly induction
Retro rotary poly induction
Hoop gear
Anterior hoop gear
Posterior hoop gear
Internal juxtaposed gear
Internal superposed gear
Intermediate gear
Spur gear
Central active gear
Paddle hoop gear
Gear like structure
Eccentric gear

Piston Machines as Mechanical Induction Machines

As we have already brought to attention, the extremely abundant and generalized use of piston engines, using as the main ligature method, a combination of rods, running pistons and cylinder, leads automatically to believe that these forms of engine realization are generic, which is false in our opinion is false. In our opinion, the equal pressure on the compressive parts is the main factor allowing us to totally neglect the realization of the machine by a totally mechanical control of the positional aspects and the orientation of the compressive parts. The natural equality of the push on the compressive parts has thus allowed us to use, on the practical lever of shortcuts, which can not however, alter the conceptual nature of these machines. As we have already noted, if we try to produce these machines with a perfect mechanical coordination of the compressive parts, this time, as in paddle machines, totally independent of the cylinders, we'll realize the real complexity of these machines which, after analyses an alternative, difficultly realizable aspect of orientation.

The following section will demonstrate that we can control mechanically, without any ligature method, the strictly positional aspect of the piston by one or the other of the support methods of the mechanical block previously proposed, which will prove beyond a doubt that piston machines, in spite of their generalization of their positional control as a running form are all good and well, conceptually, of motor machines of the same order as paddle motor machines, and emerge from the same general definition initially given.

In this realization we'll apply the retro rotary mono induction method to pistonnated compressive part machine. To realize this type of machine, we'll install in this machine a conventional type crankshaft. On it's crankpin, we'll set up in a rotary manner an eccentric, of equal radius to that of the crankshaft, and we'll provide it with an external type gear which we'll name induction gear. We'll then set up in the side of the machine an internal type gear, which we'll name support gear, this gear being double the size of the induction gear. The two gears just described sill be coupled to one another. We'll be able to hear the eccentric as a rod in which the directional aspect is governed, or even as a secondary layered crankshaft, as it'll seem necessary. The piston, directly or by means of fixed rods, depending on the scenario, will be attached to this eccentric. The post active movement of crankshaft's crankpin will lead the retro rotation of the eccentric, and we'll notice that, by observing the ensemble for a rotation, that the vertical movements of the rotary parts will add up, whereas the lateral parts of these movements will cancel themselves out. Consequentially, the movement of the eccentric will be alternative and perfectly rectilinear. (FIG. 35)

As we have already more precisely commented, a second manner to build the movement in an alternative rectilinear one will this time be bi rotary. If we couple in fact, by some means, two crankshafts in such a manner so that they turn contrary to one another, and to which we'll attach each of these crankshafts, to a rod, linked between each other at their other extremity, we'll realize that during the rotations, the extremities by which the rods are linked produces a perfect rectilinear alternative, to which can be attached the piston (FIG. 35).

In both previous manners, the orientation aspect of the piston will be controlled in a convetionnal manner, in other words, by the running of the piston in the cylinder, but it's orientation aspect will be totally controlled by the mechanical induction paddle.

In fact, if we push the analysis furthers, we'll realize that we can consider the purely rectilinear action machine, in other words, a simple piston machine, as if it was a limit machine between the post, retro and bi rotary machines.

The consequences of this final realization will have as effect that the rectilinear mechanic, allowing a direct support of the pistons, or even by fixed rod, will allow to realize a strictly rectilinear action of the said part. This contribution will allow, from this point on to isolate the inferior part of the casing's cylinder, and consequentially produce the machine with a two time gas management, without need to add any burning oil, the lower part of the cylinder serving as an aspiration pump of fresh gas to be injected in the cylinder.

Piston Machines as Mechanico Inductive Machines: Generalization Methods

We have thus determined in our first demonstration that piston machines, from a positional view of the displacement of the said, being in fact machines describing the limit figures of retro and bi rotary machines.

The following matters will have for object to generalize, for piston machines, the use of all support methods previously exposed, which will prove beyond a doubt, the mechanico-inductive aspect of these machines. We'll show that in fact, we can use suitably all these methods applied to rotary machines, to activate the central piston axe of piston machines, and this as in mechanical induction machines, without the use of any rod.

A first generalization of the use of these methods will be given to us by the hoop gear method.

In fact, in this realization, we'll be able to show in the machine, a crankshaft on theclankpin on which, as previously, we'll install an eccentric, or a rod provided with an external type induction gear. Then we'll link these two gears by a hoop gear, mounted in a rotary manner on the sleeve of the crankshaft. We'll note that, if these gears, or even the length of the eccentric is correctly calibrated, the hoop gear, as in previous versions, will realize a retro rotation during the rotation of the crankshaft, which, transmitting itself to the induction gears and to its eccentric, will cancel out the lateral aspect of the said and will add the vertical aspect to that of the crankshaft (FIG. 37).

A third example, will be that of the use of the intermediate gear method. We'll show as previously the crankshaft inside the machine, and we'll mount on it's crankpin an eccentric, or a rod, as previously provided with an induction gear. We'll then mount in a fixed manner in the side of the machine or on an axe to this effect, a support gear. We'll then couple the support and induction gears by means of an external type tiers gear, said intermediate gear, this gear being mounted in a rotary manner on the crankshaft's sleeve (FIG. 37).

We'll then be able to take all the methods previously exposed and realize with them the mechanico-inductive support of the positional aspect of the piston machine's pistons. In fact, we'll automatically obtain many new rectilinear action machines, adding themselves, to the already patented methods by mono inductive retro rotation.

We'll then produce, in addition to rectinilear rod engines, for example, by anterior, by posterior, hoop gear, by semi transmission, by internal juxtaposed gears, by internal superposed gears, by intermediate gears, by spur gear, and so forth (FIG. 38).

In each of these cases, it will be the goal to systematically replace the paddle connected to the induction bears by an eccentric or a rod mounted with an axe and to connect one of these parts to the pistons of these machines. In all of these realizations, the crankpins or the eccentric of these machines will produce with great exactitude the rectilinear we've been searching for, and could consequentially activate the pistons without any positional governing effort of the cylinders.

We have just automatically determined more than sixteen ways of realizing piston machines in which pistons will be activated directly by the mechanics, or even, by resortingto rods in which the action will be purely rectilinear.

This is of high importance since all and each of these methods, like the first method by mono inductive retro rotation, could allow us to close off the cambers, at the bottom of the piston and isolate them in the crater. We'll be able to consequentially produce, with all these manners without exception, motors with two time gas management, but this time around without any necessity to add combustible oils to the combustion gas.

Each of these engines could not only replace actual two time engines effectively, but also, since the burning gases will be more pure, they could replace four time engines as well.

Generalizations of the Group of Shapes of Piston Engines

As we have demonstrated, amongst ligature shapes already enounced by us in the beginning of analysis, that said by mechanical induction could be heard under all the diverse forms which we have commented.

In addition, we have also showed, in figure ten, that the piston machines could be realized as a form consisting of many machine geometries, as for example, standard, orbital, by rotor cylinder, etc.

It is then important to mention that the mechanical extentions which we have produced, by taking for example the standard form of realization of piston machines, apply automatically to all other forms of piston motor machines. In other terms, we'll be able to differentiate many types of orbital piston machines not only by their ligature type usedy, by free rod, by runner, by flexible rod, and so forth, but to go further in the precisitons, once they have been realized by mechanical induction, by précising the type of mechanical induction used. In fact, we must necessarily deduce that we have established that we could realize orbital engines by cutting off the rods in sixteen different mechanico-inductive ways already indexed. We'll then be able to realize orbital engines by mechanico inductive ligatures, said by retro mechanical mono induction, or even by mechanico inductive ligature said by intermediate gear, and so forth.

These possibilities will remain more realizable for machines, rather than pistons, which have to be vertically, obliquely or horizontally set up.

In the same manner, we could realize rotor cylinder engines with, for each piston, an action of the sort.

The group of these methods will also be applicable to differential machines, in the measure in which we realize the commanding horizontal rectilinear action of the paddles. This is why we'll add this possibility to the current table, a table which will give a range of variables of more than three hundred possibilities of motor machines.

The group of these final precisions helps us widen the table of the group of motor machines in such a manner to consider these new variants. The new table will thus be the following. As previously, we'll add an X to machines which are already of public use.

TABLE 3
Motor Machines

| Compressive parts with rectilinear | | Compressive parts with | |
|---|---|---|---|
| movement | | non-rectilinear movement | |
| Standard pistons | Orbital Pistons | Paddle | Paddle structure |

| | | | | |
|---|---|---|---|---|
| Ligatural | Linking Rod | X | | |
| Methods | | | | |
| | Inflection Rod | X | Inflection Paddle | X |
| | Oscilating Cylinder | X | | |
| | Mechanical Induction | X | Mechanical Induction | X |

| | | | | |
|---|---|---|---|---|
| | | Retro | Post | Bi |
| | | mechanical | mechanical | mechanical |
| Number of | Boomerang | 3 | | |
| cylinder sides | | | | |
| | | | 2 | |
| | Polyturbine | | | 2 |

Types of ligatures by mechanical induction
Post rotary mono induction
Retro rotary mono induction
Post rotary poly induction
Retro rotary poly induction
Semi transmission
Hoop gear
Anterior hoop gear
Posterior hoop gear
Internal juxtaposed gear
Internal superposed gear
Intermediate gear
Spur gear
Central active gear
Paddle hoop gear
Gear like structure
Eccentric gear

Paddle Machines: Towards Ideal Shapes for Cylinder Machines

As we have already mentioned many times, the post rotary, retro rotary and simply, rotary machines are base machines, which we can obtain, by mono induction or by poly induction with non modified simple gears, or with the previous methods.

The most general characteristics of these figures are to the effect that generally, the post rotary figures are more rounded, whereas retro rotary figures are sharper. The bi rotary figures are situated between both. We'll obtain a decent image of these figures by observing the course of the points situated on the planetary gears mounted in a post and in a retro rotary manner, in the machine (FIG. 39).

During their realizations as all sorts of motor machines, compressors, capitation machines, engines, which we could note that the more obtuse shapes of post rotary machines allow easier, in their cylinders, the construction of compression. The shapes vary from very blunt to slightly blunt, depending on if we place the point course in the most approached manner, or furthest manner from the center or the circumference of the planetary gear, said inductive.

As for retro rotary machines, we are forced to notice that the compression ratio which they build, in direct consequence to the sharp aspect of their cylinder is minimal.

As for that which relates to bi rotary type machines, such as poly turbines, the compression is acceptable.

Contrarily, as we have already demonstrated, the coupling relations are much more interesting in retro rotary machines, since the system formed by the crankshaft and its paddle deconstruct themselves much quicker. This increased deconstruction is obtained by the fact that the paddle displaces in opposite direction to that of the crankshaft. Contrarily to post inductive type machines, the couple is weak enough, the system constituted of the crankshaft and the paddle deconstruct themselves more difficultly, the crankshaft displacing itself in the direction of the paddle.

As for bi rotary machines, as for the case of the compression, the couple being half realized in a post and retro rotary manner, we are at the level of that between the two capacities of the first machines. However, as we have already demonstrated, the specific form of the paddle structure, allowing to support in only two opposite points, makes possible to realize the machine without any dead time. But the causes of this fact are geometric, and we won't delay on this aspect much longer, preferring for the moment to encircle the mechanical aspect.

Following these statements, the following propositions will thus have for object to demonstrate that we can, for these first three types of machines propose the realization of them with, for each of them, redesigned cylinder shapes, in other words, corrected in such a manner to realize an optimal compression rate, which will allow, as we'll see, to correct simultaneously the relative faults to the coupling and consequentially to present machines in which the coupling and compression will be perfectly calibrated.

Mainly for these types of machines, the objectives to realize are, for post rotary machines, to diminish the width of the cylinder arcs forming their compressive and offensive phases, whereas oppositely for retro and bi rotary machines, to augment the bombing of the arcs and their respective cylinders. Simply put, it'll be the case to render the post rotary machine cylinders, more post rotary, and to render retro rotary and rotary cylinders, more retro rotary. This is why we speak of post rotary hybrid machines, retro rotary hybrid machines, and bi rotary hybrid machines.

In the following pages, we'll demonstrate for all of these machines, how to realize them, this time around, with curves and ideal cylinder shapes, which make their compression and couplings optimal.

To accomplish this, we'll show four proceedings of appropriate mechanical modifications, which the application will have for result the correct realization of ideal cylinder shapes. Relatively to these ideal forms, we'll find the detail of these considerations in the pre-cited demands. As for proceedings the form modification, we'll also find these in our patent application titled Geometric considerations of poly inductive set ups of post and retro rotary machines.

We can index the main modification proceedings of cylinder for in the following manner. It is a matter of the following proceedings:
a) By runner (FIG. 40)
b) By free rod (FIG. 40)
c) By active center (FIG. 41)
d) By hoop gear (FIG. 42)
e) By geometric addition (FIG. 43)
f) By layering and juxtaposition (centered or irregular movement) (FIG. 44)
g) By poly cammed gears (FIG. 45)

Afterwards, we'll show that we can even use these proceedings in composition, allowing thus to operate in a same moment many levels of modifications and allowing thus to realize more complex machines, with more irregular cylinders, such as quasi rectangular cylinders, machines designated by the term Metaturbines.

General Problem

To better understand the objectives of the current section, we'll give certain specifications relative to the general problem posed. As we have already mentioned, the three base classes of machines all suffer from geometric defaults of the cylinder shape, realizing for certain compression surpluses, and for others, a lack of compression.

The three base examples are clear on this subject. Firstly for post rotary geometry engines, in which the first example is the Wankle engine, even supported by a retro mechanic structure or bi mechanic, the cylinder is too rounded and too large for its height, which leads an excess of compression which we must diminish by cutting off a part of the paddle (FIG. 39a).

In the case of retro rotary engines, which the main example is the triangular Boomerang engine, the standard solutions result in a strong couple, but consequentially results in a lack of compression. In these cases, the compressive parts will construct a better compression if these parts would be more rounded (FIG. 39b).

As for poly turbines, contrarily to Wankle geometry engines, and similarly to those of triangular geometry, these cylinders should be rounded and widened, such as we have mentioned in our first patents to this subject.

Correction Methods

Runner Method

As for all first degree machines, the first method of correction is the runner method. We could, in fact, use the runner to correct a first degree induction, to bring it to a second degree, and thus correct the curve of the cylinder. The most illustrative example of this procedure applied to mechano inductive machines, is that of the triangular engine.

In this type of engine, to operate a runner type correction, we'll need to set up in a non inductive and retro rotary way the rotor which will serve as paddle support. This rotor will be planetary and will produce the same action of the paddle, in this type of engine (FIG. 40c). We'll produce this rotor with a runner in which we'll set up the paddle, in a running manner, both the extremities of the paddle being submitted, to the contact of the cylinder, the internal eccentric action of the said part, which will complete the mechanical actions motivating the orientation and the position of the paddle. The running action of the paddle in the rotor, in relation to its absolute action in the lower versions, allows to round out the cylinder in its sides, and to diminish the corners, which will increase the compression rate.

Method by Free Rod

The rotor of the machine, for example, post inductive, could, rather than directly supporting the paddle, support by means of free rods. The rods must be connected between themselves by gears conserving their angular intact relations. This method doesn't seem easily utilizable, so we won't comment on it more abundantly (FIG. 40d).

By Active Center

A fourth method, of advantageous correction of the machine shapes will be designated as the active support gear. For a better comprehension of this method, we'll use the post rotary Wankle geometry engine, however, mounted from our poly induction method with two supports, and opposite courses, as well as the base type retro rotary machine, the triangular Boomerang engine.

As we have already mentioned, the contrary courses of the points located on the lines from the centers to the points and on the lines of these centers of the sides to the centers, realize, one horizontally, and the other vertically, the courses of a double arc, realizable by crankpins or eccentrics mounted rigidly to induction gears coupled to support gears. The relation of the number of arcs to realize, forces literally a certain relation of gear size. In the current case, a relation of one by two is imperative, whereas in triangular engines, a relation of one by three, as well as an internal type support gear are imperative. As we have demonstrated previously, we can modify the amplitude of the arcs formed according to how we set up the crankpin in a manner more or less approached to the circumference of the induction gear or it's center of rotation, such as demonstrated in FIG. 41b. But the amplitude of our corrections leads to difficulties, mainly the sharper aspects of the moments of directional change, realized between the end of an arc, and the beginning of another. It appears as though we must be able to modify the width of the cylinders without necessarily modifying the height, and without consequentially making this aggravating situation appear.

To accomplish this, we must understand that the relation of the gears play directly on the height and width relations of the realized shapes. Consequentially, to modify these gears, without modifying the relations, we must abolish their absolute position inside the machine. In fact, if we follow a point situated directly on the circumference of the induction gear during its rotation, the height of the realized shape will be half of that of its width. We can however voluntarily modify this relation from the moment where we subtract the absolute and static aspect of the support gear and which we have realize the machine, this time, with the aid of an active support gear. In the case of the Wankle geometry engine, for example, if we use a support gear twice the size of its initial size, it is certain that we'll modify the width and height relation of the form realized, by diminishing the width of the machine in relation to its height. But, as this gear is too large, we must imprint a post rotary action to cancel out this effect. This could be produced by a small post rotary semi transmission, such as the one commented previously.

In the case of retro and bi rotary machines, we must realize the opposite effect, to know how to enlarge the cylinder by rounding. In the case of triangular engines for example, we'll need to choose the largest induction gear, in such a manner that the arc relations don't get modified, we'll need to consequentially imprint to the support gear a retro rotary action, also by small semi transmission.

It is to be noted that we'll be able to modify the same figures by opposite relations of gears, for example, oppositely by augmenting the size of the induction gears in Wankle geometries (FIG. 41d). In this case, we'll need to retro activate the support gear. Contrarily, if we diminish the size of the induction gears inside retro rotary types of machines (FIG. 41c), we'll need to post activate the support gears. It is to be noted that we can also act in the opposite manner and obtain other cylinder shapes, possessing other qualities and faults.

This is why we'll specify these types of machines as being, for example, post inductive with post active or retro active support gears.

Small semi transmissions could easily execute the post or retro activation work of the support gears. We must put in relation these gears with the crankshaft in such a manner to obtain the discounted result. It'll be the case to garnish the axe of the crankshaft and the semi transmission gear's support gear, united to each other by a third gear, mounted in a rotary manner in the machine, and which will be used as an accelerator gear or inversing gear.

Method by Hoop Gear, Intermediate Gear, and Intermediate Hoop Gear

During the exposition of these methods, we have supposed that the lengths of the hoop, intermediate or intermediate hoop gears be standard.

The current section has simply for effect to comment the idea that the sizes of these gears are very variable, and no matter what size they are, they'll always have the same incidence relation of the support gear's gears versus that of the induction gear's gears. In other terms, a same given rotation of the crankshaft for a same gear support, will always have a retreat effect of the same number of teeth of the hoop, intermediate or intermediate hoop gear, whatever it's size and, secondly, this last gear will always have the same retro rotary effect on the induction gear, whatever it's size (FIG. 42)

What emanates from this affirmation is that we can vary the size of the hoop, intermediate, or intermediate hoop gear, without varying the rotation relation of the planetary induction gear and consequentially, the paddle which is attached. In other terms, we can modify the distance relations between the gears without changing the revolution relations of these gears.

We'll then be able to modify the geometry of these figures. For example, we could reduce the lateral shape of the post rotary machines, or even augment it in the post rotary machines.

By Geometric Addition

The method by geometric addition will be strongly used. In fact, from a geometric point of view, we can demonstrate that an addition of a segment of a given length to a piece turning in a retro planetary way produces the exact same course of that realized by bi inductive mechanics. In fact, we'll see that by adding a segment to a retro rotary system, the realized shape, firstly retro rotary, passes progressively to its limit form, then, by adding the segment, becomes bi rotary. (FIG. 43)

The most illustrated case is that realized by a planetary mounted in a retro rotary manner in a gear, thus of internal type, twice its size. The shape created, once the crankpin is located between the center of this gear and its circumference is of retro rotary type. Once the crank pin is located, at its limit, on the circumference, we realize, as previously demonstrated, an alternative segment. Now, if we add to the system a segment, represented by a geometric rod, we pass in the field of bi rotary shapes, which the ellipse is one of the main figures.

The obtained form is thus equivalent to that which we'd have obtained by a mechanical bi structure and is thus consequentially bi mechanical.

The geometric addition has thus allowed the necessary correction to change the machine category and level.

We'll note that the geometric rod could be, afterwards, as we'll demonstrate further, applied to all methods of the mechanical corpus exposed to the present, and realize the same results of that which we have just demonstrated, which will allow to realize many adequate poly turbine support methods.

Method by Combination of Juxtaposition and Layering Methods

Another manner to adequately modify the course of the paddles will be that of a combination of methods.

The best ways to conceive an exact idea of this method will be to well understand that we can correct the course of the paddle by producing a correction which will modify the first form obtained, said first degree form (FIG. 44a).

We can, in another manner, think of things differently. In fact, up to now, in all the studied machines, we have supposed a course of paddle center, in other words, a circular positional course.

In the current method, we'll treat in a differentiated manner the orientation and position aspect of the paddle. However, we suppose that there exists a certain correlation between both of them. In fact, we suppose that modifications brought to the positional course of the paddle will have an incidence on the course of its extremities, and consequentially on the form of the cylinder realized by the said, during its double rotation, from the position and orientation aspects.

We'll then induce in the center of the paddle a non circular movement, all while continuing the mechanization of it's orientation in such a manner so that during its new positional course, it's orientation course will not be modified.

We'll thus always produce the machine with specific mechanical inductions of the position and orientation aspects. The two most common machines, being triangular Boomerang engines and the Wankle geometry engines will serve as examples . . . .

In the first, we'll aim to replace the circular course of the center of the paddle by a clover shaped course, each of the petals of this clover approaching to the sides. We'll thus produce a retro rotary mono inductive mechanic, governing the eccentric on which will be set up the paddle. In addition, as we intend to keep the paddle's retro rotation similar to that of the original machine, we'll activate, also by mono induction, this time layered, which will assure the orientation governing. The rotary figure realized by the paddle will thus be a combination of both these figures, and consequentially, through its retro rotation, it'll go deeper into each side, realizing thus strong compression rates (FIG. 45).

The example of the Wankle type geometry engine will be similar, by its mechanic, but completely different when it comes to the result. As we have already demonstrated, this type of machine suffers from over compression, caused by its excessive rounding of the lateral parts of the cylinder and its lack of compression.

A modification by layered method combination will correct both these problems at once.

As previously, we'll abandon the idea of realizing a circular positional course of the paddle. In the current case, we'll realize a center course of the paddle which will have for object to reduce the lateral movement of the parts. We'll then produce a course of the center of the paddle which is less large than high, thus elliptical and vertical. To do this, we'll use a structure similar to that already showed for the support for poly turbines by the addition of a geometric rod. We'll thus use a retro rotary mono inductive structure with the addition of a geometric rod, taking form as an eccentric in this case. This eccentric will thus realize an elliptical course and will receive the paddle. A second mono inductive structure, this time layered, will couple the paddle, by it's induction gear, to the support gear, set up at the height of the crankpin on the crankshaft, which will allow to realize a movement of the paddle similar to the original orientation movement, in spite of the modifications brought to its positional course.

By observing the mechanic, we'll realize that in addition to having cancelled out the over compression of the machine, we have also strongly increased the descending torque, since the double reversed crankshaft which supports the paddle not only has an adequate total length, but also acts as a lever.

Particularizations and Generalizations of the Combination Method

It is important to mention that the control of the positional parts of the eccentrics and the orientation aspect of the paddles can be made as much from retro rotary mechanics as from post rotary mechanics, depending on the figure and the correction chosen.

It is also important to mention that the paddles could also be provided with an induction gear of either internal or external type. In the later case, if they can be activated by an external type support gear, set up rigidly on the crankshaft at the height of the crankpins, or even by a linking gear (FIG. 47) which would be mounted in a rotary manner on the crankshaft's sleeve.

It is to be noted that, which is of the uttermost importance, that we must in addition, enounce here a general combination rule not only for mono inductions between themselves, in a juxtaposed or layered manner, but all the inductions forming the corpus by inductive methods given up to present. In fact, we must consider as an important rule that all method can be combined with another, in a layered or juxtaposed manner, to carry out the positional control and the orientation of the paddles and in this manner, coupled by an induction, for example, by mono induction, by hoop gear, to the side of the machine (FIG. 48). We'll be able to, for example, combine positional induction control by hoop gear to an orientation induction control by mono induction (FIG. 48a). We can also combine a positional method of control by mono induction and an orientation control method of poly inductive type (FIG. 48b). Although impossible to comment exhaustively all the combination methods, we'll be able to refer to supplementary figures which we have annexed for many supplementary examples.

A final figure case in these matters is that of the case in which the paddle will be provided with an external type induction gear and will be linked directly to a support gear in the side of the engine.

In this case, we'll need to realize either a paddle induction gear, either an irregular support gear, in such a manner that the support and induction gears remain coupled to one another in all point of the rotation, in lack of the irregularity of the displacement of this induction gear issued from it's eccentric course.

We'll call these irregular gears, eccentric gears and polycamed gears (FIG. 49). The final type of correction will be said by polycammed gears (FIG. 50). In this final correction type, the central course of the paddle remains circular, but the orientational speeds of the retro rotation of it are affected alternatively in an accelerative or decelerative by the use of specific couplings of eccentric gears and/or polycammed gears, for which we will give more ample explanations.

Eccentric Gears and Polycammed Gears

We'll find in our previously cited patent applications, the detail of the current section, which presents only the main characteristics of the eccentric and polycammed gears applied to motor machines.

As we have demonstrated, we can couple an irregular shaped gear to a regular shaped gear if the displacement of one of the two gears is in itself irregular (FIGS. 49, 51a).

We can also set up in a rotary manner on the fixed axesby coupling two simple irregular shaped gears, or even by center of the eccentric's rotation, in such a manner so that they always remain coupled. To do this, we couple these said eccentric gears in such a manner so that the standing and lying positions of one be alternatively complementary of the standing and lying positions of the other (FIG. 51a).

We can also modify the turning relation of these gears and by conserving one which will remain eccentric, and by producing a second, which the center of rotation will be well centered, but which the form will be irregular, it as well in a manner to posess more than standing or lying part, these standing and lying parts being alternatively coupled to standing and lying complementary parts in the eccentric gears (FIG. 51b). We'll call these gears having many lying and standing parts polycammed.

We can now render the relations of these gears even more complex by combining to polycammed gears. Finally, we can, realize these gears as other types, such as internal gears, by tooth rack.

In the same manner in which we can assemble as other formulas than on the fixed axes, which for example here as planetary paddles, or even as induction gear or support gear form (FIGS. 51a,b,c,d).

Application Rules in Motorology of the Eccentric and Polycammed Gears

The three following rules can be put forwards, relatively to the use of such types of gears in motor machines
the rule of the equal distance between the centers of rotation of the center of the machine
the rule of equal distance and of parallelisms of the centers of the eccentric gears
generalization rule: for example, polycammed semi transmissitive, by hoop, by poly induction

The first rule can be interpreted in the following manner; once a polycammed gear is coupled in a planetary manner to a second polycammed gear, the center of rotation of the planetary polycammed gear has a perfectly circular course in spite of the irregularities of it's gears. The rotation speed of the planetary gear is however affected, in that in which it undergoes alternatively accelerations and decelerations. This is why we'll give also to these gears the name accelerative gears (FIG. 52).

This rule allows us to realize retro and post rotary machines, in which the cylinder figures could be modified by the acceleration and the deceleration of the paddles to which is connected the gears, which become support gears and polycammed induction gears.

In retro rotary machines as in post inductive machines, we'll obtain excellent results during the application of such gears, these results being similar to those of other modifications already exposed. In addition, we'll reduce the dead time in post inductive machines and increase their torque (FIG. 53). All “n” sided machine figures of post retro or bi mechanical could be affected in the same manner.

This first rule will also find applications in semi differential turbines (FIG. 54). In these, when mounted with conventional gears, we'll need to carry out a ligatural correction, by runner or other method from the paddle to the eccentric of the crankshaft. With this use of eccentric and polycammed gears, this rule allows to state that the distance from the rotation point of the eccentric gears is always equal to the center. We could then connect the paddles to this point which, although turns perfectly circularly, produces decelerations and accelerations necessary to the bringing together and apart of the paddles forming the compression and depressions of the gas.

The second rule which states the equal distance of the centers of the planetary eccentric gears to the surfaces of the support gear shows that the realized form by the course of its centers of the planetary gears is a parallel form to that of the support gears (FIG. 55a)

The third rule implies that a same point located on the planetary gears is always from equal distance of a same point, on a gear on another planetary gear (FIG. 55b).

A third rule flows directly from the first two, which is that of the use of polycammed gears can be realized in all corpus methods already commented, by replacing standard gears located in the corpus, and which has for effect to modify the speeds of the parts, the form of the cylinder, and/or machine levels.

This rule thus allows us to support paddles from complex second or third degree machines such as poly turbines, or even metaturbines to produce a polycammed action of the first degree machine paddles supported by poly inductive methods (FIG. 56). We'll be able to realize in a polycammed manner not only, as we have just seen, mono inductive machines, or even poly induction machines, but also machines supported by semi transmission, by hoop gears, by intermediate gears, by spur gear and so on.

Generalisation Rule

We must, finally, mention that the polycammed gears can be employed as a replacement for all gear participating to the mechanical corpus mentioned previously to produce modifications of the form of compressive parts, or of motor part dynamics.

We'll be able to, for example, produce semi transmission mechanics with induction gears and eccentric support and/or polycammed. We'll be able to react in the same manner for example, with hoop gear methods, or even intermediate gears (FIGS. 57a,b,c).

Geometric Comprehension of Course Modification Methods and of Compressive Part Dynamics and of Obtained Cylinder Forms

In the previous pages we have demonstrated how to modify machines in such a manner to improve and balance the qualities.

In fact, we have improved the qualities by modifying the forms of these machines in such a manner to give to post rotary machines a retro rotary tone and inversely, in a manner to give to retro rotary machines a post rotary tone.

We can deduce that if we place on a same line retro and post rotary machines, the ideal machines, in which the compression and the torque will be optimal, will situate themselves between bi rotary machines and post rotary.

Conclusion and Recapitulation of Correction and Production Methods of Ideal Cylinders

The final comments can be synthesized in the following manner. All machine figure can be corrected or realize by producing a different control of the central positioning of the course of the paddle and its orientation.

The techniques can aim to conserve a regular central movement, but to produce accelerative variations—deccelerative of the orientation movement of the paddle. This is what happens with the application of eccentric and polycammed gears, that these machines be produced by mono induction, by poly induction, by semi transmission, or even by any other method belonging to the corpus of methods previously commented. In another manner, we could modify the positional course of the paddle which will lead, by diverse combined ligature mechanisms, a global movement of the paddle corrected according to the demanded calibration parameters.

The control techniques can be realized by many means, depending on whether the support gears and paddle gears are internal or external, and depending on whether the paddle support gears will be fixed or active, thus being linking gears . . . .

We must also differentiate the manners in which the paddle gears are coupled to a support gear located on the crankshaft, to a support gears located on the side of the machine.

In this second case, it must be used, as we have demonstrated, a new type of gear which we have named polycammed or eccentric, this gear having to be used here either on the paddle, like the orientation induction gear, either in the side of the machine, as polycammed support gear (FIG. 48).

We must note, finally, that we'll be able to realize from the coupling of two irregular gears, eccentric or poly cammed, a type of correction allowing the realization of objectives similar to the previous.

We must finally mention that, since the cylinder corrections can be realized only by mechanical corrections, and that, as we have already noted, the cylinder corrections lead in each machines, added qualities of complementary machines, these qualities are also notable on the mechanical level.

We can give the two following examples to demonstrate. Firstly, the poly cammed realization of Wankle type engines, not only reduces the width of the cylinder, but increases the power of the coupling of the machine, accelerating the paddle to the opportune moment (FIG. 49).

A second example, always applied to the post rotary Wankle geometry engine consists to demonstrate that when the shape of the cylinder is corrected by reducing the width, by oval course of the position aspect of the course of the paddle, we increase, by the addition of the crankshafts, one directed towards the outside, and the other, geometrically subtractive towards the inside, the machine's coupling (FIG. 45).

We can currently construct a table even more complete of the range of variations of the mother motor machine. To do this, we'll add to the previous tables the correction modes realized on machines and if this mode is by juxtaposition and combination of methods, we'll specify the methods participating to this combination by layer or juxtaposition.

Generalization of Poly Turbine Support Methods

We have already shown, at FIG. 38 of the current disclosure that we can generalize the realization methods of rectilinear rod machines, by demonstrating that we can use, to produce them by totally controlling the position aspect of the displacement of the piston all the mechanics, by uniting to their induction gear an eccentric or an induction rod directly connected to the piston. In addition, we have demonstrated, during our last commentaries relative to corrections of paddle courses of machines that we've been able to produce the poly turbines not only in a bi rotary manner but also in a mono rotary manner, corrected with a geometrical rod in such a manner to confer a bi rotary course (FIG. 43).

As we have already mentioned, the corrected first degree figures can always be produced by method combinations, and we must specify that the second degree figures can be them just as much. This assertion allows us to verify more than four hundred adequate support methods of poly turbines, issued from the mechanical corpus provided in the current work. We must also specify that the correction method by addition of geometric rod is not only simple by realization, but also for poly turbines as for rectilinear rod machines generalizable to all the methods (FIG. 58). We'll be able, for all method comprised in the mechanical corpus of the current, add a geometric rod sufficiently long enough to make the form pass from a retro rotary form to a bi rotary one, and thus be able to realize the desired poly turbine. We can then, not only realize poly turbines by mono induction with added geometric rods, but also by hoop gear with added geometric rod, by semi transmission with added geometric rod, by intermediate gear with added geometric rod, and so forth.

Generalizations of Assets to Rotor Cylinder Machines

The following statements will demonstrate that when rotor cylinder machines are built with an activation mechanic of active pistons, these machines have a mechanical structure identical to that of poly turbines and consequentially, all support methods which we have generalized for the previous ones, will apply themselves automatically for these, which will prove, beyond any doubt, their belonging to the general definition rule of all motor machine enounced to the present.

In fact, if we follow attentively the displacement of a piston displacing alternatively twice every cylinder rotation, we'll see that it realizes exactly an ellipse similar to that of the points of the paddles of poly turbines. If it displaces three times by rotation, it's displacement will also be equivalent to that of the displacement of the paddles of a three sided poly turbine (FIGS. 59c,d). Consequentially, we needed to deduce that all the first degree support methods corrected by one of the methods previously exposed will be adequate to support pistons of such machines, in perfect conformity with the circular movement of the rotor cylinder. We can also deduce that amongst the simplest realisation methods, we could use all support method comprised in the corpus of the method exposed, and add to them geometric rods. We could thus produce the machine by mono induction with a geometric rod, by hoop gear, added with geometric rods, by intermediate gears added with geometric rods and so forth (FIG. 61). The previous tables can therefore be updated with the following table:

TABLE 4
Motor Machines

| Compressive parts with rectilinear | | Compressive parts with | |
|---|---|---|---|
| movement | | non-rectilinear movement | |
| Standard pistons | Orbital Pistons | Paddle | Paddle structure |

Ligatural Methods of all motor machines

| | | | |
|---|---|---|---|
| Linking Rod | X | | |
| Inflection Rod | X | Inflection Paddle | X |
| Oscilating Cylinder | X | | |
| Mechanical Induction | X | Mechanical Induction | X |

| | | | | |
|---|---|---|---|---|
| | | Retro | Post | Bi |
| | | mechanical | mechanical | mechanical |
| Number of | Boomerang | 3 | | |
| cylinder sides | | | | |
| | | | 2 | |
| | Polyturbine | | | 2 |

Types of ligatures by mechanical induction
Post rotary mono induction
Retro rotary mono induction
Post rotary poly induction
Retro rotary poly induction
Semi transmission
Hoop gear
Anterior hoop gear
Posterior hoop gear
Internal juxtaposed gear
Internal superposed gear
Intermediate gear
Intermediate posterior gear
Intermediate anterior gear
Spur gear
Central active gear
Paddle hoop gear
Gear like structure
Eccentric gear
Correction forms and mechanics
Runner
Free rod
By active center
Hoop gear
Geometric addition
By layering and juxtaposition
By polycammed gear

Engine Degrees and Levels

The following commentary will have for goal to show another resulting aspect of geometric corrections effected, which consists of showing that we can determine, from a comprehension of these corrections, a determination of the degree of a machine, depending on the number of modifications effected.

Although we'll use for example the Wankle, Boomerang, and polyturbine geometry engines, all these rules will apply, as we'll see further, to all post and retro mechanic machines seen in this disclosure.

We know that we can, in a planetary manner (FIG. 39), realize the course of the point of the paddle. We imagine this structure too rounded. We thus imagine the course of a gear tooth as the center of a retro rotary circumference. We'll see that the creation of this subsidiary or secondary circumference produces a curb resulting opposite to the first, correcting it. We can now suppose that the course obtained serves in itself to the creation of a third circumference, secondary, to a superior degree, and this time post rotary. In the measure where this circumference is even smaller than the previous, we'll assist a correction of the figure, making it pass to a more irregular form, for example quasi rectangular.

We can now imagine that the courses aren't synchronized, which adds to the complexity of the obtained figure, which we'll name resulting figure.

We can now claim that the method by layering and juxtaposition already shown can realize these curbs.

Equivalence Rule of the Procedure of Figure Modification

It is important to note that the other modification methods of the figures arrive to the same results.

For example, the addition of a geometric rod to a retro rotary structure realizes a very adequate machine support for poly turbine types, and efficiently replaces support by double bi rotary crankshaft which we have already exposed (FIG. 43).

In another manner, the poly cam support in mono induction is equivalent, and can be used by replacement, either the double support, either the geometric addition (FIG. 49).

The composition of these methods allows us, obviously, to fabricate machines which would require two levels of layered poly cams. In machines, for example, such as poly turbines, but this time with a single poly inductive support level, modified by addition or poly cammation (FIGS. 58a,b). This composition method will replace even machines in which the shape of the cylinder can require three levels of layered polyindcution, such as for example metaturbines, understood as irregular cylinder machines, such as quasi rectangular cylinders. We can thus realize it with a single level of poly induction, adding afterwards a poly cammation of the gears, and simultaneously, a geometric addition (FIG. 58c)

In the previous statements, we have demonstrated, first and foremost, the main types of machines, being post, retro and bi rotary machines. On a second level, we have shown that there exist two large classes of support mechanics for these types of machines from which they derive from the observation of the conduct of the master pieces by an exterior observer where, from which we proceeded to an observation from an interior observer, in other words, more precisely located on the crankshaft, or the paddle itself. In the third part of our proposition, we have demonstrated that we can then, not only for point of observation questions, but for form modification reasons, produce machines which would be of a post rotary prominence, or of retro rotary prominence, wince each of them, by its geometry would comprise also an opposite stock. In the fourth part, we have demonstrated how to realize these simply prominent hybrid figures.

Interchangeability of Mechanics Rule (Brothers, Parents, Children)

It is important to note before going any further that in the current disclosure, to note that we have distinguished geometric forms of the post, retro, and bi rotary nature of the post, retro and bi rotary mechanics. In fact, we must state that in their initial form, we can create a mechanic of a retro rotary form with a retro rotary type mechanic, and in the same manner, a post rotary form with a post rotary mechanic. We must also add, that the modifications presented previously allowing more independent types of figure mechanics, when realized in a second degree. In fact, we can from these modifications realize post rotary figures from modified retro rotary mechanics and vice versa Both these types of modified mechanics could realize bi mechanical figures, for which we have produced a retro rotary polycammed mechanic and afterwards a post rotary polycammed mechanic. Generally however, to pass from a post rotary mechanic to a bi rotary one, we'll need a correction and to a retro rotary mechanic, two corrections, and inversely.

The corrections will thus be useable to increace the complexity of the cylinder, and consequentially obtain polyturbines, metaturbines, but also to obtain a geometry opposed to the mechanical structure.

Machine Layering and Degrees Laws

We'll find precisions relative to the following propos in our patent application titles Combinatory guiding and guiding level summary.

First Degree Machines

We call first degree machines, machines which could be produced with basic, non layered, non geometrically added, non eccentricised or polycammed mono induction or poly mono induction or poly induction. First degree machines are thus basic post and retro rotary machines, non modified wich as Wankle geometry engines and subjacent to n sides, which the paddles are motivated by the corpus methods of the current disclosure.

Second Degree Machines

We can distinguish two types of second degree machines.

We call second degree machines basic bi rotary machines, such as for example, poly turbines, or even rotor cylinder engines with a sinusoidal piston course.

We can also class as second degree machines, basic mono inductive machines to which we have produced a corrective modification, by one of the previous proceedings demonstrated, in other words, by geometric addition, polycamation, mechanization layering, and other forms of ligatures such as runner method and so forth.

In summary, second degree machines are:
a) Machines in which the course of the pieces and/or the shape of the cylinder is bi rotary in a natural manner
b) first degree post rotary or retro rotary machines, with a degree of alteration
   Third Degree Machines

We can classify third degree machines according to the fact that they are in a natural way, by the natural curve of their cylinder, or even if they are an inferior degree machine having undergone alterations

We call these types of machines metaturbines, in which the cylinders are irregular, quasi—rectangular. In the same manner, Slinky type rotor cylinder machines, as well as rotor cylinder machines, of peripheral piston types, which we will comment further in the current disclosure can be considered as third degree machines. Finally, balloon cylinder machines, which we will comment on further as well, can also be considered as being third degree machines. Finally, the conventional piston machines, once the position and orientation aspect of the pistons are simultaneously controlled, are theird degree machines.

This machines are all third degree machines for the reason that the natural form of their cylinder or even of the course of their compressive parts, always need three levels of mechanical induction to realize the support methods. At the limit, if we proceed by mono induction, we should layer three levels of induction to realize these machines.

We must also consider as third degree machines, second degree machines having undergone two composition alterations, such as for example a geometric alteration and a poly cam alteration, a structure layering and polycam alteration, etc, or even second degree machines having undergone an alteration.

We can thus define by examples first degree machines, for example, post and retro rotary machines having undergone two alterations like third degree machines. Another example is that of piston engines which we have produced with a rectilinear rod, but which the rod will be oblique and which consequentially we'll need to produce a polycammed gear to bring it back to the vertical rectilinear course of the piston. The differential semi turbines, rotor cylinder machines, mounted with poly cammed gears will also be third degree machines. Poly turbines, which we have over rounded the cylinder will also be of this nature

In summary, third degree machines are:
a) machines in which the course of the paddle and/or the shape of the cylinder are naturally of third degree
b) second degree machines for which we have brought a modification in such a manner as to improve the cylinder
c) Post or retro rotary machines of first degree, being modified in two manners (in the measure where they don't cancel each other out)

Generally, we can deduce that a machine will be of the same number of degrees as the number of inductions necessary to the correct motivation of these compressive parts.

In another manner, we can also understand the degree of the machines according to the number of inductions and corrections brought to the inductions, these corrections being equivalent to an induction itself.

A final manner to understand the degree of a machine will be that a machine of a superior degree can be constructed by using the paddle of an inferior machine as a supplementary support piece to the support of its own compressive parts. In these senses poly turbines are Wankle machines in which the paddles become support rods for the paddle structure, wheras the metaturbines can be assimilated to machines in which the paddle structure becomes in turn a support structure in which we have attached paddles.

We'll understand better in this figured manner the notion of machine degrees and why, more the degree is raised, more the mechanical support realizations are complex and abundant in number.

Anti Corrections

We also demonstrate that we can use a support method, for example of second degree, to support a first degree machine. In this case we must effect a third correction, or a reestablishing type, which will cancel out the effects of the first correction.

A probable case is the construction of a mono inductive machine, for example a Wankle geometry with mono inductive supports added with geometric rods, supports which would be most appropriate, as we have already demonstrated, a poly turbine machine, of second degree. We'll need to produce supports with polycammed gears in a manner to conserve the equal distance between the connecting points of the geometry rods and the paddle.

Modification of Machine Degrees

The current section has for object to show that we can
a) either modify the degree of a machine by adding a correction, in other words, bring a machine naturally from a first degree to a second degree.
b) realize a second degree machine with corrected first degree mechanics.
c) realize a machine with two different degrees of support acting in combination to support the paddle parts
   Two Examples:

### EXAMPLE OF MECHANIZATION WITH A LOWER DEGREE

The first case will be that of a second degree machine, being poly turbines, which we'll realize with first degree mechanics having undergone a degree of correction. In fact, to realize a machine of a second degree nature, we can use first degree mechanics to then bring a correction.

An interesting example of this consists to realize the polyturbine, as we have already shown for machines of a two degree nature, with a first level corrected mechanic. For example, the case of the mechanized poly turbine by a retro rotary mono induction, to which is added a geometric rod.

As we have already shown, we could generalize this last idea by saying that all first level mechanics forming the mechanical corpus could be with a correction, such as for example a geometric rod, become support methods which are very suitable for the poly turbine, which regroups more than two hundred methods for this machine.

The machine could thus be, for example, built by hoop gear and geometric rod, by semi transmission and geometric rod, by spur gear and runner correction and so forth

### EXAMPLE OF DEGREE INCREASE: SECOND DEGREE RECTILINEAR ACTION MACHINES

As we have already mentioned, if we agree to only occupy ourselves with the positional aspect of the pistons, this could be heard as a first degree machine, and in this sense can be realized by an induction method, which the simplest is by retro rotary mono induction with no other corrections brought.

We can however note that we can build this machine in such a manner so that the rectilinear action realized by the mechanic isn't in the direction of the cylinder, but rather, for example, oblique. Many examples could be produced, but we will content ourselves with only two. The first case is that of first degree vertical rectilinear action machine which we'll transform in a second degree vertical rectilinear action machine.

We'll note that if we organize the gears in such a manner, so that the rectilinear action realized by the mechanics of the machine be not vertical, but rather oblique, we must bring a re-establishment correction, for example, by realizing the machine by poly cammed gears, which will make this machine a third degree machine.

In addition to the second degree machine, this new machine will possess speed accelerations and decelerations which could be synchronized with the thermodynamic determinations of the machine (FIG. 63).

Consequentially, a form of ligature will be necessary, as for example, the runner or even the free rod, uniting the piston to this mechanic.

This machine is thus said a second degree machine, excluding the orientation aspect of the piston, realized by the cylinder.

All correction methods already demonstrated are applicable, which notably that by eccentric and polycammed gears. We have realized the fact that we'll be able to economize the corrective rod by using polycammed gears, straightening the oblique to a rectilinear. This new rectilinear will have dynamic qualities that the first one won't possess, in other words, it realizes accelerations and decelerations consequentially to the polycamation which will allow to tae the increasing and decreasing speeds of the piston at the beginning and end of the course for a larger compressive power and a larger expansive power, without supplementary pieces added.

We'll note that all the mechanics up to the currently exposed to realize rectilinear action could in this manner be oblique and then corrected.

We'll note, in a final analysis, that, as we have already mentioned, post rotary forms can be supported by corrected retro rotary mechanics and vice versa. These methods could be pertinent for notably transforming machines with a compressive prominence to motor machines, and vice versa.

Poly Turbines; Generalizations of the Support Methods

As we have already explained, some machines have a natural level. For example, poly turbines, with their circular sinusoidal cylinder, can be defined geometrically as bi rotary type machines, the forms situated between conventional retro and post rotary forms.

This is why the most expressive basic mechanics, allowing to adequately support the extremities of the paddle structures are methods using in combination retro and post rotary inductions but, as we have already demonstrated, we can carry out corrections to the base figures, and these corrections can be at this point accentuated so we can finally realize post rotary geometric figures, with corrected retro rotary mechanics, as we can contrarily realize retro rotary figures with retro rotary mechanics. The theoretical explanation of this realization consists of proposing a first level support method, corrected by a corrective method can be an adequate realization method of the second level machine. This being said, we can now generalize support methods of the paddle structure of the poly turbine, by saying that all the retro rotary methods of the first level already mentioned in the general mechanical corpus could be added to a correction to realize assembly methods for poly turbines. The simplest method will be that by adding a geometric rod.

We could for example adequately support the poly turbine with the aid of a hoop gear mechanic, added to a geometric rod, or even the intermediate gear mechanic, as previously added to a geometric rod, or even from the heel gear mechanic, added to a geometric rod and so forth. We'll note that all these corrective methods are usable, but the rigidity aspect of the geometric rods seems the most relevant to show more in detail.

For these machines, we'll proceed as for rectilinear rod engines in which we have forced the rectilinear alternative to produce in an oblique manner to then correct it in a poly cammed way. In fact, we could produce the elliptical movement in an oblique maner, and then correct in a polycammed manner, for example. We'll thus have a machine of a natural level brought to a third level, in which we'll be able to profit from new accelerations and decelerations.

Metatrubine Support

As we have already mentioned, meta turbines are machines in which the third level is the natural level. We must, to adequately support the paddle extremities, bring two mechanical corrections, being a mono induction, added by the decentered, oblique, geometric rods.

We must however remark that the center of the paddles of these machines, which oscilate by their extremeties, traverse to the contrary a circular sinusoidal course, which is a second degree course.

We can thus state that if as for piston machines, we intend to support only the position aspect of the course of the paddles, leaving the cylinder govern the orientation aspect of the paddles, we can realize the machine with mechanics governing the center of the paddles and all of the second degree mechanics, or of corrected first degree could be efficient. We'll then use all the previously exposed mechanics allowing us to support the ends of the paddle structures of poly turbines, or even the pistons from rotor cylinder machines, which demonstrates well the genesis of the whole machine.

However, if we intend on governing also the orientations of the paddles in a mechanical manner, and autonomous from the cylinder, we must produce third degree mechanics, in other words, add to each of the mechanics a supplemental correction. We'll then have a very impressive selection of over a thousand mechanics. We'll take attention to preferably use mechanics using poly cammed gears and geometric rods, because these mechanics don't add any pieces free from the basic mono inductive mechanics, which is very pertinent in motorology.

This brings us to a final statement, relative to the machine degrees. We could state that we can always add free paddles on the adequately motivated parts to create a more complex machine of a degree higher. We can thus, for example, add pivoting paddles to a first degree rotor, which will render it a second degree machine. We could even add oscilating paddles on support pieces similar to paddles of inferior machines. We'll then create third degree machines. We can push the application by attaching paddles to structures similar to that of paddle structures, this time used as support structures. We end with very complex fourth degree machines, in which the paddle is the only part whose positional aspect is controlled, and for these reasons, probably won't be produced frequently.

In addition, we can ally these two types of support and produce the support of each paddle of these machines with, in the center of the second degree support structure, and in the ends of the paddles, of third degree, which allows more than seven hundred support variations possible for these types of machine, supports which won't be necessary to index here, one by one, since the concept of their realization is enounced here.

We can thus add yet another these components to our initial table, including generalized poly turbines and meta turbines, since, as we have demonstrated, these machines aren't isolated machines, but rather machines which obey to the same mechanical corpus allowing to support all motor part of a motor machine.

We'll also add to this new table, in addition to the determination for each machine, the number of its degree. The basic support method used and/or correction methods used.

TABLE 5
Motor Machines

| Compressive parts with rectilinear | | Compressive parts with | |
|---|---|---|---|
| movement | | non-rectilinear movement | |
| Standard pistons | Orbital Pistons | Paddle | Paddle structure |

Ligatural Methods of all motor machines

| | | | |
|---|---|---|---|
| Linking Rod | X | | |
| Inflection Rod | X | Inflection Paddle | X |
| Oscilating Cylinder | X | | |
| Mechanical Induction | X | Mechanical Induction | X |

| | | | | |
|---|---|---|---|---|
| | | Retro | Post | Bi |
| | | mechanical | mechanical | mechanical |
| Number of | Boomerang | 3 | | |
| cylinder sides | | | | |
| | | | 2 | |
| | Polyturbine | | | 2 |

Types of ligatures by mechanical induction
Post rotary mono induction
Retro rotary mono induction
Post rotary poly induction
Retro rotary poly induction
Semi transmission
Hoop gear
Anterior hoop gear
Posterior hoop gear
Internal juxtaposed gear
Internal superposed gear
Intermediate gear
Intermediate posterior gear
Intermediate anterior gear
Spur gear
Central active gear
Paddle hoop gear
Gear like structure
Eccentric gear
Correction forms and mechanics
Runner
Free rod
By active center
Hoop gear
Geometric addition
By layering and juxtaposition
By polycammed gear

| | |
|---|---|
| | Number of Corrections |
| Machine | |
| Degree | |

Interchangeability of Mechanics Rule

All the mechanics mentioned above are machines in which the stock has different degrees and ways more or less close to retro, post, or bi mechanical machines.

This is why we can affirm as a rule that all the current mechanics apply, not only to basic machines, but to all types of machines presented.

We can, for example, apply with success retro rotary type mechanics to rotor cylinder machines to support their piston, and these mechanics will be used efficiently because they'll allow to cut off some rods.

For the same engines, we could also apply hoop mechanics, semi transmission, post induction with geometric addition, and in addition, apply, as for basic machines, layered mechanics, etc which realizes more than four hundred types of mechanics by type of machines.

Thus all mechanics will be realizable for all types of engines, which we give here for example the slinky engine, either with a hoop gear mechanic, a retro rotary poly induction mechanic, an intermediate gear mechanic, and so forth.

Recapitulation

Up to date, we have shown that there are three main classes of paddle machines realizable, whose type can be determined depending on the construction manner, being either mono inductive or poly inductive, post rotary, retro rotary, or bi rotary. We have shown that it's the case of generalizations for which we have submitted appropriate side rules.

We have then demonstrated that two large mechanic support groups can be possible for these machines, depending on whether the compressive and mechanical parts are being observed from the interior or exterior.

This has allowed us to create absolute types of mechanics
Mono inductive similarly realized by Wankle for post rotary machines, with triangular and square paddles.
Poly inductive . . .
Relatively:
By gears, polycammed, by semi transmission, as well as all other methods having been exposed by us

We have then demonstrated that these three types of machines could be realized in a less strict manner, bringing each type complementary qualities of complementary generation of machines, which allows us to rather mention the post rotary prominence of the machine, to retro rotary prominence, to bi rotary prominence, the ideal machines being located between bi rotary and post rotary forms.

These distinctions have allowed us to show that we can establish machine degrees depending on the number of layered inductions necessary to realize an adequate support method.

The following statements will have for objective to show, both the homogeneity and the variability of the mechanical group that we have already demonstrated, that the post, retro, and bi rotary machines can be realized by many compression figures, all of which are supported by this same mechanical group.

Well show that the complexity of the movement of the paddles or paddle structures can be reduced by using pistons, aligned by vertical periphery (poly inductive rotor cylinder machines), by horizontal periphery (horizontal piston rotor cylinder machines), central (central explosion machines), or even with a rectilinear-circular course (slinky machine).

From another point of view, we'll show that poly inductive machines can also have many paddle conceptions, thus realizing peripheral paddles (poly inductive rotor cylinder paddle machines), by traction paddles (poly inductive traction machine), by differential paddles (differential poly induction machine), or by central paddles (central paddle machine).

Piston Machines, as Fourth Degree Machines

Piston machine realizations, as simple in their current realizations, mask their complex reality. In fact, the equal distribution of the forces on the piston minimizing the friction on the cylinder makes the orientation control useless, adequately realized by the running of the piston through the cylinder. The following matters will simply have for effect to demonstrate that if we intended to produce the position and orientation support of the piston, this machine could be in reality a third, or even fourth degree engine.

We have seen up to here that all the first degree methods suffice to adequately support the piston from its only positional point of view. We'll realize that if we intend to also support its orientation point of view, and consequentially without any incidence of the cylinder, we'll always need to produce the machine in its corrected, bi rotary aspect. We'll produce the machine for example by double support of the crankshaft, reattached to two opposite parts of the piston (FIG. 64). Or even, we'll support the piston by double mono induction, by double hoop gear, etc, always by supporting the piston by two different parts.

We thus see that if we intend on supporting in a total and autonomous manner the compressive part of this machine and that we must mechanically realize the form of its course, this machine answers to all the criteria of machines previously exposed, the inductions having to be doubly produced. This assertion reinforces the general idea that we defend that all machines answer to the mechanical corpus of support, of ligatures, and of corrections stated in the current disclosure, which the rods and runners are but the most elementary expression, applicable preferably in certain more particular contexts.

Subsidiary Motor Machine Figures

We have established up to here that the basic geometric forms for which the application of the corpus of mechanization is realizable are mainly rectilinear compressive part machines, being either pistons, or geometric compressive parts, being either post rotary, retro rotary or bi rotary engines.

In the same manner we have showed that the forms derived directly from them, geometrically, such as for example the orbital engine, answers to the same mechanical corpus, and must be comprised in the current disclosure, and asserted under all its mechanical forms not yet patented before the currently exposed.

In the same manner we have shown more subtle forms, as for example rotor cylinder engines, could be considered as hybrid machines, located halfway between the machines already exposed, somewhere along the lines of a piston machine, but rotary.

The following objectives will have as objective to show that subsidiary machine forms, emanating from basic geometries or even basic mechanics which can be realized and to be considered variants of the general definition of motor machines since the general mechanical corpus can be applied in an adequate manner. The following matters will cover these geometric variants of the compressive parts, for which we comment the stock.

The group of these machines could thus be indexed in the following manner:
a) poly inductive rotor cylinder machines
b) poly rectilinear Slinky machines
c) simple or poly cammed peripheral rectilinear machines
d) central explosion machines
e) semi turbine poly cammed machines
f) anti turbine type machines
g) pure hybrid machines
h) poly rotary machines
i) semi turbines and traction poly turbines
j) meta turbine machines
k) compositional auto pumped machines
l) peripheral rotary machines
m) poly inductive differential machines (without geometric considerations)
n) poly inductive traction machines
o) poly inductive and rotor cylinder combinatory machines
   Subsidiary Poly Inductive Machine Types

As we have demonstrated, by the interchangeability laws of the mechanics for various machine types, we can recognize whether or not it's of a poly inductive type of machine in the measure where we can apply to it favorably, one of the previously commented support methods, this method depending on the degree of the machine, also modified by methods we have commented, either by addition, dynamic support gear, gear polycamation, or layering.

The following matters will thus have for goal to present new machines or even present machines for which we have already obtained a patent, but this time, shown with poly inductive methods.

Poly Inductive Rotor Cylinder Machines

As we have already seen in the current disclosure, once the rotor cylinder machine is produced with a dynamic action of the mechanical parts motivating the pistons, proving to be a machine belonging to the mechanical group described previously.

Central Explosion Machines

We can note that, due to our first mechanizations of central explosion machines (FIG. 65), all the mechanics are usable to activate a compressive part between themselves. We must deduce from our central explosion machines the following rule, which applies to all of our machines: what can be produced in a standard manner can also be produced in a central manner, and the central production of the motor machine presented here is to be applied strictly in their field applications.

Poly Rectilinear Slinky Machine Types

The slinky piston machines (FIG. 66) could be realized with the help of rods or runners. However, as we have shown, we could advantageously realize them with all types of mechanical inductions already elaborated by us.

We'll note that all the realization mechanics of rectilinear rod machines are applicable here to the piston of slinky type of machine, taking care to calibrate the mechanics in such a manner to realize many piston extensions and retractions per rotation, through the rotation of the rotor cylinder. We can thus realize slinky machine mechanics by using mono induction, hoop gear inductions, intermediate gears, and so forth Also while taking care to realize the necessary geometric additions in such a manner so that the piston passes correctly by the center.

Slinky type machines can be considered as second level retro mechanical machines, since we must add to the system a supplementary correction, allowing the coordination the rotor cylinder movement with that of the piston. Many methods are possible. We'll choose to alter the speed of the rotor by the use of polycammed gears, or even by altering the speed of the piston, also by such gears. We could also simply add a rod or a runner to the piston.

In fact, here we find characteristics of rotor cylinder machines, rectilinear rod machines, and triangular machines. The current situation is that, for example, when we intend on giving to the pistonnated part three rectilinear movements per turn, as if we're putting in rotation a rectilinear rod machine. A simple retro rotary mechanic will be necessary, by taking care to produce it in such a manner so that the center of its eccentric or induction crank pin passes by the center. For this reason we need that the rectilinear action be as perfect as possible, we could, if necessary, use polycammed gears to assure this.

Simple or Polycammed Rectilinear Peripheral Machines (FIG. 67)

We can note, as for the preceding, these machines are limit geometry machines, where we suppose, for example when realized in a triangular manner, doesn't realize a retro rotary mechanic passing by the center, but realizes a perfect triangle.

The differences between the retro mechanical realization of this triangle and will allow, without any use of a rod the rectilinear horizontal displacement of a piston through a rotating cylinder.

As for the previous cases, all the mechanics are applicable, although we give but two examples here, either by retro rotary mono induction, or by poly induction. In the same manner, the polycamation and other modifications are applicable. In a final case, we must mention that the number of pistons is variable as well as the number of “aller retour” per turn. The differential use of the force between the pistons is also realizable. Even then, we could state that many mechanics allow the governing the horizontal “aller retours” of the pistons, without using rods.

Polycammed Semi Turbine Machines

As we have already mentioned in our introduction, motor machines define themselves when there is a difference between the regular circular movement of the motor parts and the irregular non circular movement, and even the circular movement of the compressive parts.

The differential semi turbines situate themselves in this machine category. As before, all the previously exposed mechanics can serve to govern the paddles. Such as we have already exposed beforehand, the simplest version is by simple poly induction, coupled to a runner.

As we have already demonstrated, the differential semi turbines can be with great advantage realized from polycammed gears (FIG. 68), which allows the realization without running support parts. We'll note that these types of machines, as for all exposed here, can have their compressive parts motivated by all the mechanics indexed here, which assures that they're in the field of motor machines claimed here.

Antiturbine Machine Types

In these machines (FIG. 69), we simply demonstrate that, by opposition to semi turbines, in which the paddles are mounted in a semi rotary manner in the center of the machine, these paddles could be mounted in a semi rotary manner at their extremities and motivated retro or post mechanically in their central part. There is also a certain complexity within the displacement movement of their center however. These machines will be by nature second degree machines, which we'll realize with the aid of runners or polycammed gears.

Traction Driven Semi Turbines and Poly Turbines

A third version of machines, said traction driven poly inductive, consists simply, for example, for semi turbines, to show that the power produced, can be realized by the traction between two support points (FIG. 70). In the same order of ideas, it is important to underline that the poly inductive machines, when produced with successive paddles, can be produced in a differential manner, by accumulating the energy produced between these two paddles in which one is in acceleration and the other in deceleration.

Poly Inductive Peripheral Machines

As for rotor cylinder machines (FIG. 71) we can show that we can realize from the poly induction method a machine including in periphery many poly inductive types of machines. We'll only give the most basic example, being the Boomerang engine.

Machine Compositions

As we have seen up to now, many machine variants can be created, all these machines having the common characteristic of being able to see their compressive part being driven by a same logical group of mechanics issued from internal or external observation.

As we'll be able to remark here, we could realize these machines in combination, these combinations having for goal to adequately realize two possible objectives. The first will be to realize by combining, machines with a compressive prominence to machines with a depressive prominence, in such a manner to realize optimal pump and motor parts.

The second reason will allow the de synchronization of the two combinatory parts of the machines in such a manner as to mislead the dead point of the machine, in other words, to control the de perdition of one of the systems by the combined system.

Combined Successive Piston Machines

In this type of machine (FIG. 72) we use two machines in composition in such a manner to serve of their de synchronization to attenuate the dead time of the machine.

Compositional, Auto Pumped Machines

It is apparent in these figures that we can create a combination law between retro and post rotary machines and by showing that a same machine can comprise for a same paddle, an exterior post rotary movement, as well as an internal retro rotary movement, and this with the same mechanic (FIG. 73). This law allows us to understand that we can produce a retro rotary geometric mechanic by a post rotary action of its cylinder, and inversely, a post rotary geometry by a mechanical action of its retro rotary type cylinder. This machine allows us to understand other complementary, subtle laws of these machines.

Generalizations of Meta turbine Machines (FIG. 74)

As we have seen previously, we can create more irregular machine cylinders, such as quasi rectangular cylinders, rectangular-triangular, and so forth, by the use of two layered alterations of basic post or retro rotary mechanics. Such is the example for the case of metaturbines with quasi rectangular geometry, for which the simplest realization is produced from a retro rotary mechanic, done with a first correction of geometric addition type, and with a second polycammed correction. As with inferior level machines, these machines can be understood as machine classes, realized through many figures in series and according to a rule of the sides.

Pure Hybrid Machines

In the same order of ideas, we can speak of a cylinder machine whose appearance has been simplified such as balloon cylinder machines (FIG. 75). These machines need many degrees of correction, which produces third and fourth degree machines, depending on which degree of perfection of the balloon aspect we want to realize.

Machine Compressive Part Rules

Division of Movement

In certain machines, we can turn to the division of movement. In fact, man machine movements are composed of a combination or an addition of circular movement and of one or many other movements. We can then divide the movement of many machines, by keeping only a part of the movement, even strictly circular, to the eccentric or the crankshaft, or even if we want total or partial movement execution.

This is the case, for example, for oscillating or rotor cylinder engines. We'll note that we can find engines in which the cylinder will not produce a circular action, but will with one of the first or second degree figures. Other machines will be possible by dividing the movement in such manners so that the cylinder movement is circular, but that of the poly inductive crankshaft is rectilinear.

All of these machines also fit in the current invention since they all answer, as their cylinder is also mechanical, to methods previously enunced in the mechanical corpus.

Stability and Movement

Consequentially, some motivated machine pieces, other than the crankshaft, can become static and certain static pieces can become active.

Compressive Part Motivation Modes

In all the machines indexed here, we'll note that all the compressive parts can be motivated, as much by push as by traction. The simplest example consists of the push or traction motivation of a piston machine.

We'll note that even the same attributes can be indifferently granted to all types of machines, these machines remaining explicitly in the field of the current invention.

Vertical, Horizontal, or Oblique Action of the Piston Type Compressive Parts

We'll note, more specifically for our rotor cylinder machines, that the pistons can be set up vertically, horizontally, or in an oblique manner in the center of the machine.

In all cases, and this to fortiori if their mechanization methods are of the currently disclosed mechanics, it is the case that they are rotor cylinder machines, covered by the current disclosure.

For example, we can just as well set up a group, not only peripherally, but also, horizontally in the center and activate the pistons by poly inductive, mono inductive, hoop, etc, sub sets allowing to cut off rods and these machines will be in the field of the current disclosure.

In the same manner, in all machine we can interchange the centrality to the exteriority without changing the genesis of the machine. We can also interchange the pieces in movement to static pieces and vice versa without changing the genesis. We could even interchange the eccentricity and circularity without changing the genesis of the machine.

Standard, Central and Peripheral Action

Whether it is for a paddle, piston, or paddle structure engine, the compressive parts can be set up in a standard manner, in periphery, and in the center, and their support by the corpus of mechanical methods enunced will assure the belonging to the current invention.

In the multiple realizations of all machines described in our previous works, in the current works, we have demonstrated how to realize, with the least explosive effort, the largest systematic deconstruction, which, by opposition to conventional rotary type engines, will be a guarantee of the resistance to premature wear. It remains that, practically all machines presented by us, need, on one level or another, and in diverse quantities, gears. It is thus important to specify that all these machines can also advantageously use overlapping type gears (FIG. 76) and that all the variants realized with this type of setup are an integral part of the current invention.

Before concluding the matter of the current patent application, it is important to mention that all the machines shown here can be used with different variants, for example, as a compressor, artificial hard, pumps and as well as engines.

Eccentrics

As we have already showed in our patent application relative to poly inductive machines titled bridges for machines took up again in our international patent, we can use in an advantageous manner eccentrics by replacing induction gear axes mounted in a rotary manner on the crankshaft's sleeves or even of the conventional crankshafts provided with crankpins, in such a manner to be able to cross, by other axes, the machine lengthwise and thus assure to all the elements an equal, balanced support from each side.

The current simply has for object to generalize this technique to all machines presented in the current disclosure and in the group of our works. Everywhere where this is necessary in fact, we could change conventional crankshafts by eccentrics and allow

Selector Fork

In the same manner, we intend by generalizing that the induction gear support if it is preferably produced by axes mounted in a rotary manner on the crankshaft's sleeves will be advantageously realized with the aid of selector forks, either internal or external, allowing to determine the position of the gears as being located between the two parts of the fork, and consequentially the best possible support

Free Support Gears

A third support method could also be realized in all the cases where we judge it pertinent, notably in the cases where we can't use the first two methods, in which, for example, we'd prefer not to cross the machine lengthwise.

In these cases, as we demonstrate in our application . . . and titled . . . we can produce a sleeve for the crankshaft in the part opposite to the main sleeve, and set up in a rotary manner a or many support gears, these gears being, like the induction gear, coupled to the support gear.

The crankshaft will thus assist in its support, of these gears supporting the support gears.

The Isolation of Compressive and Mechanical Parts

In summary, the current invention intends to prove that retro rotary type machines, which the main form is the triangular engine, rectilinear rod machines, post rotary machines, poly turbine machines, rotor cylinder machines, peripheral piston machines, differential semi turbines, meta turbines, and all other motor machine, all work under the same corpus of support mechanics for compressive parts, and, depending on the case, one or more mechanization levels, and for this, constitutes one and only one machine which is claimed here, in all its forms, not already made evident up to this day.

TABLE 6
Motor Machines

| Compressive parts with rectilinear | | Compressive parts with | |
|---|---|---|---|
| movement | | non-rectilinear movement | |
| Standard pistons | Orbital Pistons | Paddle | Paddle structure |

Motor machine variants
Poly inductive rotor cylinder
Slinky
Rectilinear peripheral
Central Explosion
Polycammed semi turbines
Anti turbines
Hybrid Machines
Pluri rotary machines
Traction Machines
Meta Turbines
Auto Pumped
Peripheral Rotary
Poly inductive differential
In Combination and/or movement demission
Ligatural Methods of all motor machines

| | | | |
|---|---|---|---|
| Linking Rod | X | | |
| Inflection Rod | X | Inflection Paddle | X |
| Oscilating Cylinder | X | | |
| Mechanical Induction | X | Mechanical Induction | X |

| | | | | |
|---|---|---|---|---|
| | | Retro | Post | Bi |
| | | mechanical | mechanical | mechanical |
| Number of | Boomerang | 3 | | |
| cylinder sides | | | | |
| | | | 2 | |
| | Polyturbine | | | 2 |

Types of ligatures by mechanical induction
Post rotary mono induction
Retro rotary mono induction
Post rotary poly induction
Retro rotary poly induction
Semi transmission
Hoop gear
Anterior hoop gear
Posterior hoop gear
Internal juxtaposed gear
Internal superposed gear
Intermediate gear
Intermediate posterior gear
Intermediate anterior gear
Spur gear
Central active gear
Paddle hoop gear
Gear like structure
Eccentric gear
Correction forms and mechanics
Runner
Free rod
By active center
Hoop gear
Geometric addition
By layering and juxtaposition
By polycammed gear

| | |
|---|---|
| | Number of Corrections |
| Machine | |
| Degree | |

Brief Lexicon

Post rotary figure: figure in which the number of paddle sides is superior by one to that of the cylinder

Retro rotary figure: Figure in which the number of paddle sides is inferior by one to that of the cylinder

Bi rotary figure: figure in which the number of paddle sides or paddle structure is double to that of the cylinder

Post inductive mechanics: Mechanics producing the movement in the same direction, but slowed down, of the paddle

Retro rotary mechanics: Mechanics producing an inversed direction paddle movement

Bi rotary mechanic: mechanics used by combining post and retro rotary mechanics

Support gear: a gear supporting the induction gear; is defined as layered or orientation if it governs the orientation of the paddle in combined constructions. Can also be instigated to modify the size relation

Induction gear: gear fixed firmly on the paddle

Linking gears: gears uniting in certain cases, notably when the paddle gear is of internal type, the support and induction gears

Semi transmission gear: set of gears governing the turning of the crankshaft and of support gears or of active links

Eccentric and polycammed gears, defined as accelerative gears: irregular gears, built in such a manner to be able to act as a coupling when on rigid axes and planetary axes

Mechanical corpus: group of support methods for compressive parts of a given machine

Degree: number of mono induction layers required to activate the compressive parts. Can also signify the number of induction layers and of corrections

List of Patents and Patent Applications

[1 to 36]

### SUMMATIVE DESCRIPTION OF THE FIGURES

FIG. 1 shows, in a recapitulative goal, the main types of known engines of the previous art, being standard piston engines, orbital engines, paddle engines, and Wankle geometry engines, and paddle structures, of Wilson geometry.

FIG. 2 shows a recapitulation of some of the inventor's motors of the previous art, being the rotor cylinder, the triangular running paddle motor, and the differential semi turbine.

FIG. 3 shows, also from the inventor, triangular retro rotary engines, defined as Boomerang engines, as well as the mechanical bi rotary and retro rotary aspect of poly turbines.

FIG. 4 shows, in addition to rectilinear rod piston machines, the various types of machines that will be affected by the various machine figures. We find in a), post rotary machines, in b), retro rotary machines, in c), paddle structure poly turbines, in d), differential semi turbines, in e), rotor cylinder machines, in f), peripheral piston machines, in g), slinky machines, in h), hybrid machines, and in i), peripheral rotary machines

FIG. 5 shows that the field of the current invention applies also, indifferently on the compressive parts by push in a), or by traction in b), in a standard or differential manner.

FIG. 6 shows that all the geometric realizations answer in diverse ways to the general definition of the motor machine, according to which the movement of the compressive parts is irregular in geometry or in dynamics and differentiates of the circular and regular movements of the motor parts.

FIG. 7 shows in a the fundaymental differences between piston and paddle machines according to which the compressive parts are linked either indirectly or directly to the motor parts.

FIG. 8 shows the various indirect linking ways of the parts, defined as interstice means or ligatures

FIG. 9 shows that a generalization of the ligature means exposed in 9 can be produced for all piston machines. Here the example is given from a rotor cylinder machines.

FIG. 10 shows that the runner can also be used in paddle machines.

FIG. 11 shows the two basic methods of irregular movement correction of the paddles and compressive parts towards the retrorotary movement of the mechanical parts.

FIG. 12.1 shows in a), b), and c) the important distinctions on the dynamic level relative to the direction of the paddle movement, in relation to that of their motor parts, for each of these machines, which allows us to determine the belonging to either the post or retro rotary class.

FIG. 12.2 shows in c) that we can support a paddle at each extremity by a structure combining retro and post rotary methods.

FIG. 13 shows that the actions of the mechanical parts in the opposite direction of the paddles, in retro rotary machines, result in a reduction of high dead time in them, in relation to piston machines and other post rotary machines.

FIG. 14 shows that the retro rotary, post inductive and bi rotary Boomerang machines, can be generalized in machine classes depending on the side relation rule

FIG. 15 shows that starting from these generalizations and rules, a three sided cylinder for example, can allow the totally different realization of retro mechanical, post mechanical, and bi mechanical machines, depending on the from of the paddle used and the dynamics which are applied to it.

FIG. 16 presents a more detailed commentary of the paddle motivation method defined as post rotary mono induction and by retro rotary mono induction, respectively to Wankle and Boomerang geometry machines already presented in 12.

FIG. 17 gives a geometric explanation preconditioned to the construction of the method defined as, by poly induction.

FIG. 18.1 shows how to realize the mechanics of the geometry commented at FIG. 13

FIG. 18.2 shows a similar method, defined as by poly induction, this time produced in a manner as to be able to realize a planetary retro rotation during the rotation of the crankshaft, which allows us to realize a retro rotary type of machine.

FIG. 19 shows the work of the paddle in relation to the crankshaft when observed by an interior observer, located on the crankshaft or on the paddle itself.

FIG. 20.1 shows the support method defined as by semi transmission.

FIG. 20.2 describes the same method, applied this time to a basic post rotary machine, which will be defined as semi transmission post rotary machine

FIG. 21 shows the support method defined as by hoop gear

FIG. 22a) and b) show respectively methods said by anterior coupling hoop gear and exterior coupling hoop gear

FIG. 23.1 shows the support method said by internal juxtaposed gears

FIG. 23.2 represents the same method, but this time applied to a post rotary machine

FIG. 24.1 shows the method said by internal superposed gears

FIG. 24.2 shows a same method as the previous figure, but this time applied to a post rotary geometry

FIG. 25.1 shows the method said by intermediate gear

FIG. 25.2 is a method similar to the previous figure, applied to a post rotary machine

FIG. 25.3 is a method derived from the previous, but the intermediate gear activates the paddle gear, since it is of internal type, by means of a liking gear

FIG. 26 shows the method by intermediate hoop gear

FIG. 27.1 shows the method by spur gear

FIG. 27.2 shows the same method as the previous, but this time applied to a post rotary geometry machine

FIG. 28.1 shows the central post active gear method

FIG. 28.2 is a method similar to the previous, but this time applied to a post rotary geometry machine

FIG. 29 shows the method by central post active gear motivated by double linking gears

FIG. 30.1 shows the paddle hoop gear method

FIG. 30.2 shows that we can apply a method similar to a retro rotary type of machine. This time however, we left the central paddle gear free and we're motivating it by the hoop gear, the crankpin's superior gear.

FIG. 31.1 shows the method said by gear like structure

FIG. 31.2 shows the previous figure in three dimensions

FIG. 32 shows the method said by eccentric gear

FIG. 33 shows the method said by centralo-peripheral support

FIG. 34 shows the method by deported attack

FIG. 35.1 shows, in summary, that all the exposed mechanics apply to retro rotary engines, which the most representative form is that of the triangular Boomerang engine.

FIG. 35.2 is the continuation of 35.1

FIG. 36.1 shows that all the commented mechanics also apply to post rotary machines, which the most common form is that of the Wankle geometry, generally realized by a mono inductive support method

FIG. 36.2 completes the previous figure

FIG. 37 shows in a) and b) respectively, the retro mechanical and bi mechanical support methods of the compressive parts of rectilinear rod engines

FIG. 38 shows the four main types of support balance for these machines

FIG. 39 shows that all the supports already commented, more specifically here as their retro mechanical form, can, in addition, be applied to piston engines

FIG. 40 shows the application of other methods, which allows to generalize this machine

FIG. 41 shows the main differences of the three main types of geometries which can be realized with the mechanical inductions presented previously as well as the corrections which can be brought

FIG. 42 shows that the runner is not only a correctional first level ligature, as it can also be used as a second level ligature.

FIG. 43 shows by paddle movement and cylinder form corrections brought by the active support gear

FIG. 44 shows the movement corrections of the paddle and the form of the cylinder brought by the hoop gear, intermediate gear, or intermediate hoop

FIG. 45 shows the movement corrections of the paddle and the form of the cylinder brought by addition of rod or geometric eccentric

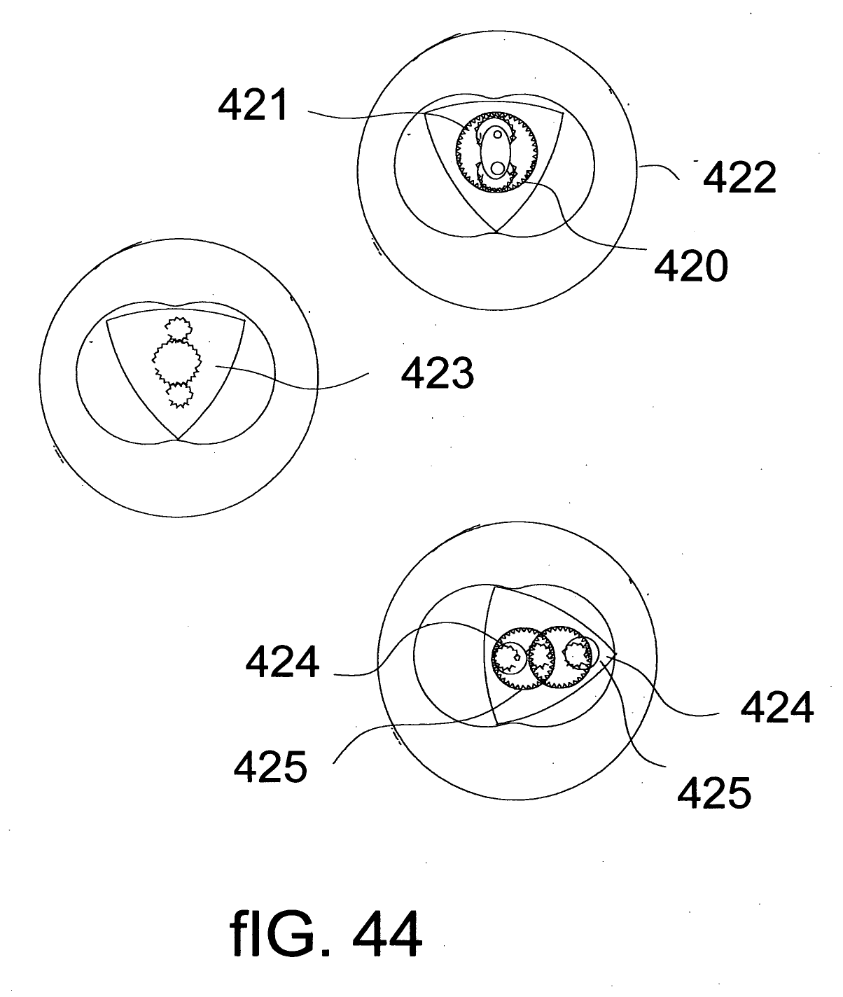

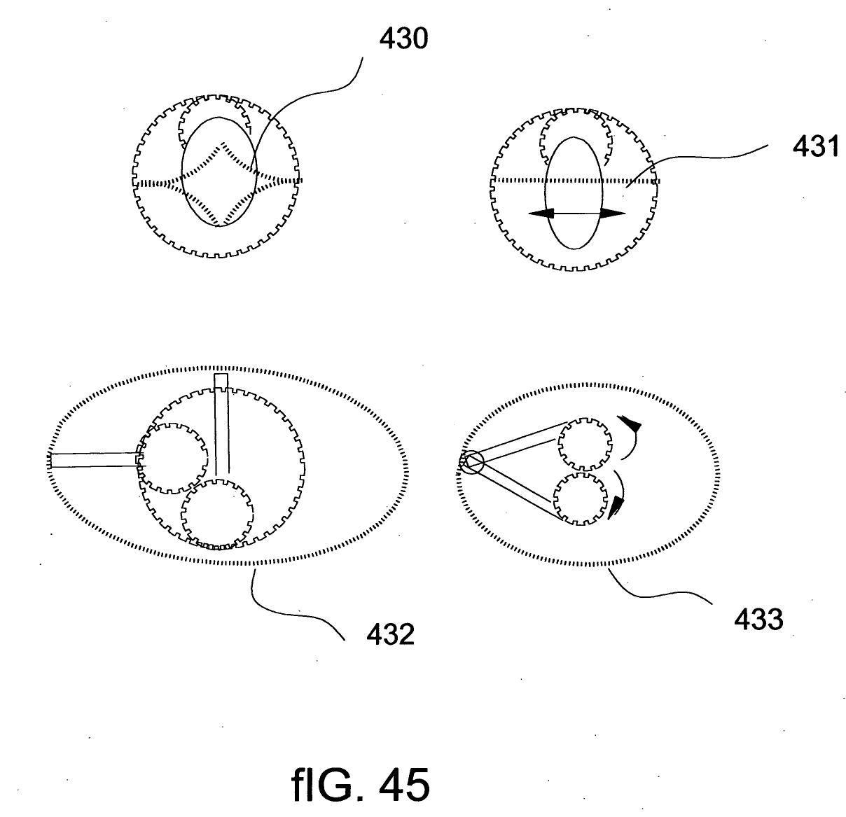

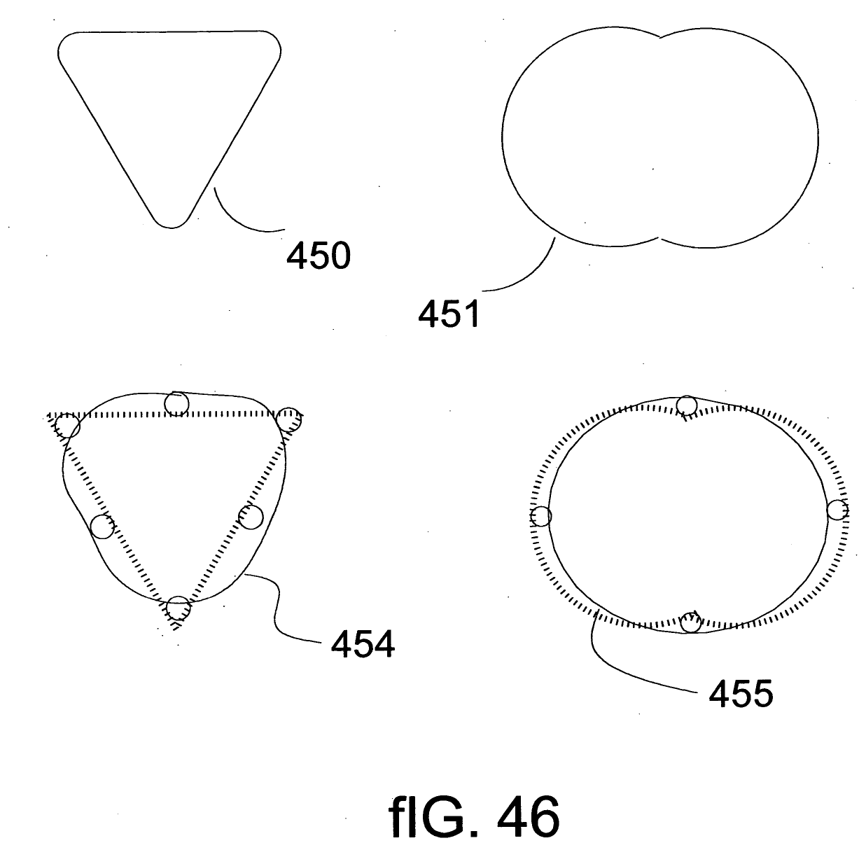

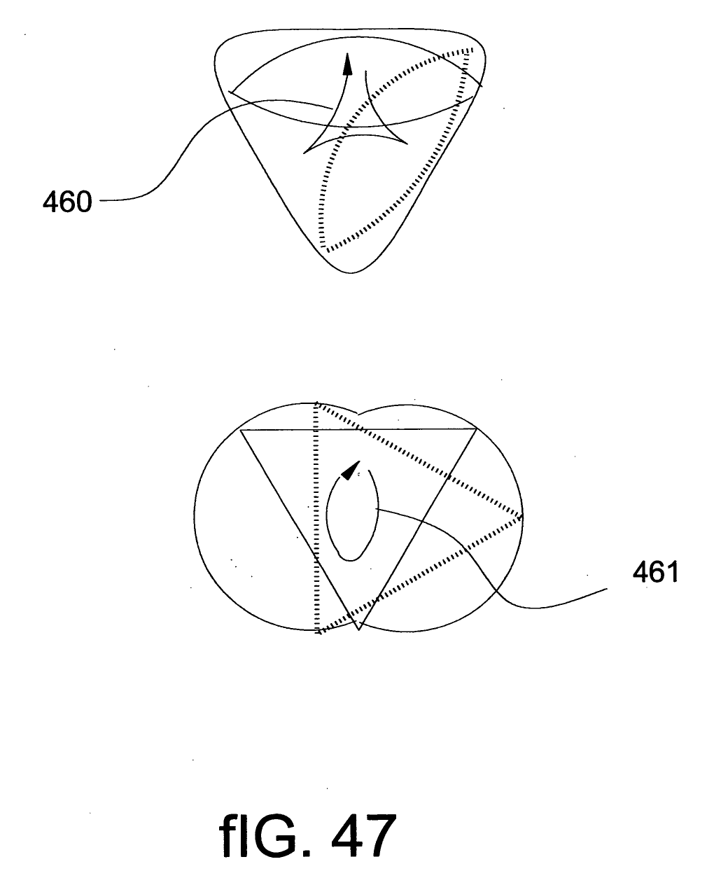

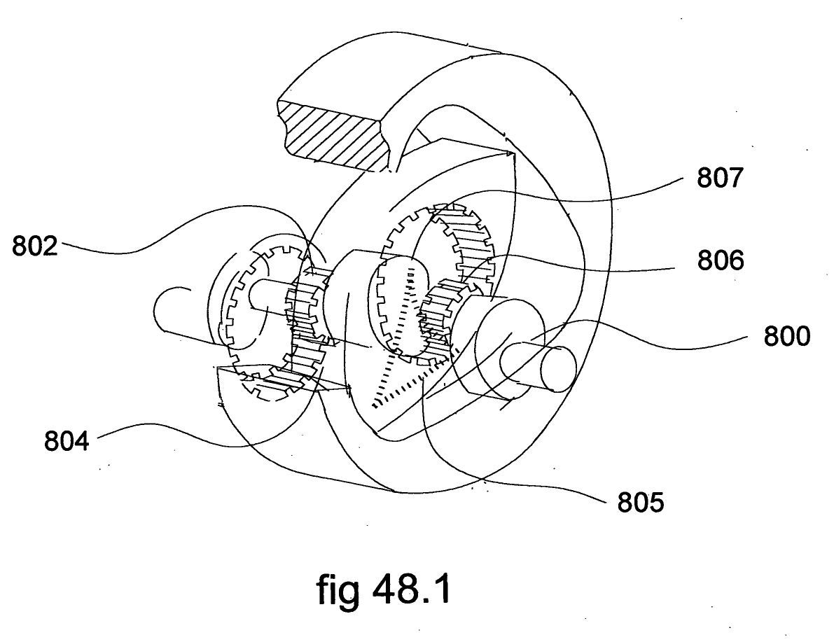

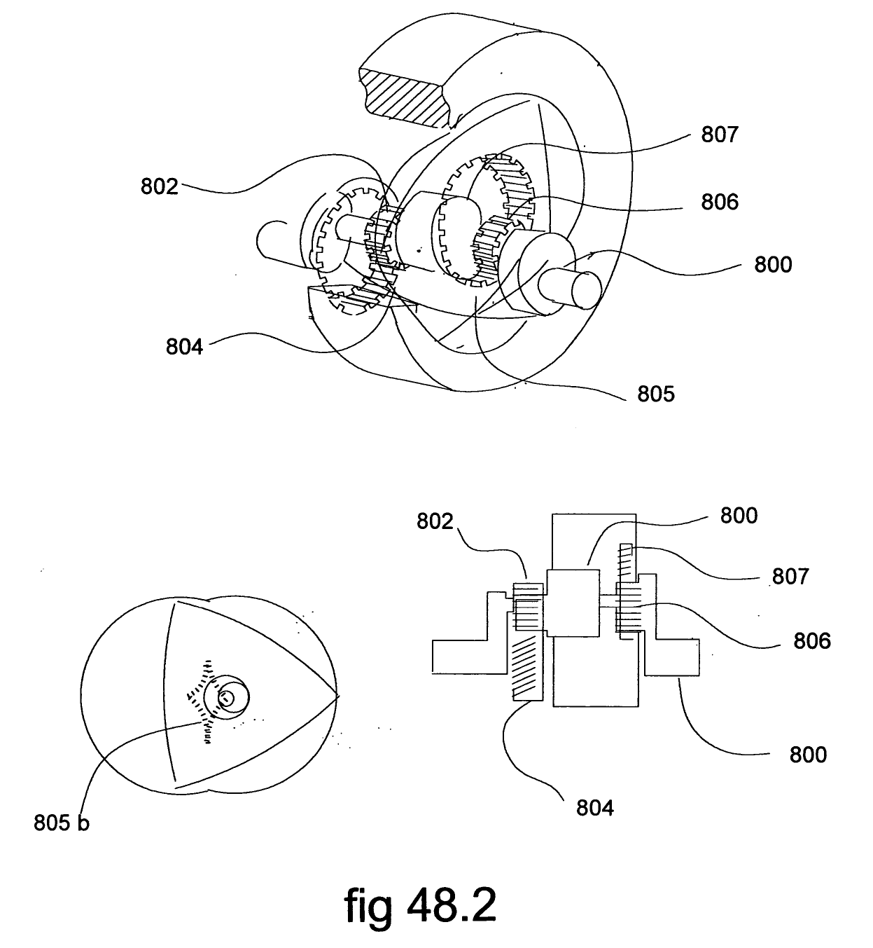

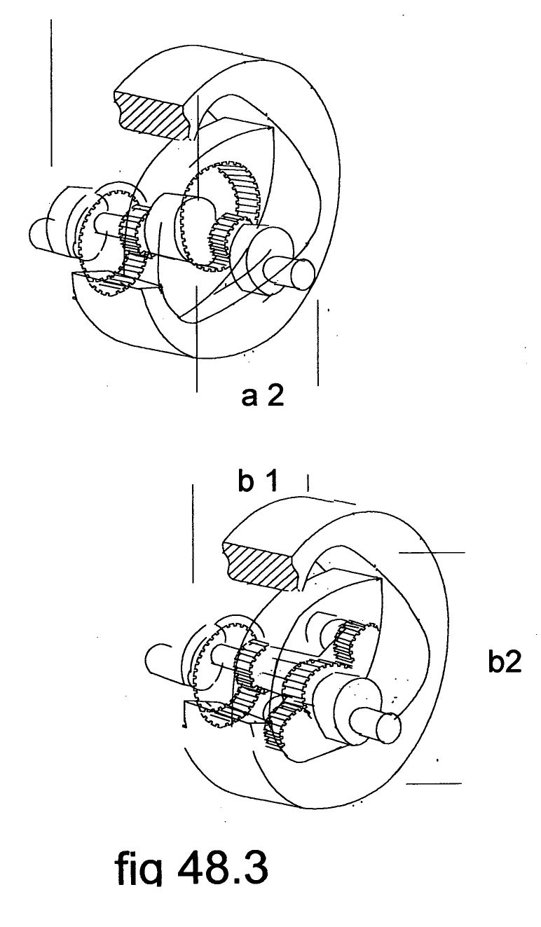

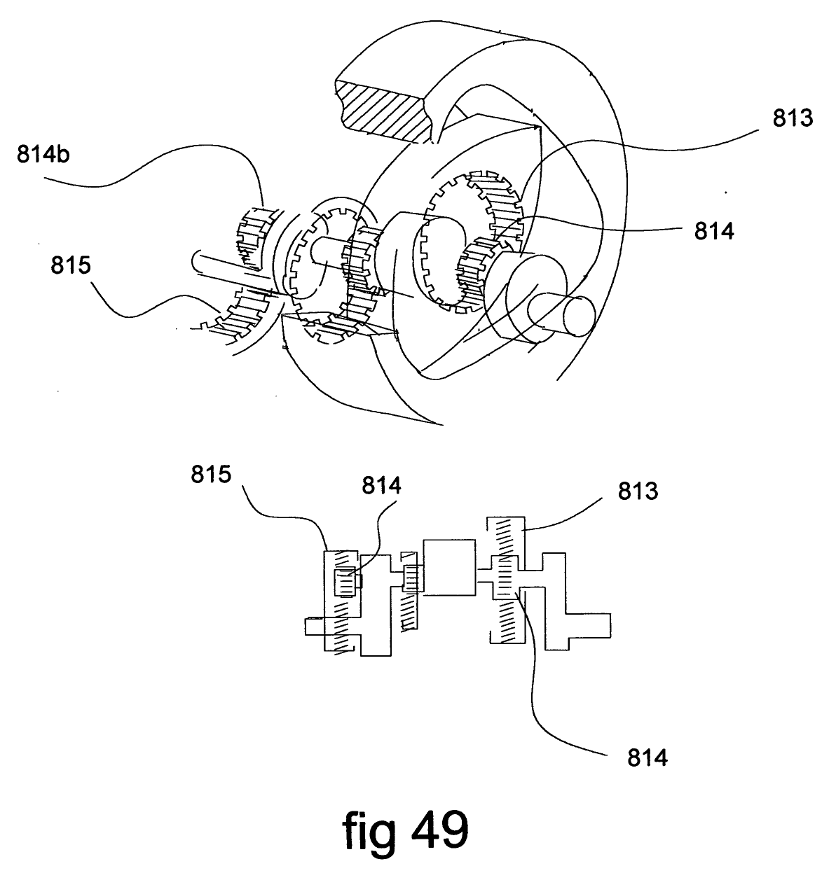

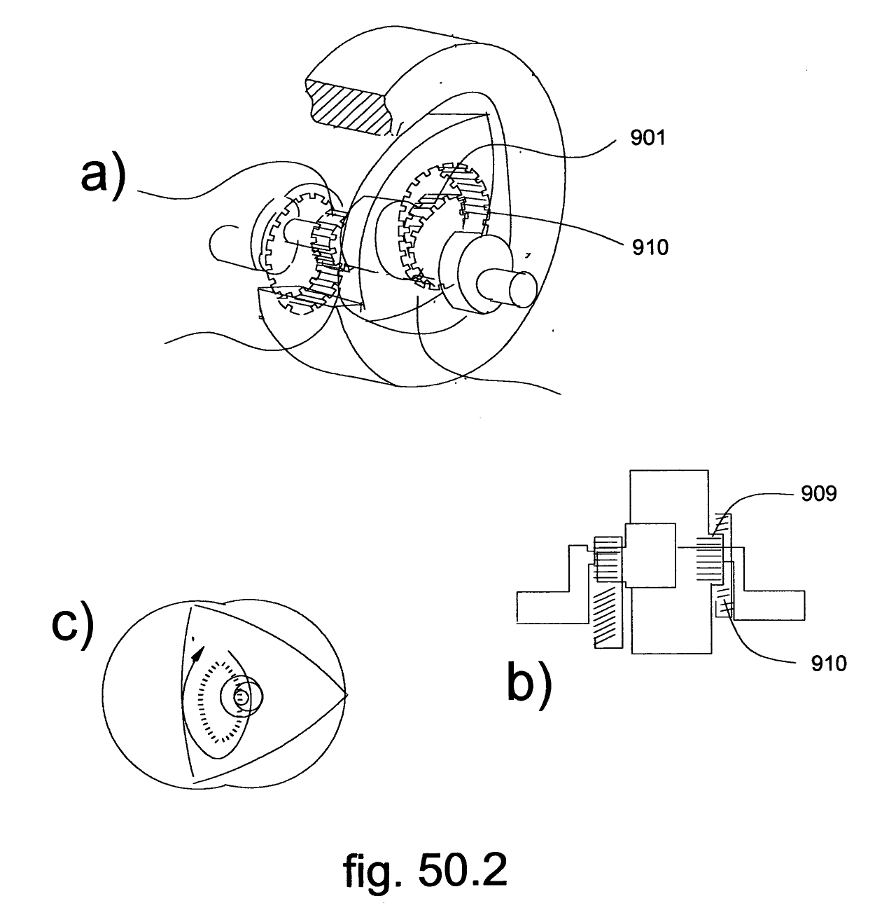

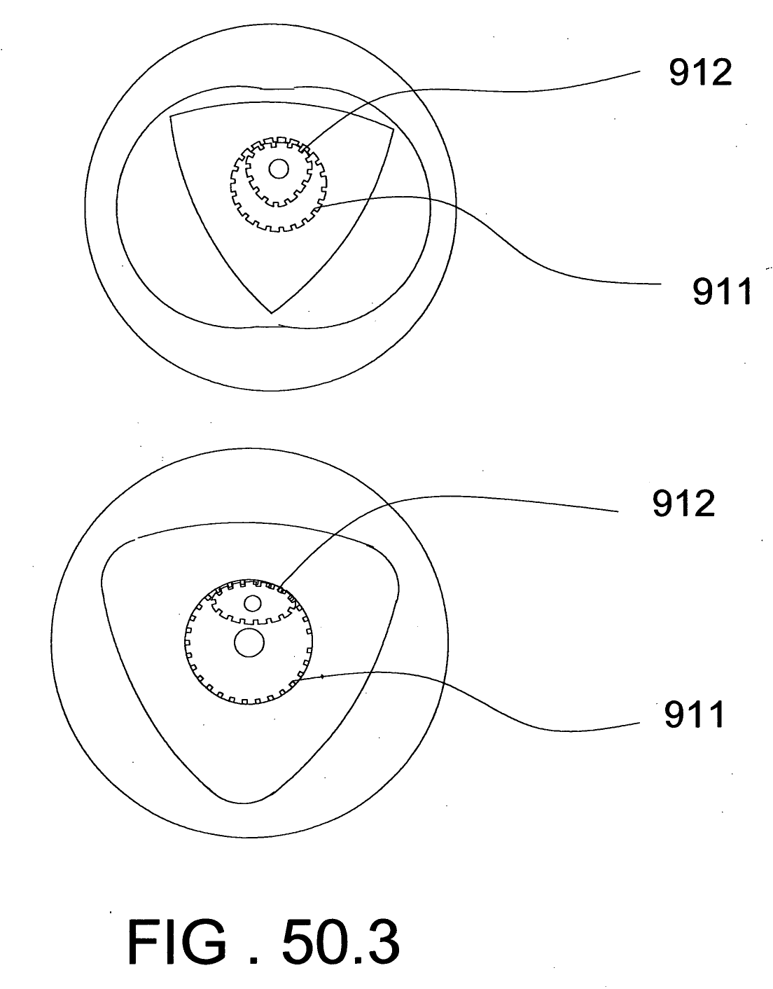

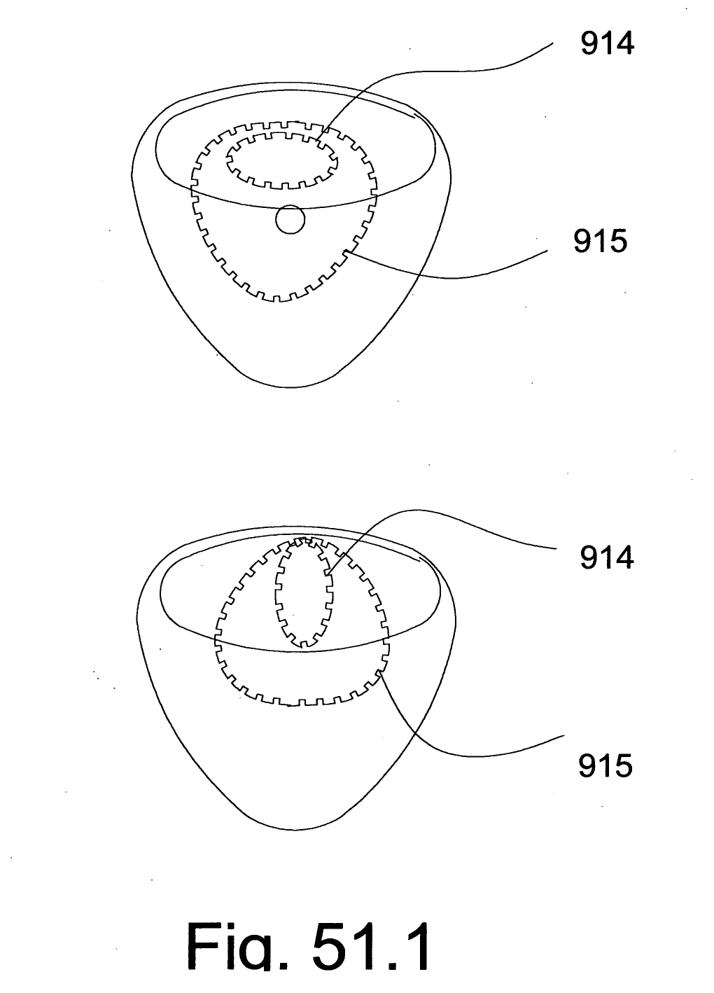

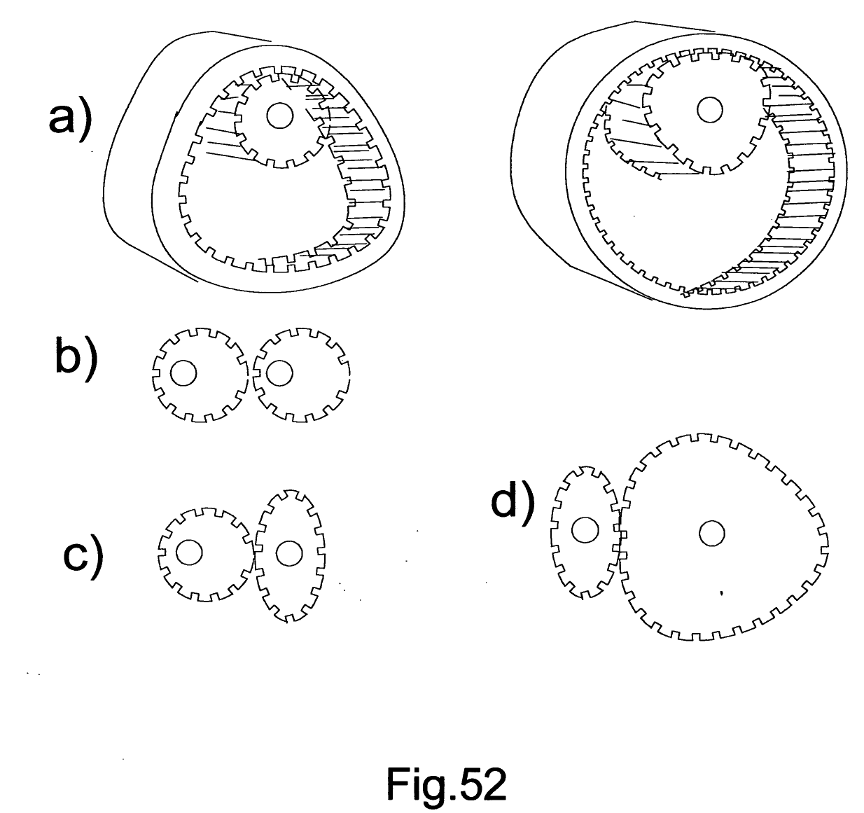

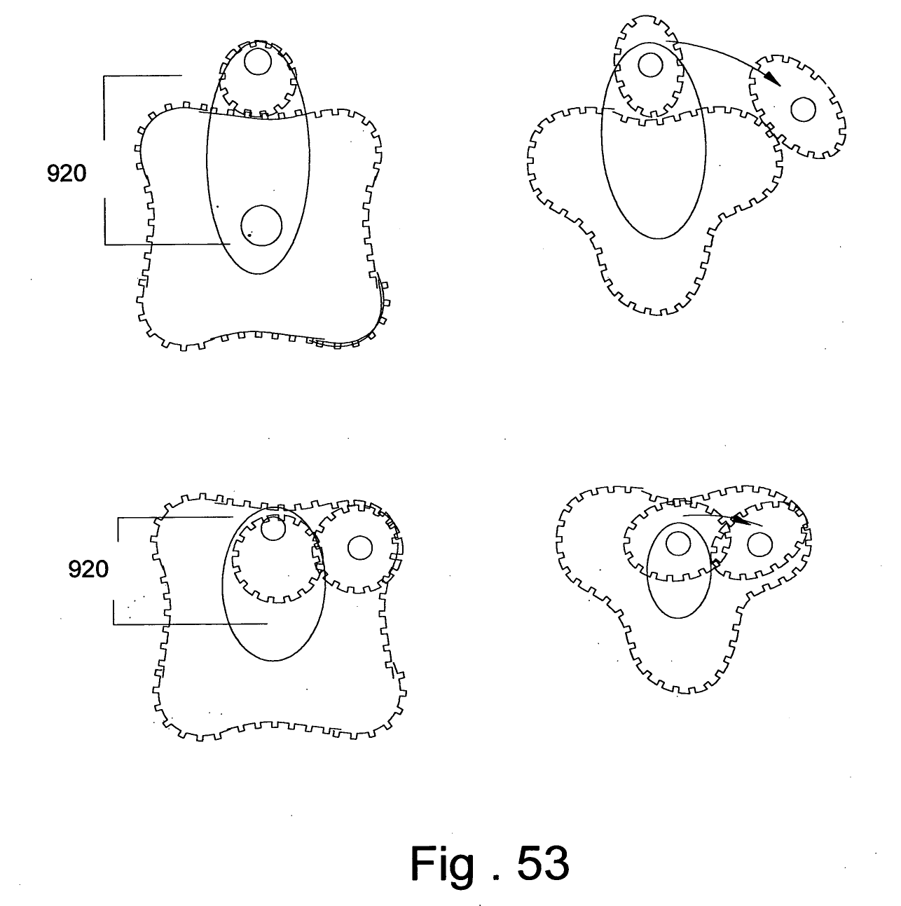

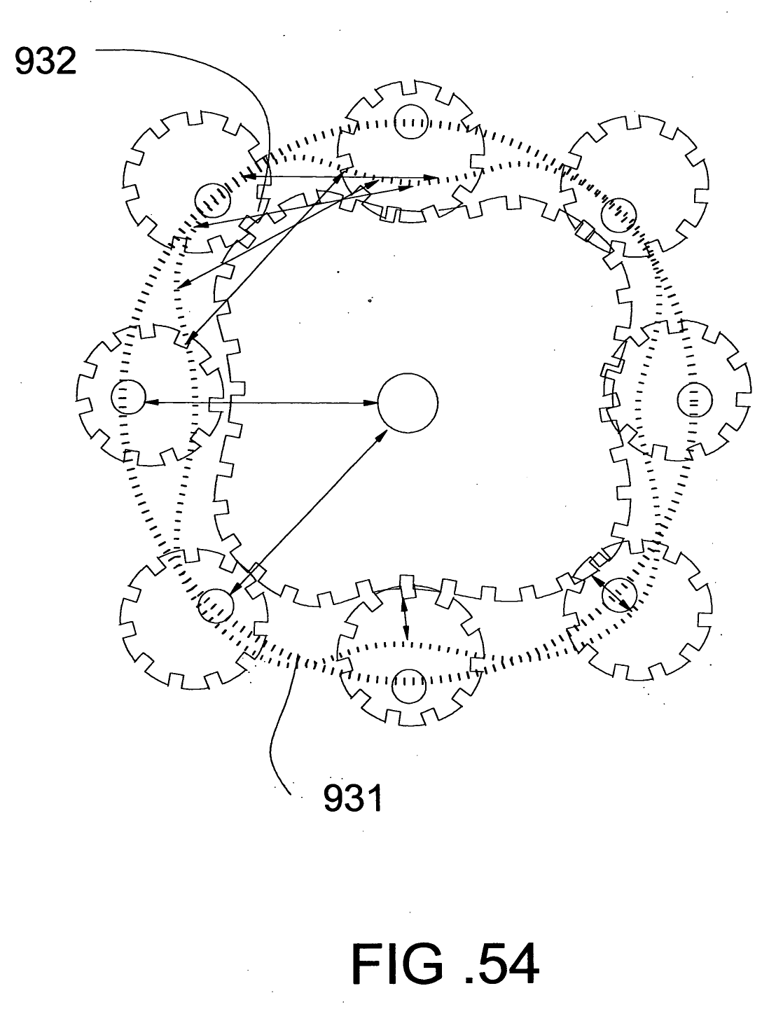

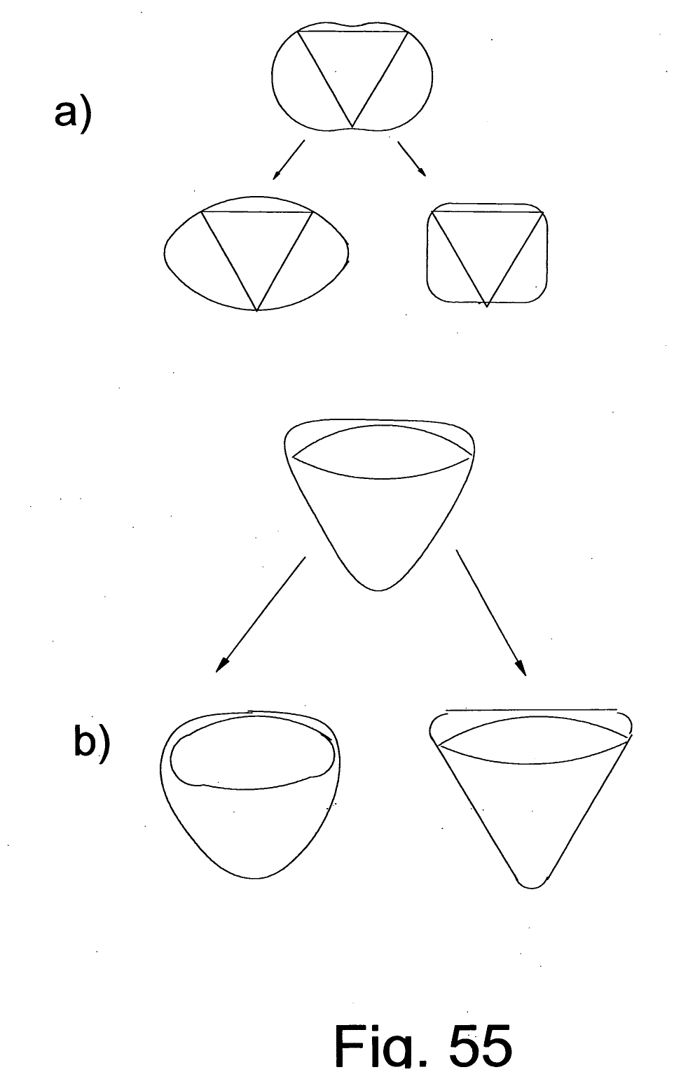

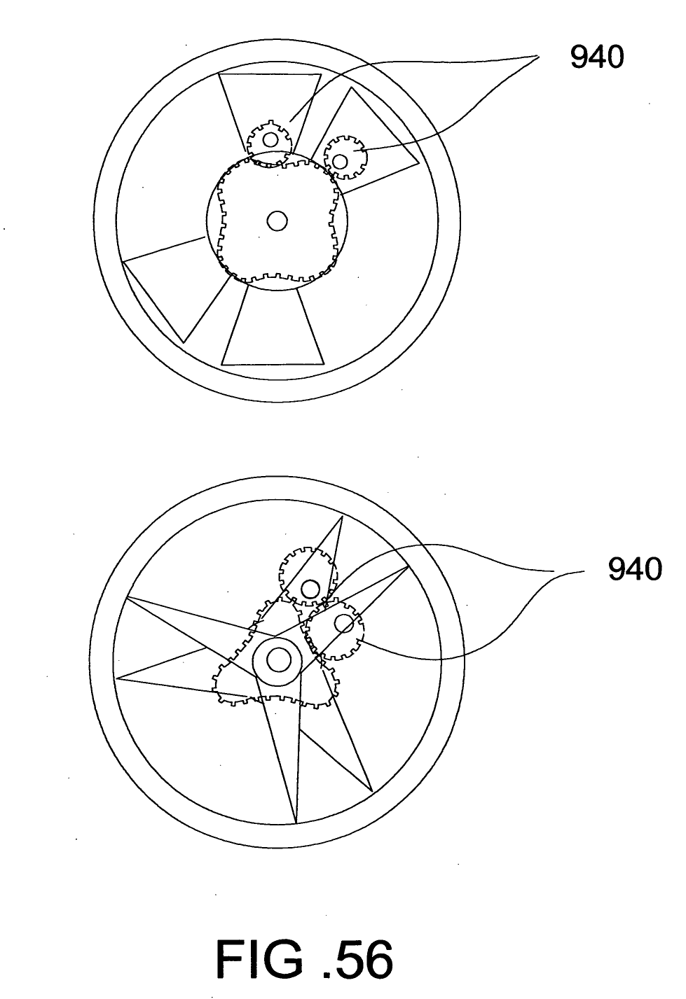

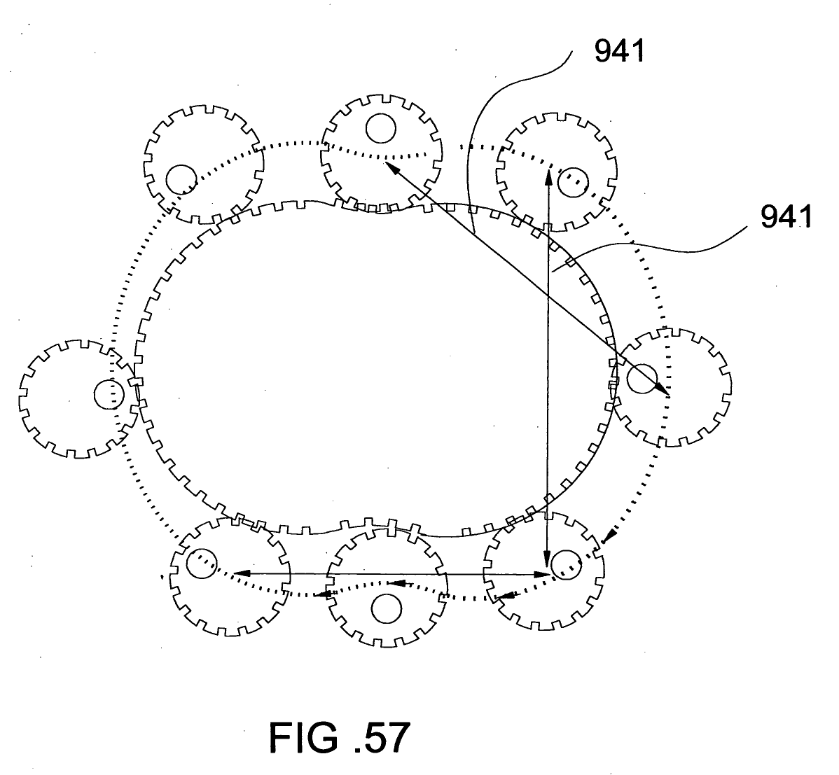

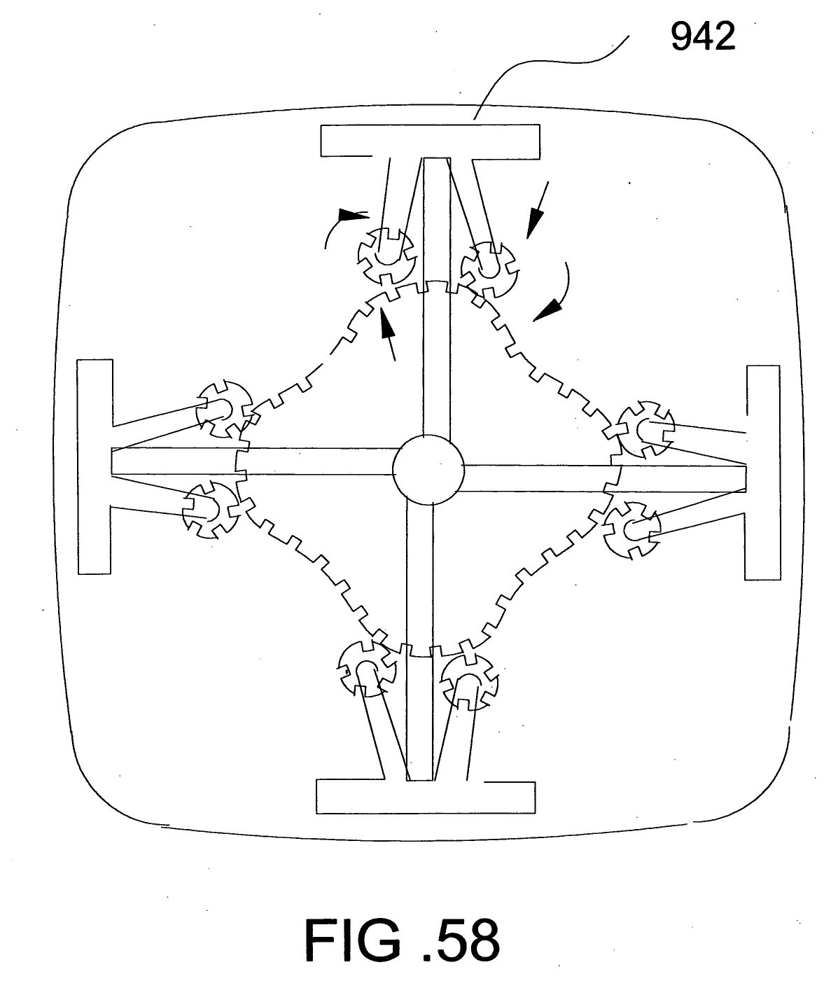

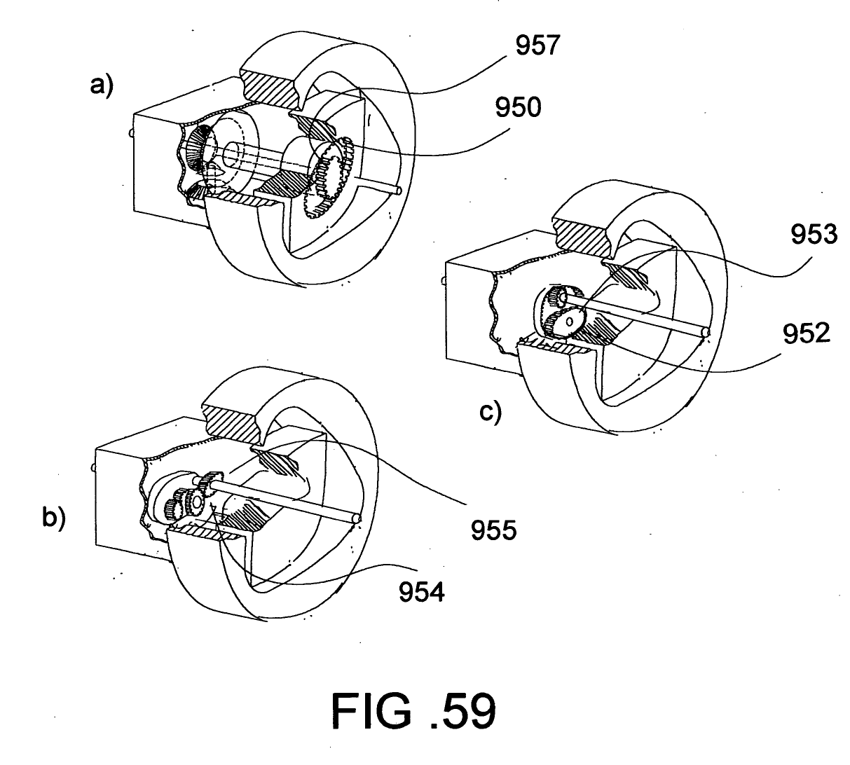

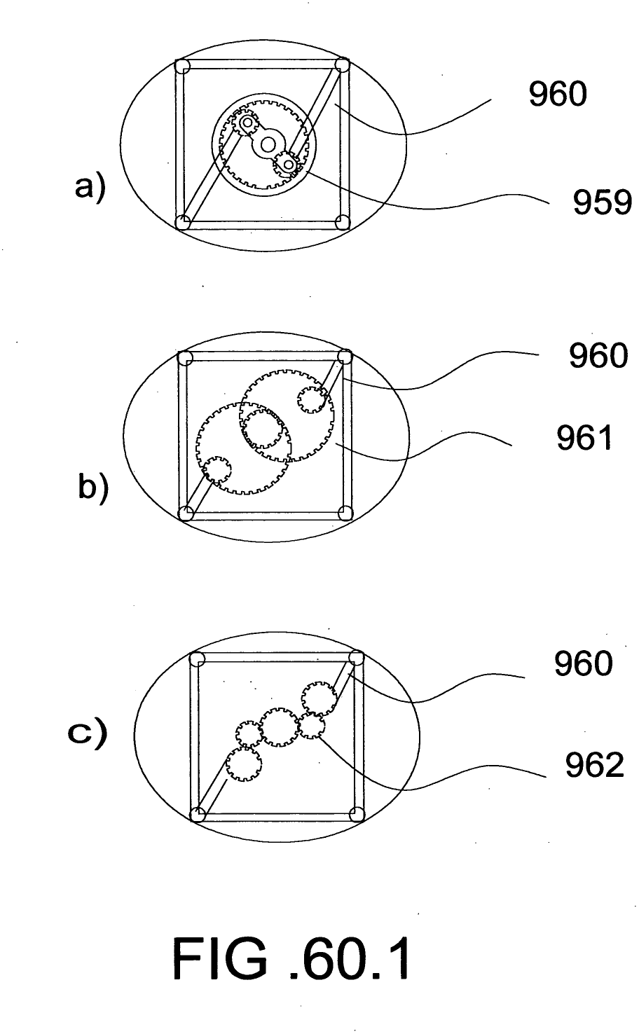

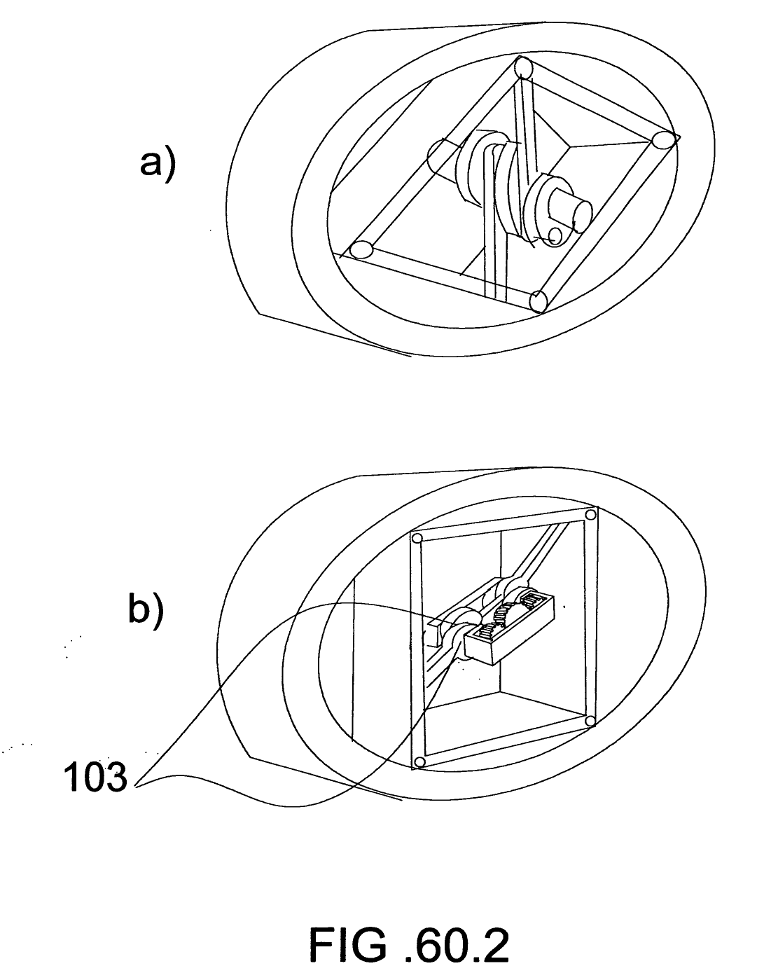

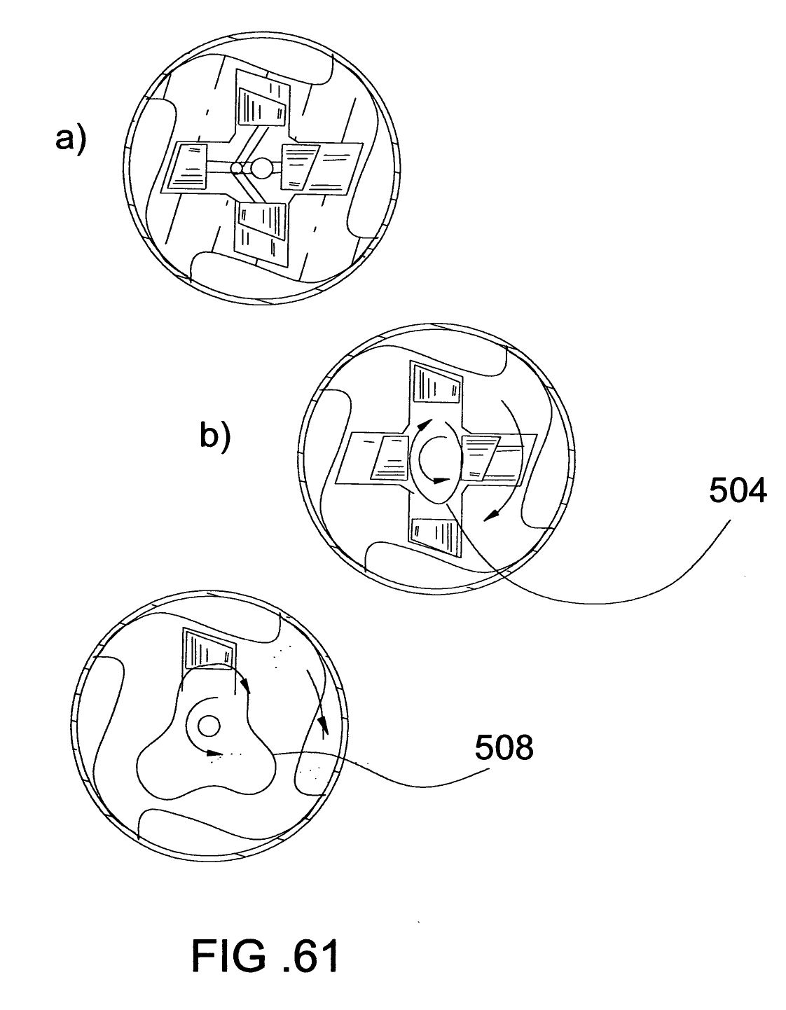

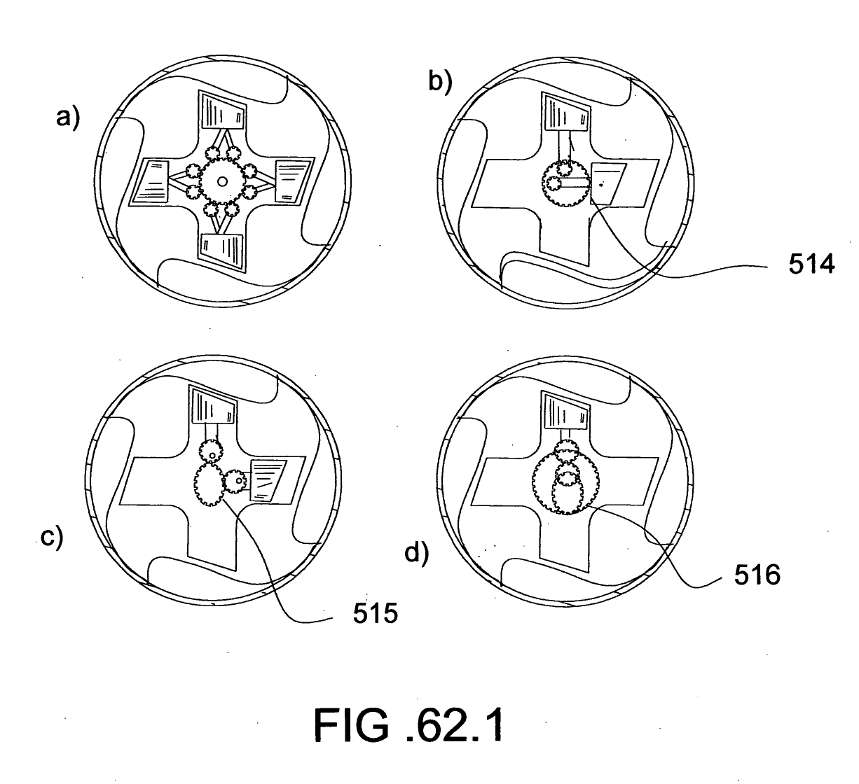

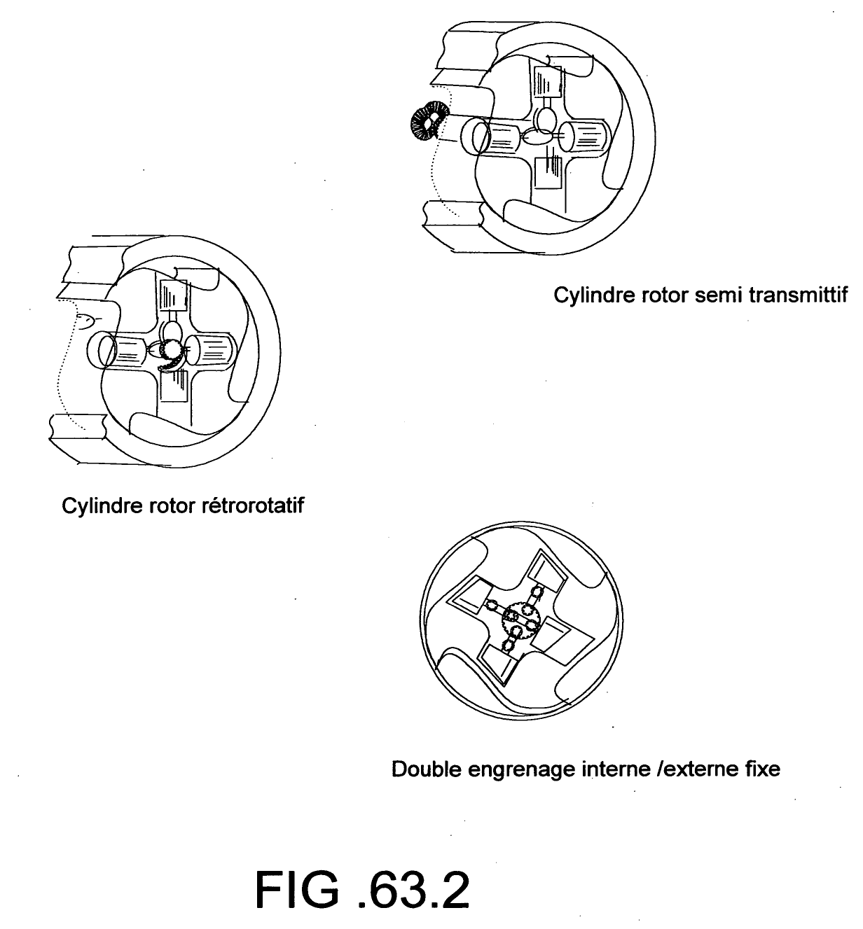

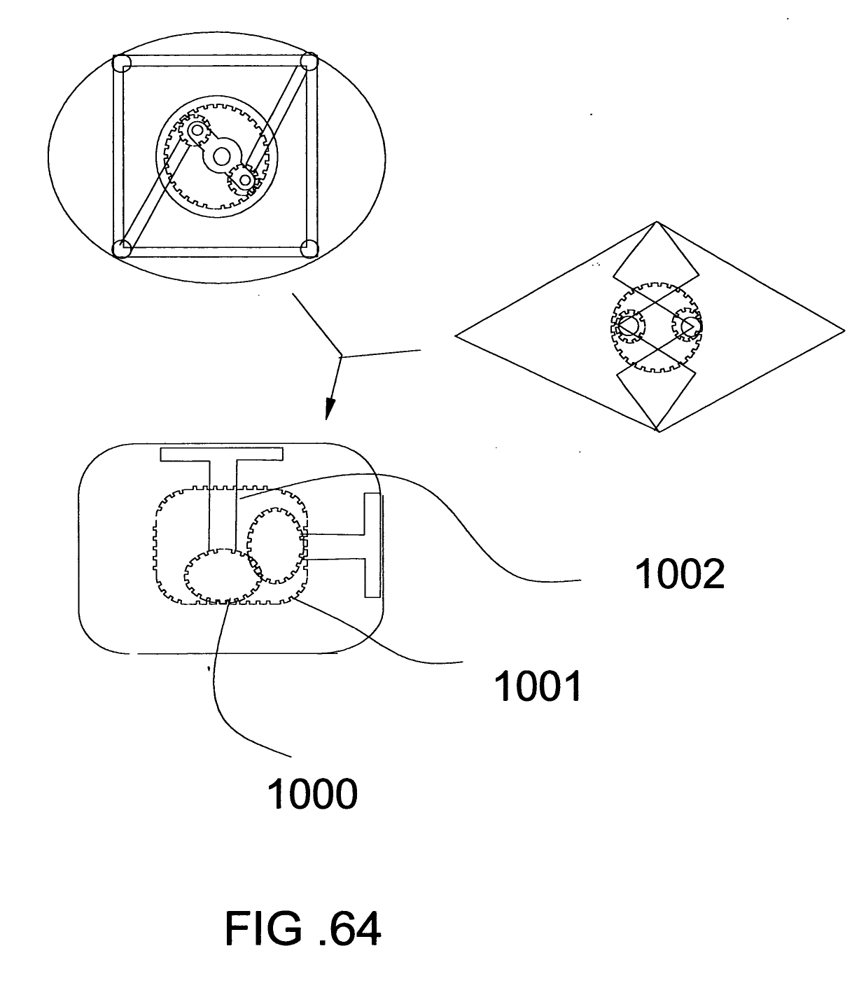

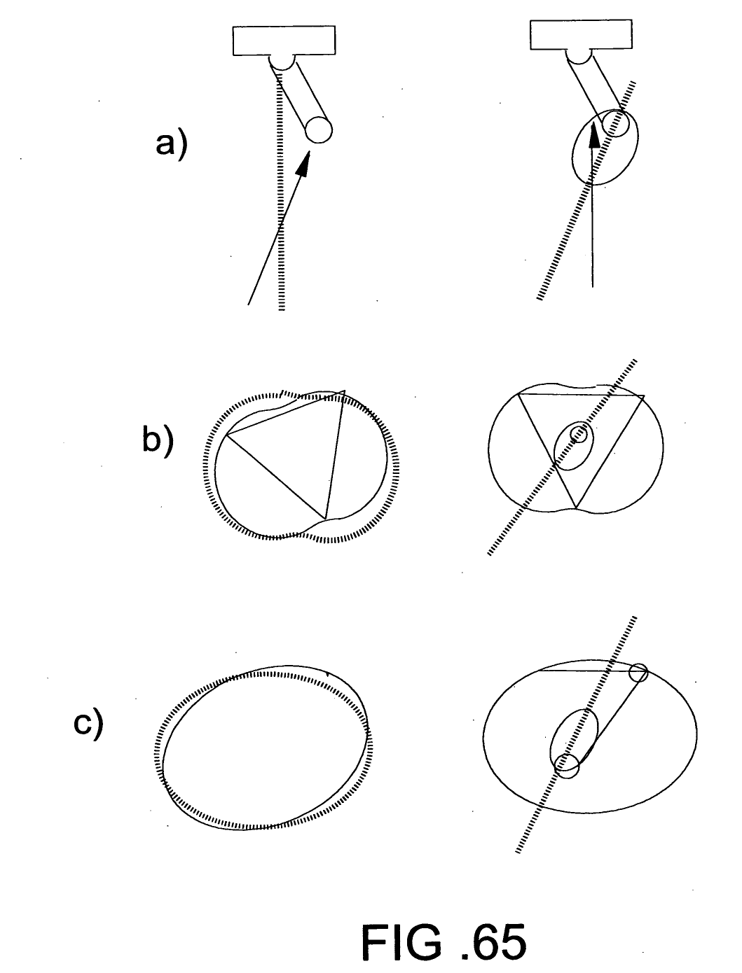

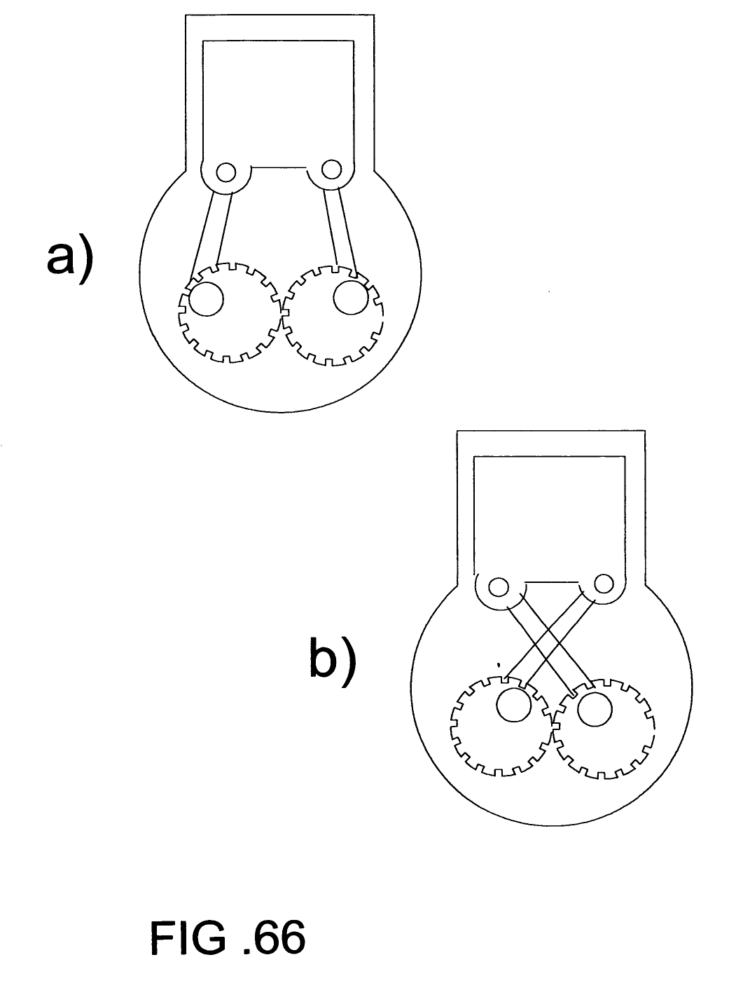

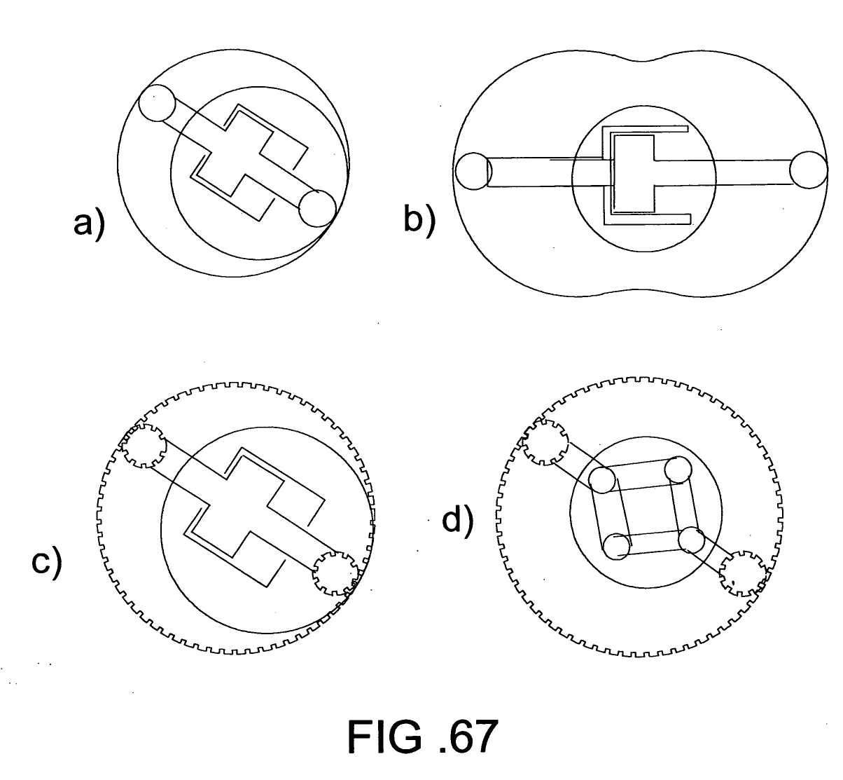

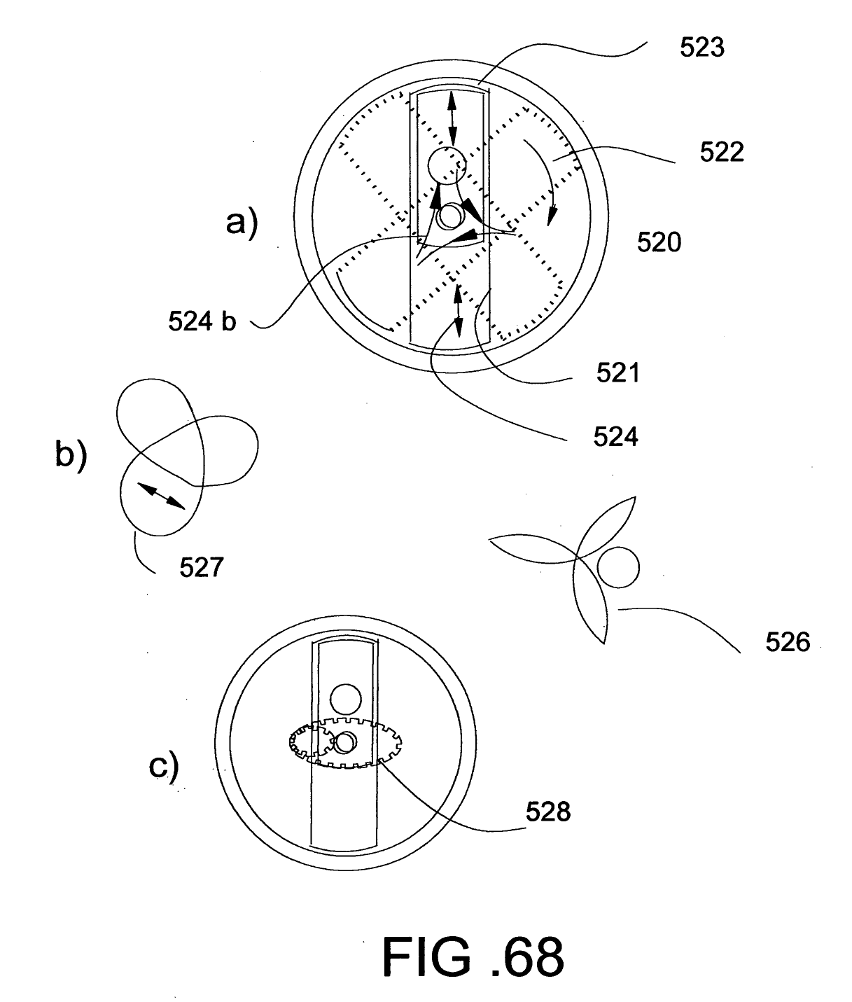

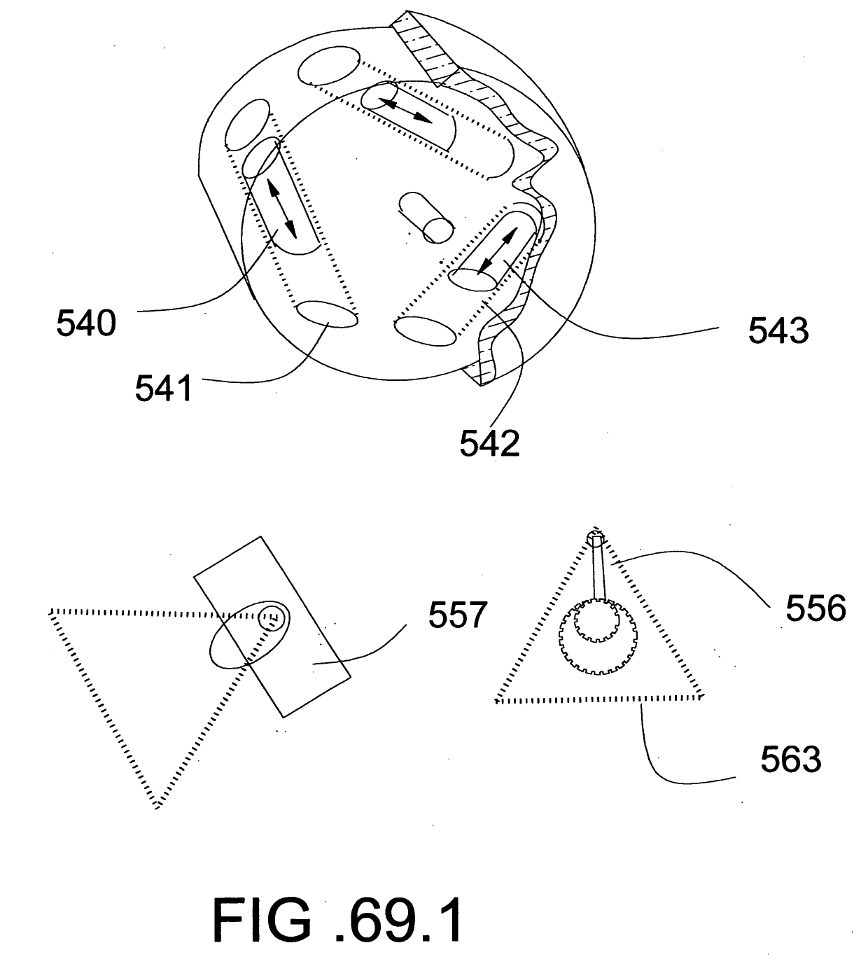

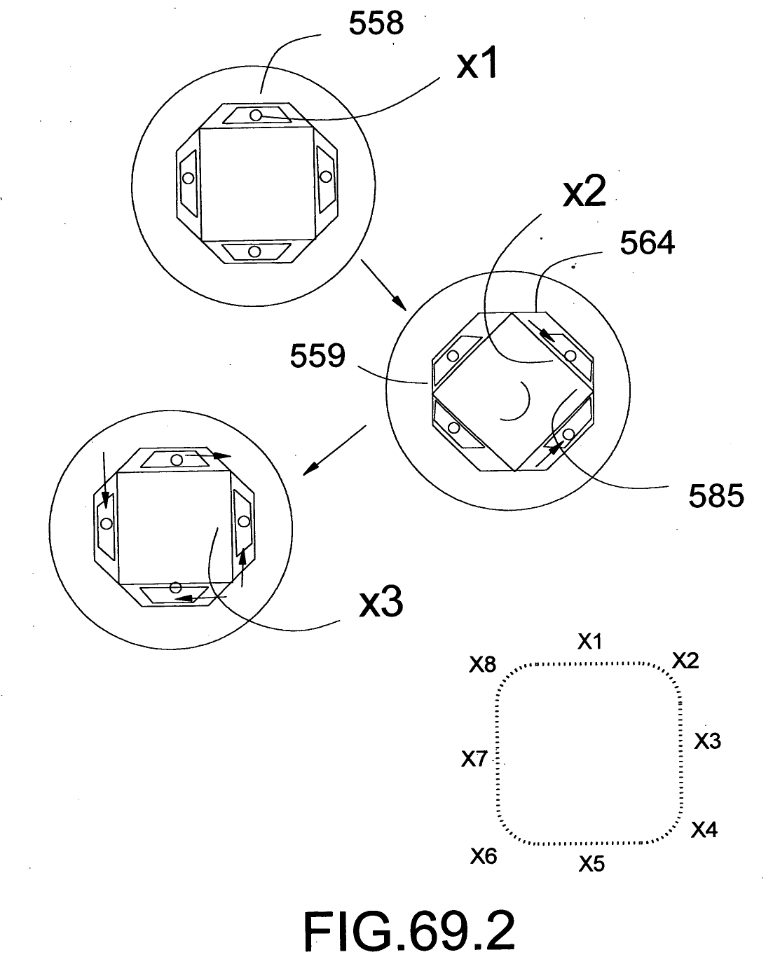

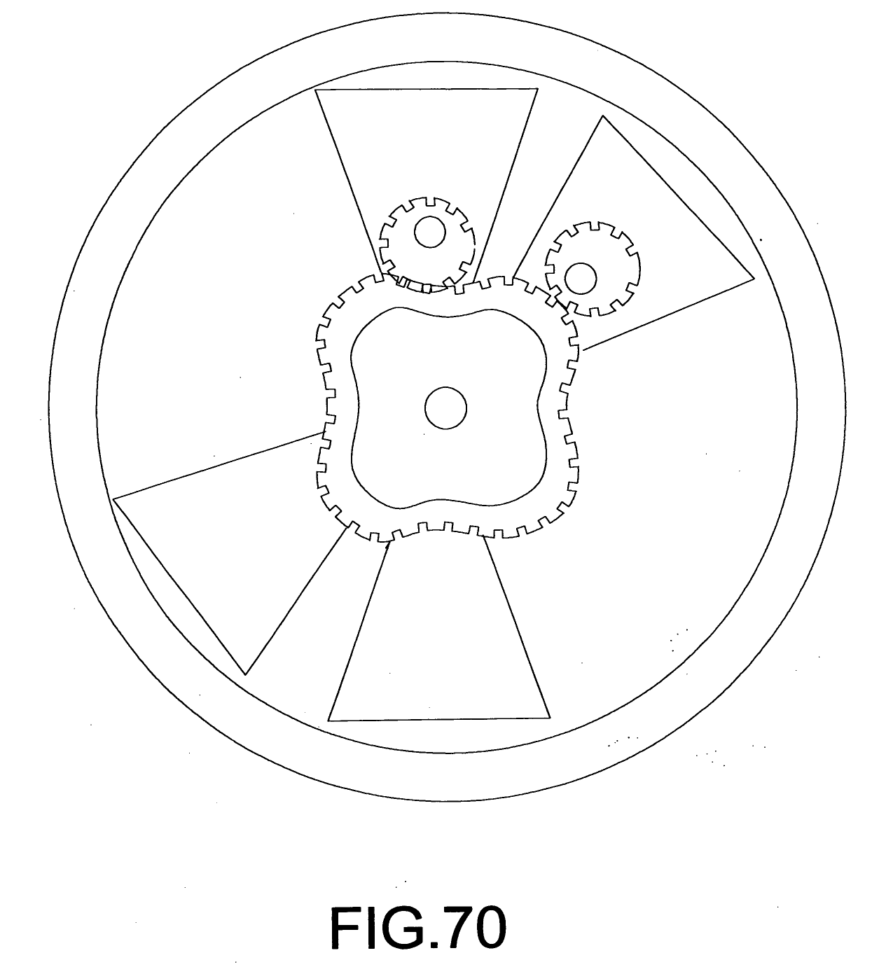

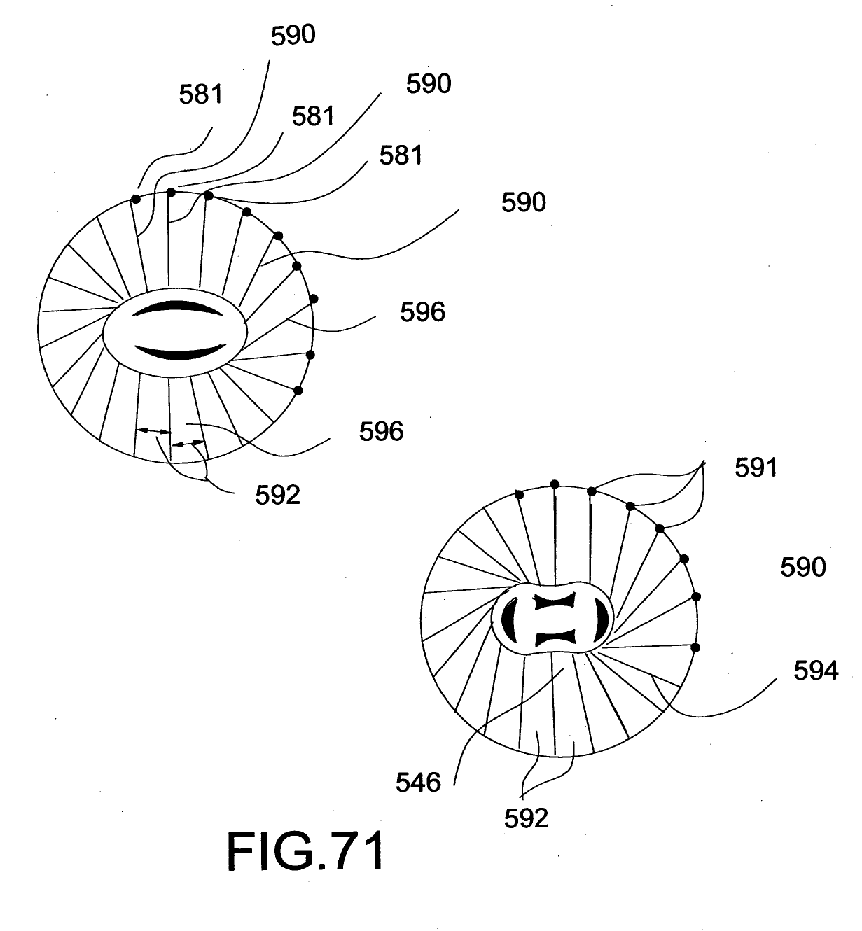

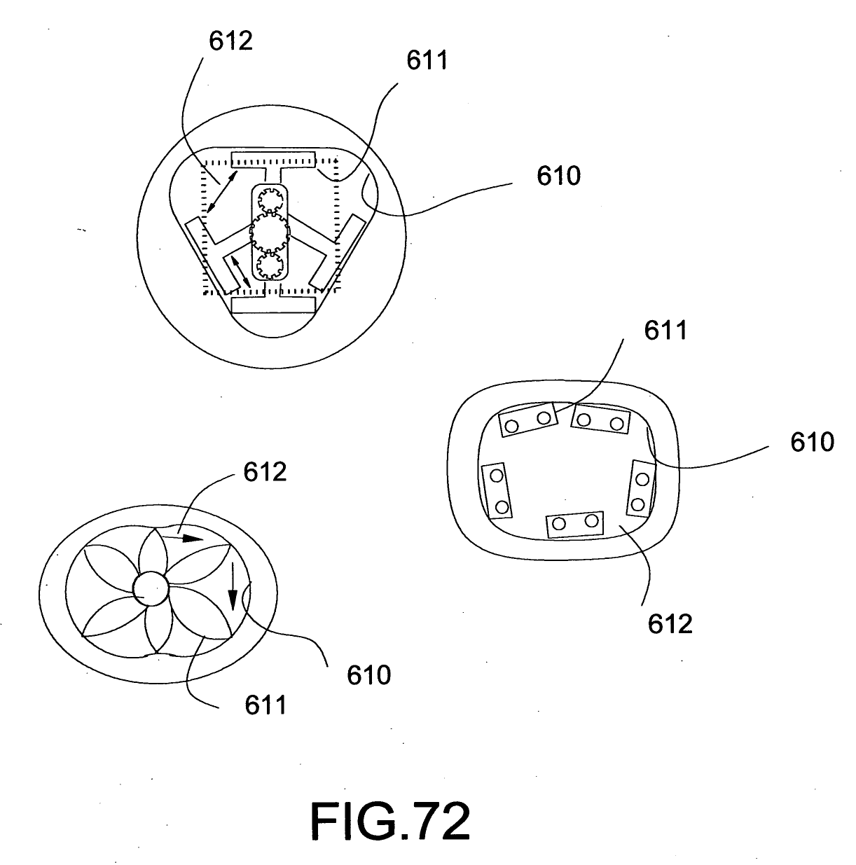

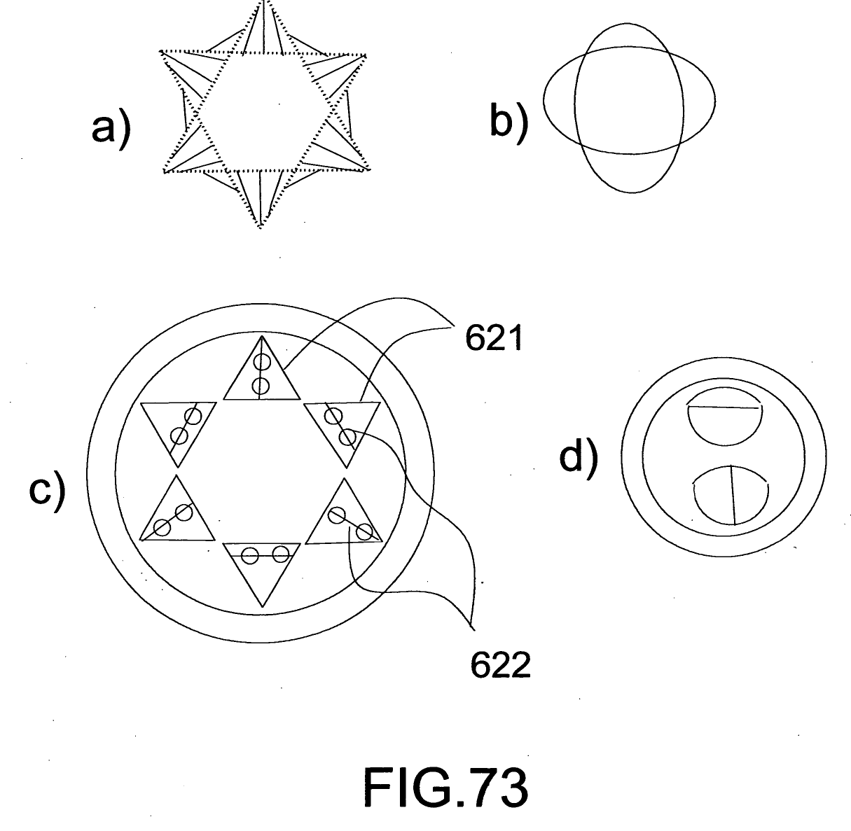

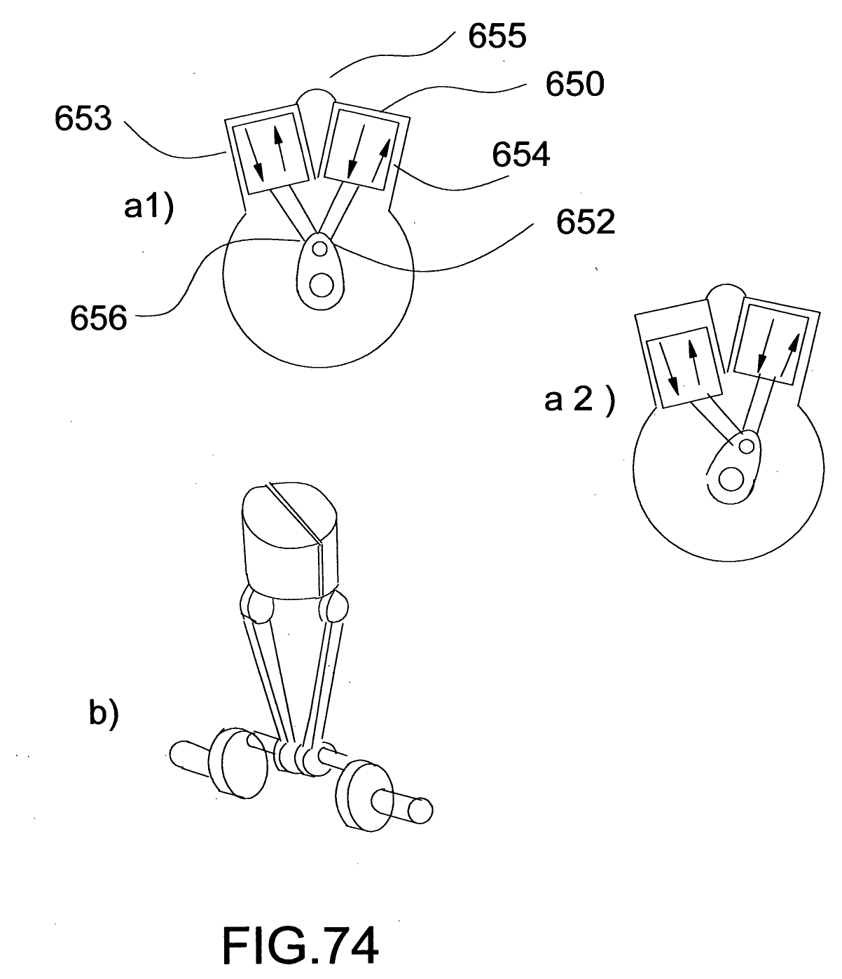

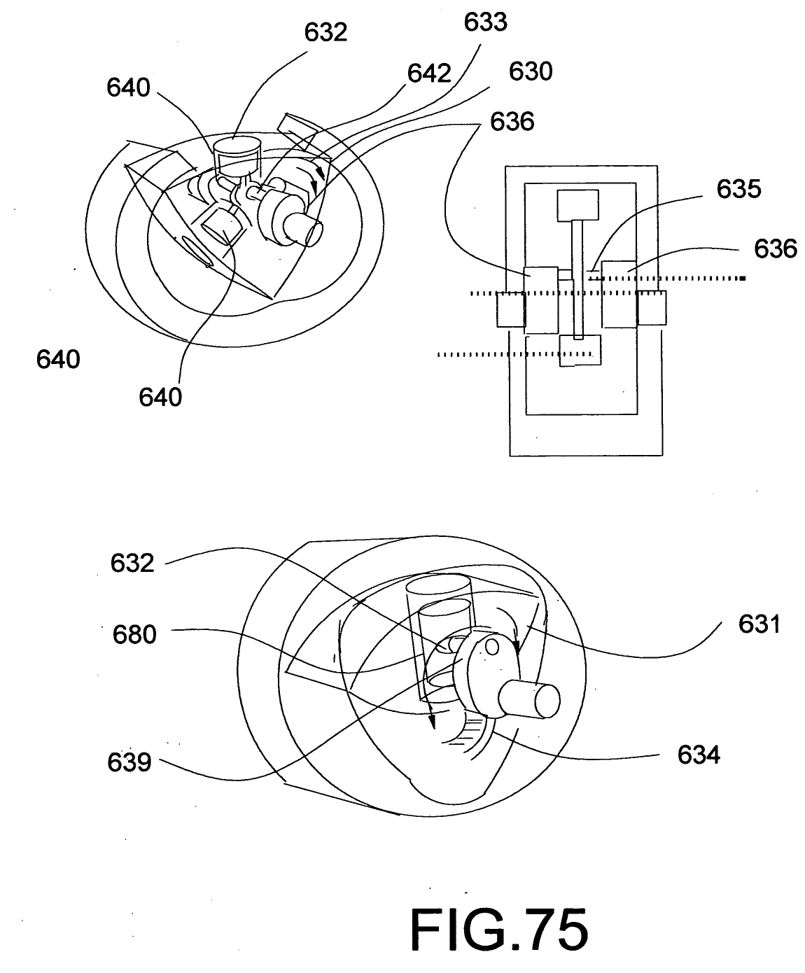

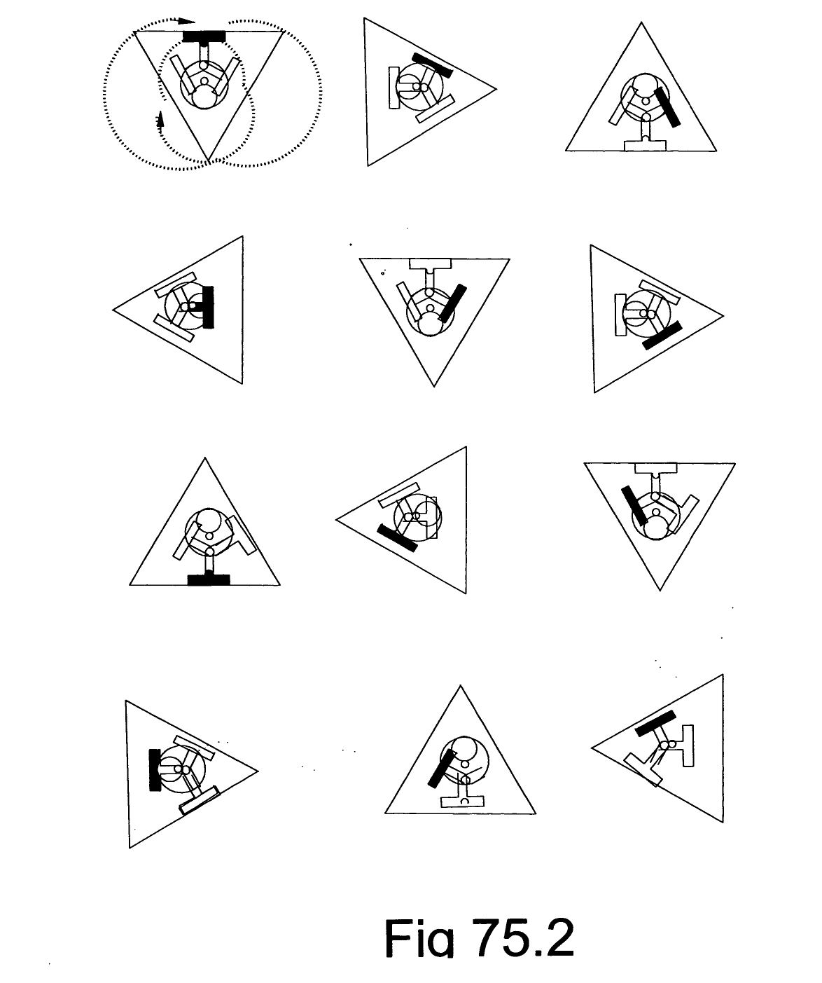

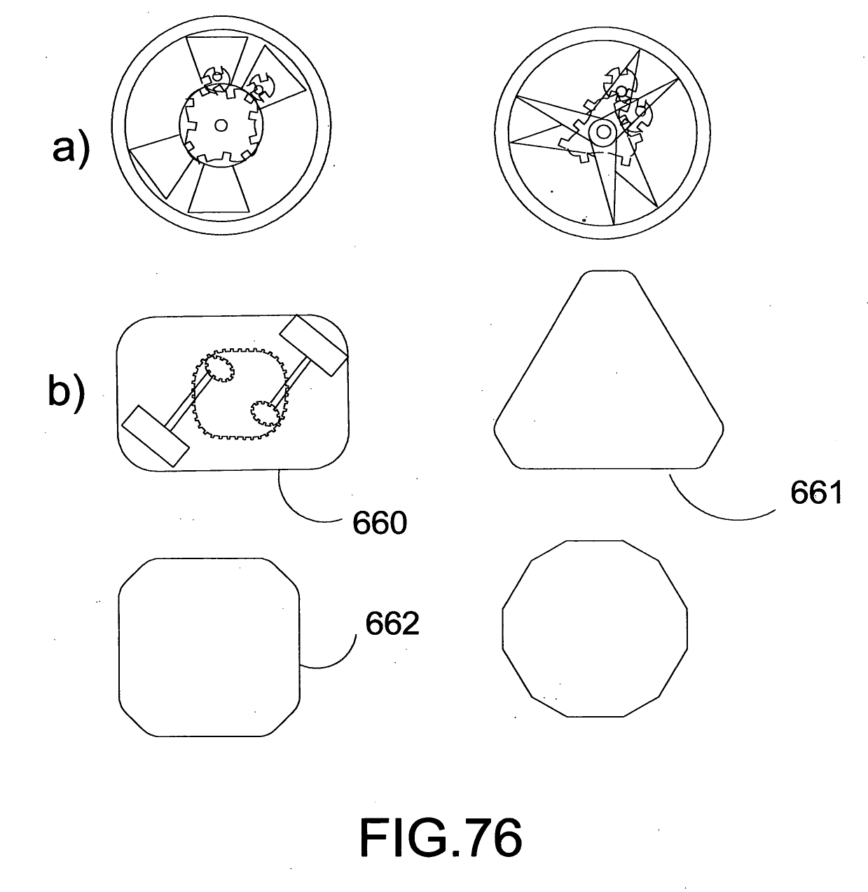

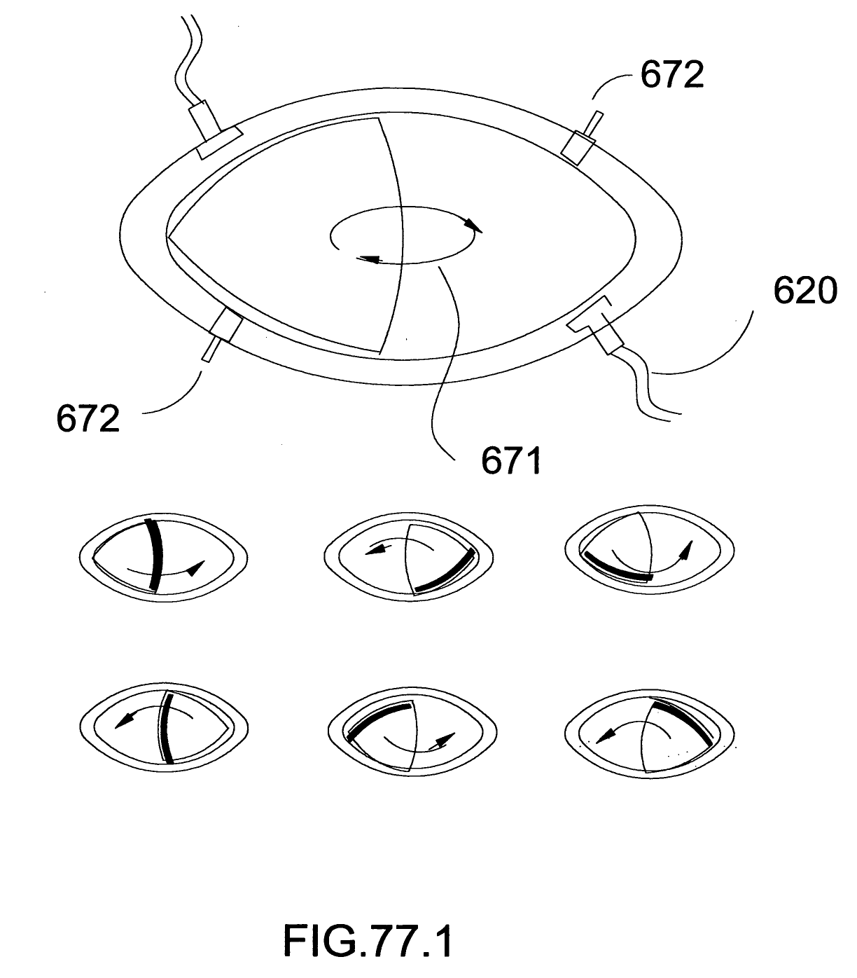

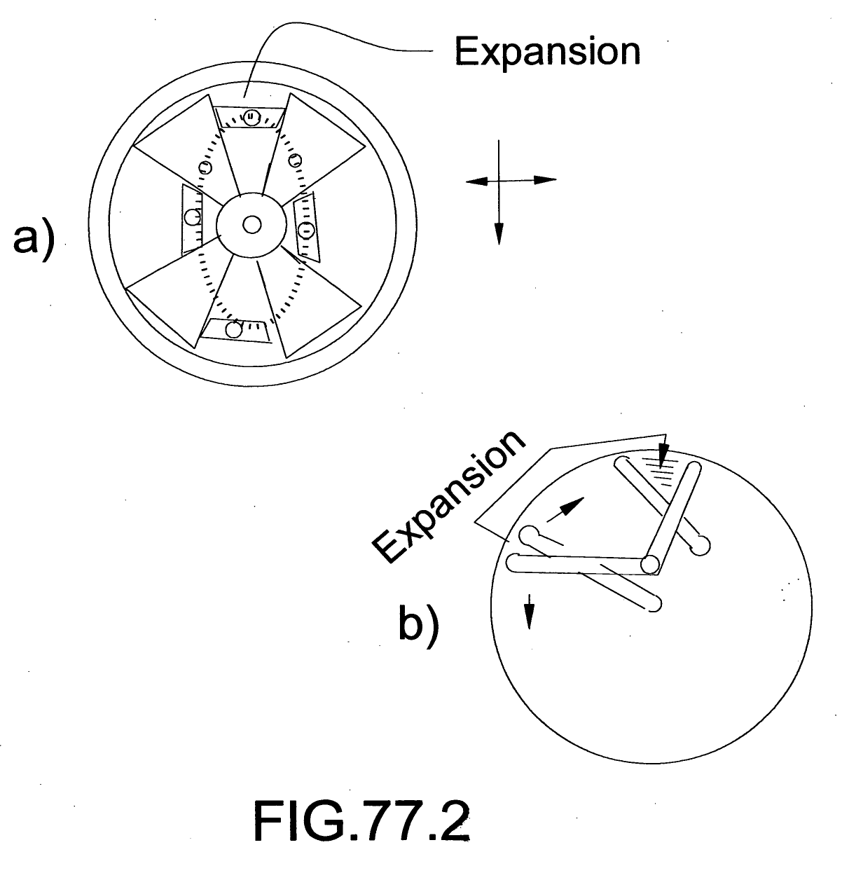

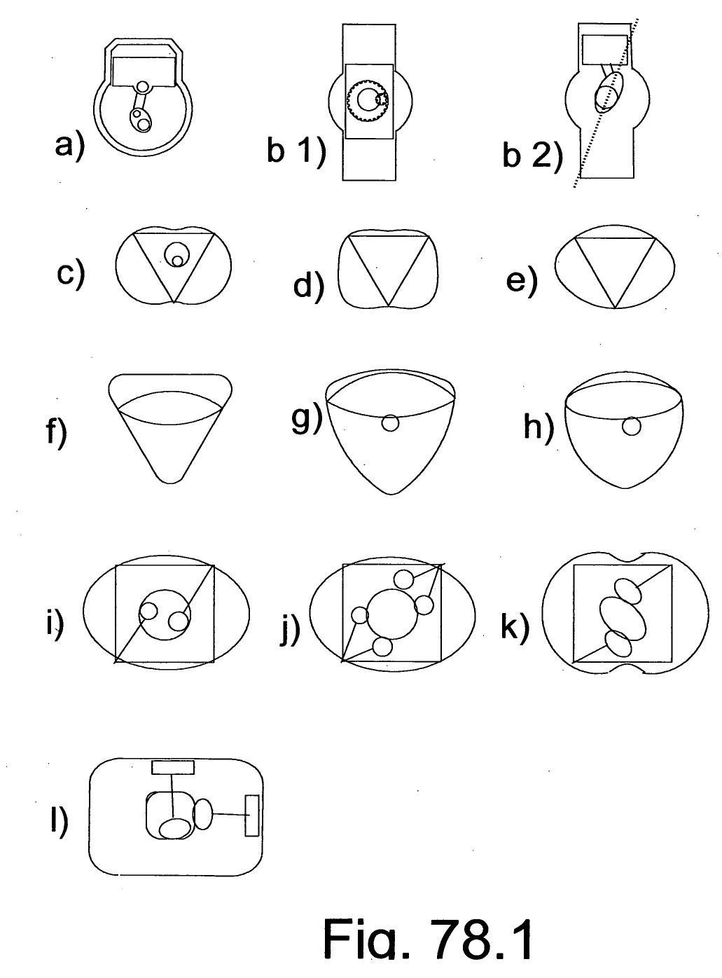

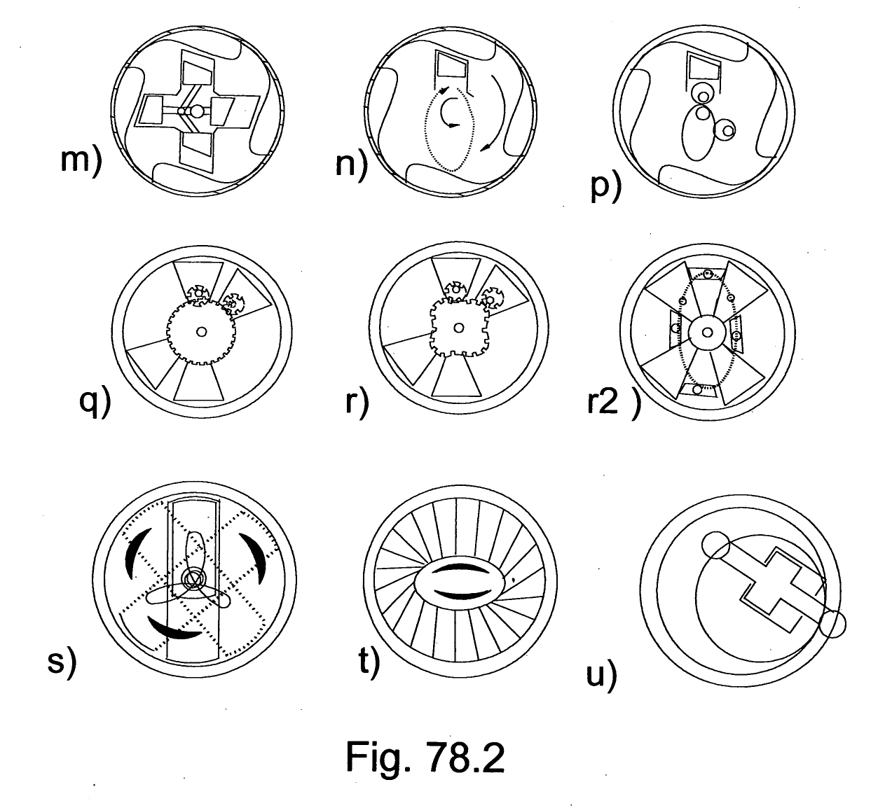

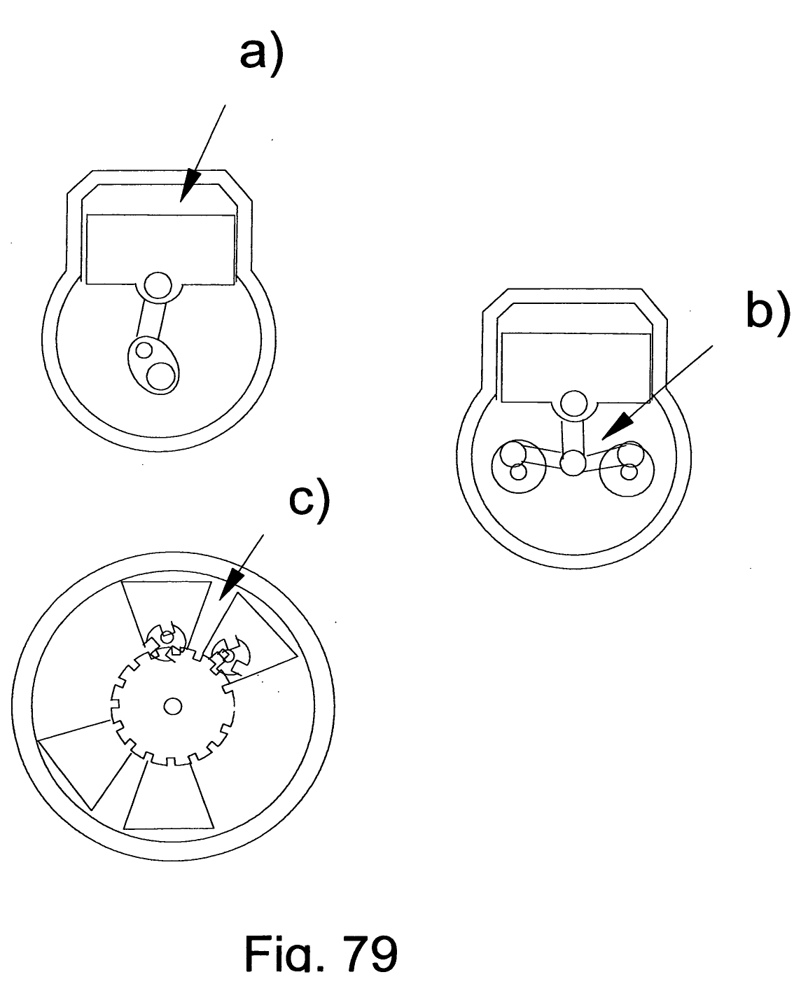

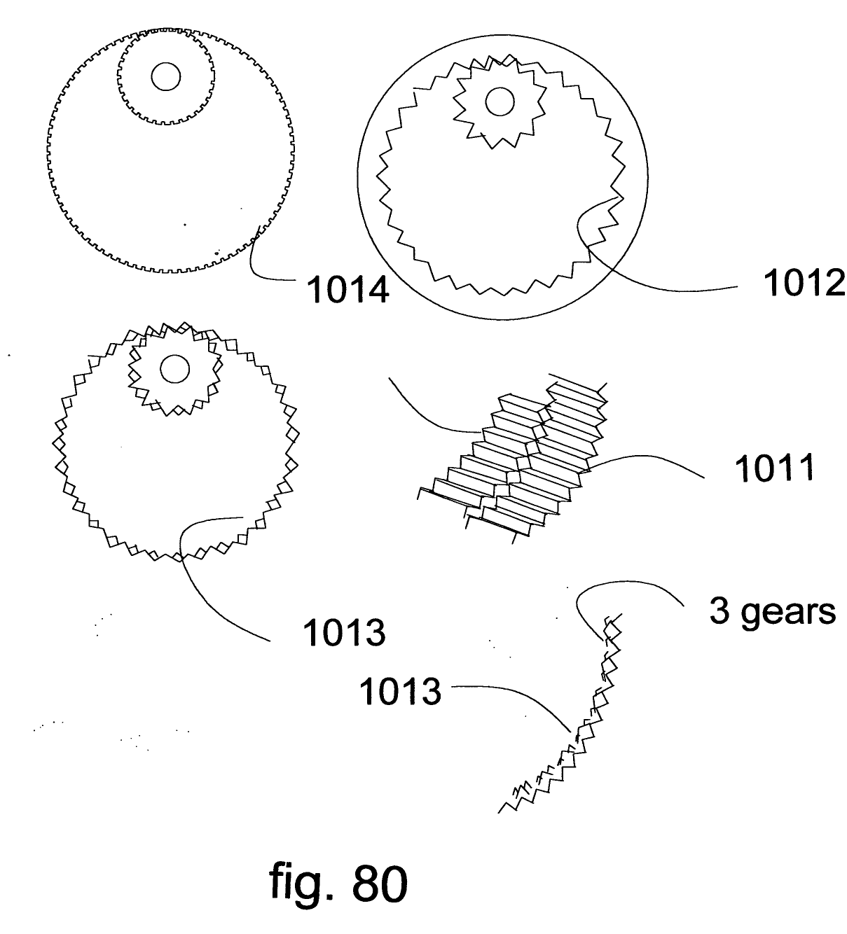

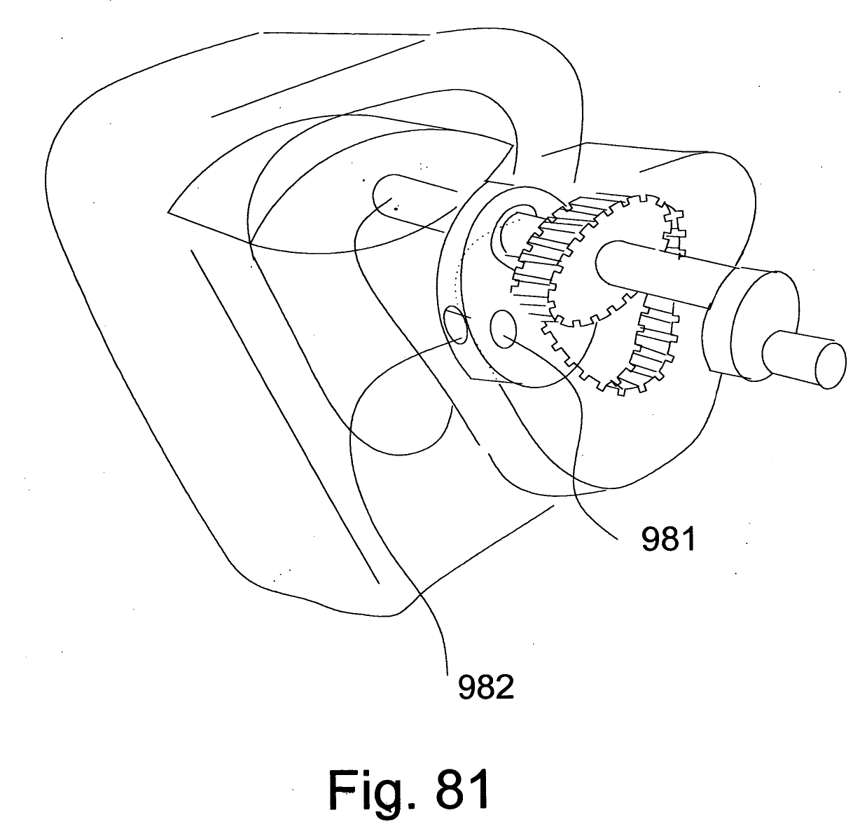

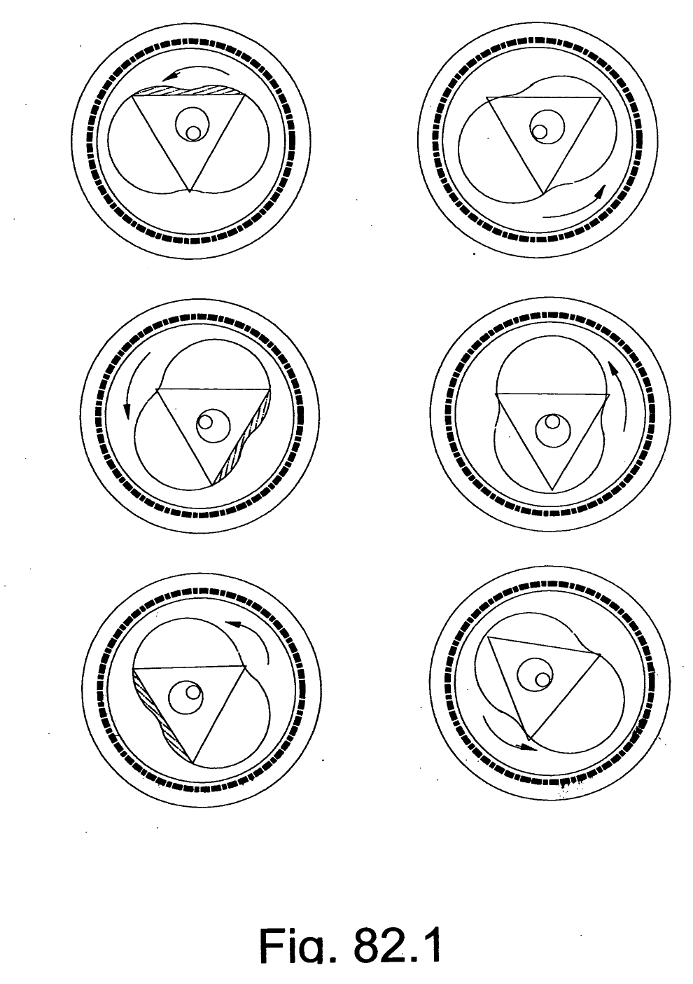

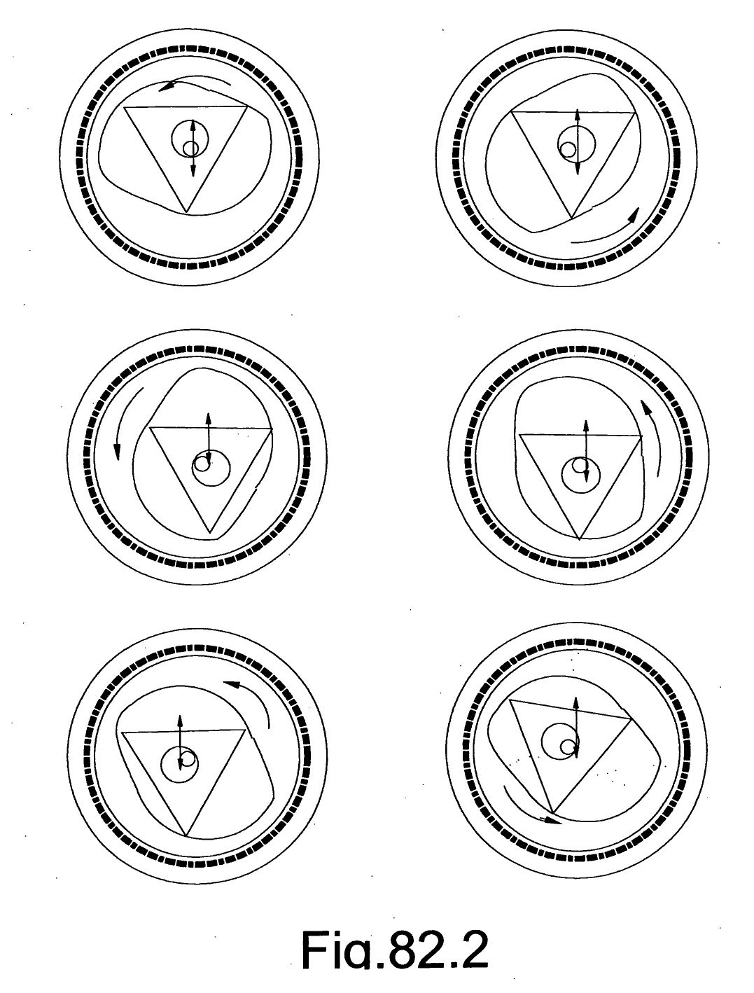

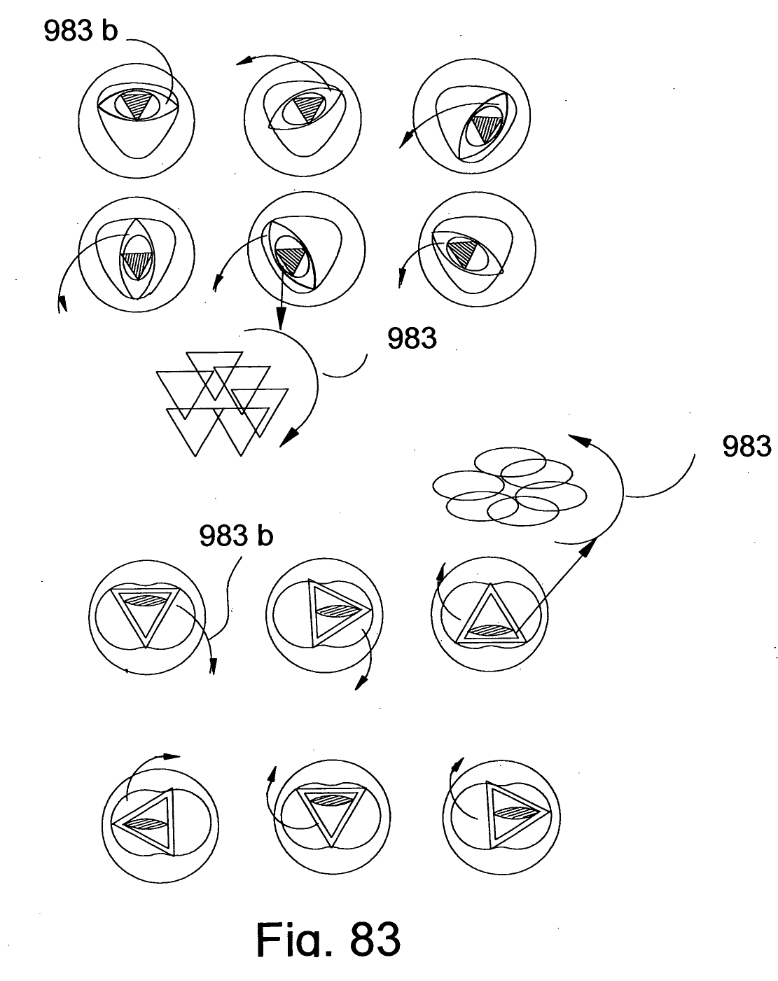

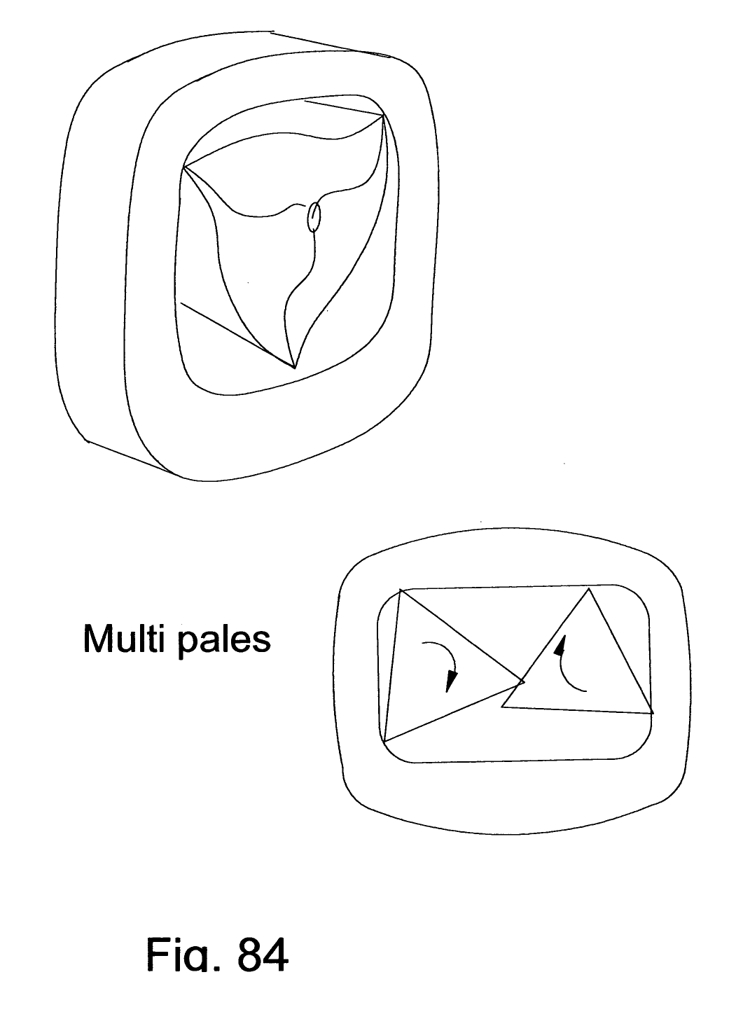

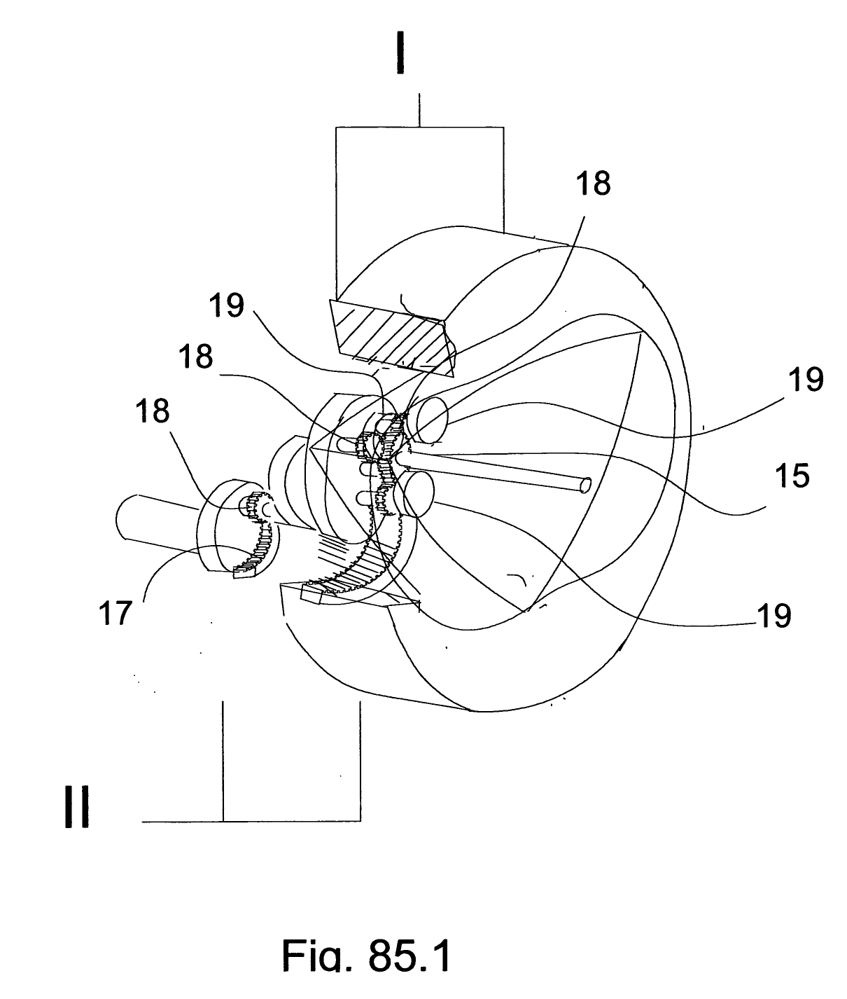

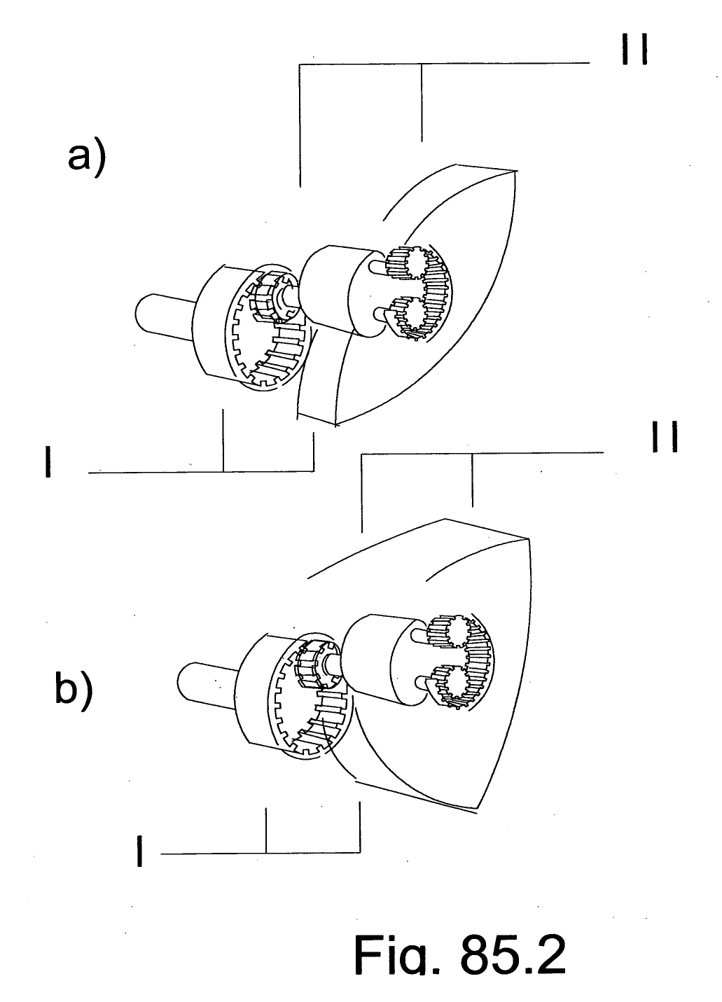

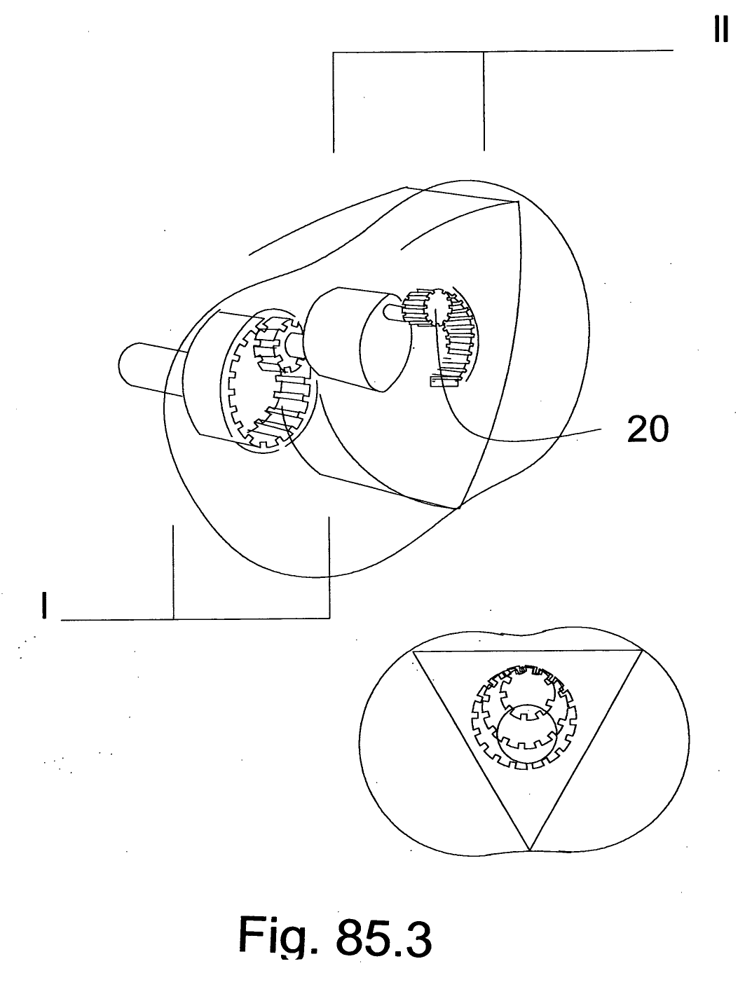

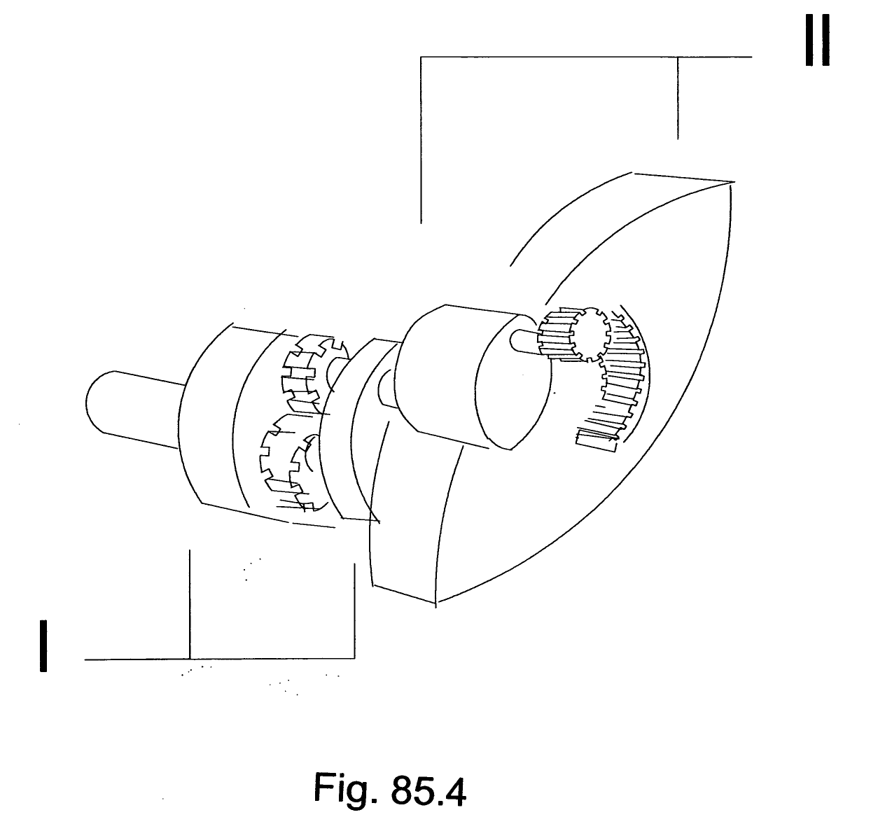

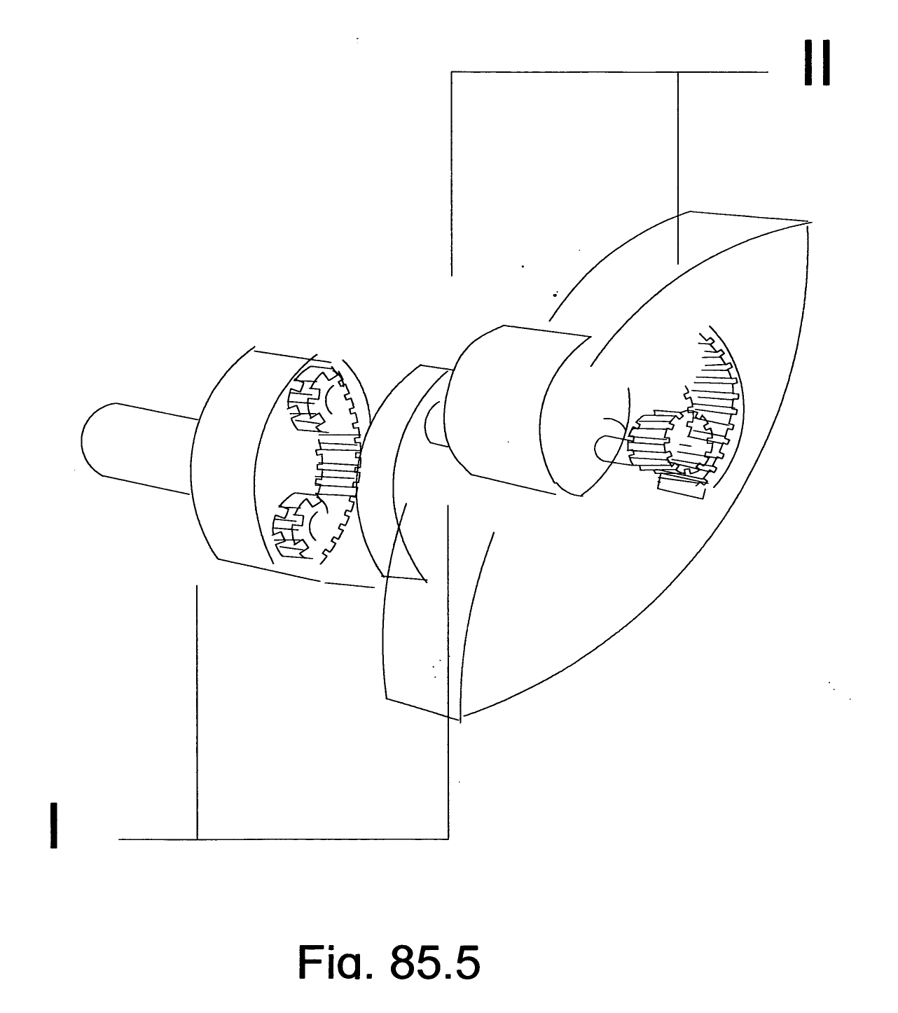

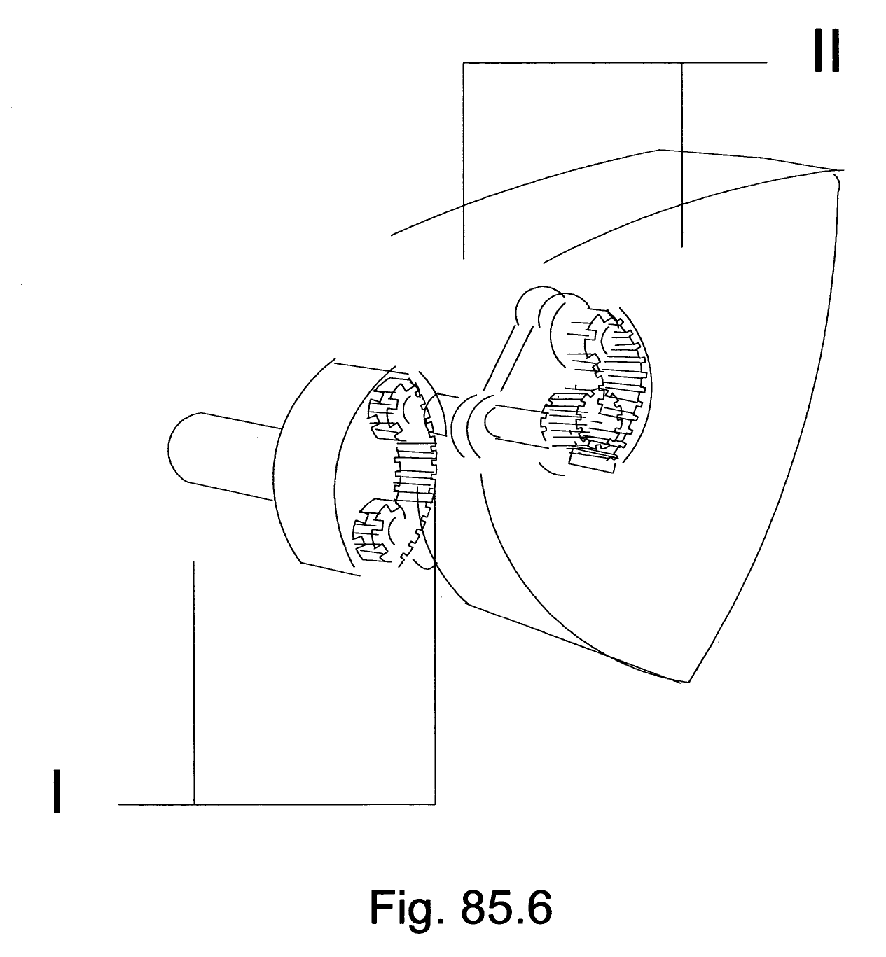

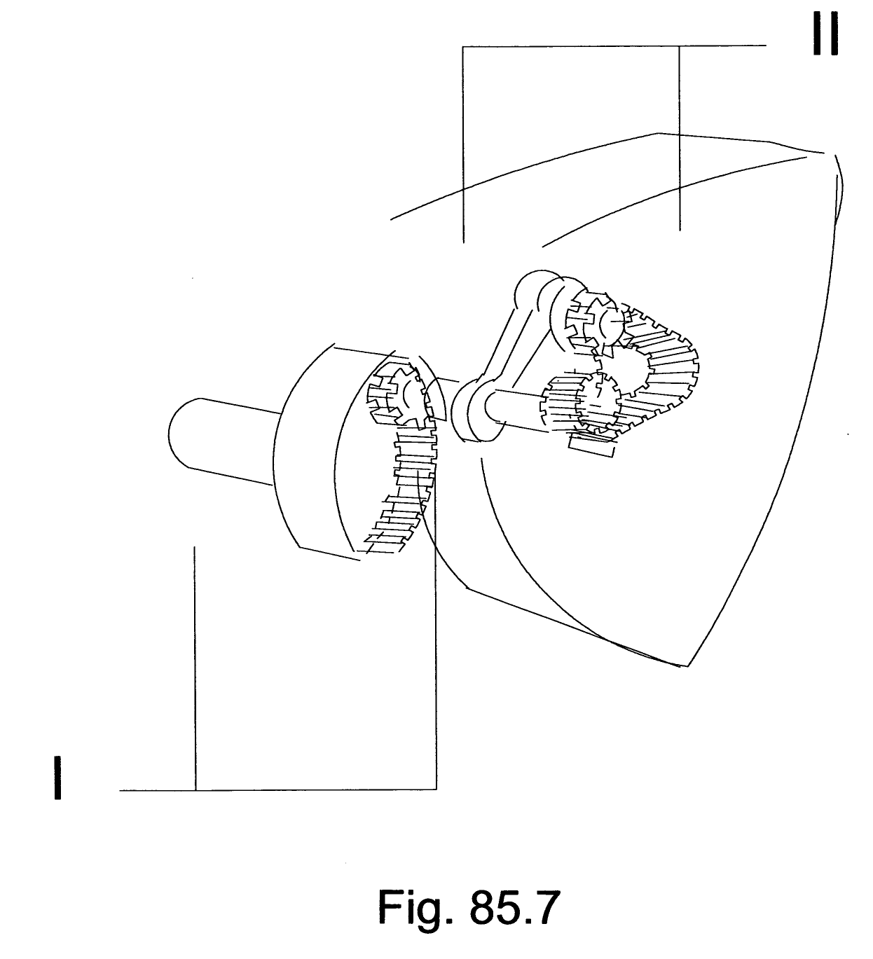

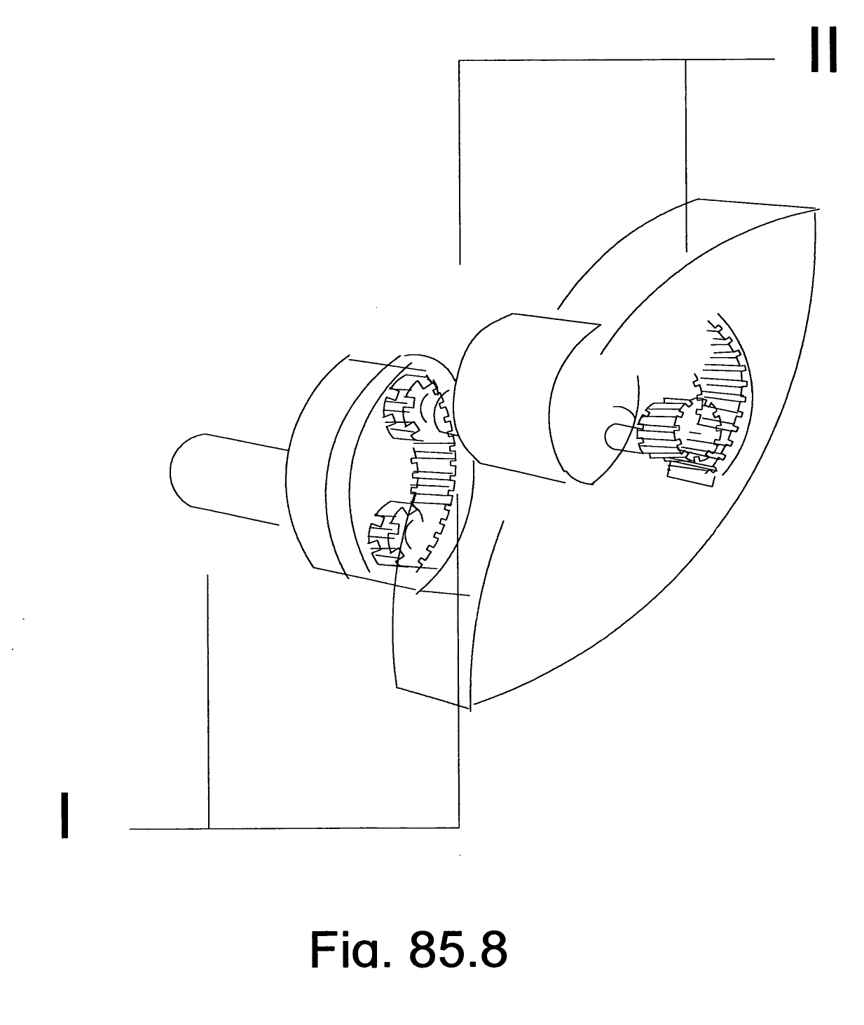

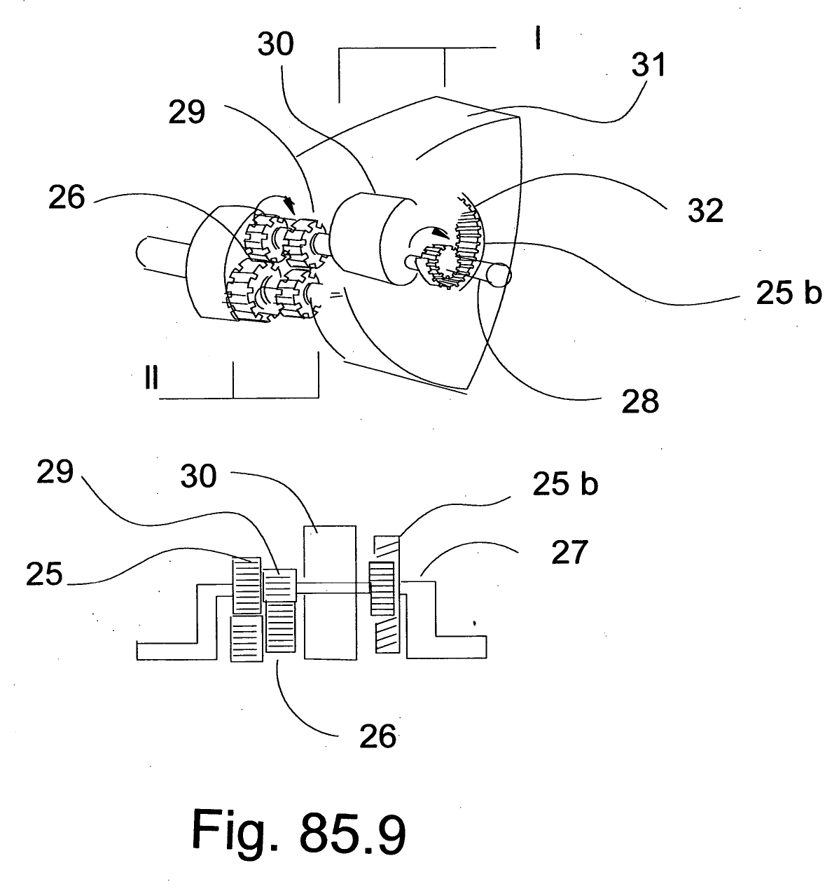

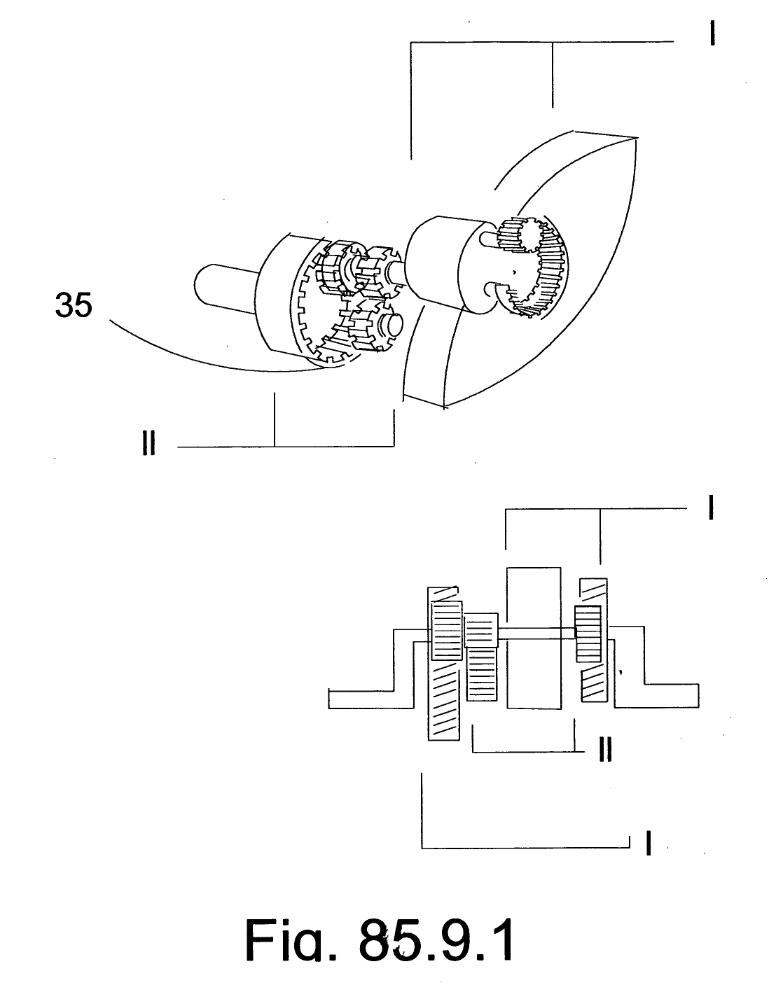

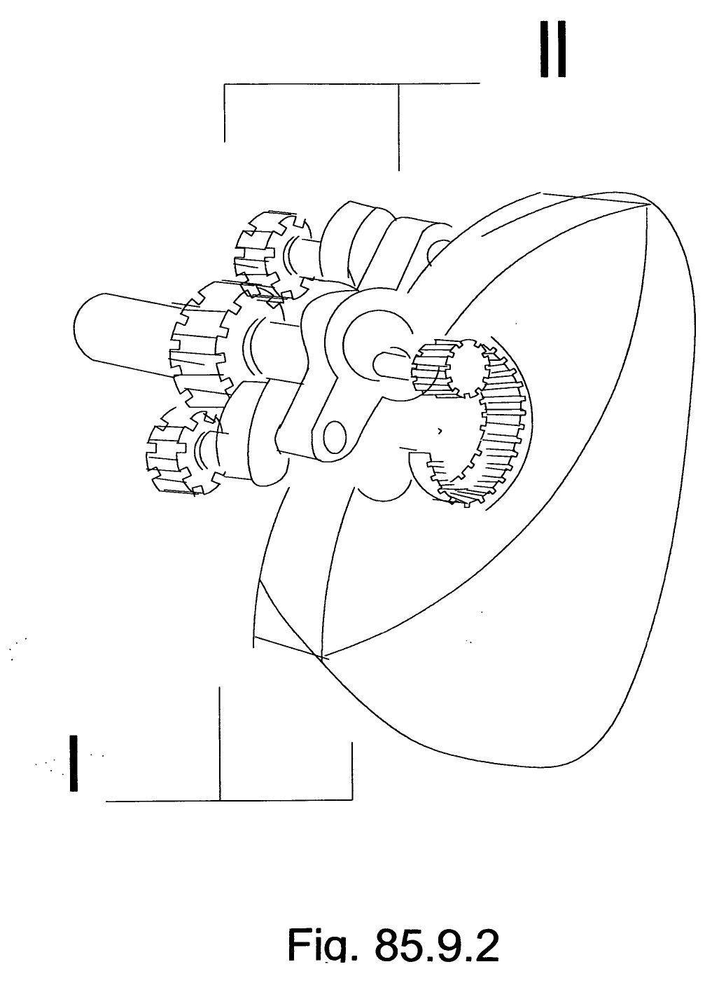

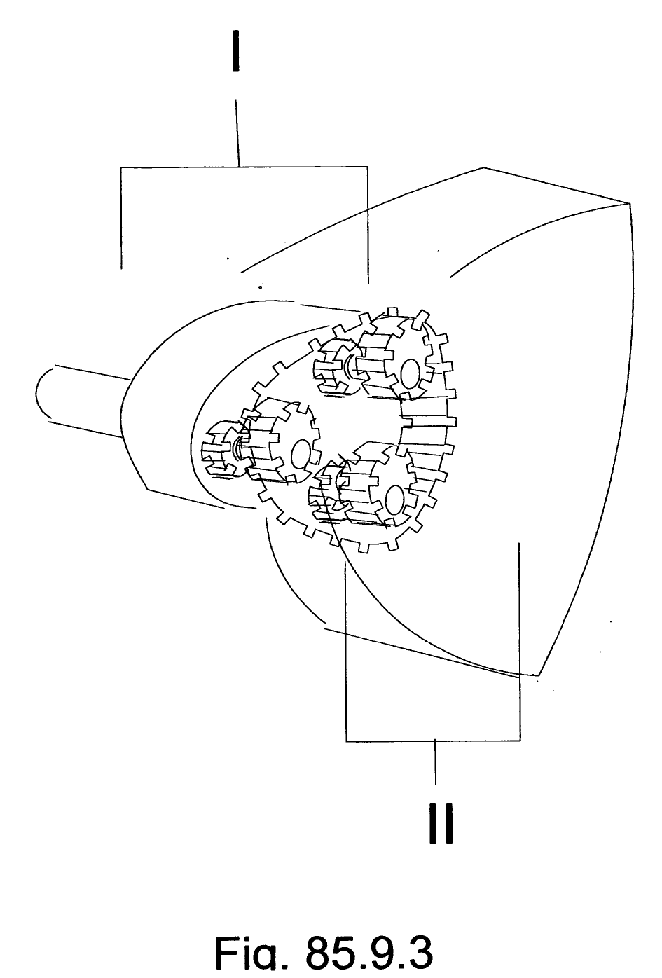

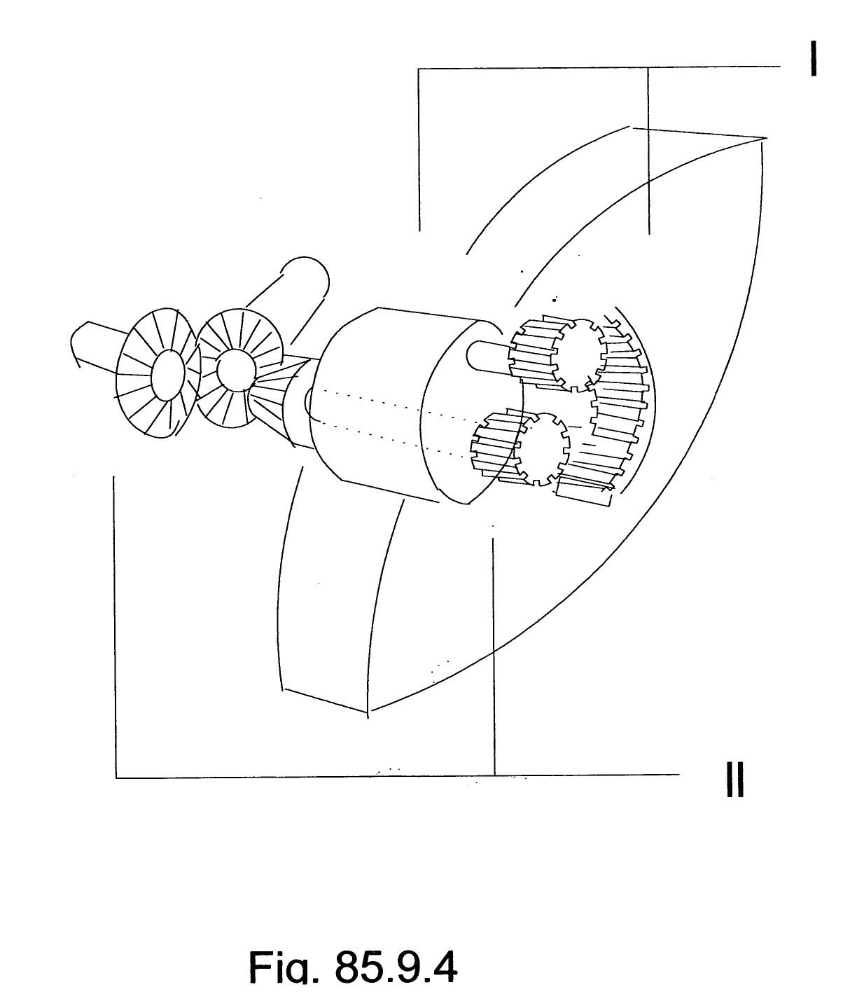

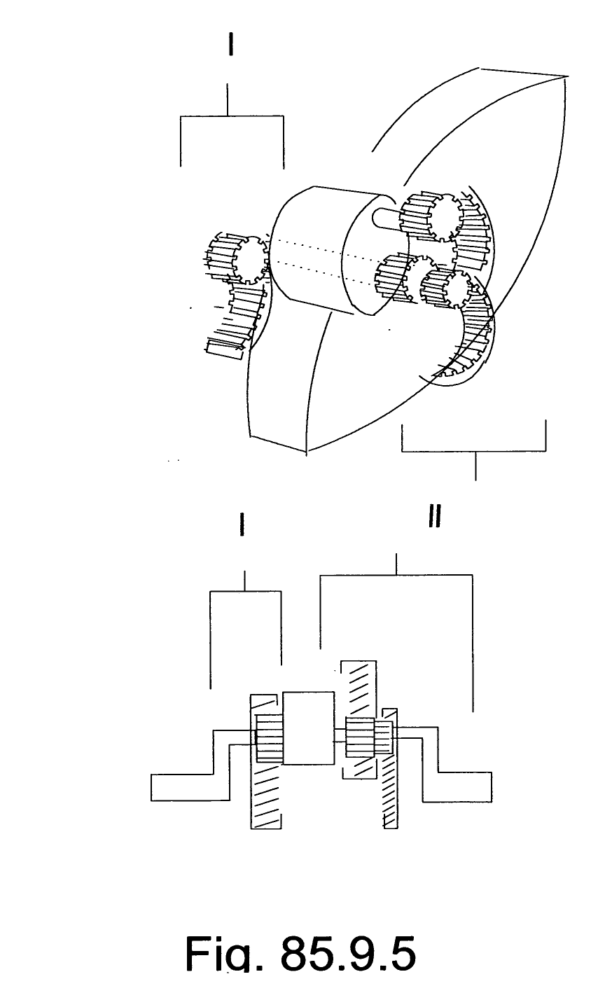

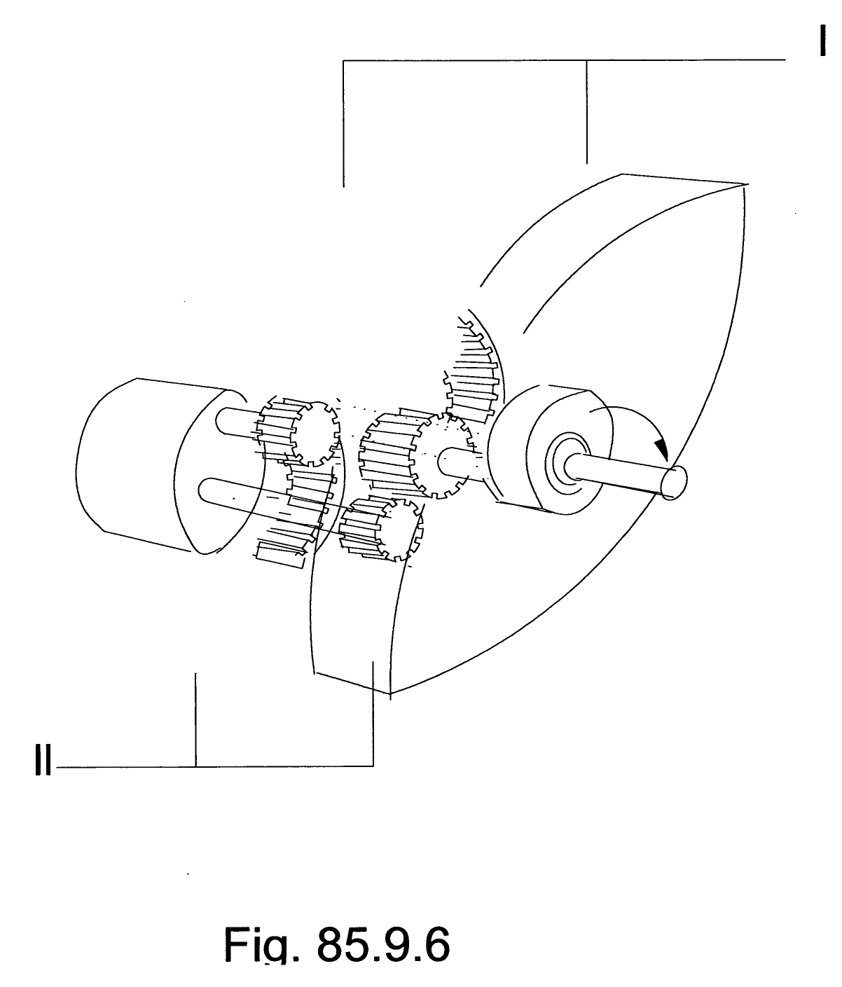

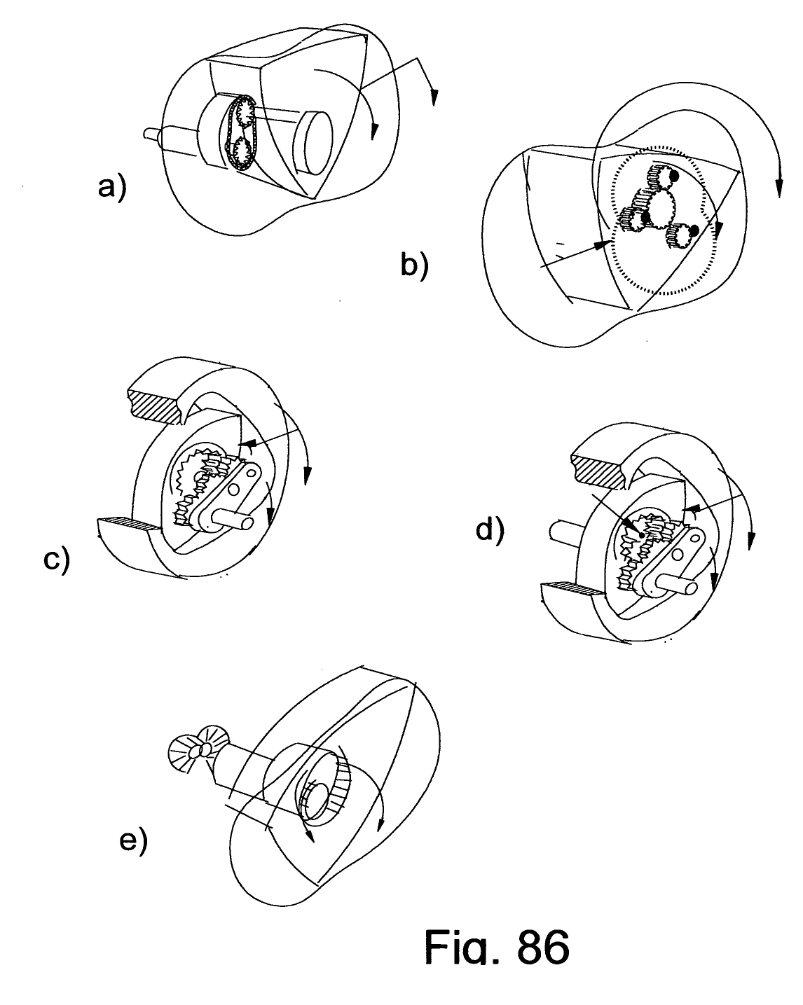

FIG. 44 shows a comprehension of the movement corrections of the paddle and the cylinder form brought by layered or juxtaposed combinations of support methods modifying the paddle course.

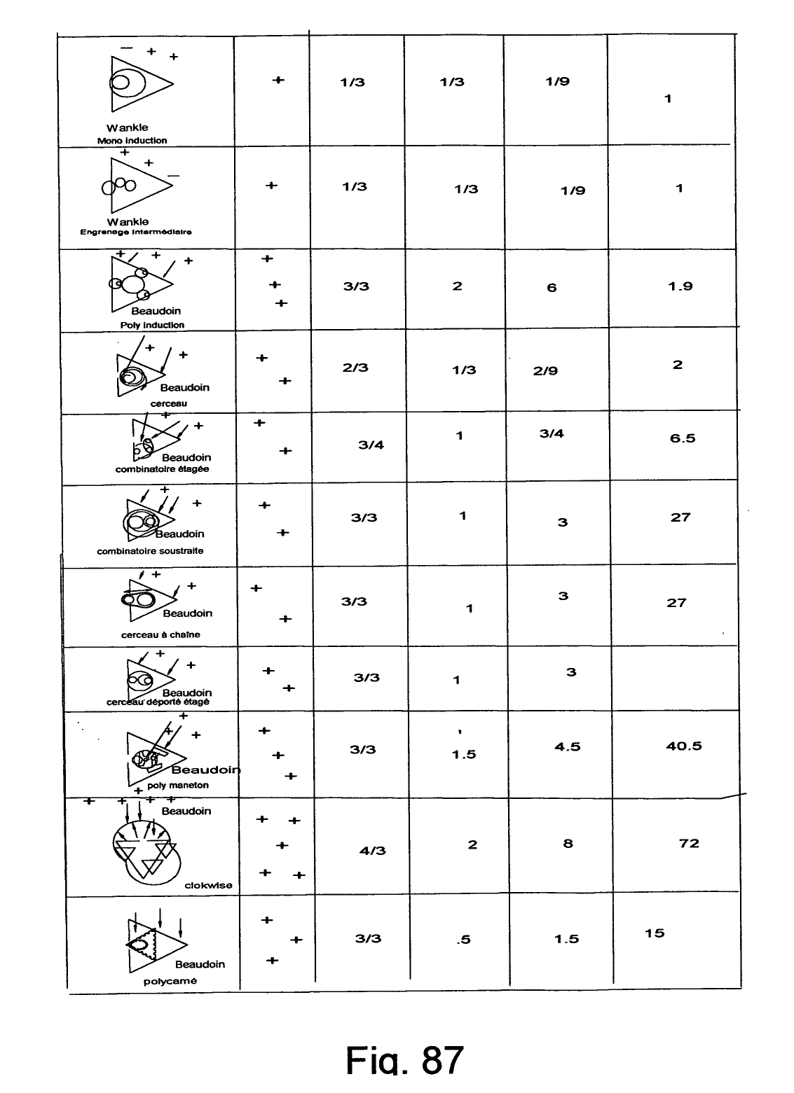

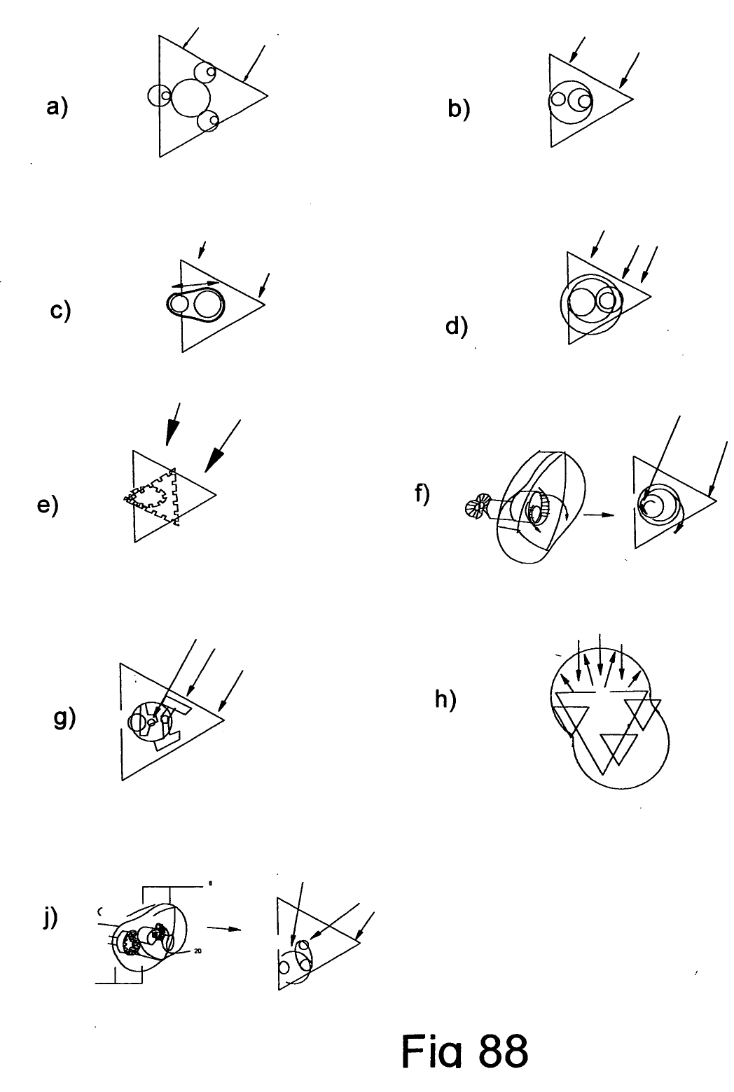

FIG. 45 shows a comprehension of the movement corrections of the paddle and the cylinder form brought by layered or juxtaposed combinations of support methods modifying the course of the crankshaft's eccentric

FIG. 46 schematically shows one of the most mechanical ways to realize changes in the cylinder form, which consists of layering mechanical inductions

FIG. 47 shows another way to understand the necessary corrections. We know that in the triangular engine, we need to increase the compression, whereas in rotary engines, we need to decrease it

FIG. 48.1 and the following figures show the rule according to which we can layer two types of support methods in such a manner to synchronize the position or orientation control of the paddles allowing us to realize the required forms

FIG. 48.2 shows in a) that we can produce the Wankle geometry engine with a less large cylinder with a realization similar to the previous, realizing however the elliptical course of the central eccentric

FIG. 48.3 shows two other combination possibilities. Here we have produced a Wankle geometry machine, but this time with an improved cylinder curve, resorting to, on the positional level, the method said by hoop gear a1), and on the orientation level, the method by mono induction a2).

In FIG. 48.3b), the two combined methods are rather, at the first level, in b1) the method by mono induction and in b2), by poly induction

FIG. 48.4 shows that the mechanics can be realized in an inversed manner. We could for example realize, by layered induction, a retro rotary induction.

FIG. 49 shows that, in the case where we intend to realize the machine with internal type induction gears, we could mount the inductive mechanic combinations by juxtaposition, one of them controlling the positional eccentric, and the other, indirectly controlling the paddle induction gear, by means of a third gear named linking gear.

FIG. 50.1 shows the control case of combination paddles, in which the support gear of the layered induction would be set up firmly in the side of the machine. In this case, either the induction gear, or either the support gear would be irregular, which we'll name polycammed gear.

FIG. 50.2 shows the hypothesis where the deformation is rather brought on the paddle gear. 909, whereas the support gear is regular. In fact, the paddle gear, irregular in this case, will remain coupled to the paddle gear, even if the center of it has an elliptical displacement.

FIG. 50.3 shows a transversal coupling of these gear ratios. We see that round gears will remain coupled to the irregular gears, which the courses are also irregular FIG. 51.1 shows the movement corrections of the paddle and the form of the cylinder brought by eccentric and/or polycammed gears

FIG. 51.2 shows opposite gear ratios to those of the previous gear figure, this time applied to a Wankle geometry engine

FIG. 52 and the following give more ample explanations allowing us to understand the incidence and the application possibility of eccentric and polycammed gears. In a), we show that the regular and irregular, eccentric or polycammed gear relation. In b), c), d), we show the ratio of irregular gears between each other, having fixed rotation axes.

FIG. 53 shows the eccentric or polycammed gear relations set up in a planetary manner

FIG. 54 shows the rule of equidistance to the center which produces the planetary gear

FIG. 55 shows the incidence of use of this type of gear used during a mono inductive method, applied to Wankle geometry and boomerang geometry engines.

FIG. 56 shows the application of this type of gear to differential semi turbines, which allows us to cut off interstice or ligature means

FIG. 57 shows the rules of equidistance of the center of planetary gears to the surface of the support gear in a), and in b), the rule of equidistance of the points, the centers, and the induction gears between each other in course of rotation

FIG. 58 shows the possible support and the ease of the paddles in which the course is complex with the aid of such gears

FIG. 59 shows three examples which show that the use of eccentric and polycammed gears can be used in all location in which we could normally use a standard gear. In a) we find a method by semi transmission used in a poly cammed way, in b) we produce a method by polycammed hoop gear, and in c), a method by intermediate polycammed gears

FIG. 60 shows a poly turbine realized by a corrected mono induction by geometric addition in a), then by hoop gear added to geometric rod in c), and then by intermediate gear added to a geometric rod in d). All the other methods of the body would also be adequate with the addition of geometric rod to support the parts of the paddle structure, or even of the paddle structure, used as meta turbine support structure.

FIG. 61 shows that, if we follow the displacement of the piston in a rotor cylinder machine, we'll note that the piston follows with exactitude the same course as the extremities of the placement of the support of the paddle structure of the poly turbines. It emanates from this important statement that not only, this machine can be produced with all the mechanization methods comprised in the current corpus, with a geometric correction, which gives us more than four hundred support methods for this machine, but also that all the methods comprised within the corpus can, with the addition of a geometric rod, allow piston support without the use of free rods.

FIG. 60 shows the bi rotary aspect of the machine, each piston being supported bi mechanically

FIG. 62 shows in a) a piston support by mono induction added with a geometric rod, in b) a hoop gear induction, added with a geometric rod, in c), an intermediate gear added with a geometric rod, these applications showing without a doubt the membership of this type of machine to the general definition.

FIG. 63.1 shows that we can realize the rotor cylinder machine in a mechanico inductive manner

FIG. 63.2 is a three dimensional view of these mechanizations

FIG. 64 shows the meta turbine as a third degree machine, this machine needing to be realized by three layered mono inductions, or even a mono induction corrected twice In c), we see that the two corrections carried out simultaneously realize a machine with a superior complexity level, being of third level, producing irregular cylinders; these are poly turbines

FIG. 65 shows that we can offset in an intentional manner the natural courses of machines, for example an elliptical course rectilinear rod machine, to then re-correct by some means such runners and free rods or preferably polycammed gears.

FIG. 66 shows that if we intend on governing the piston of a machine as much from the positional aspect as the orientation aspect, we must use fourth degree mechanics.

FIG. 67 shows that all machine which can be made in a standard manner, can also have its compressive parts centralized and it's mechanics in periphery.

FIG. 68 shows examples of rectilinear central piston machines, known as Slinky engines.

FIG. 69.1 shows standard or differential peripheral piston machines

FIG. 69.2 shows that the number of cylinder and pistons is variable, as well as the number of alternative movements for each turn, which could thus result in a rather squareish, octagonal, etc course

FIG. 70 shows that we can generalize the use of polycammed gears for example to differential semi turbines, which allows to change the initial ligature method of the paddle to the eccentric which was initially, by runner.

FIG. 71 shows a cut of a differential anti turbine

FIG. 72 shows a differential poly turbine

FIG. 73 shows a rotor cylinder poly turbine

FIG. 74 shows a desynchronized piston-piston combination machine

FIG. 75 shows a combination of post and retro rotary auto pumped piston machines

FIG. 76 shows the meta turbine generation of machines

FIG. 77.1 shows a balloon cylinder machine

FIG. 77.2 shows that we can also combine rotor piston machines and semi turbines

FIG. 78.1 shows a classification of machines according to their degrees

FIG. 78.2 pursues the main forms of the preceding figure

FIG. 79 shows many compression modes, by push in a), by traction in b), and differentially in c)

FIG. 80 shows gears named overlapped gears

FIG. 81 shows that we can indirectly, yet rigidly, couple compressive parts of motor machines, and produce between them a circular isolation plaque of these parts which could also serve as a valve

FIG. 82 shows that we can decompose and divide the partition of the movement

FIG. 83 shows during the observations of the previous figure, that we can even combine post and retro rotary machines in such a manner so that one is the pump of the other, which will be motorized

FIG. 84 shows that the paddles could also be drawn in such a manner to realize hydraulic machines

FIG. 85 are all reproductions of our patent application, in priority here, which give other realization possibilities of machines by combination methods

FIG. 85.1 shows a mono inductive retro rotary combination of first degree and a level two method by layered poly induction

FIG. 85.2 shows a method by mono induction of first level and by paddle hoop gear for second level

FIG. 85.3 shows a retro rotary mono induction of first level and retro rotary as well for level two

FIG. 85.4 shows a method by post rotary mono induction of first level and retro rotary of second level

FIG. 85.5 shows a method by hoop gear for the first level and post rotary for the second level

FIG. 85.6 shows a method by hoop gear at the first level and by paddle hoop gear on the second level

FIG. 85.7 shows a mono induction added with a geometric rod at the first level and a polycammed gear induction in two.

FIG. 85.8 shows two inductions by hoop gear

FIG. 85.9 shows a post rotary mono induction for levels one and two

FIG. 85.9.1 shows two layered inductions in which the non polycammed support gear is for each of them in the side of the machine. We'll say that they are layered in juxtaposition. To do this, we use an internal paddle gear and we use linking gears to couple it to the support gear.

FIG. 85.9.2 shows a first level mechanic of the poly inductive type and the second of mono inductive type

FIG. 85.9.3 shows two layered poly inductive mechanics

FIG. 85.9.4 shows a semi transmission mechanic combined to a paddle hoop gear mechanic

FIG. 85.9.5 shows two layered juxtaposed retro rotary mechanics

FIG. 85.9.6 shows two layered juxtaposed retro rotary mechanics

FIG. 85.9.7 shows two layered juxtaposed retro rotary mechanics Here, the support gear is fixed solidly on the eccentric in a centered manner which creates the same geometry as if, as in the other versions, it had been centered by crankpin

FIG. 86 shows the accelerative mechanics variations

### DETAILED DESCRIPTION FIGURES

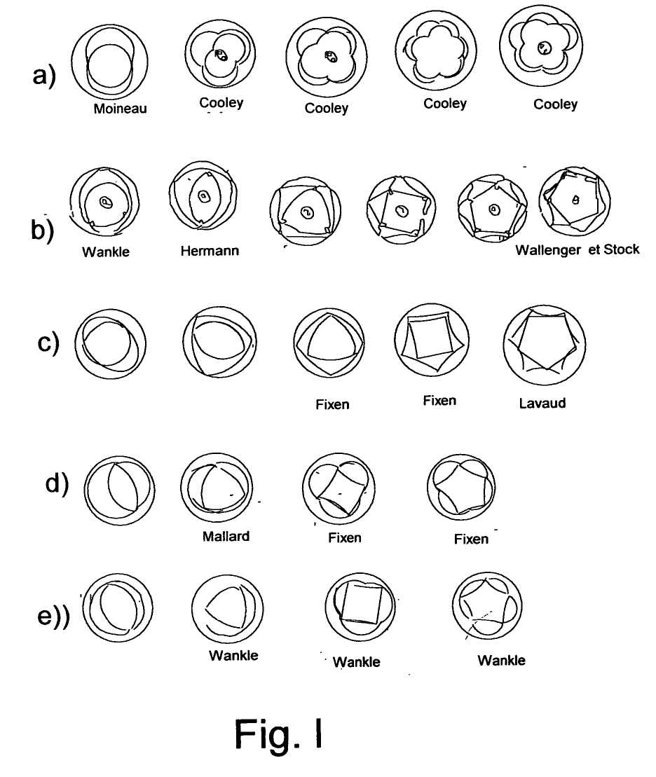

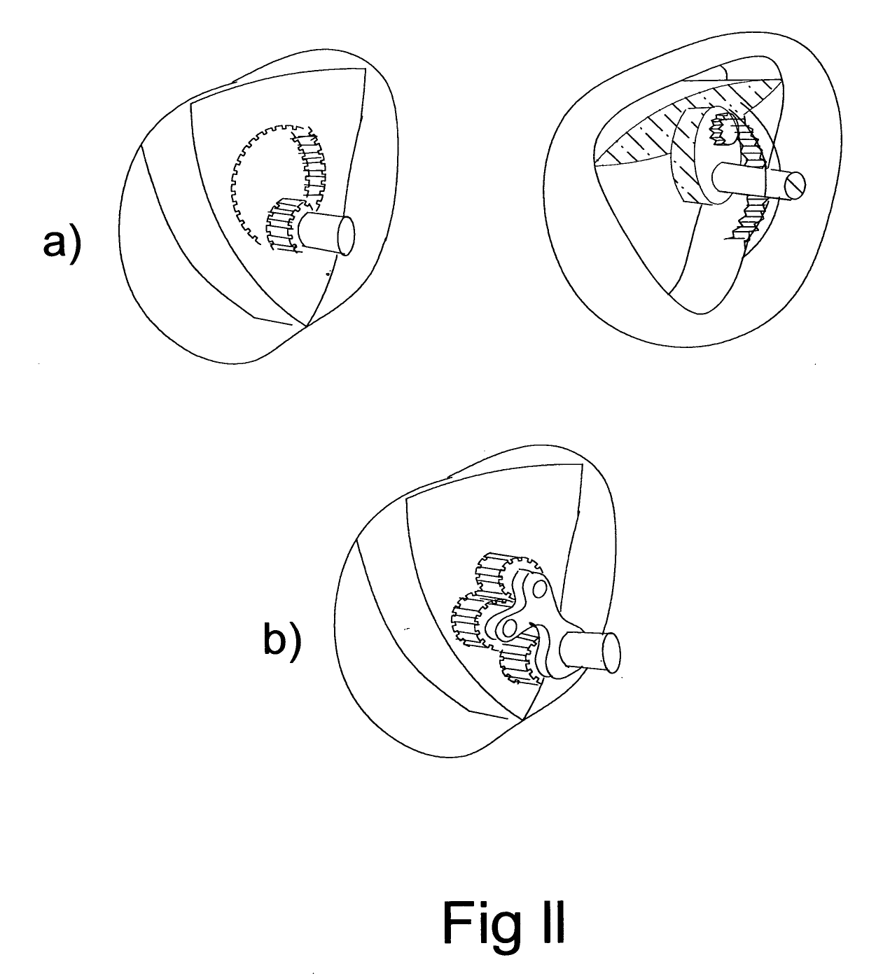

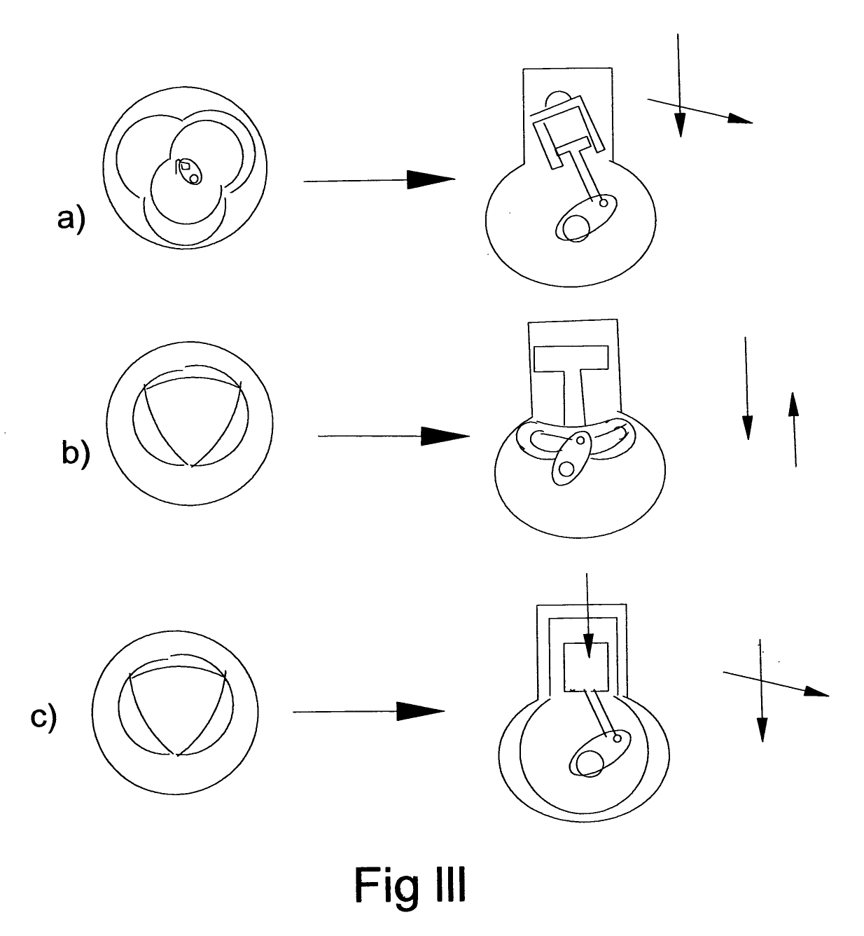

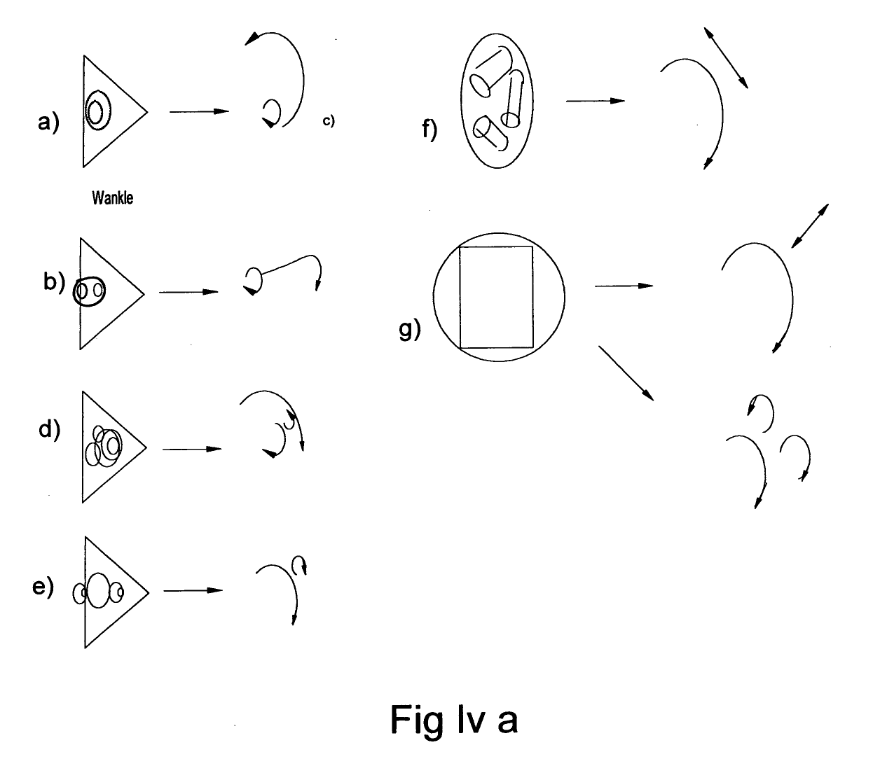

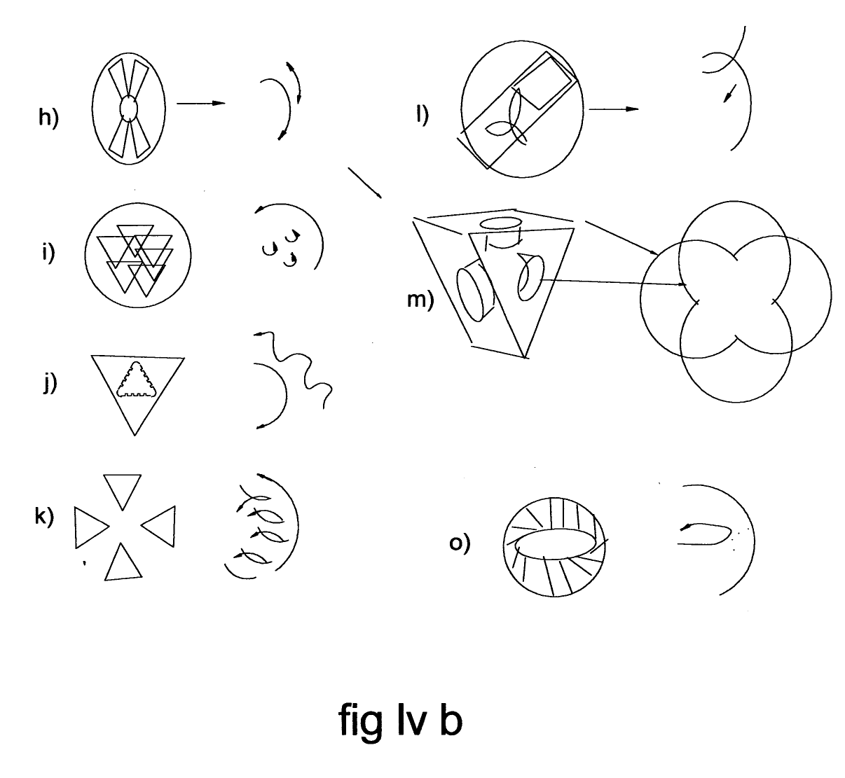

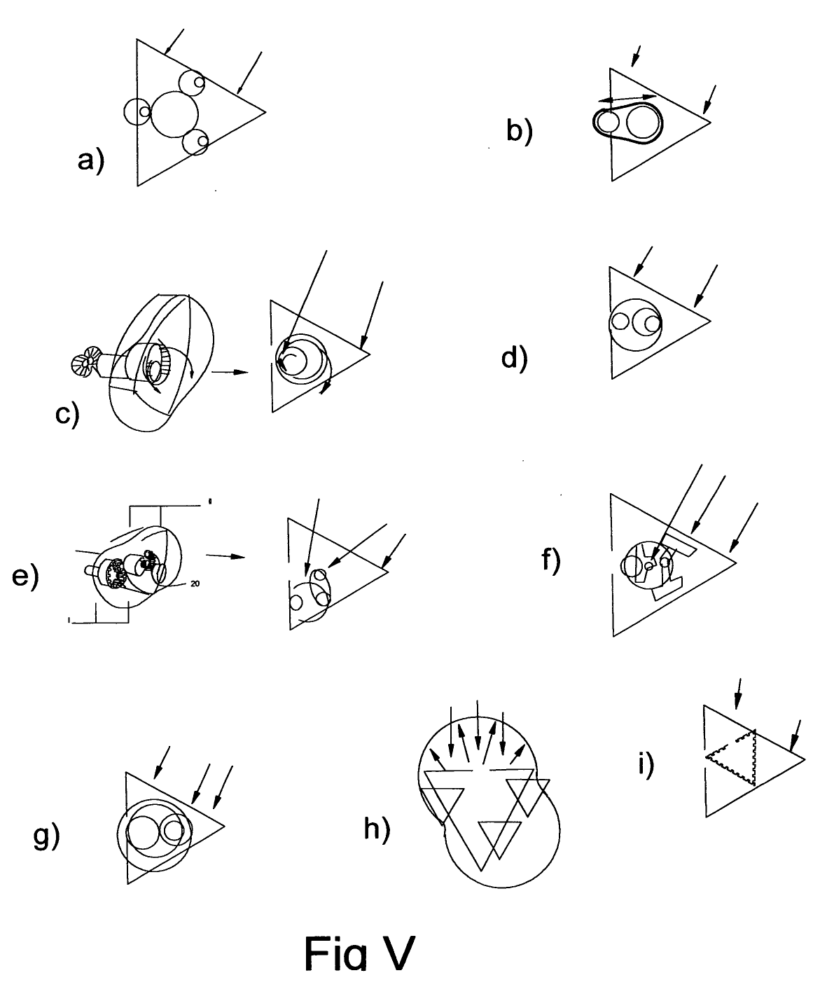

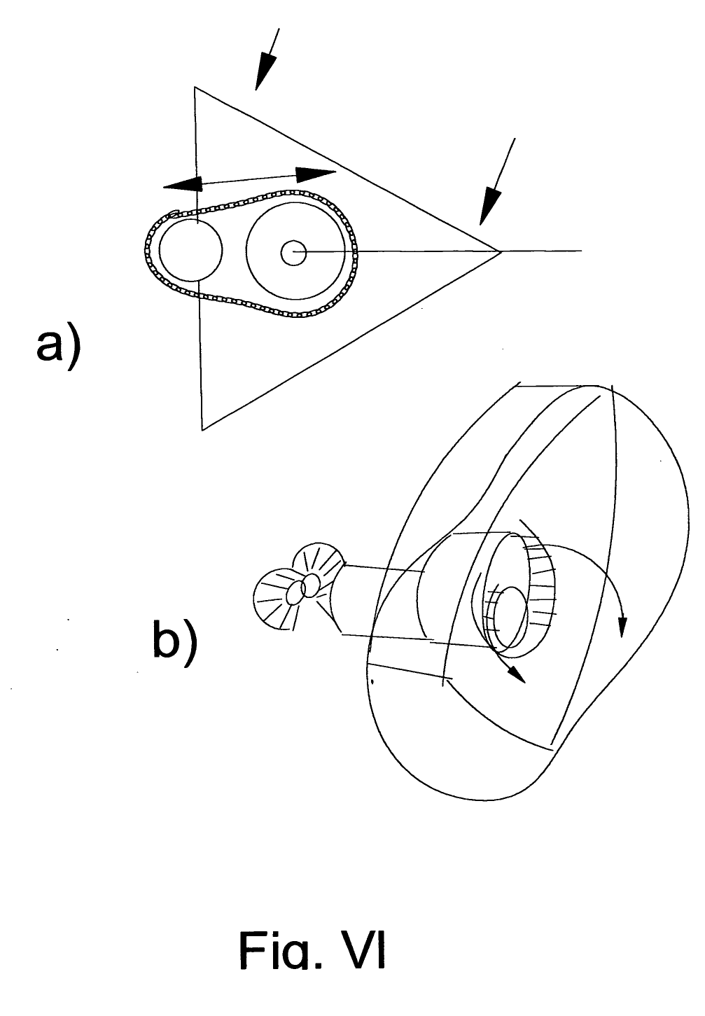

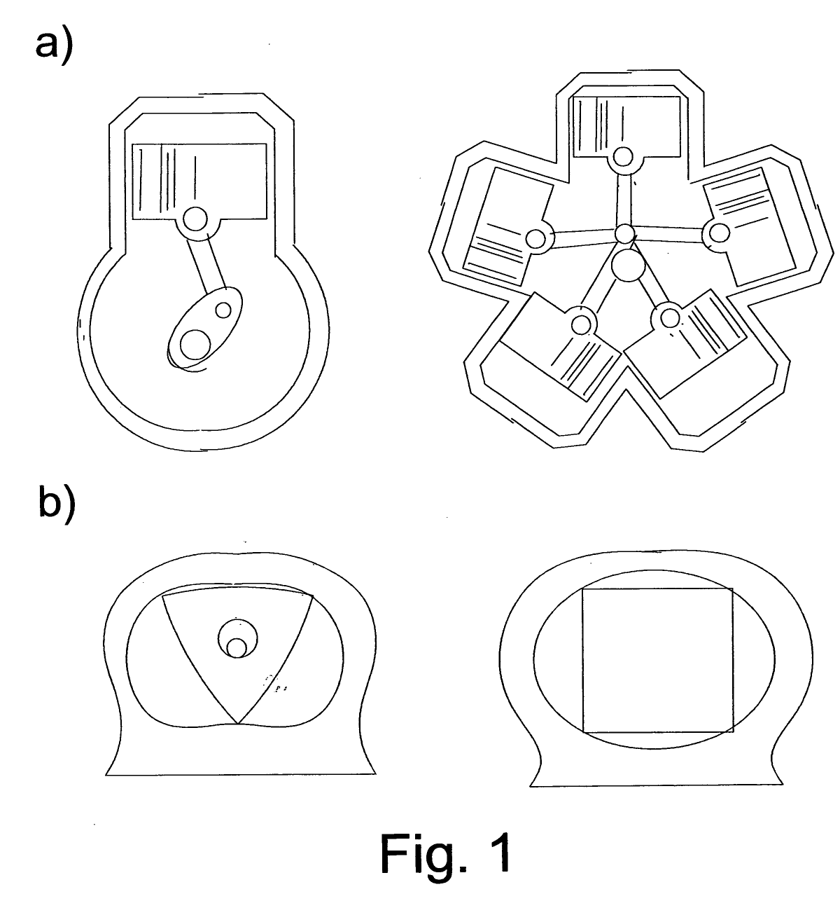

FIG. 1 shows, in a recapitulative goal, the main types of known engines of the previous art, being standard piston engines, orbital piston engines, paddle engines, Wankle geometry engines, and the Wilson geometry of the paddle structure. In a), we show a standard piston machine. In this machine, the rectilinear, alternative movement of the compressive part, being the piston 1, is synchronized to the movement of the crankshaft 2 by use of a rod 3

In FIG. 1b), we have an orbital type set up. This set up has frequently been used, for example, in aviation. Here, the movement and synchronization of the pieces is identical to the standard setup. However, the geometry of the location of these cylinder-pistons compressive parts in relation to the crankshaft is specific: they are set up on different axes 4, which makes possible the realization of the crankshaft with a single crankpin 5, fueling each set of piston rods.

Figures c) and d) show principally post and retro rotary paddle machines, supported in a mono inductive manner. The post rotary machine, specifically a triangular paddle machine, is generally called Wankle engine, named after the inventor. The triangular retro rotary machine, also known as Boomerang, has its geometric form disclosed in our previous patent poly inductive energetic machine

In these types of machines, the rod is subtracted, and this has for result that the compressive part, realized as a paddle, the orientation aspect must be controlled as well as the position aspect. In fact, the positioning of the paddle is assured by an eccentric, set up in a rotary manner inside the machine, whereas it's orientation is assured by a post rotary mono inductive mechanic, in other words, leading the paddle in the same direction of the crankshaft.

In 1d), we find paddle structure machines, which the first realization of this type of compressive part was produced by Wilson (1978). In fact, the pistonnated part is realized by paddles assembled as a flexible quadrilateral. The paddle's alternative form modification from square to lozenge allows the paddles to follow the quasi-elliptical shape of the cylinder.

It is important to mention here the original movement aspect of each paddle of this paddle structure, which is both rotary and oscillatory

We have already mentioned that Wilson did not realize the true nature of this type of machine and for this reason did not fulfill the correct and viable support structure of the paddle structure. We have to this day realized this work and proposed many pertinent support methods for these paddle structures. For more ample details, our patents treating of this matter are consultable.

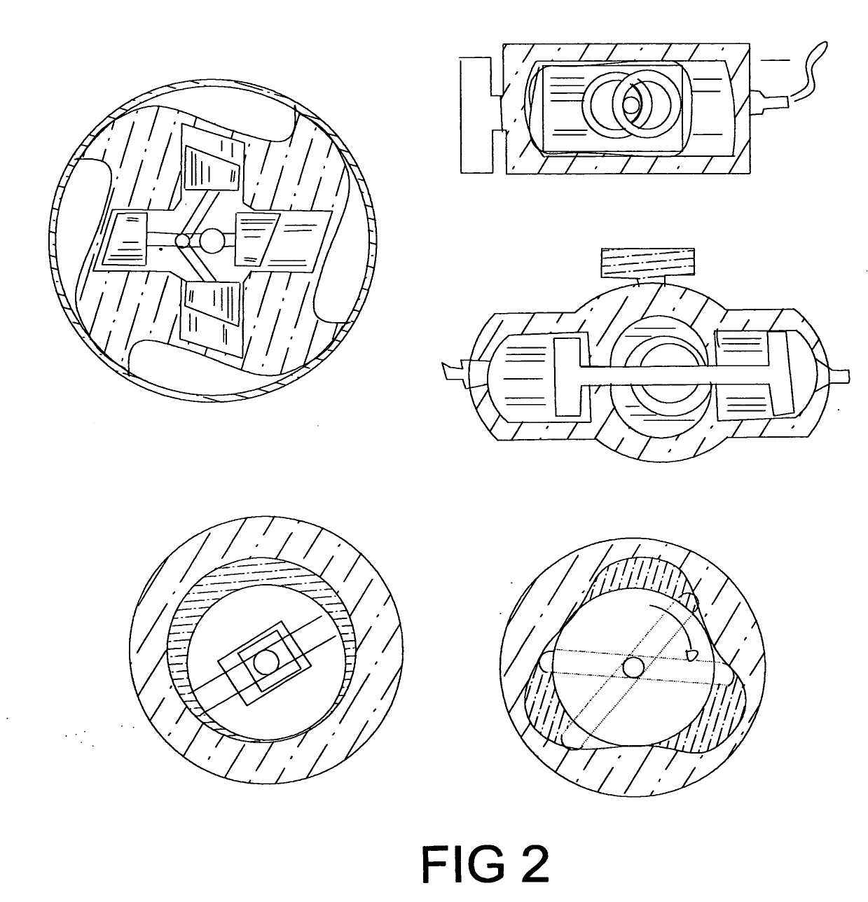

FIG. 2 shows a recapitulation of a few of the inventor's engines of the previous art, being the rotor cylinder engine, the triangular running paddle engines, and the differential semi turbine. This figure shows a different version of piston engines which we have named rotor cylinder machines this machine being covered by our Canadian patent on this matter. In this machine, the two rotor and rod support axes are located differently, one of them, the rotor cylinder's 11 axe being centered, and the second one 12 being eccentric. Consequentially, differentiations between the cylindrical parts 13 and the pistonnated parts 14 are not due to the alternative rectiliniear movement of the piston, but rather due to the double differential circular movements of the cylindrical 15 and pistonnated 16 parts.

In b) we find a rectilinear mechanization motor. In these machines, the rectilinear movement of the piston is obtained by the assembly of an eccentric 17 on a master-crankshaft's crankpin 16. The eccentric is provided with an induction gear 18, coupled to an internal type support gear 19, this gear being rigidly fixed in the side of the machine.

FIG. 2c shows that we can also produce the machine in a rotary manner with central pistons 14b or even with the aid of running paddles 19.

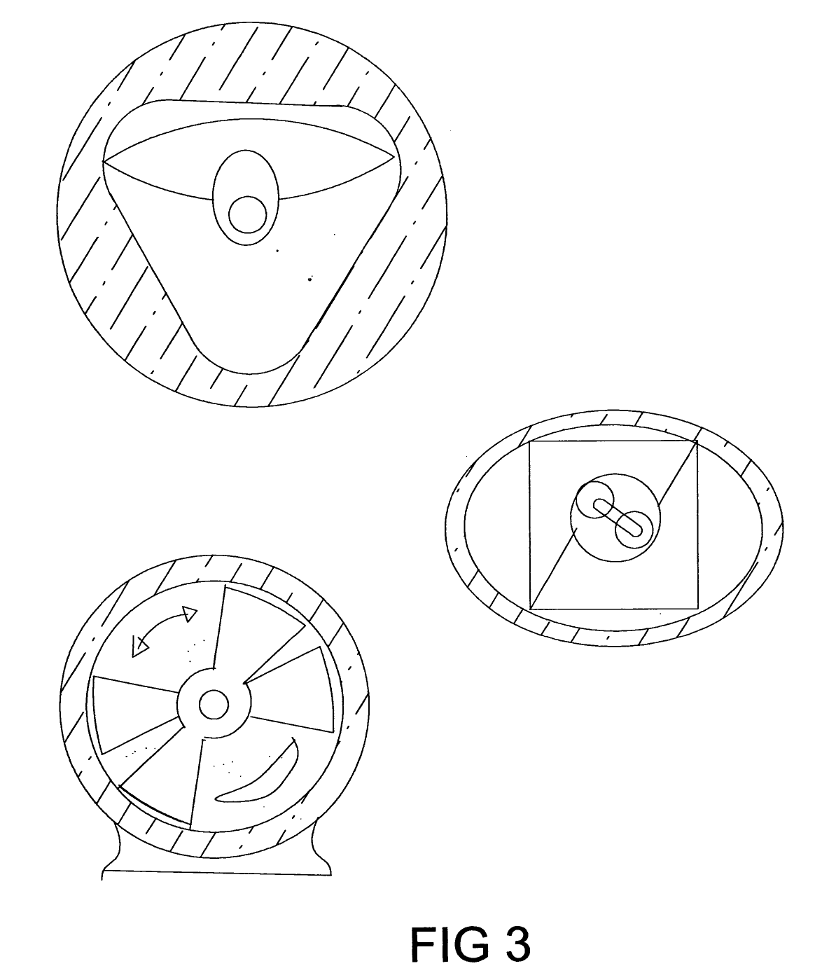

FIG. 3 shows, also from the same inventor, triangular retro rotary engines, defined as Boomerang, as well as the bi rotary and retro rotary mechanic aspect of the poly turbines. We can see in a, a first retro rotary type of machine, defining itself by a two sided paddle 21 motivated in a rotary manner in a three sided cylinder 22; this is why we named it the triangular Boomerang engine.

Figure b makes evident, by its retro rotary mechanic corrected in a post rotary manner by the action of the geometric rod 24, the bi rotary aspect of the poly turbine

Figure c shows that the differences can be considered between two circular movements of the same center 25, in the measures where the crankshaft's movement is regular 26, and that of the accelero-decelerative paddles 27, which shows that all motor machine answers to the general definition which we have made in our disclosure.

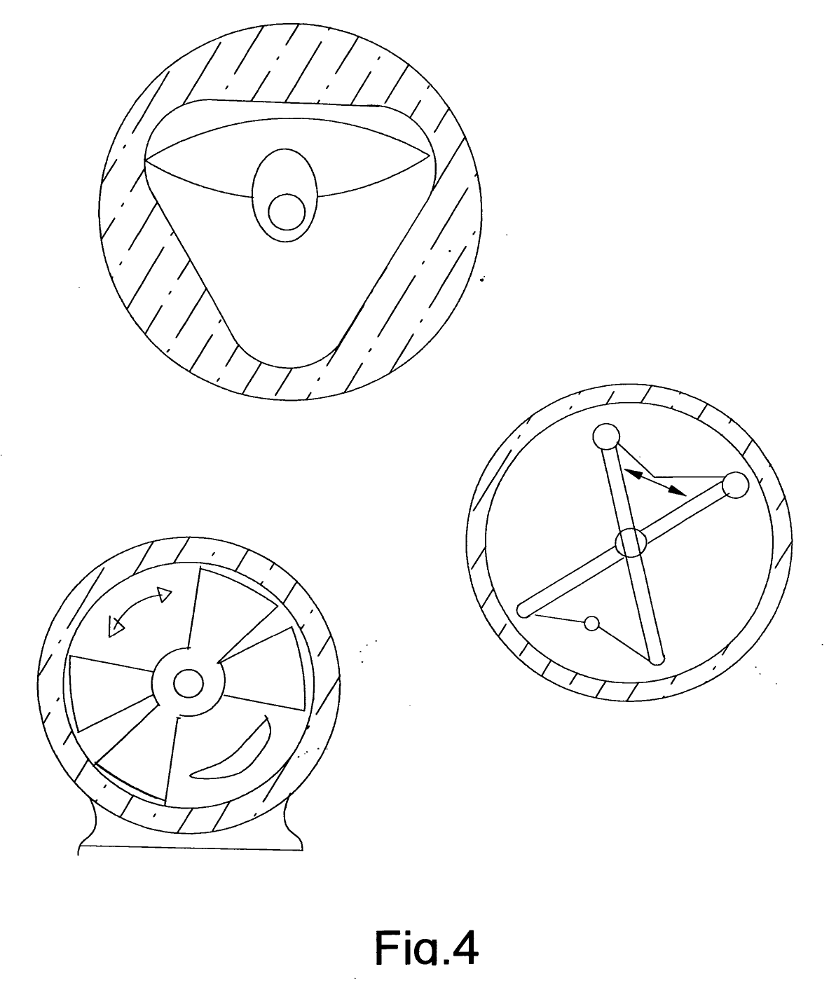

FIG. 4 shows in addition to rectilinear rod machines, the various types of machines which will be affected by the diverse machine figures presented. We'll find in a), post rotary machines, in b) retro rotary machines, in c) paddle structure poly turbines, in d), differential semi turbines, in e) rotor cylinder machines, in f) peripheral piston machines, in g) Slinky machines, in h) hybrid machines, and in i) peripheral rotary machines.

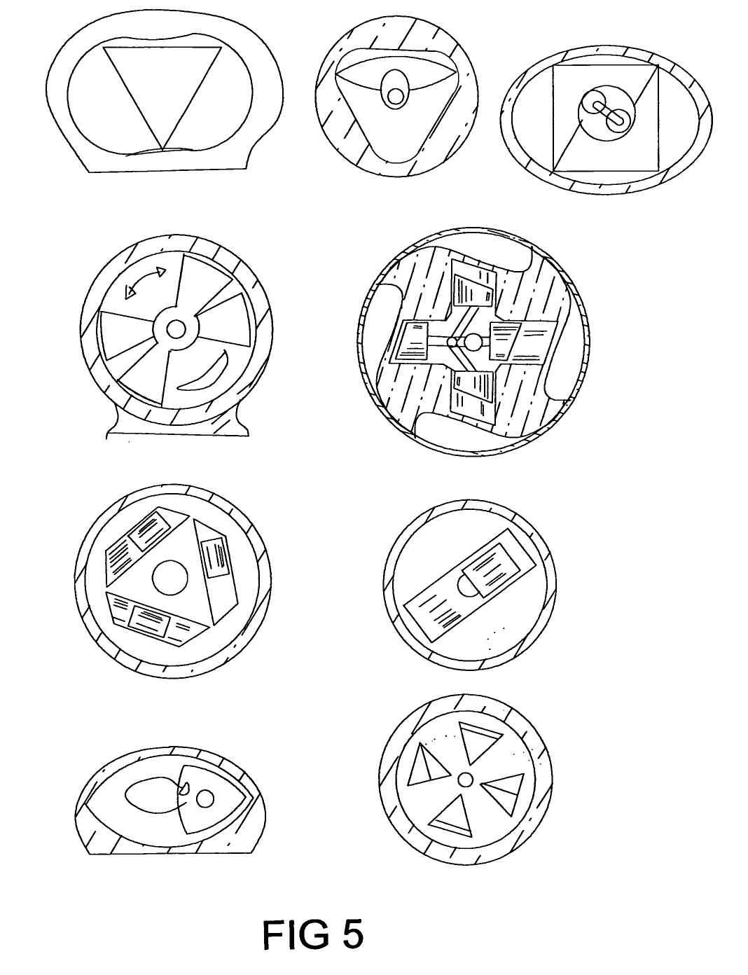

FIG. 5 shows that the fields of the current invention also apply indifferently on the compressive parts either by push in a), by traction in b), in a standard or differential manner in c), and as well they'll be vertical, horizontal or oblique, standard, in peripheral, or by central explosion. In fact, the variants of the previous machines realized by compressive part modification, by combination, by geometric inversion, by traction, and so forth, which in spite of these modifications could also be supported by the proposed mechanical corpus, and could consequentially belong to the general definition.

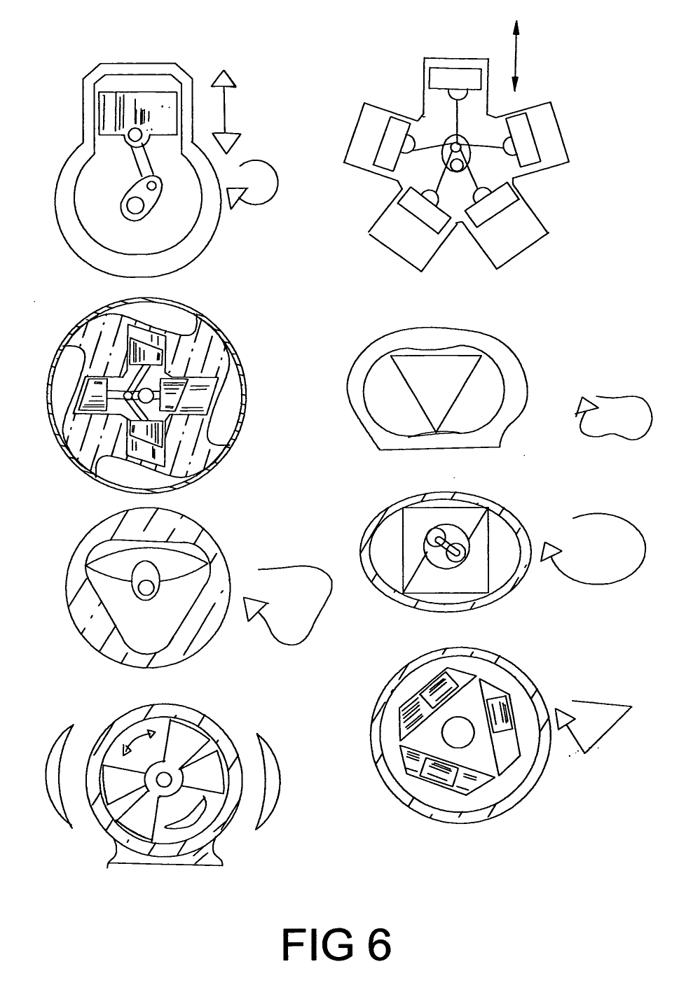

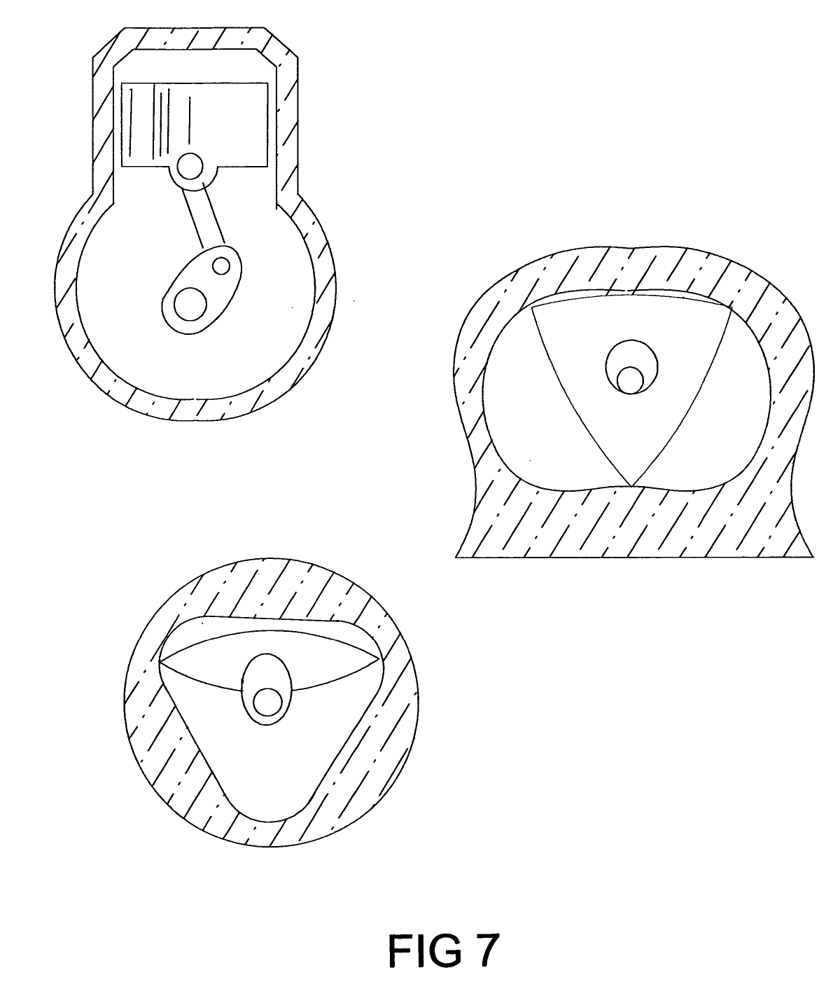

FIG. 6 shows that all geometric realizations answer in many ways to the general definition of the motor machine according to which the movement of the compressive parts is irregular in geometry or in dynamic and differentiates itself from the circular and regular movement of the motor parts. This figure shows schematically that we can in fact define all motor machines as a machine transforming an irregular movement, either geometrically or dynamically, or both at once, into a regular, circular movement.

In fact, whatever the type of machine exposed here, as much from the compressive part point of view as its mechanization methods, this basic rule is verifiable and applicable. We'll see more abundantly in the following pages that diverse complexity degrees can intervene between the regularity of the circular movement of the motorizing part and the irregularity of the movement of the compressive parts.

For the moment, however, the current figure's objective is not to show this previous definition more specifically.

In figure a), we can see that the power is equalized in a conventional piston engine, is given by the dynamic difference which is produced between the realization of an alternative rectilinear movement 41 and by the compressive part, here being a piston 42, and the regular circular movement 43 of the crankshaft's crankpin 44.

In figure b), we have realized the motor machine under its orbital form. The fundamental difference between this type of engine and the standard piston engine is before all geometric, the piston compression organs, cylinders 45 being set up each at a specific angle 44, and connected to a same crankpin 45, whereas in a conventional engine, it is rather the crankpins which are differentiated.

The dynamico-mechanical structure thus remains the same as in standard piston engines, since as before, the alternative rectilinear movement of each piston 46 is transferred into a circular movement.

We find in c) a third version of the pistonnated compressive part engine, said rotor cylinder engine. The particularity of this engine is that the cylinder, which we have named rotor cylinder, has a dynamic function since it is mounted in a rotary manner in the machine. The irregular differential actions of the piston courses 49 and of the cylinder 50, serve as a crankshaft, resulting in engine movement, and realizes the definition given before.

In d) in which is realized a rotary Wankle engine, the movement of the compressive parts realized by the paddle 51 has a form approaching that of an eight, and is transformed into a circular movement 52, realized under the form of an eccentric.

In figure f), the irregular movement of the compressive pat, being the paddle 53, this time in a triangular Boomerang engine, is also transformed in a regular and rotary movement of the crankshaft 54.

Also in f), the alternative-rotary movement of each of the paddles of the paddle structure of the poly turbine is transformed into a circular movement of the crankshaft 56.

We'll note that the movements of the crankshafts of machines mounted in e and f is possible in e, are opposite to that of the compressive parts, paddles, and paddle structures, which makes machines of a retro rotary nature, or of retro rotary stock, bi mechanical depending on the case. Figure h) also represents a motor machine respecting the general definition which we have given to the disclosure. In this machine, the piston is set up horizontally in relation to the center of the machine and their alternative and irregular movements are transformed into a regular circular movement 61.

In g of the same figure, we reproduce our differential semi turbine. The particularity of this machine consists that the paddles, as well as the crankshaft turn in a perfectly circular manner. The motor difference consists in that of the difference between the movement of the paddles and the movement of the crankshaft, which is thus not of a geometric order, but rather dynamic. In fact, whereas the movement of the paddles, although circular, is alternatively accelerative and decelerative, that of the crankshaft is regular 59.

Of course there exists, as we have mentioned, in other motor machine variants, according to which, for example, the action of the compressive parts is by traction, by push, etc, but the previous examples seem sufficient to show that the definition given remains pertinent no matter the machine.

FIG. 7 shows the fundamental differences between piston and paddle machines, according to whether the compressive parts are linked indirectly or directly to the motor parts. This figure shows in fact that the piston machines, in their simplest realizations differentiate themselves from paddle machines in what the compressive parts 70, which the directionality is assured in part by their introduction in the cylinder 71, are linked indirectly by the intermediate of a means, which we'll name ligature means, to the crankshaft of the machine. This ligature is most generally realized as the form of a free rod 72, but there exists many other ligature methods.

Paddle machines are characterized by the fact that the compressive parts are mounted directly on the crankshaft's eccentric 73 or the crankpin 74.

The differences between the movements of the compressive and motor parts are thus deported towards the exterior of the system, affecting directly the course of the compressive parts and consequentially, the form of the cylinder 75. Not only the positional aspect, but also the orientation of the compressive parts themselves, the paddles, must also be controlled. This is realized by many methods already exposed by ourselves, as well as by mono induction, realized in post rotary engines with a figure eight cylinder of the Wankle type 76.

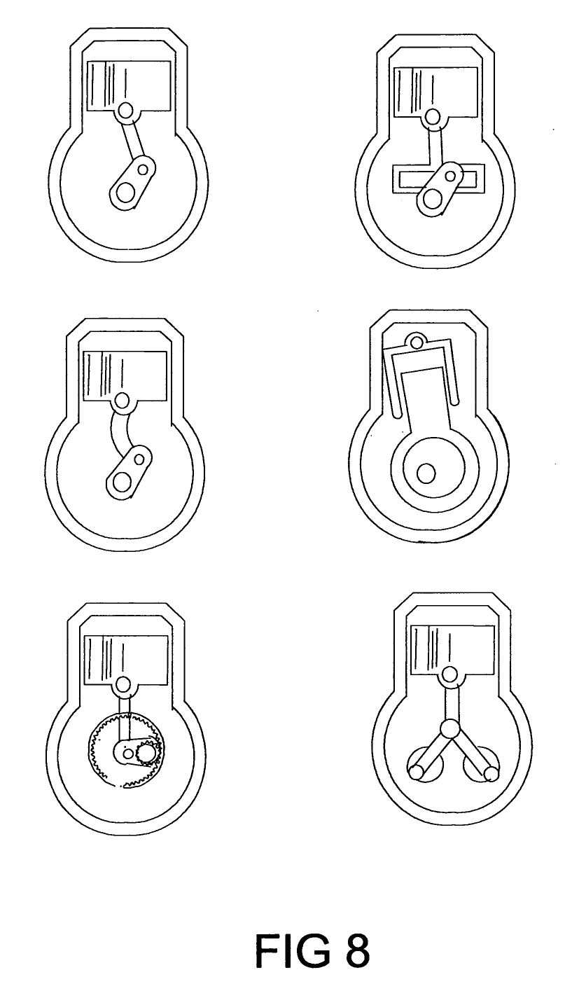

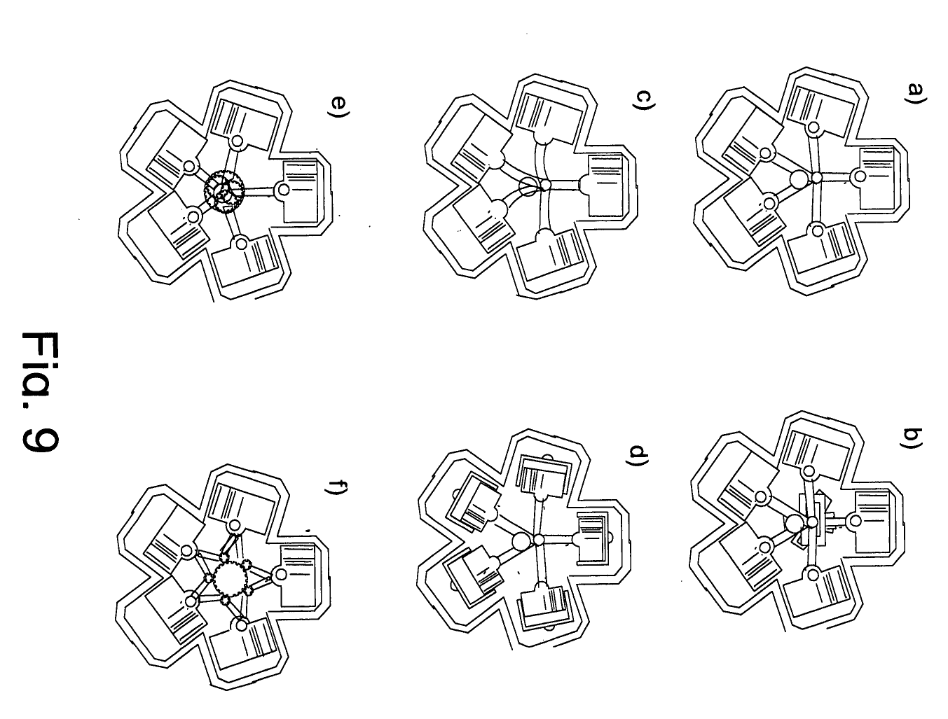

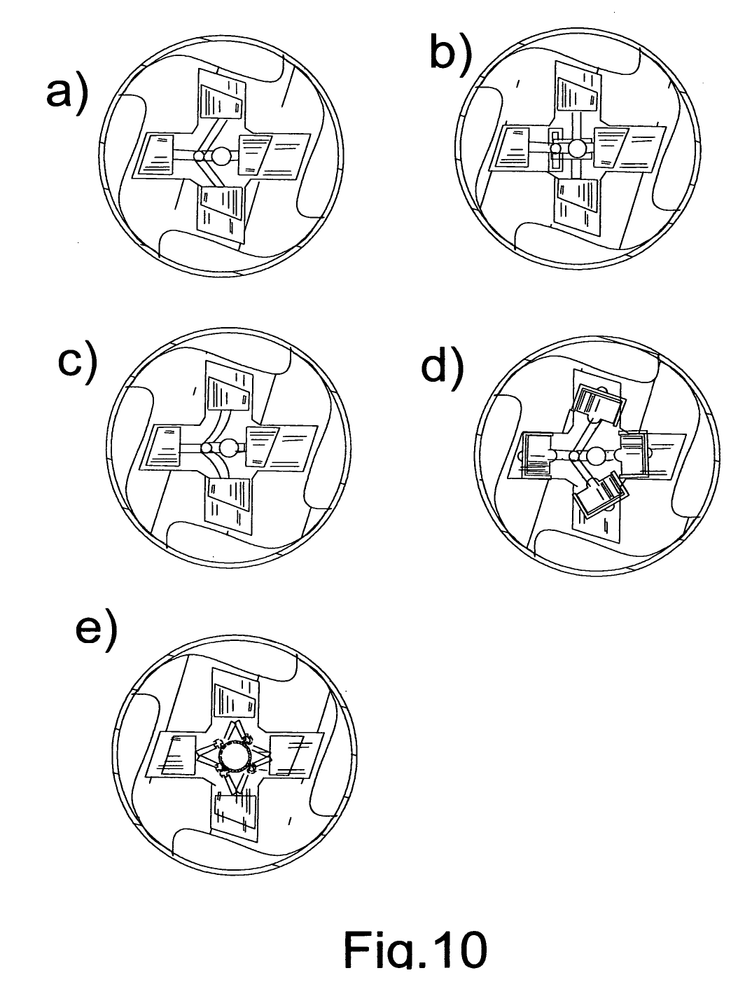

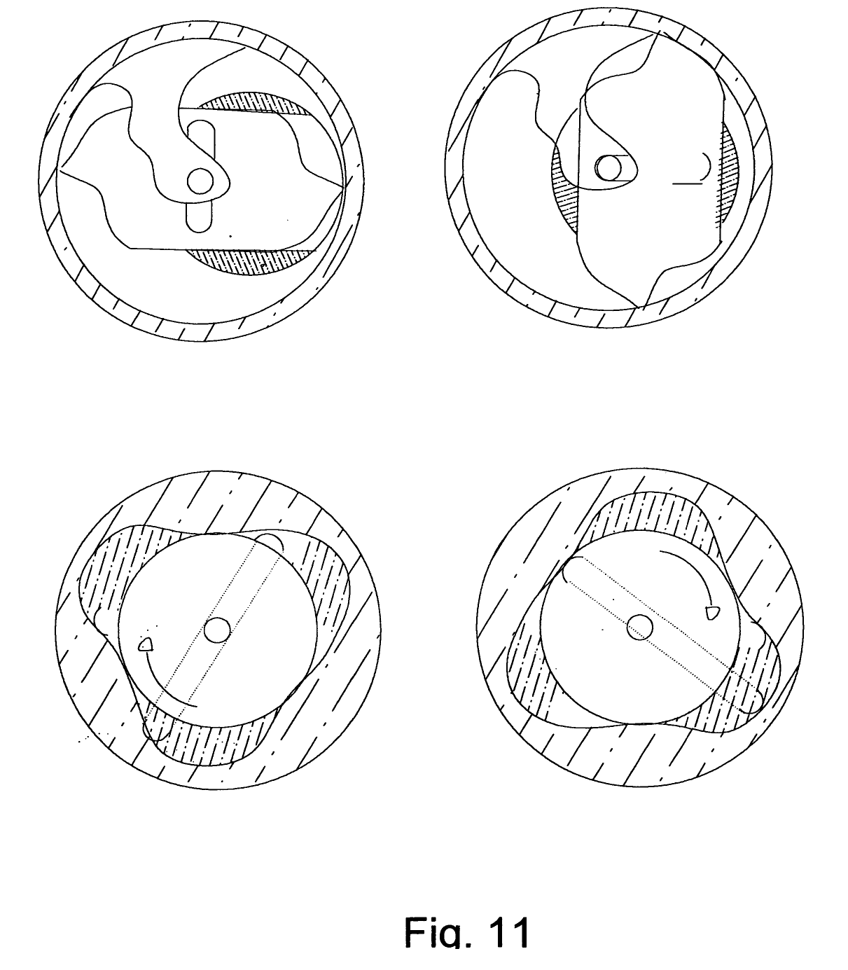

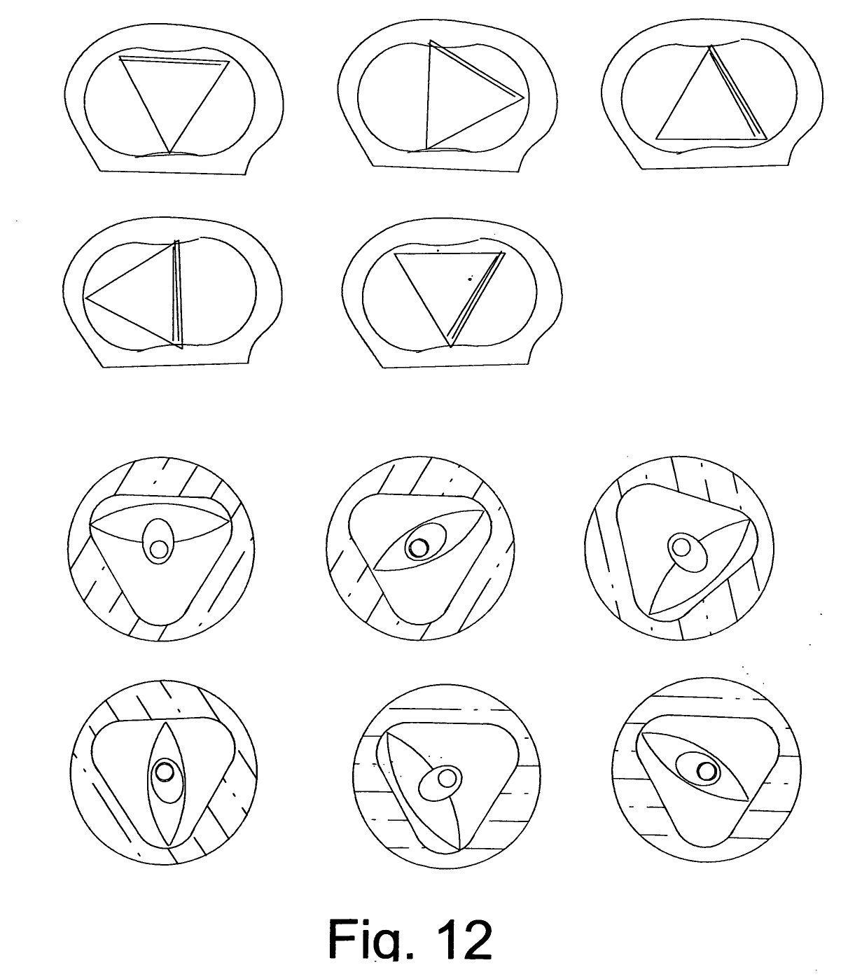

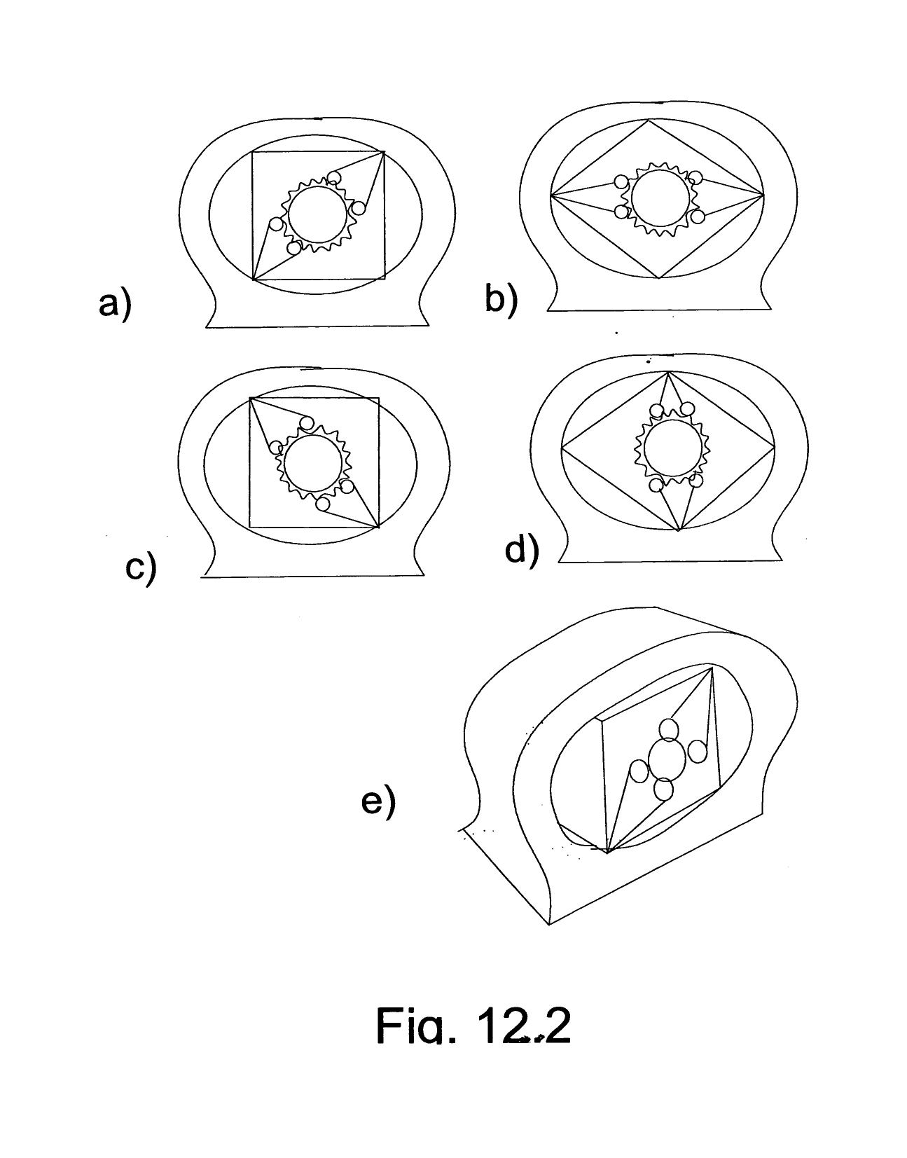

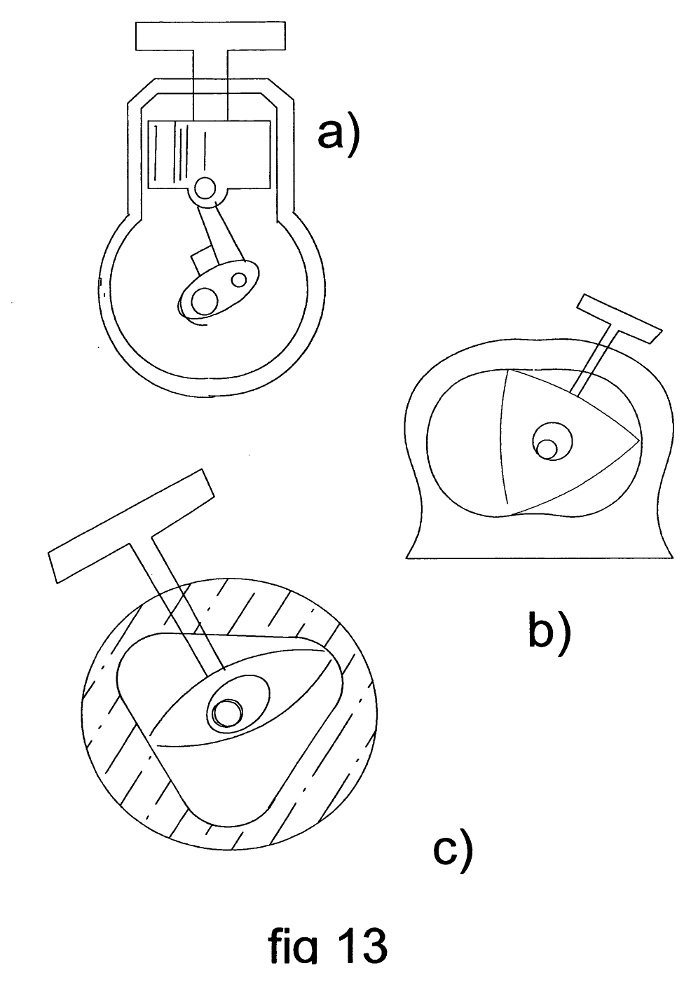

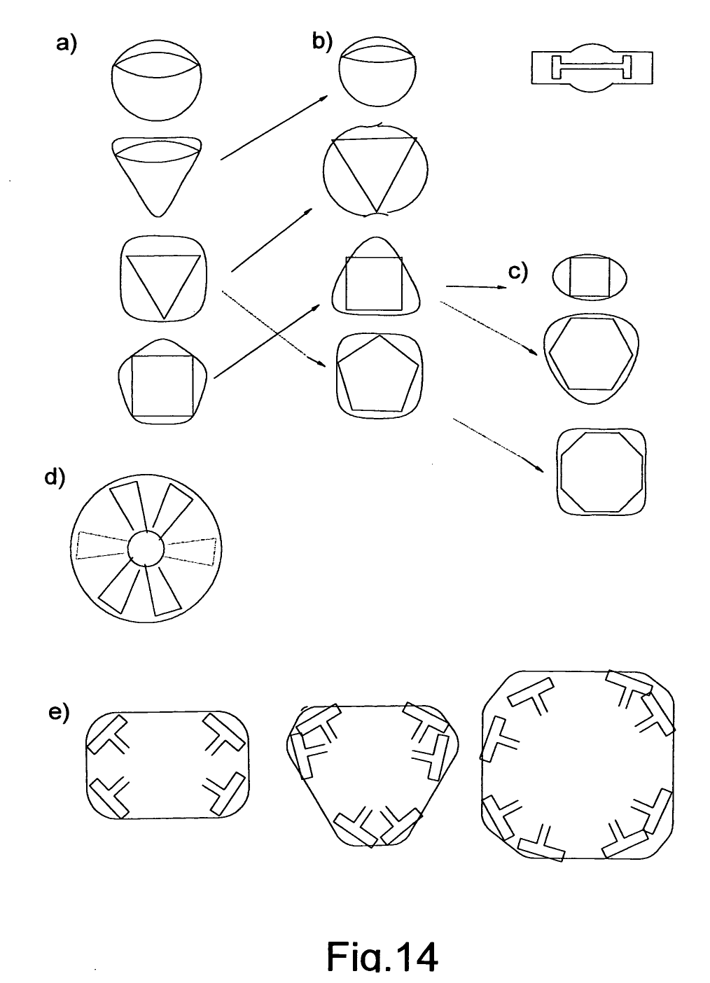

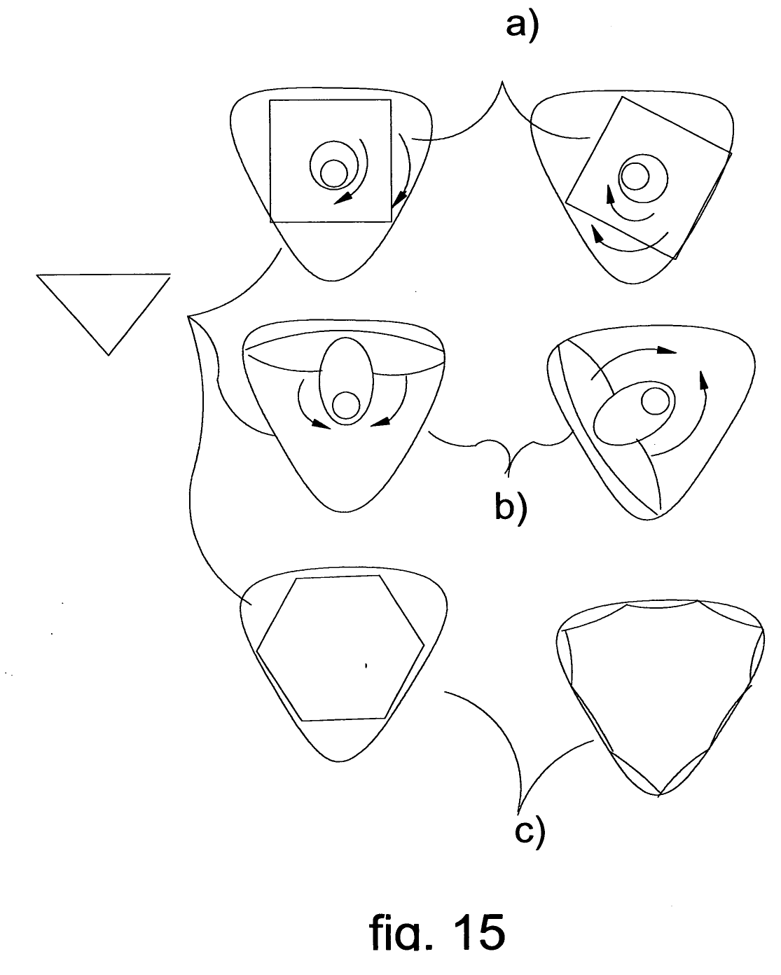

FIG. 8 shows the main types of ligatures uniting the pistonnated compressive parts, to the motor parts.

In a), the most common, we find the free rod 90. Fixed freely from its superior extremity to the piston axe 91, and from its inferior extremity to the crankshaft's crankpin 82, it easily transforms, due to its flexibility, the alternative-rectilinear movement of the piston in an inferior circular movement.

In b), we find the correction by runner. This type of correction is frequently used in other devices, notably in jigsaws. Here, the rod 90 is connected by the top 93 in a fixed manner to the piston. At the base of this rod is set up, also in a fixed manner, a piece provided with a lateral runner 94, in which will be engaged in a running manner the crankshaft's crankpin 95.

The later action of the crankshaft 96 in course of rotation will be absorbed by the runner, and will consequentially be cancelled 97. As for its vertical action, it will be transmitted directly to the piston.

The third ligature method of the pistons and the crankshaft could be said by flexible rod. We'll suppose in this method a rod realized with a flexible material coupled by the top in a rigid manner to the piston 98 and by the bottom in a free manner to the crankshaft's crankpin 99. In this realization the flexibility 100, of the rod will absorb the lateral aspect of the displacement of the crankshaft but will guarantee the transmission of the vertical relation between itself and the piston.

The fourth method of ligature of the pistonnated compressive parts to the motor parts of the crankshaft will be said by oscillating cylinder.

In this method, each cylinder is set up in an oscillating manner 101 in the machine. The rod and even the piston could thus directly be connected to the crankshaft's eccentric 103, the lateral aspect of the movement of the crankshaft's eccentric will thus be absorbed by the oscillatory quality of the cylinder, whereas the vertical aspect will conserve it's incidence on the piston.

Another ligature method of the compressive and motorized parts will be said by mechanical induction. As we'll see more frequently in the following figures, this method can be realized by many ways, which will form the mechanical corpus of the current disclosure, and which we'll present for the moment but the most elementary form for this type of support.

In the current mechanic, we set up in a rotary manner on the crankshaft's crankpin 104 an eccentric 105 which the radius is equal to that of the crankshaft. This eccentric is provided with a rigid induction gear 106, this gear being coupled to an internal gear, twice its size, set up sturdily in the side of the machine, which we'll name support gear 107.

The post rotary action of the crankshaft 108 will lead the retro rotary action of the eccentric and the vertical aspects of each of the movements will be added whereas the lateral aspects will be cancelled. The action of the eccentric will thus be alternative and rectilinear, which allows a control or support of the piston without a mechanico-inductive type rod.

In f), of this previous figure, we can note that we can lead the piston in a perfectly rectilinear manner by the competition of two sets of crankshafts 90a) 90b) mounted in an antirotary manner between themselves.

FIG. 9 shows that a generalization of ligature means exposed in 9 can be produced for all piston machines. Here the example is given from an orbital machine.

For example, here in a) we have a conventionally produced orbital engine. In b), we have realized it with runner rods. In c), the engine is realized with flexible rods. In d), we have produced the machine with oscillating cylinders, and in e), with a basic mechanic from the range of mechanical methods which we'll expose more in detail further in the current description.

FIG. 10 shows that we can also apply these methods to rotor cylinder engines, each piston being controlled by ligature mechanics of the same nature of the previously used methods.

In a), we have the basic rotor cylinder, realizing a single alternative movement of each piston per turn. In b), it is realized with a ligature of the running rod type. In c), it is realized with flexible rods. In d), it is realized with oscillating cylinders.

FIG. 11 shows two basic correction methods of irregular paddle movement of the compressive parts towards the rotary movement of the mechanical parts. The figure shows more precisely that the runner can also be used in the paddle machine.

The first method is by running action of the paddle, set up in a rotor, being installed in a rotary manner inside the machine.

In the two figures, quasi circular and quasi triangular, the paddle 110 is set up, in a running manner 111 in a rotor named the turbine core 1 12, set up in a rotary manner 113 inside of it.

In both these cases, the combined action of the rotor and of the eccentricity of the cylinder used as cam produces the desired movement of the paddle.

As we have already mentioned many times, this type of very elementary mechanization, though proving sufficient in specific applications requiring very little power, such as small pumps, or compressors, would only be used conveniently in heavier motorology, in which more power and pressure on the elements would be realized.

FIG. 12.1 shows in a) b) and c) on a dynamic level, the important distinctions relative to the direction of the paddle movement, in relation to that of its motor parts, for each of these machines, which allows to determine the belonging to the post or retro rotary class. This figure explains in fact the main dynamic reasons which can allow us to classify the basic rotary machines with triangular pistons, of wankle geometry as a post rotary machine. In fact, when we observe the unfolding oh the sequence of the dynamic pieces of the machine for a turn, we can note that the action 121 of the crankshaft 120 is in accelerated post rotary speed in relation to the action 123 of the paddle 124. We must also note that the crankshaft turns in the same direction of the crankshaft which it supports.

In fact, we could note that it is an art very well known in the matter of that paddle turns one third of a rotation for ever complete rotation of the crankshaft.

These statements bring us to specify that the dead time of retro rotary machines, is for this reason, much weaker than the piston machine and that in the post rotary machines, in their most elementary forms, to piston engines and to retro rotary engine, in their most elementary form, that is to say triangular boomerang engines, we notice that at the halfway point of decent of each of these units, the post rotary coupling of the machine is weak, whereas that of the piston engine is mid-strength and that of the triangular engine is much more powerful.

FIG. 12.2 shows in c) that we can support a paddle at each extremity by a structure combining retro and post rotativity. Each part opposed to the paddle 140 is in fact supported by a set of two rods 141, where one is attached to a crankpin set up on a retro rotary planetary gear 142, and the other to a post rotary planetary gear's crankpin 143.

The combined action of these rotations will describe a perfectly bi rotary form, in other words, allowing the oscillation of the paddle.

FIG. 12 in a)b)c)d)e) shows the action for a rotation of the mechanics and compressive parts.

FIG. 13 shows that the actions of the mechanical parts in opposite direction of the paddles, in retro rotary machines, result in a reduction of their high dead time, in relation to piston machines and post rotary machines. As we have already mentioned, in this type of machine, the crankshaft, or the eccentric is caracterised by the fact that its movement is realized in opposite direction of that of the paddle. We can also state that the angle of the couple between the crankshaft and the paddle 145 is much more important in these machines than in piston and post rotary types; a second fundamental difference with the post rotary machine. A second difference, relative to the angle of the piston rod 146, realized here in a figured manner, which is weaker than in the piston engines.

FIG. 14 shows that retro, post and bi rotary Boomerang engines can be generalized in machine classes depending on the side rule. This figure shows as previously disclosed that basic post, retro and bi rotary machines on which we have applied our commentary, are but the most elementary machines in an infinite series which we name x sided post, retro or bi rotary machines.

We 'll note that, as we have previously defined, post rotary machines are defined geometrically as machines in which the number of paddle sides is superior to that of the cylinder in which it is motivated, by one, as shown in a), whereas retro rotary machines are caracterised by a geometry, making evident that the number of paddle sides is inferior by one to that of the cylinder in which it is being motivated, such as demonstrated in b) of the same figure. As for bi rotary machines, such as those exposed in c), the number of sides of the paddle structure is double that of the cylinder. In d) we can see that the number ofpaddles per cylinder, for all machines of differential semi turbine type, is variable up to n paddles. In e) we see, as we'll state abundantly hereafter, that the meta turbines can also be produced by generalizations.

FIG. 15 shows that starting from these generalizations and rules, a cylinder of similar belonging, for example here of three sides, will allow, depending on the paddle form used and the dynamic which is applied to it, the realization of machines totally different and even opposite, such as retro post and bi mechanical machines. Figure a) shows that cylinders of the same number of sides, three for example here, can consequentially allow, depending on the number of paddle sides and the type of mechanics used, allow to produce totally different and opposite machines, such as post, retro and bi rotary. As we can note, when the machine will be realized by a post rotary type construction, we'll use a four sided paddle in a), when we have realized the machine with a retro rotary construction we'll use a two sided paddle, such as in b). Finally for poly turbine machines, the suitable paddle structure will be six sided.

The three following fundamental differences assure more power from bi and retro rotary machines, than from post rotary machines. In fact, the number of explosions per paddle sides in a retro rotary engine is superior since the number of sides of its cylinder is superior by two to that of post rotary machines. In fact, as we have already shown that a three sided paddle, when the machine is set up in a rotary manner, voyages in a four sided cylinder, whereas when the machine is set up post rotarily, the paddle voyages in a two sided universe.

In a retro rotary machine with a triangular paddle, each paddle side produces the four times necessary to the combustion, twice by turn, whereas in a post rotary type of machine, a paddle of the same side number produces but two.

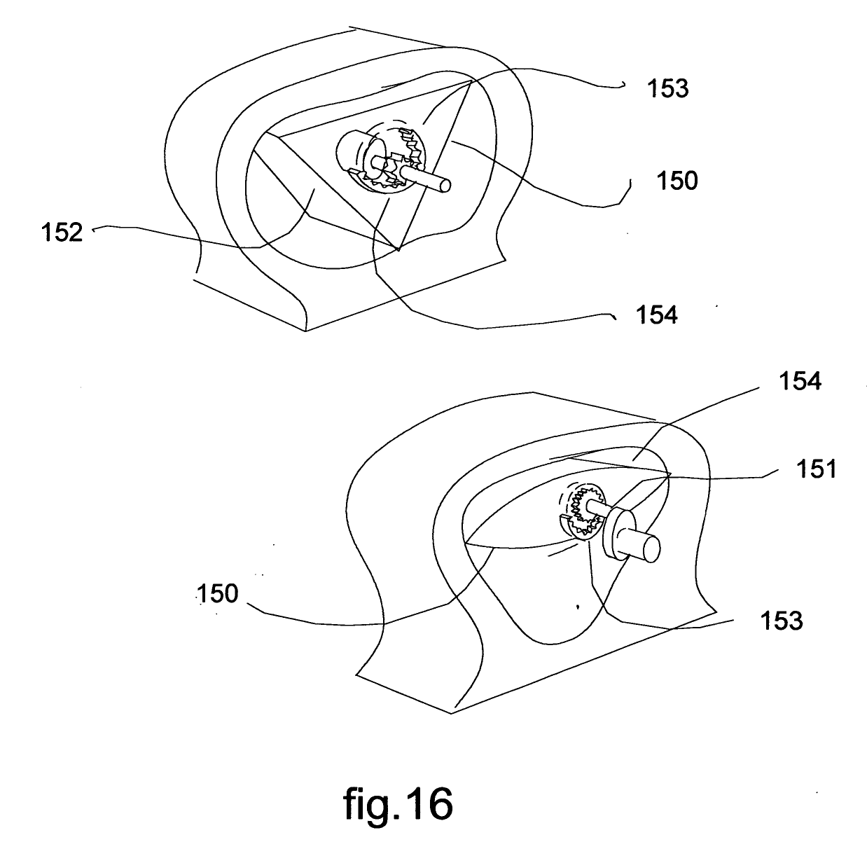

FIG. 16 shows the basic position and direction mechanical paddle control method of simple paddle compressive part machines. We'll say that this method is a method by post rotary mono induction, if it uses an internal type paddle gear and an external type support gear, these parts leading the paddle, at a somewhat reduced speed, in the same direction of that of the crankshaft's eccentric, we'll even say that the mechanics are of retro rotary mono induction type, if the paddle gears are of external type, whereas the support gear is of internal type, which has for result to lead the paddle in the opposite direction of the crankshaft's eccentric.

These two types of mono induction will thus produce in their most simple expression, when realized by post rotary mono induction, post rotary eight shaped cylinder engine of Wankle geometry and, when realized by retro rotary mono induction, triangular Boomerang engines.

This method by mono induction consists of mounting the paddle 150 on a crankpin 151 or eccentric 152 of the crankshaft. We'll mount rigidly to the paddle of a post rotary machine, taking in account the side rule, an internal type gear which we'll name induction gear 153. We'll couple this gear to an external type gear 154, this gear being set up rigidly in the side of the machine. This gear coupling will reduce the speed of the paddle which will consequentially conserve a movement in the same direction of that of the crankshaft.

Retro rotary type machines mounted in a mono inductive manner, will have mounted on the side of their paddle, in this particular case, an external type induction gear 154, and in the side of the machine, an internal type support gear 155.

This type of gear, contrarily to simply reducing the action of the paddle in relation to that of the crankshaft, will lead it in a planetary movement opposite of that of retro rotary machines.

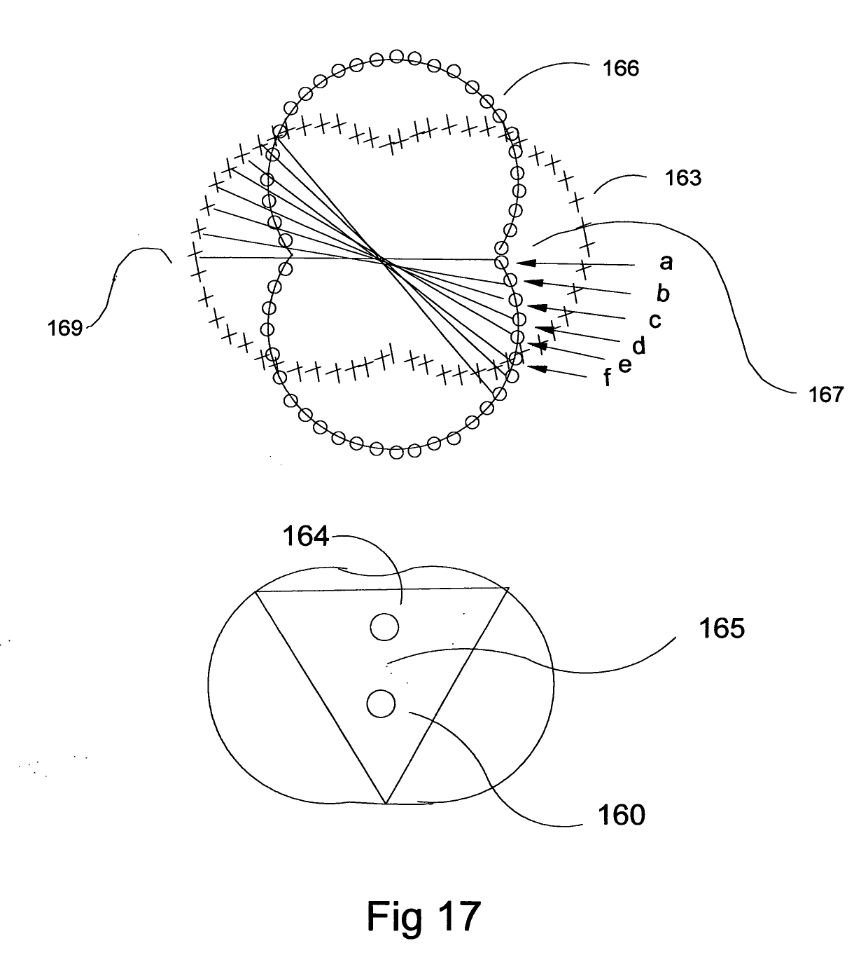

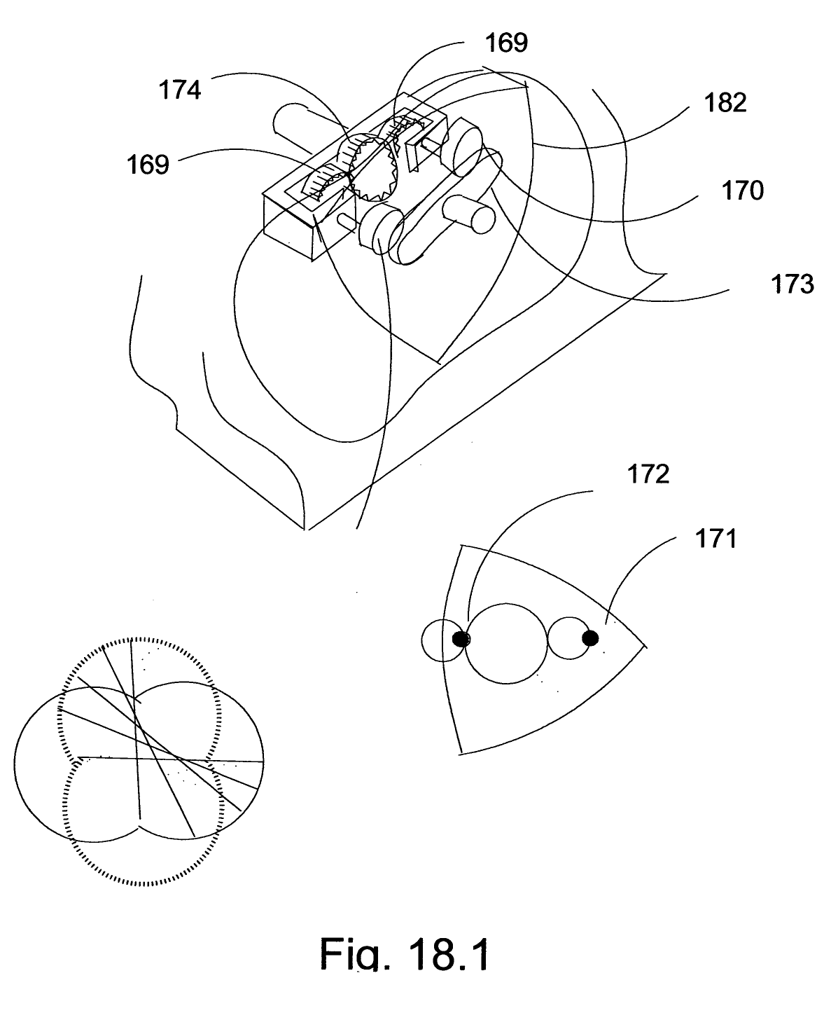

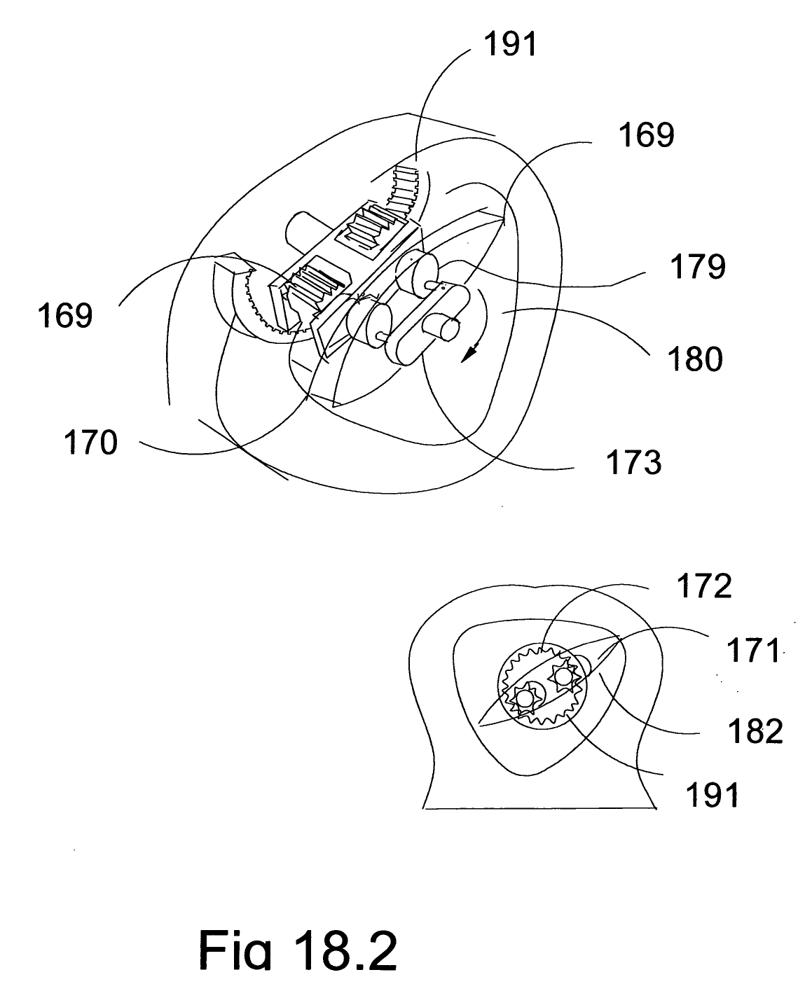

FIG. 17 comments the geometry which has before hand been applied and has allowed to us bring forwards and realize the method by poly induction, applied to post and retro rotary machines. To realize the support method of compressive parts of poly inductive paddles machines, we must first attentively observe the displacement of certain specific points located on the paddle, when mounted by mono induction. Thus if we observe a point 180 located on a line uniting the center of the paddle and one of its points 161, we realize that the course of this point is comparable to that of a horizontally realized eight 163, described by the o's. In another manner, if in opposite manner, we observe the course of a point 164 this time located on the line uniting the middle with one of the sides to the center of the paddle 165, we'll observe that this point describes a double arc, much lie an eight shape, this time, however, vertical 166, described by the x's, and thus perpendicular to the first course analyzed.

If we pursue the comparison analyze of the two courses, this time from a dynamic level, we notice that the distance between the two points each realizing their opposite figure is always equidistant. In fact, if we imagine a line uniting the lowest level of one of these courses, 167, to the highest level of the complementary course 168, and that we follow the displacement of this line connecting the two points during their respective courses, we'll note that the length of this line is invariable, and that the distance separating these two points is thus equidistant, for all specific emplacement of these two points in question, which is illustrated by the points a) b) c) d) e) f) of the current figure.

This invariability is very important because it allows the supposition that this line on the material level can be replaced by a rigid piece, for example a paddle.

FIG. 18.1 shows how to realize mechanically the geometric data commented in FIG. 13. This figure shows the technical realizations allowing the production of such geometries. Having determined the courses, as well as their specific relations, we have demonstrated that we could realize it with the help of two planetary type gears 169, provided with a crankpin or eccentric 170, these gears being set up in a rotary manner on a master crankshaft 173, and coupled to a support gear 174 initially set up in their opposite phases. From the start we position the gears and crankpins in such a manner so that when one is at the highest phase of its course 171, the other at its lowest phase 172. We'll then couple the paddle 182 to these two eccentrics and this will execute the desired movements.

This set up has the following main advantages, a better repartition of the load and push on two different pressure points, diminishing the friction of this type of machine, when mounted with a central eccentric, and b) the dynamic blockage of the rear push on the paddle, increasing the front power of the machine.

This type of method also verifies the post rotary aspect of the machine, in what concerns the secondary crankshaft, or even the eccentrics that will turn in the same direction 175 as the main crankshaft, as well as in the same direction of that of the paddle 176.

FIG. 18.2 shows a similar method, said by poly induction, this time produced in a manner to realize a planetary 169 retro rotation 179 during the rotation of the crankshaft 180, which will allow the realization of a retro rotary type of machine.

Here the gears, being induction gears 169 will, to realize the pre-described objectives, be coupled to an internal type support gear 191, this gear being set up in a fixed manner in the side of the machine.

As previously, we'll mount the paddle on the eccentrics or the crankpins 182, and we'll obtain, during the rotation of the crankshaft and the retro rotation of the eccentrics and the triangular course desired.

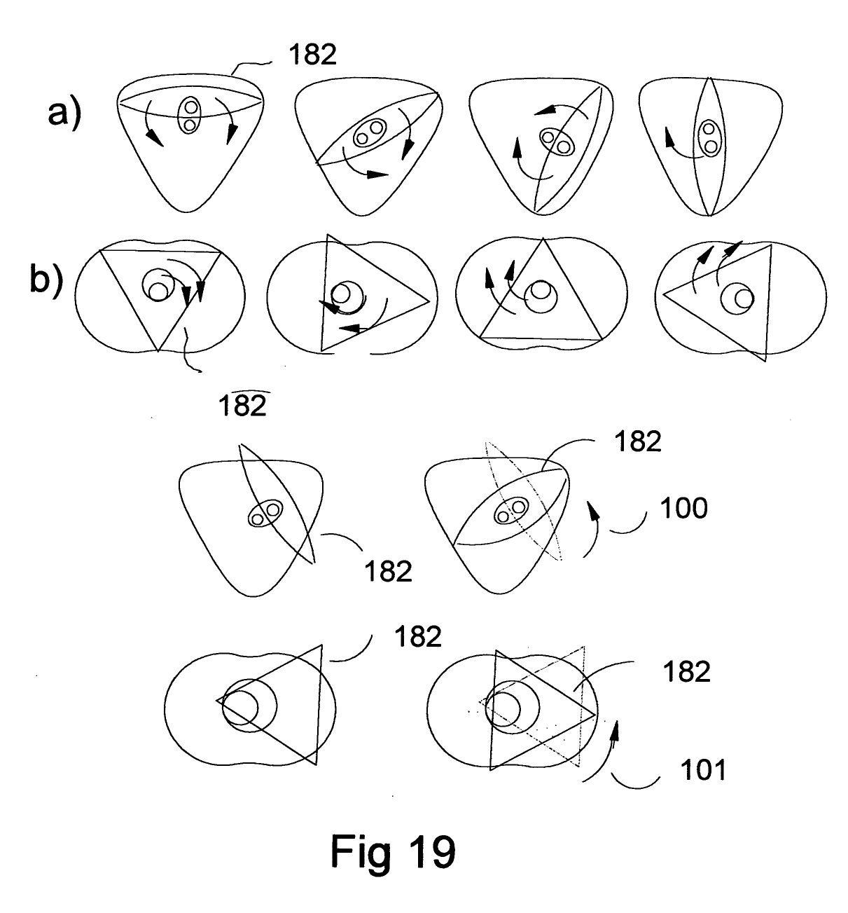

FIG. 19 shows the work of the paddle in relation to the crankshaft when observed by an interior observer, located on the crankshaft or on the paddle itself. We see that when we observe retro rotary and post rotary machines by means of an exterior observer we note that in the case of retro rotary machines in a) the paddle, as we have already mentioned, moves in opposite direction of that of the crankshaft, whereas in the case of post inductive machines in b) the paddle moves, although at somewhat reduced speed, in the same direction as the crankshaft.

It's from this type of observation that we have already elaborated mono induction and poly induction methods already commented.

FIG. 19 c) and d) shows that if we consider the paddle movement, this time not in relation to a fixed point located on the body of the machine, but rather in relation to a point located on the crankshaft, we realize that, in both these cases, retro and post rotarily, the paddle is always in retro rotation in relation to the crankshaft.

For a better comprehension, we suppose in fact in c) and d) that the paddle hasn't turned on its axe at all after a quarter rotation of the crankshaft. We have thus positioned the paddle in b) and c) as if it was rigidly fixed to the crankshaft. In figures c) and d) we see very well that to replace the paddles to specific positions that they must occupy at these dynamic moments of the machine, we must apply a retro rotation to each of them, much lighter 100 for post rotary machines and more pronounced 101 for retro rotary machines.

We can in fact, state that a retro rotation of the paddle of a post rotary machine will be approximately in the order of 60 degrees whereas retro rotary machines, here triangular, will be of approximately 130 degrees.

In other words, it's saying that seen from the angle of an observer located on the crankshaft or on the paddle, we'll note that in both these cases, there is a retro rotation of the paddle in relation to the crankshaft, and that they are before all, differences of the degree of retro rotation which characterize these two types of machines.

It is thus of the uttermost importance to note the two following points:
a) that the same parts support methods could be used fro the two types of machines
b) that these methods will make evident an action of the paddle in relation to the action of the crankshaft and vice versa, in relation to the two simply converging actions, such as the ones realized in the first methods.

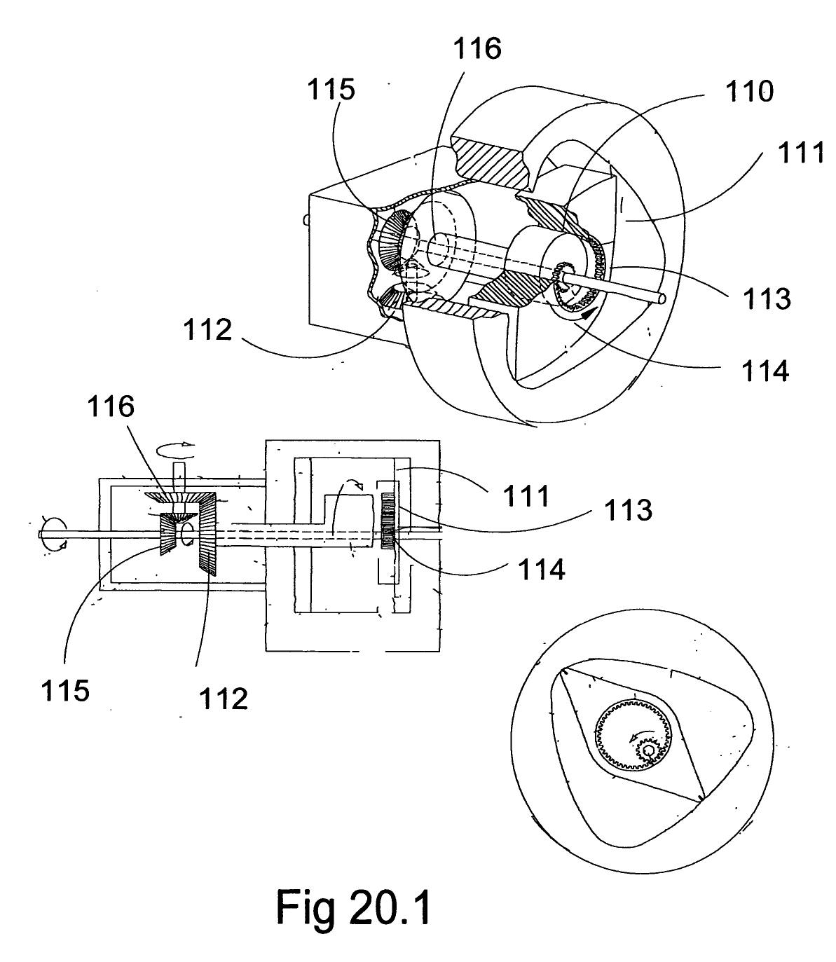

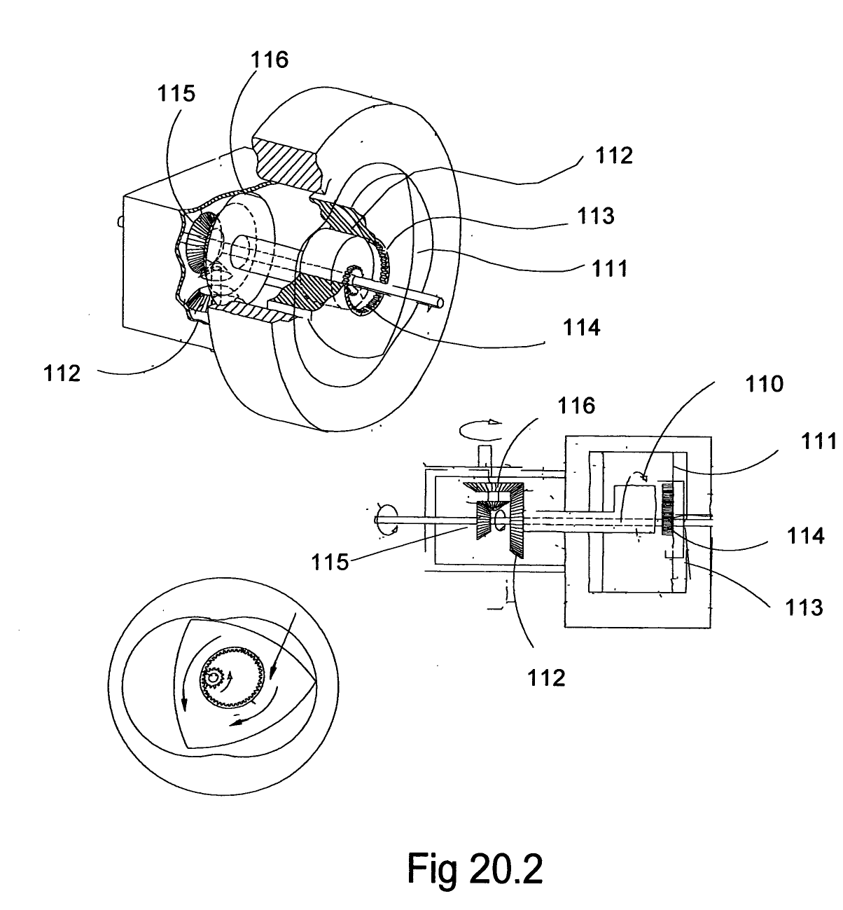

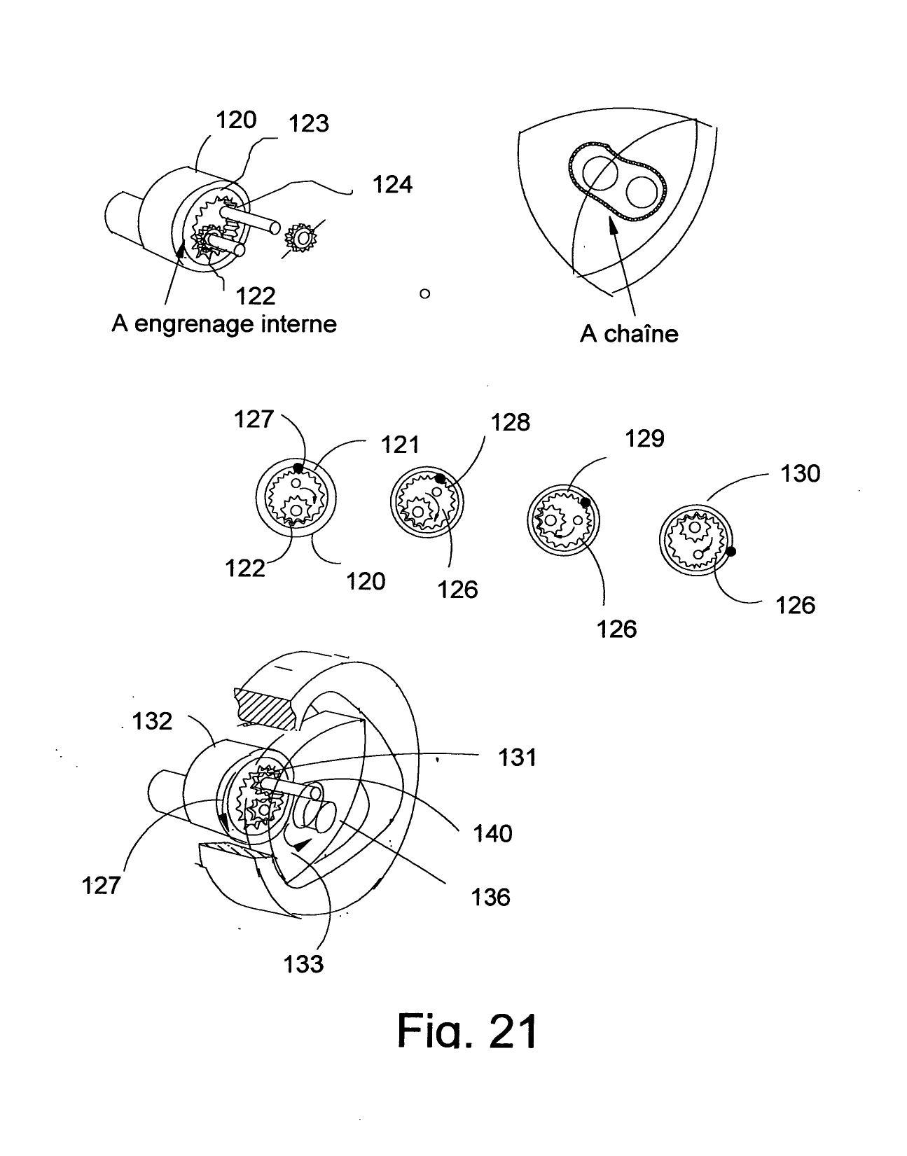

FIG. 20.1 shows a first paddle support method obtained by an interior observation, in which the crankshaft will not only participate to the positional aspect of the paddle, but also to its orientation aspect. It's the case of the method said by semi transmission . . . in this method it's the case to modify the absolute function of the support gear, which is originally static, controlling the orientation of the paddle in a dynamic and relative position in relation to the crankshaft. We'll set up in a rotary manner in the machine an eccentric 110 on which will be set up in a rotary manner the paddle 111. The gear will be pursued by an axe and finished with a first semi transitive gear 112. The paddle will be provided with an induction gear 113, here of internal type, which will be coupled to the support gear 114, this time dynamic. Here, like the eccentric, the support gear will be followed by an axe, which on the end will be set up a second semi transmission gear 115. The two semi transmission gears pre-described will be indirectly coupled by the contest of an inversion gear 116, set up in a rotary manner in the side of the semi transmission

The movement of the paddle will be realized not by resorting to the positional character of the crankshaft and orientation character of the machine, but rather by both the position and orientation character of the crankshaft.

FIG. 20.2 describes the same method, this time applied to a basic post rotary machine, which we'll call from now on, semi transmission post rotary machine

FIG. 21 comments the method said by hoop gear. The method by hoop gear has been constructed by ourselves in the goal of providing the paddles of all type of external type induction gear machines, and consequentially being able to produce all these machines in a retro rotary manner, and in addition, by an attack of the induction gear from the top.

The complete explanation is as follows. In a) we see the basic structure receiving the paddle later on. In c), a crankshaft 120 is set up in a rotary manner in the body of the machine and is built in such a manner to be able to receive in a rotary manner a hoop gear 121. A support gear 122 is set up in a fixed manner in the side of the machine, preferably by the means of an axe. The hoop gear is set up in a rotary manner in the basin of the crankshaft's sleeve to this effect 123, in such a manner as to be coupled to the support gear.

We'll note that the hoop gear could also be set up in a rotary manner from an axe, or even replaced by another means such as a chain.

In b) of the same figure, we observe that the rotation of the crankshaft 126 leads the orientation retro rotation of the hoop gear, and that if a mark 127 is put on the gear, this mark will back up to 128, 129, 130 in course of the crankshaft's rotation.

Consequentially, if a gear 131 is engaged in a rotary manner on the crankshaft's crankpin in such a manner to be coupled to the hoop gear 132, the retro rotation of this part will automatically lead to the retro rotation of this gear 133, and will thus produce the retro rotation of the paddle's orientation which is attached. This is what happens in c1) and c2) since the paddles 134 will be provided with induction gears 131 and will be set up in a rotary manner on the crankshaft's crankpin 136, in such a manner so that the induction gear is coupled to the hoop gear, this gear having it's course controlled as we have previously explained and commented, by it's coupling to a support gear simultaneously to the rotary action of the crankshaft.

The advantages of having such a mechanic are admittedly, first and foremost a great fluidity resulting of the use of a crankpin 140, in opposition to that of an eccentric as it's the case in standard versions. In a second case, we must mention the other important advantage which consists of allowing an attack of the paddle's induction gear, this time externally, from the top, which removes the effect of the continued back push in these types of engines.

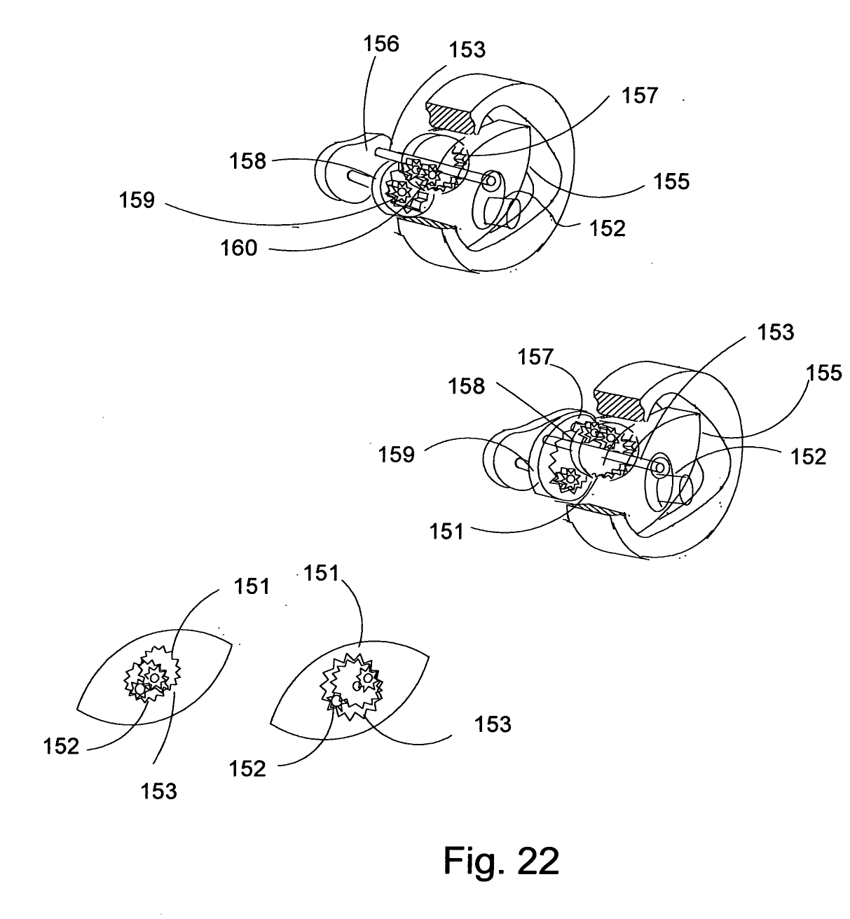

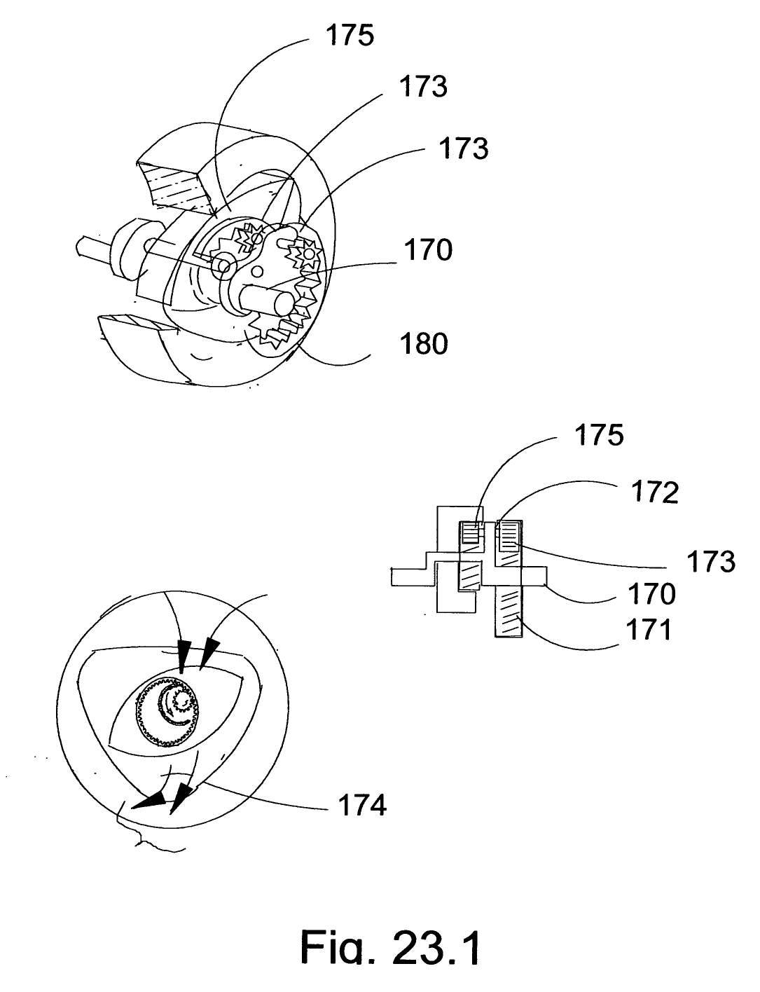

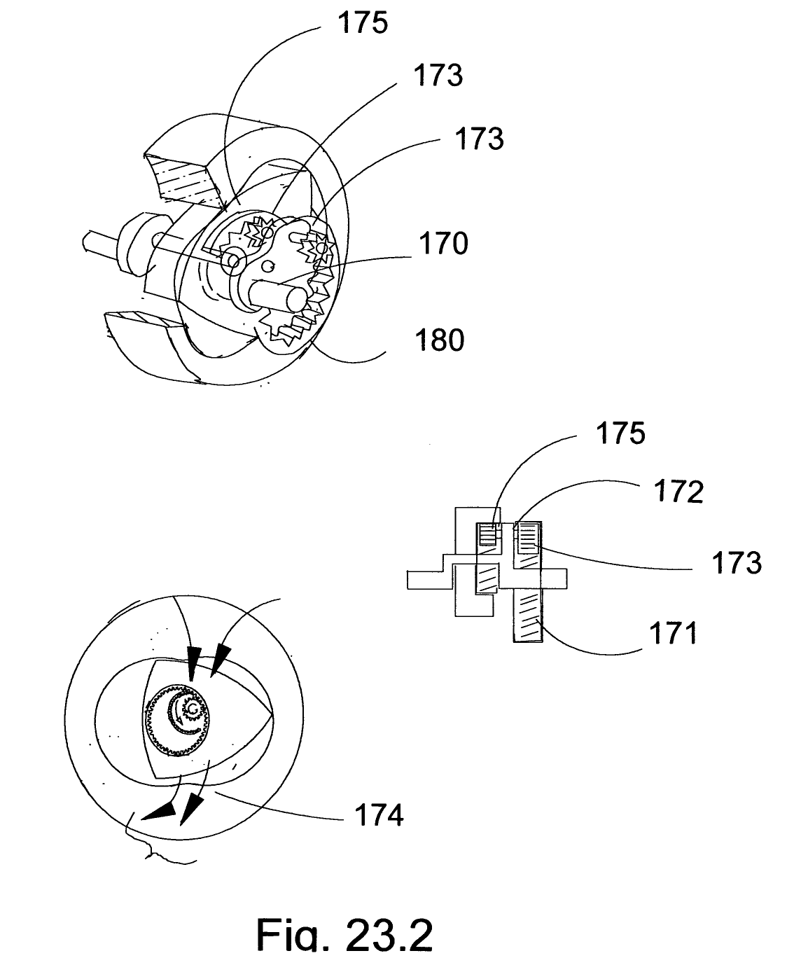

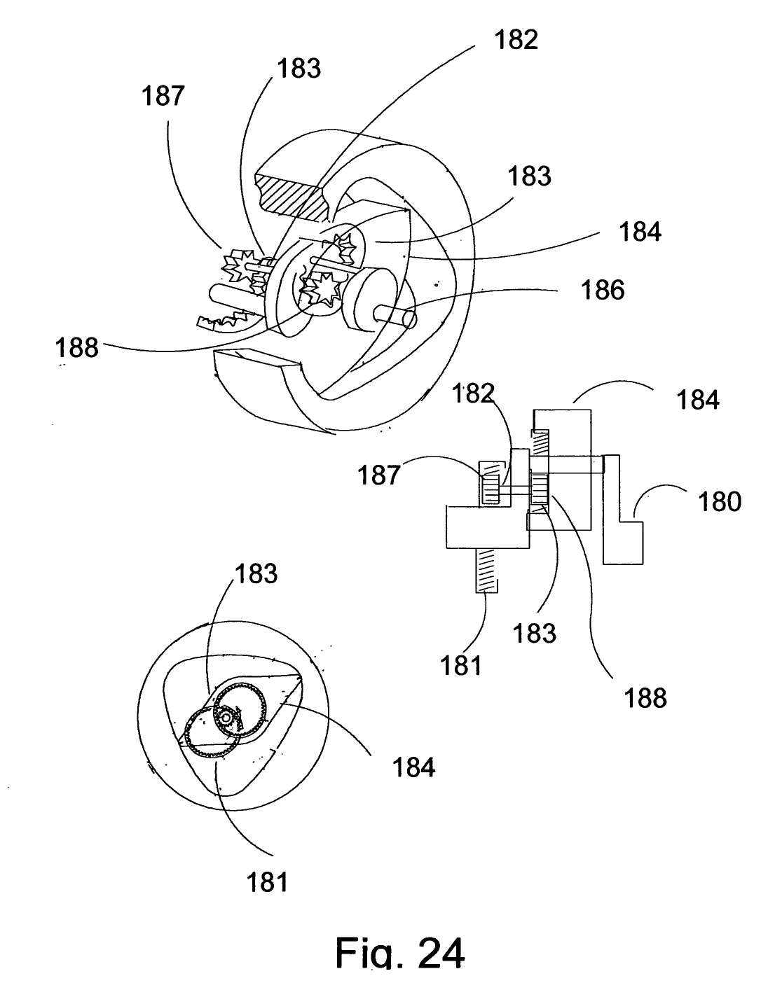

FIG. 22 a) and b) show respectively the methods said by anterior coupling hoop gear and by exterior coupling hoop gear. The figure shows that the use of the hoop gear can be multiple. In fact, for example, in this figure, the technique of the hoop gear allows the activation of a third gear, in this case, a lining gear 160, this gear motivating in turn the paddle's induction gear, which is of internal type this time.

In the current support method, a crankshaft 152, provided with a crankpin 153, or an eccentric 154, will be set up in a rotary manner inside the machine, and a paddle 155 provided with an internal type gear 151 will be set up on the crankpin or the eccentric.

The crankshaft will possess, on the anterior 156 or posterior 157 sides a support crankpin 158 of the linking gear, on which will be set up in a rotary manner the liking gear 150, this gear being coupled to both the paddle's gear as well as the hoop gear.

The hoop gear will, beforehand but not obligatorily, be mounted in a rotary manner on the crankshaft's sleeve, by it's intrusion in a basin where with the aid of an axe, in such a manner to couple the linking gear with the support gear.

The crankshaft's rotation will lead the retro rotation of the hoop gear, which in turn leads the retro rotation of the linking gear, which consequentially, leads to that of the paddle gear and to the paddle to which it is connected.

In c1), the linking gear is placed on top, for a more forwards attack which could be interesting in the case of retro rotary machines. In a) and b), it is placed closer to the center for a more backwards attack of the paddle. The diagrammatic figuration of these possibilities is shown in d) the general idea of it is to properly show the versatility of the use of the hoop gear, which coupled in this manner, allows to find the perfect balance of post and retro rotary push on the same paddle, in such a manner to balance these pushes, to totally cutting off the counter push.

FIG. 23.1 shows the method by internal juxtaposed gear, applied here to a retro rotary type machine. In a), the pieces are seen in three dimensions, whereas in b) and c), they are rather seen by transverse section. In this method, a crankshaft 170 is mounted in a rotary manner inside the machine and an internal type support gear 171 is set up rigidly in the side of it. The crankshaft's eccentric, in it's superior part, is crossed by an axe 172 supporting on each side a linking gear 173.

The exterior linking gear is coupled 174 to the support gear whereas the interior linking gear is coupled to the internal paddle gear 175, this gear being mounted on the crankshaft's eccentric.

The crankshaft's rotation will lead the double retro rotation of the linking gears, which will lead the paddle in a retro rotary manner.

FIG. 23.2 represents the same method, but this time applied to a post rotary machine.

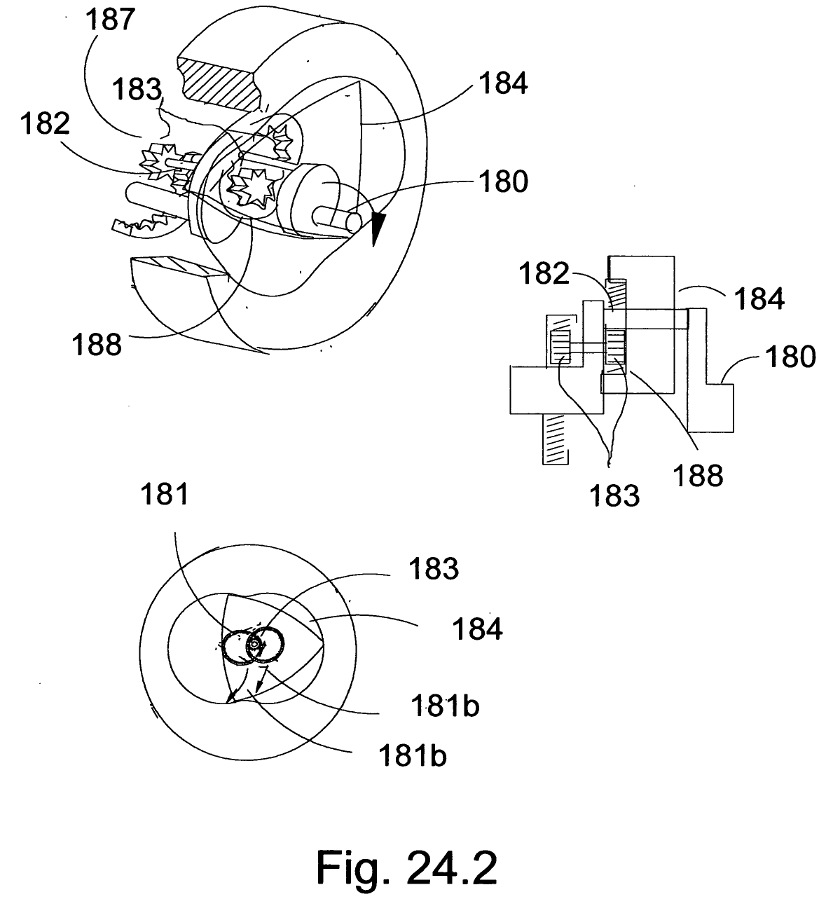

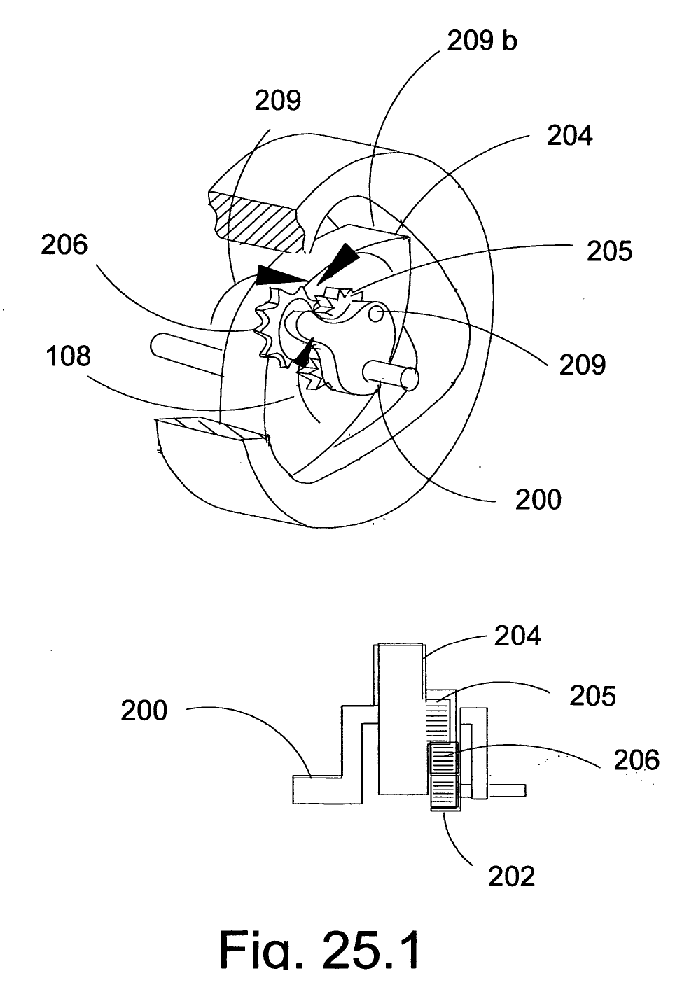

FIG. 24.1 shows the method by internal superposed gears. In this method, we show a crankshaft 180 mounted in a rotary manner in the center of the machine and we provide this crankshaft with an eccentric or crankpin.

One of the main differences between this method and the previous one, is that the support gear will be of internal type and will be set up rigidly in the side of the machine 181. A support axe 172 for the ling gears 183 will be set up in a rotary manner on the crankshaft's sleeve. The paddle 184 provided with an internal induction gear 185 which will be set up in a rotary manner on the crankpin or the crankshaft's eccentric. The linking gear located on the exterior side of the crankshaft will be coupled to the support gear 187 and the second to the paddle gear 188.

The functioning will be the following; the rotation of the crankshaft will lead the retro rotation of the double linking gear 179 which will, in turn, lead to the orientation retro rotation of the paddle, in course of its position rotation 180.

FIG. 24.2 shows the same method as the previous one, but this time applied to a post rotary geometry. The figure allows to note that such a mechanic absorbs the forwards force 181a) on the crankpin, whereas the back force 181b) is transformed in a post rotary manner, which allows to conclude that the resulting force is made of the two previous forces added, whereas in conventional machines, they subtract, as both of these forces deny each other.

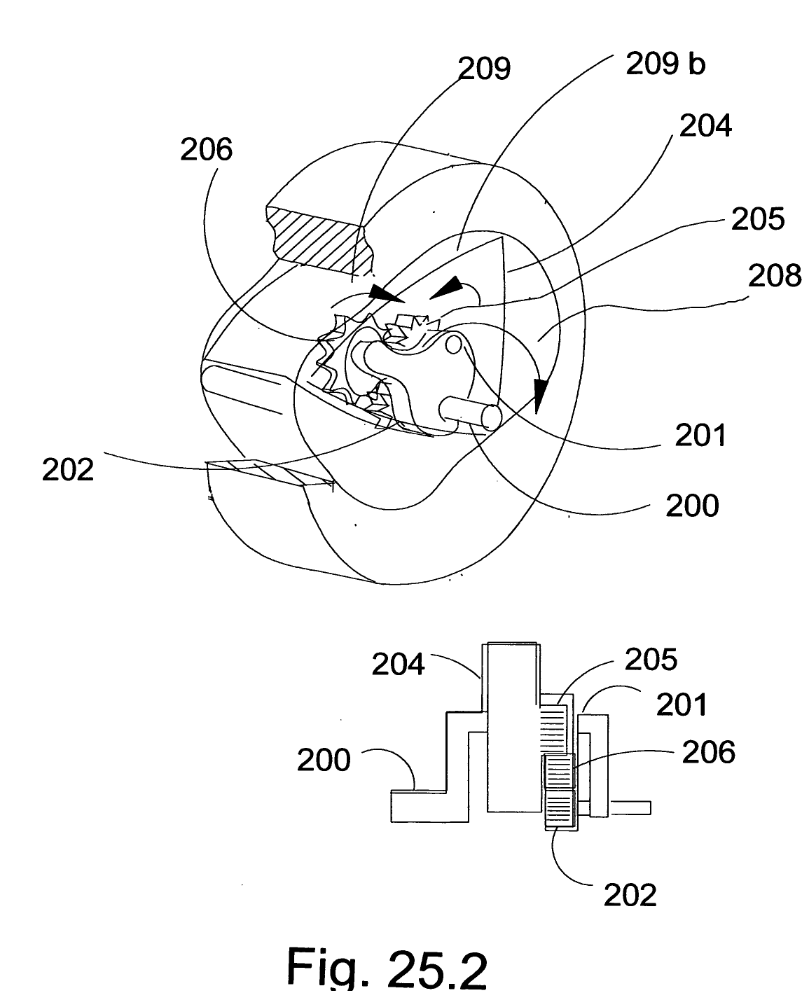

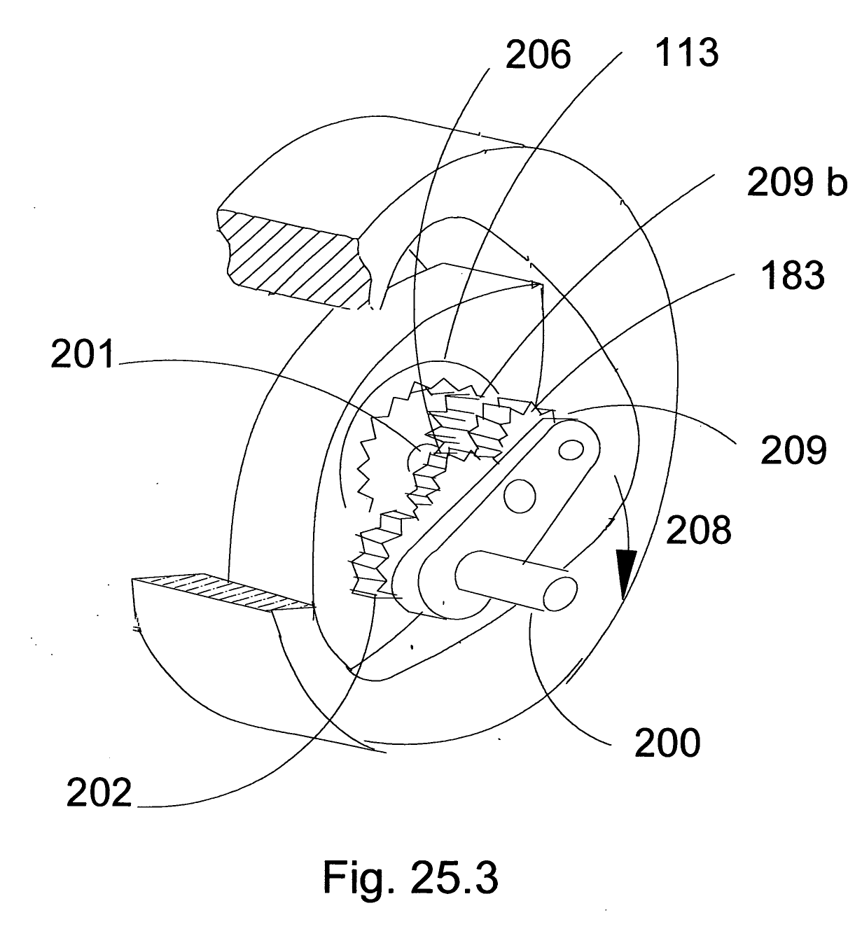

FIG. 25.1 shows the method said by intermediate gear. This method realizes the support in such a manner to use nothing but external type gears. The attack of the external paddle gear is made from its anterior side, in other words closer to the center of rotation of the crankshaft and the machine.

In this type of support, as always, a crankshaft 200 provided with an eccentric or a crankpin 201 is set up in a rotary manner in the center of the machine. In its side is set up an external support gear 202. The paddle is provided 204 with an induction gear 205 and is set up in a rotary way on the crankpin or the crankshaft's eccentric. An intermediate gear 206 is set up in a rotary manner on or by an axe from the crankshaft's crankpin 207, in such a manner as to indirectly couple the support gears of the machine and the paddle's induction gear.

This gear is set up in such a manner as to couple the induction paddle's induction gears 204 and the support gear 202.

The functioning of the machine shows that during the post rotation of the crankshaft 208, the intermediate gear, being itself a planetary gear to the support gear, undergoes a post rotation 209 which leads in turn, by it's complementary side, the paddle's orientation's retro rotation 209b) in course of it's positional rotation. As previously, since the position and orientation aspects of the paddle aren't absolute, but rather relative to that of the crankshaft, this method applies as much to post rotary machines as retro rotary ones, in which it will suffice to calibrate the gears.

FIG. 25.2 is a method similar to that of the previous applied to a post rotary machine.

FIG. 25.3 is a method derived from the preceding one, but rather the intermediate gear actions rather the paddle's gear 113, since it is of internal type, by means of a linking gear 183. We'll note that the crankshaft's crankpin 201 is located this time on the level of the intermediate gear.

This realization allows us to enounce the rule according to which we can change an external paddle gear for an internal gear and a linking gear, and inversely, without modifying the machine's structure.

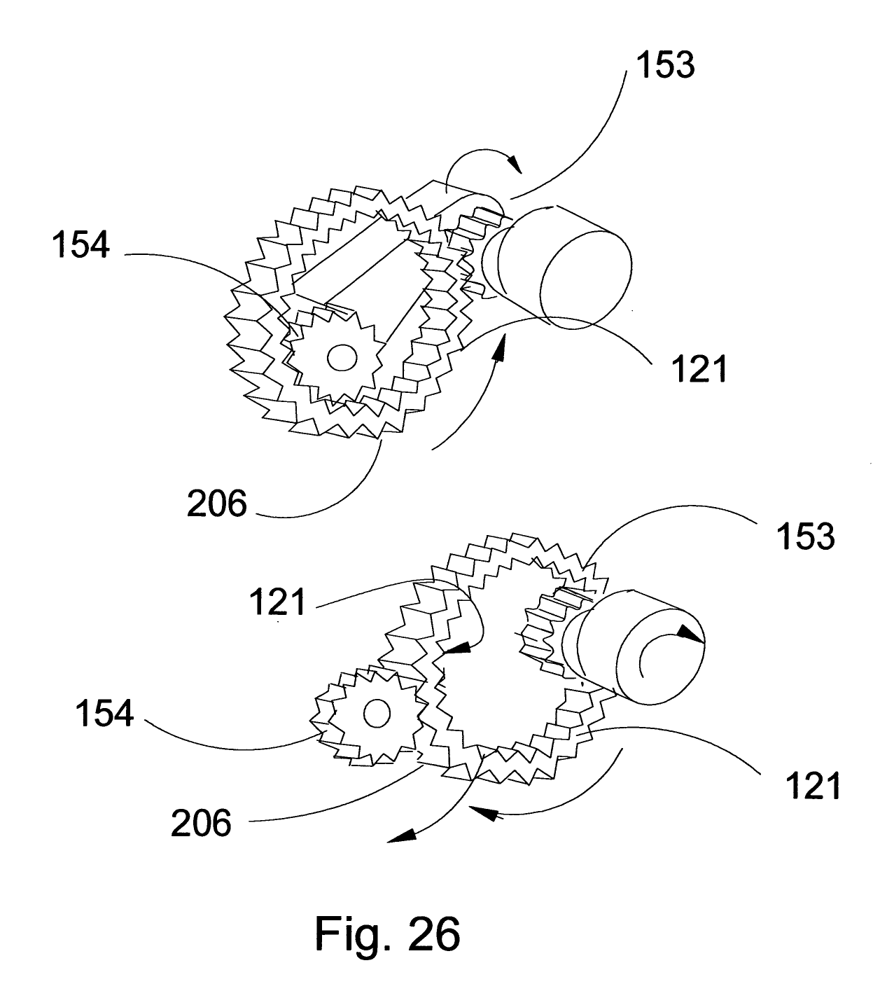

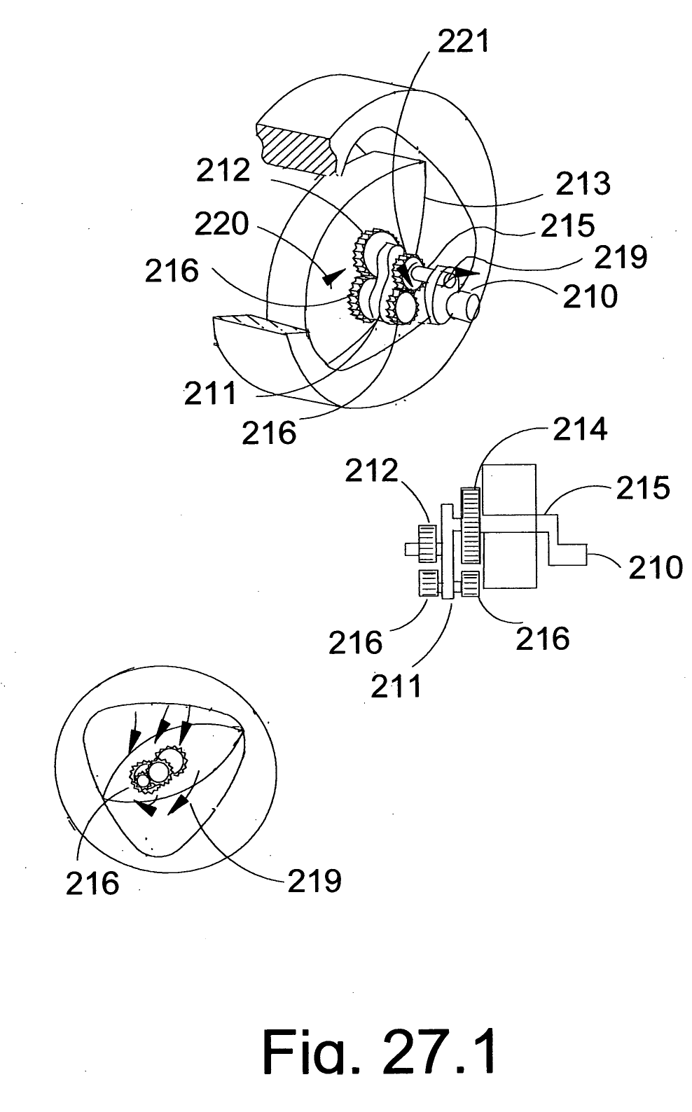

FIG. 26 shows the method by intermediate hoop gear. In this method, the hoop gear 121 of the machine is produced rigidly or in a same piece of that of the intermediate gear 206. One or the other of the gears will be coupled to the support gear 154, and the complementary gear will be coupled to the induction gear 153. These to methods in a) and b) will produce a post induction of the induction gear and of the piece, or of the eccentric which is connected.

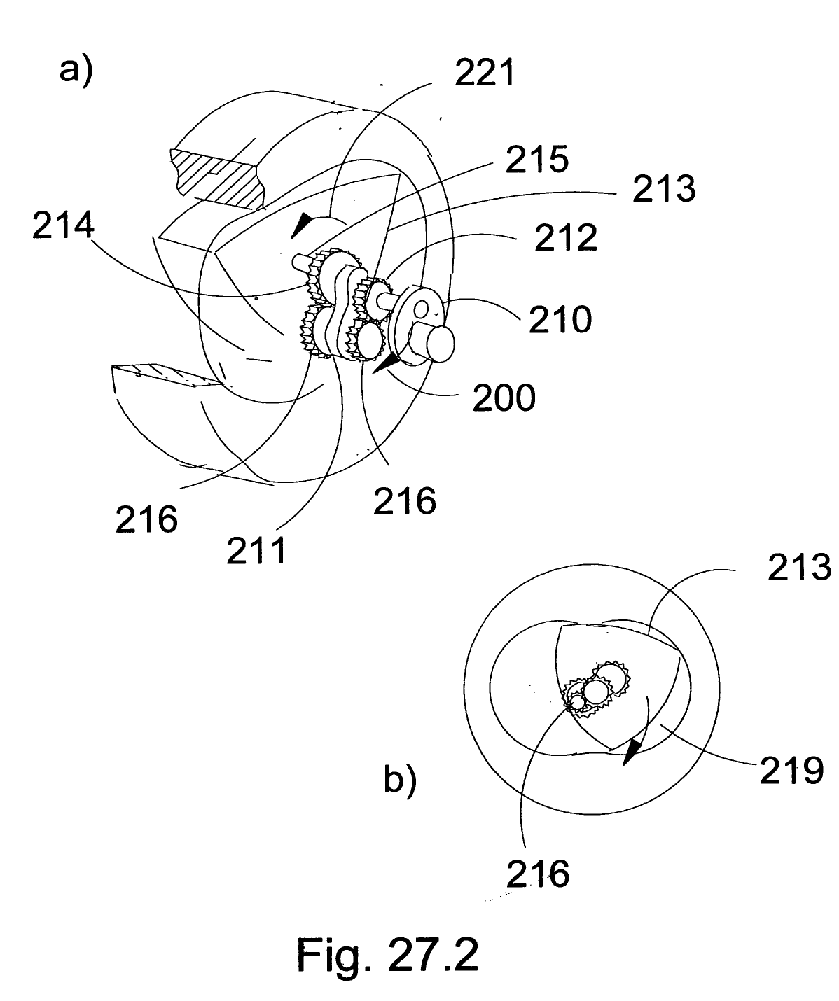

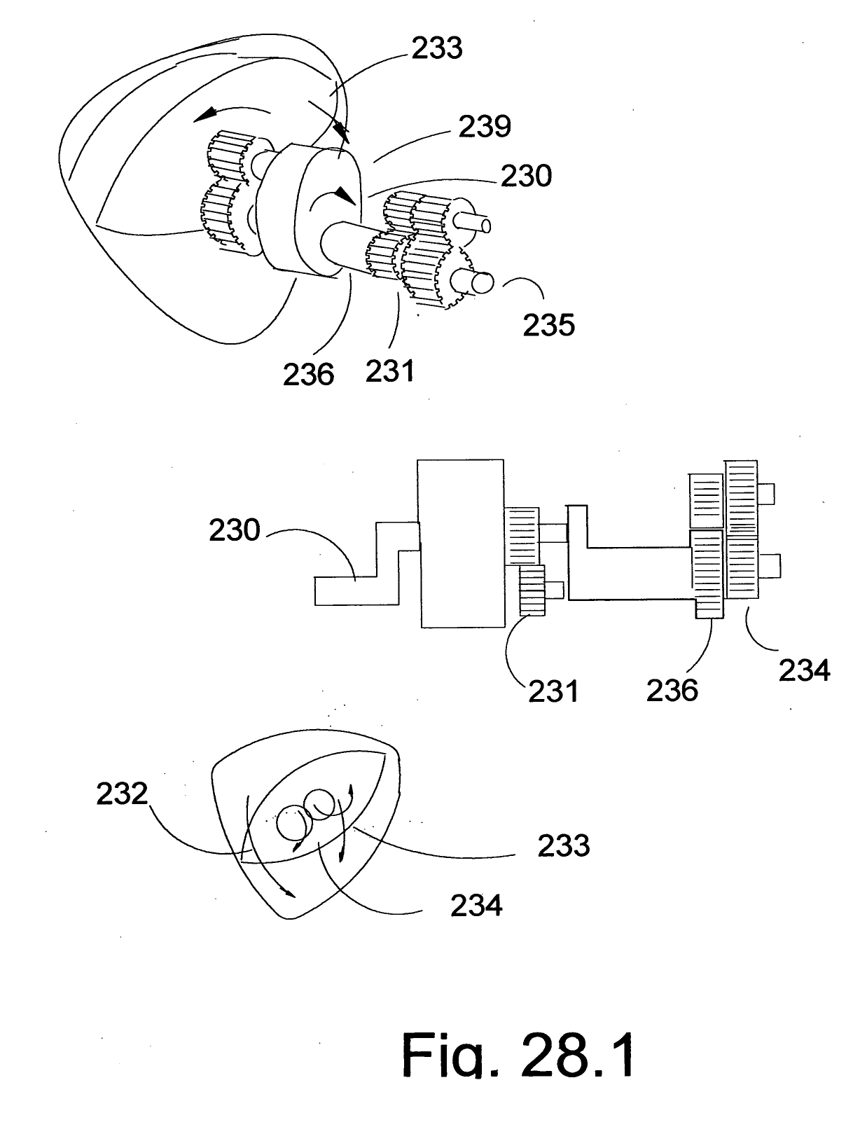

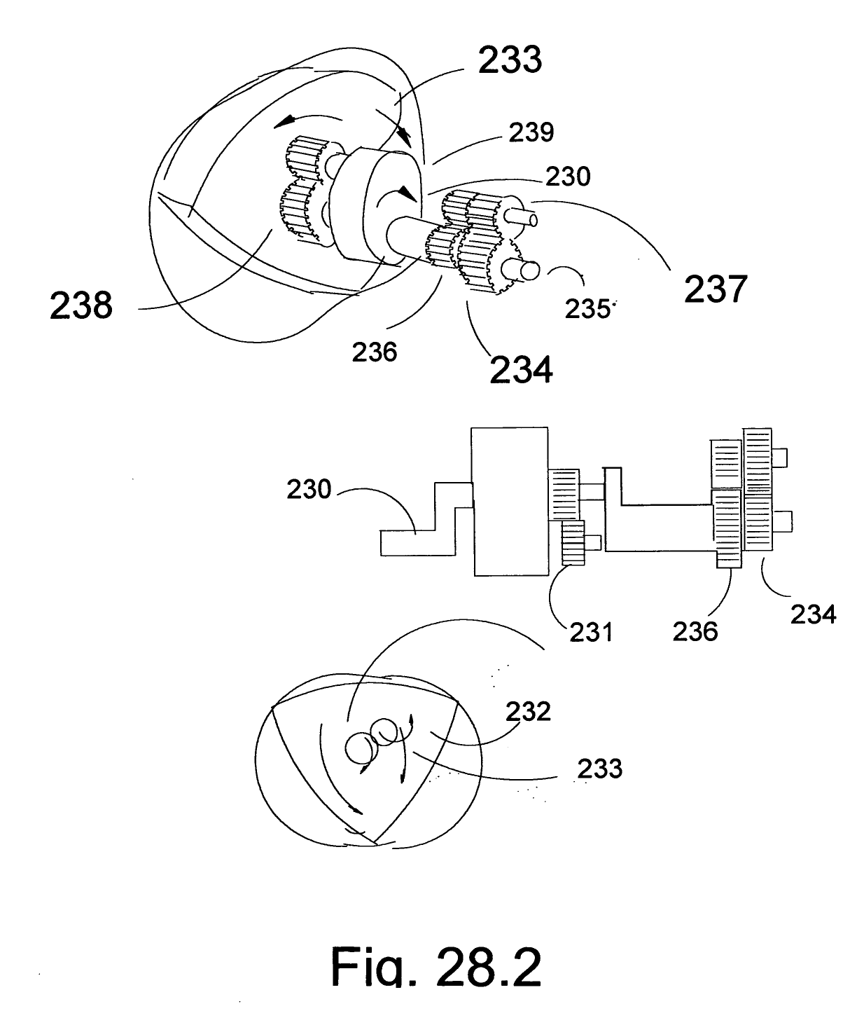

FIG. 27.1 shows the support method which will be said by spur gear. In this method, the crankshaft 210 will be set u p in a rotary manner inside the machine and will have for particularity to be pursued lengthwise at its anterior part, in other words, opposite to that of the crankpin, this additional part being named for this reason crankshaft spur 211. A support gear 212 will be set up rigidly in the side of the machine.

The paddle 213, provided with an induction gear 214, will be set up on the crankshaft's crankpin 215. Two linking gears 216 will be connected rigidly and set up in a rotary manner by means of an axe at the crankshaft's spur, in such a manner as to couple the machine's support gear to the paddle's induction gear.

The functioning of the machine is in effect only under the rotation of the crankshaft 219, the linking planetary gears mounted on the crankshaft's spur will be lead post actively 220, which will activate the paddle orientation's retro activation 221 during it's position's rotation.

FIG. 27.2 shows the same method as the one presented in 27.1, but this time applied to a machine of post rotary geometry.

FIG. 28.1 shows the method said by central post active gear, applied to a machine of retro rotary geometry. As previously, the current method shows that when the paddle is activated post actively from the rear, in course of its position's rotation, its orientation undergoes a retro rotation, which is the desired effect.

Here, consequentially, a crankshaft 230 is set up in a rotary manner inside the machine and a central gear 231 is set up in a free and rotary manner in the center on or by a central axe to this effect, in such a manner as to be coupled to the induction gear's paddle. To obtain the desired orientation effect of the paddle, we'll thus need in course of positional rotation to motivate the central gear in a post active way.

In fact, to obtain a retro rotation 232 of the paddle during it's position's rotation 233, we'll need to produce a post action of the central active support gear superior to that of the crankshaft.

To do this, many means could be used. Among the simplest, there's the following; we'll provide the support axes of the central gear and the crankshaft with gears 234, 236 these gears being coupled indirectly by a double gear, which we'll name accelerator gears 237, these pieces being set up in a rotary manner in the side of the machine.

The functioning of the machine will thus be the following. During the rotation of the crankshaft 239, the accelerator gears will lead the accelerated turning of the support gear, which will produce a retro rotary effect 232 on the paddle by means of it's induction gear.

FIG. 28.2 is a method similar to that of the previous figure, but this time applied to a machine of post rotary geometry.

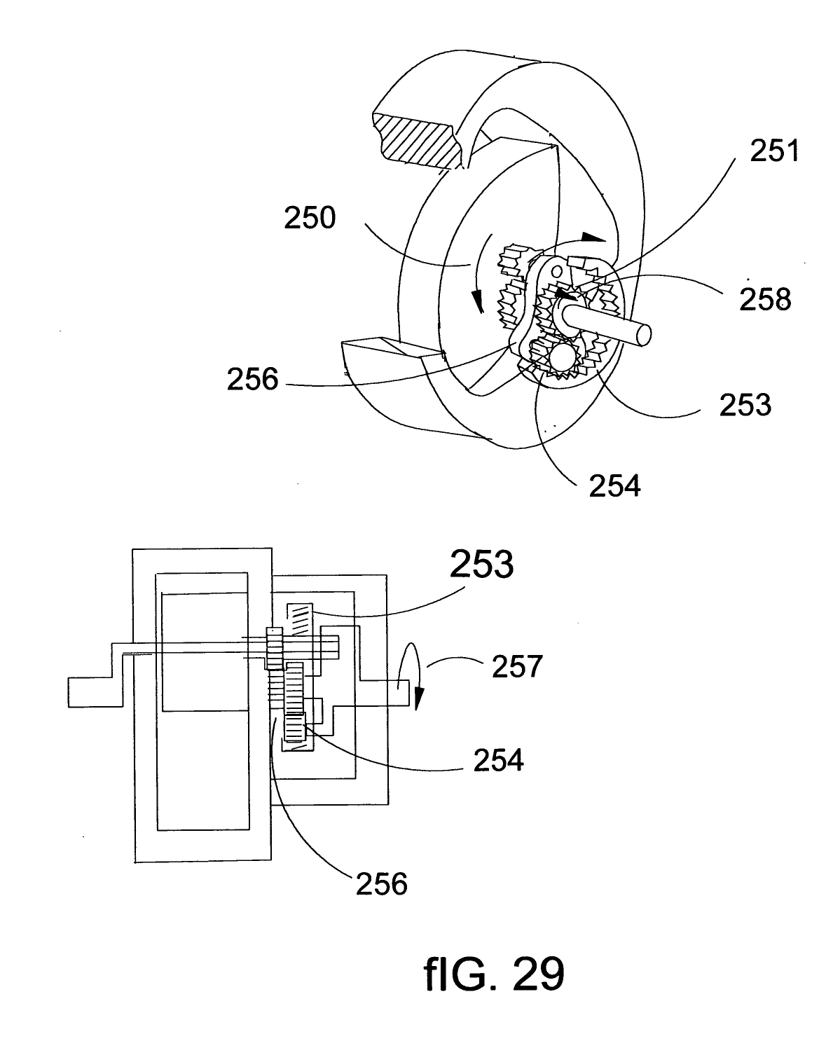

FIG. 29 shows the method by central post active gear by doubling the linking gears. In this method, the paddle is, as before, activated 250 by the anterior attack 251 by a central post active gear 252.

However, the activation method of the central gear is different. Here, we resort to an internal support gear 253. A spur gear 254 is coupled to the post active support gear, activating the doubled linking gears 256 constituting the central pot active gear with the effect we know.

The functioning consists, during the rotation of the crankshaft 257, the central linking gears are lead into post rotation 258, which leads the paddle's orientation's retro rotation 250 during the paddle's position's rotation.

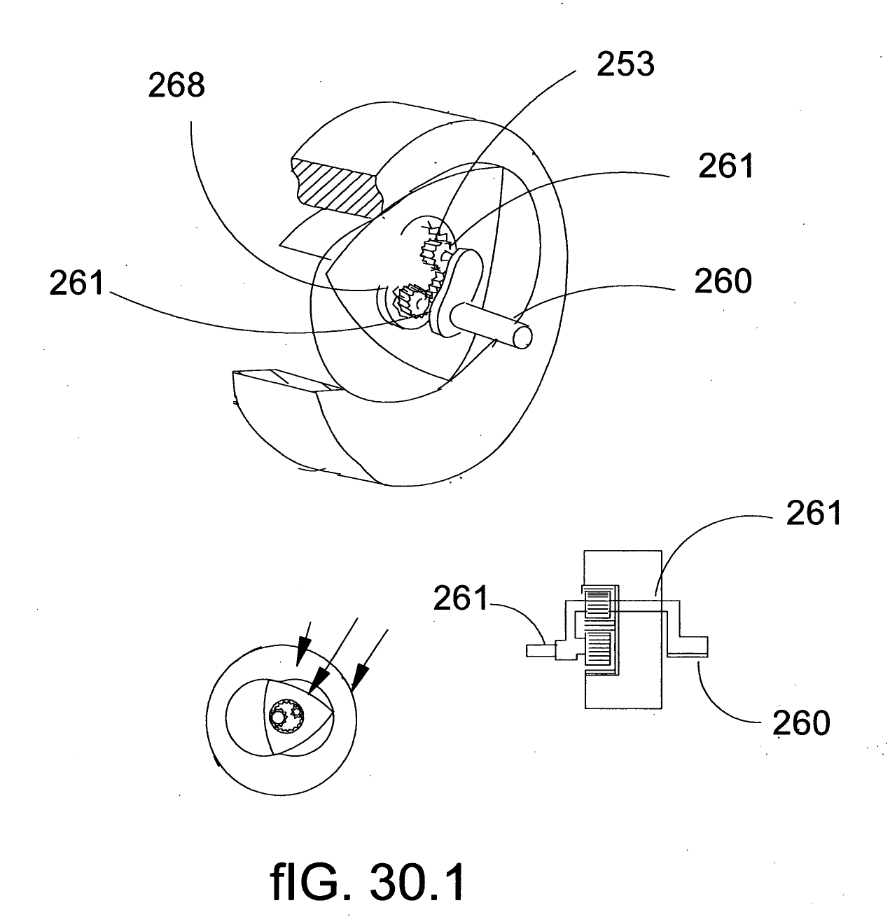

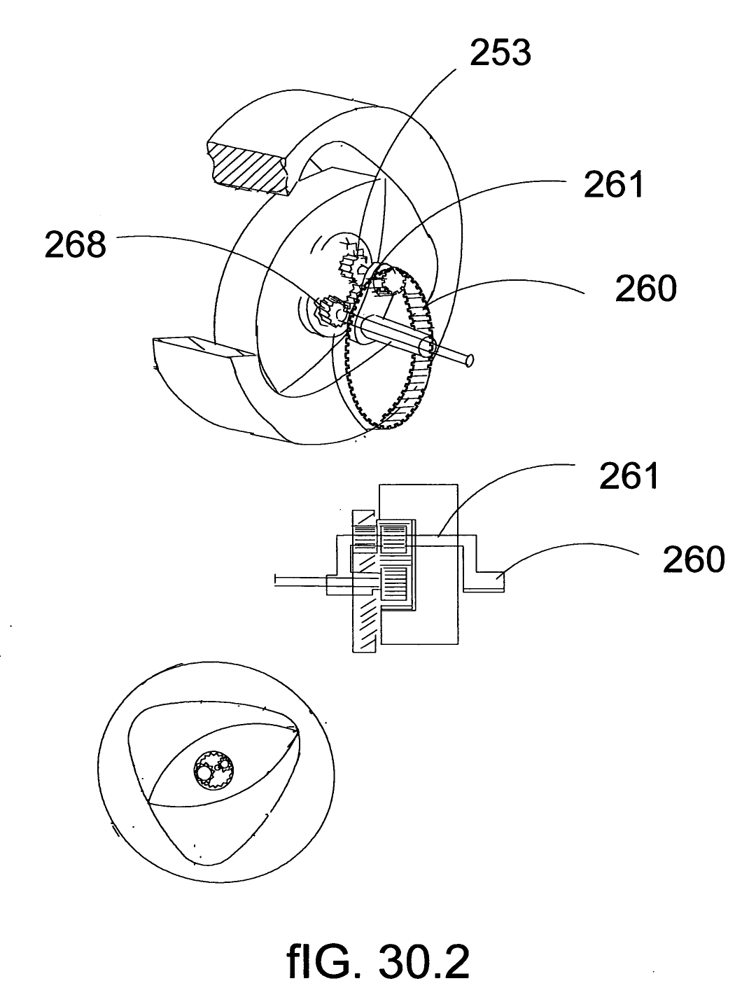

FIG. 30.1 shows the method said by paddle hoop gear. Here, we suppose that the paddle isn't, as before, supported positionally by an eccentric or a crankshaft's crankpin, but by a set of gears.

We thus suppose a crankshaft 260 set up in a rotary manner inside the machine. We suppose that, on the crankshaft's sleeve there is set up two gear support axes 261, or even, the two first supporting the free gears and the third, active link gear. We'll note that the machine will be realizable with a single support and the free gear, which we have produced with two for a better stability. We'll note that in the case of a single free gear, it could also be set up in the center of the machine and not on the sleeve. An internal paddle gear will be fixed rigidly in the center of the paddle 268, and a support gear will be, as in the previous versions, fixed rigidly inside the machine. A gear, or a double linking gear 253, will be set up in a rotary manner on the axe of the superior crankpin, and will couple the rigid paddle hoop gear and the machine's support gear.

The functioning of the machine consists that during the rotation of the crankshaft 267, the linking gear will be brought in retro rotation 268 and will thus lead the orientation's retro rotation of the paddle, applied by its fixed hoop gear, to both the linking gear and to the free support gears.

FIG. 30.2 shows that we can apply here a method similar to a retro rotary type of machine. This time however, we have let the central paddle gear free and we have motivated by hoop gear the superior gear of the crankpin. We'll note that we could also produce the machine by leaving the central gear free and by motivating retro rotationally the crankpin's superior gear.

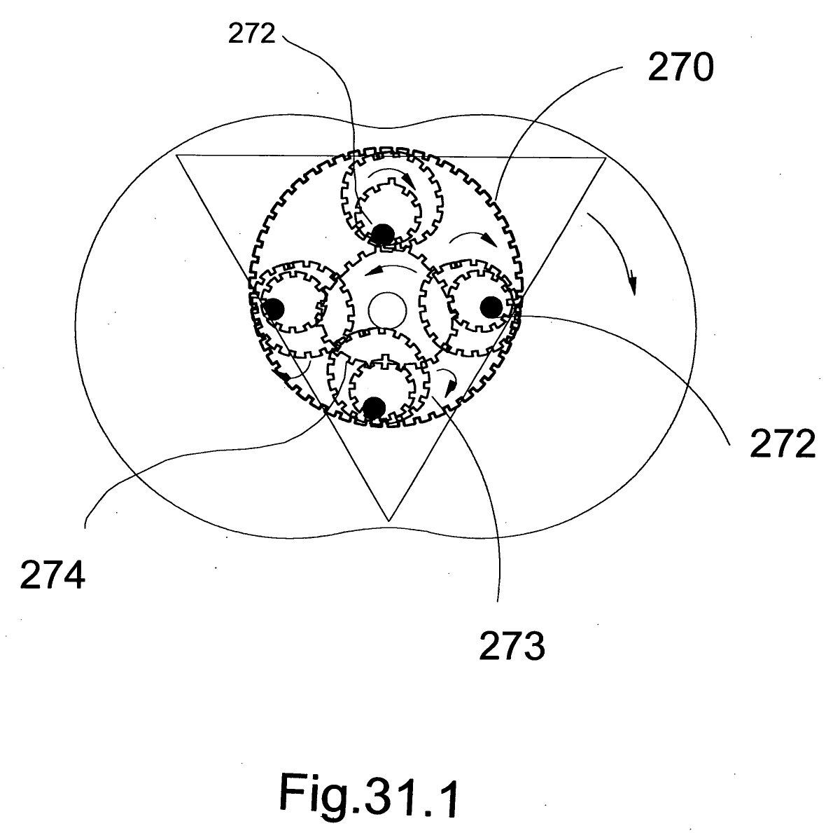

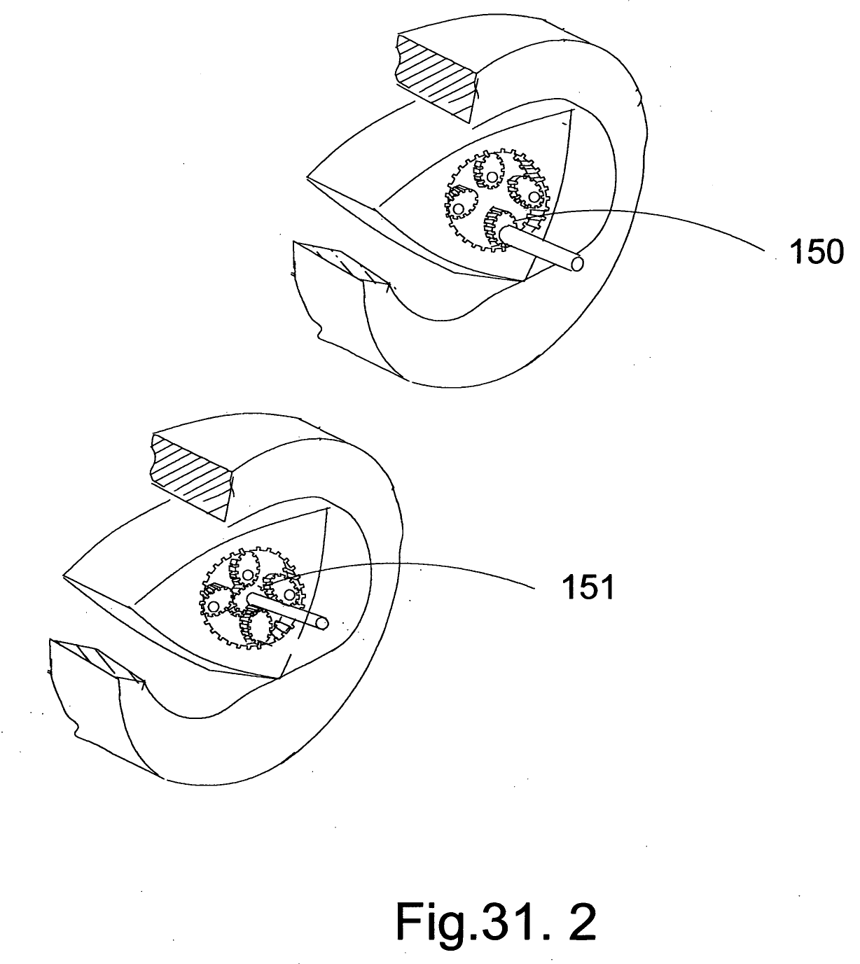

FIG. 31.1 shows the support method said by gear structure. This method, much like the following, has been conceived in such a manner to be able to construct the machine by cutting off the crankshaft or the central eccentric, and thus allow the use of this emplacement for other applications such a s pumps, turbines, generators, etc.

FIG. 31.2 shows the previous figure in three dimensions.

In this method the paddle is as before provided with a fixed hoop gear 270 which serves as support, both orientationally and positionally.

As before, it is possible to construct the machine with less gears, but by an ideal support and a better comprehension, we suppose here that four gears, said eccentric, because the direction of rotation is outside of a gear center being set up in a rotary manner in four fixed spots of the machine, either on or by four fixed axes 272 to it.

The functioning is to the effect that the functioning of the paddle turning positionally the gears will modify itself, such as demonstrated in b) and will thus realize desired machine forms.

The motor axe could thus be set up by one of the gears 273, or even on a central polycammed retro rotary gear 274, set up between the four eccentric induction gears.

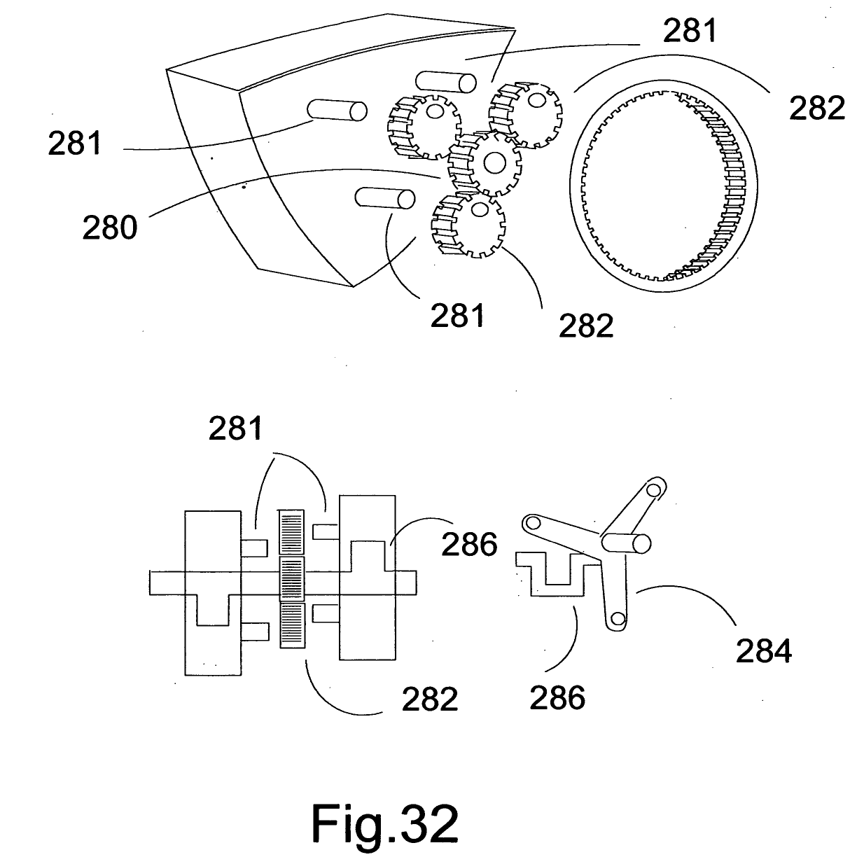

FIG. 32 shows a new support method said by eccentric gear. In this method, the paddle 280 is provided with fixed axes 281 which are coupled in a rotary manner to three gears said eccentrics 282, or even, in de-centered points.

In such a manner to conserve the eccentric gears well coupled to the support gear, we'll produce a support brace connected either to the center of these gears, either also in an off-centered manner 284, opposite of the first.

The crankshaft could be an eccentric set up in the machine 285 or a double eccentric 286. The interest of the current mechanic will be that the movement of the paddle could be made in a totally independent way of the crankshaft's eccentric, which will have for result that the friction on it will be reduced to a maximum.

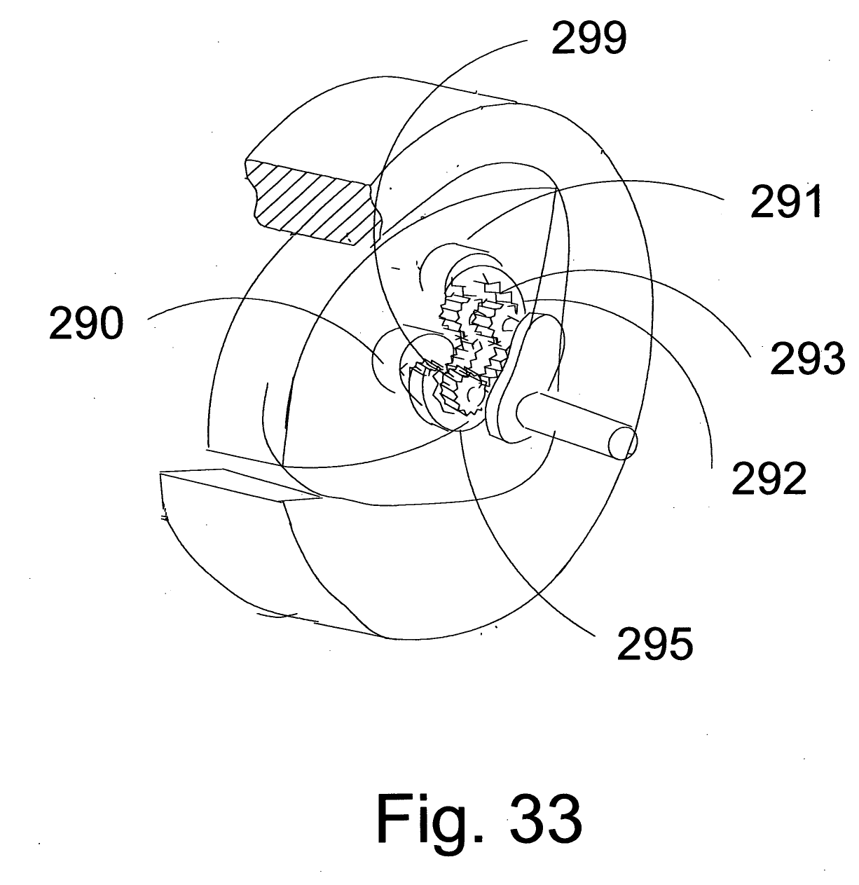

FIG. 33 shows a support method in which we state that we can support the position aspect of the paddle from a central eccentric 290 and the paddle's orientation aspect by a secondary and peripheral eccentric 291.

In the case of retro rotary machines, the peripheral eccentric and the central eccentric could be controlled by a hoop gear 292 coupled to the induction gear for each of these elements 293, 294, as well as the support gear 295.

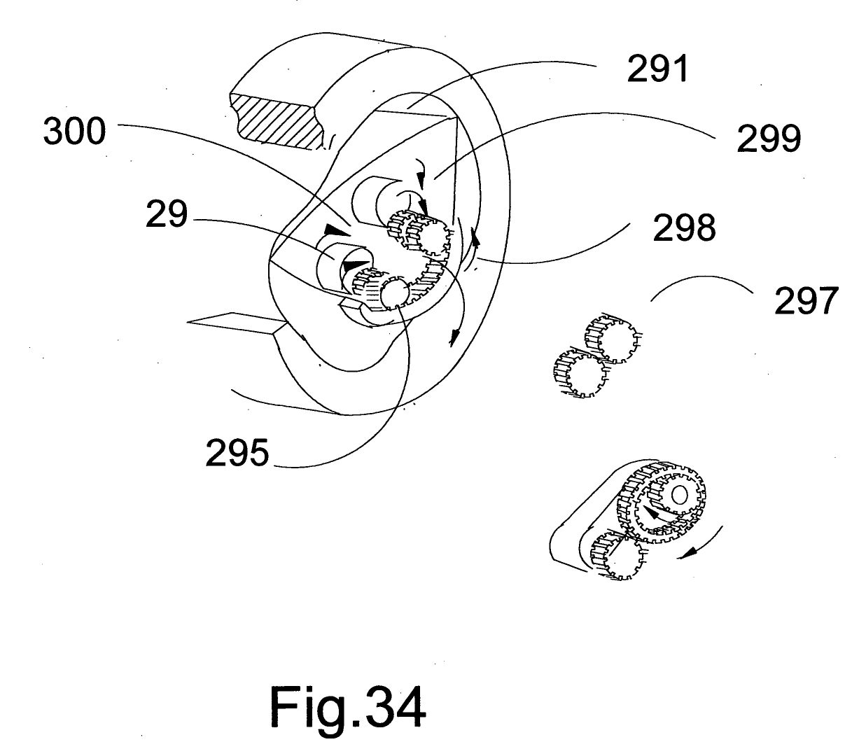

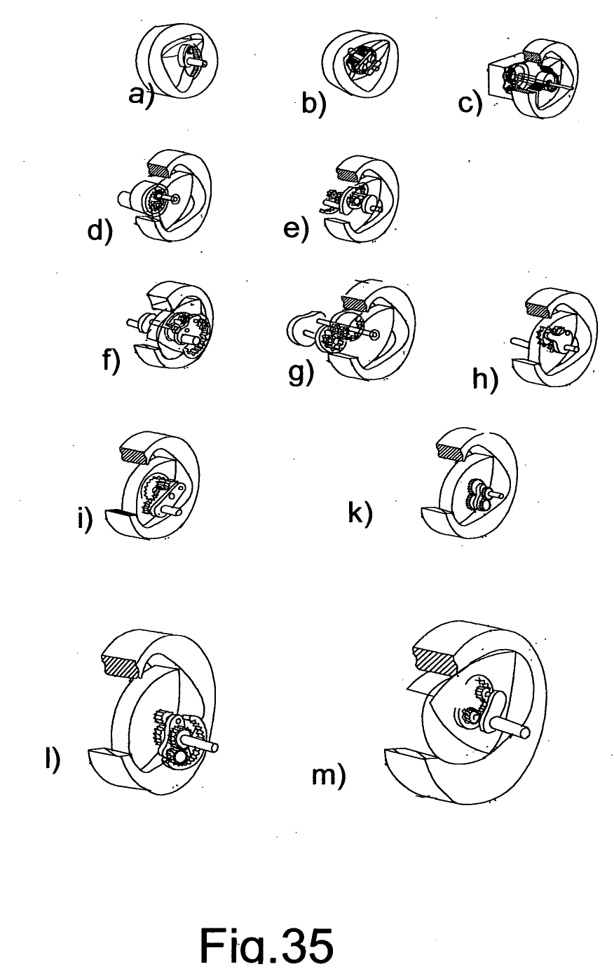

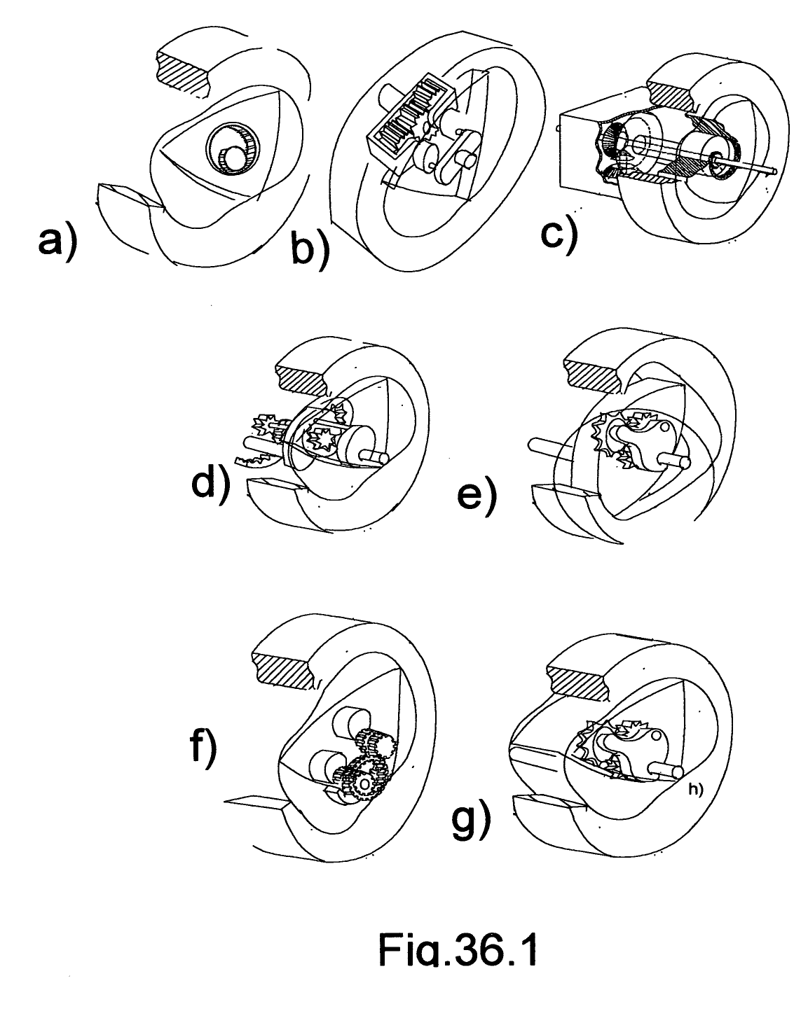

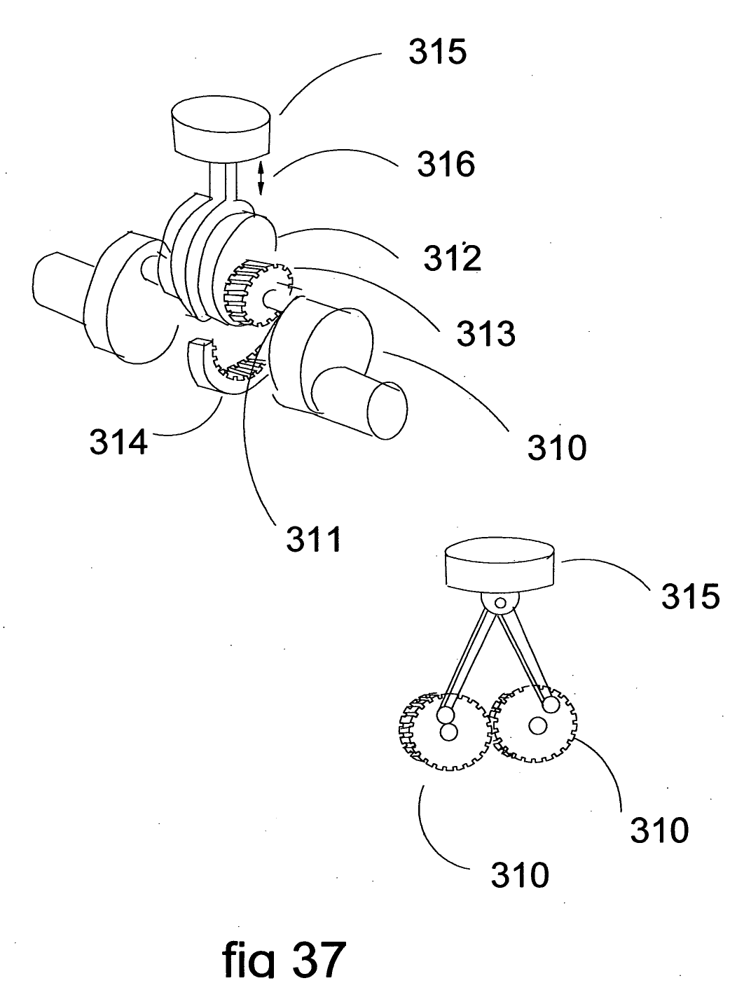

FIG. 34 is a method similar applied to a machine of post rotary geometry. In the case of post rotary machines we'll need to use a gear which we have named intermediate hoop gear, under one of these two installation and command modes 296, 297. The intermediate hoop gear is in fact a hoop gear on the exterior surface of which we have added an external type intermediate gear.

In its first installation type, the intermediate hoop gear is attached interiorly to the support gear and exteriorly to the induction gear, and for result that the retro rotation 298 leads the post rotation 299 of the induction gear. In its second installation type, the intermediate hoop gear is coupled by its exterior surface to the support gear, and by it's interior surface to the induction gear and for result that its post rotation 300 leads as well the post rotation of the induction gear.

An intermediate gear could have for effect to connect the gears of each of these eccentrics and peripherals.

The use of the intermediate hoop gear and the intermediate hoop offers, in addition to much more geometrical flexibility. As we'll show in the variety and the liberty of realization of machine forms, these pieces being much less submitted to the forced size relations of the gears in relation with their required rotation numbers.

The types of arrangements will thus allow to realize not only post rotary machines with bi rotary cylinders, but also allows the realization of more post rotary, bi rotary machines, as for example, poly turbines.

FIG. 35.1 shows in summary all the mechanics previously exposed which apply to retro rotary engines, which the most representative form is that of the triangular Boomerang. In 35a), we find the paddle support by mono induction, in 35b), by poly induction. The two methods being methods deduced from the exterior observation. In 35c), we find by semi transmission, in 35d), by hoop gear in 35e), by anterior and posterior hoop gear, in 35f), by internal juxtaposed gear, in 35g), by internal superposed gear we find a realization, in 35h) by intermediate gear, in 35i) by posterior intermediate gear, 35j) by intermediate hoop gear, and in 35k) by spur gear.

FIG. 35.2 completes the previous figure: in l) we find the method by paddle hoop, in m), the method by central active gear, in n) the method by gear structure, in o) the method by eccentric gears.

All these mechanics also apply to derived retro rotary figures, such as for example three sided paddle figures, in square-like cylinders, or even four sided paddle figures in a five sided cylinder. We must simply, for these figures, calibrate these gears.

FIG. 36.1 shows that all previously commented mechanics apply also to post rotary machines, which the most common form is that of the Wankle geometry, generally realized by a mono inductive support method, in a) with all the defaults which we know. This is the same case for post retro rotary, these mechanics also applying to derived post rotary figures, such as for example four sided paddle figures in three sided cylinders or even five sided paddle figures in a four sided cylinder. We must simple for these figures calibrate the gears.

We find in 36a), the mono induction paddle support, in 36b), by poly induction. The two methods being methods deduced from the exterior observation. In 36c), we find the method by semi transmission, in 36d), by hoop gear, in 36e), by anterior and posterior hoop gears, in 36f) by internal juxtaposed gear, in 36g) by internal superposed gear we find a realization, in 36h) by intermediate gear, in 36i) by intermediate posterior gear, 36j) by intermediate hoop gear, and in 36k) by spur gear.

FIG. 36.2 completes the previous figure; in 36l) we find the method by paddle hoop, in m) the method by central active gear, in n) the method by gear structure, in o) the method by eccentric gears.

FIG. 37 shows in a) and b) respectively, retro and bi mechanical support methods of the compressive pats of rectilinear rod engines.

In a) of this figure, we find the piston motor machine supported by this method. A crankshaft 210 is set up in a rotary manner in the machine, on its crankpin 311 is set up in a rotary manner an eccentric 312 of a same radius of that of the crankshaft. This eccentric is provided firmly with an induction gear 313, this gear being coupled to an internal support gear 314, in the side of the machine.

In b), we find the bi rotary method, in which two crankshafts, each provided with a rod, supporting the piston in turn. The pistons 315 are attached by fixed rods, or directly to the eccentric since its attachment will be perfectly rectilinear 316.

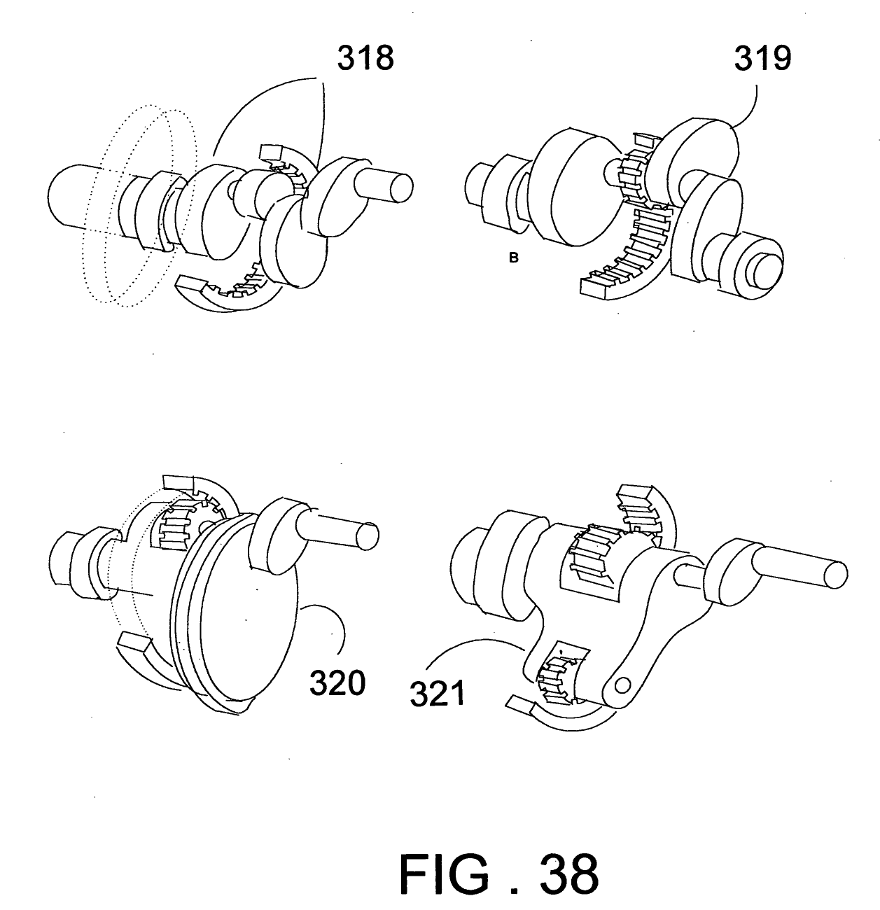

FIG. 38 shows the three main balancing methods of machine supports. We can firstly, in a), support the machine by building the main crankshaft in a standard manner, crossing the machine. As we have already shown, the method by retro rotary mono induction applies with excellent results to piston engines.

In a) we'll use selector forks 318 to balance the support of the subsidiary crankshaft axe.

In b), we'll realize this subsidiary crankshaft as an eccentric 319.

In c), we'll support the crankshaft also in its interior portion, by a circular bulge to this effect, serving as additional range 320.

In d), we'll add an interior support to the crankshaft as the form of a spur gear freely coupled to the support gear.

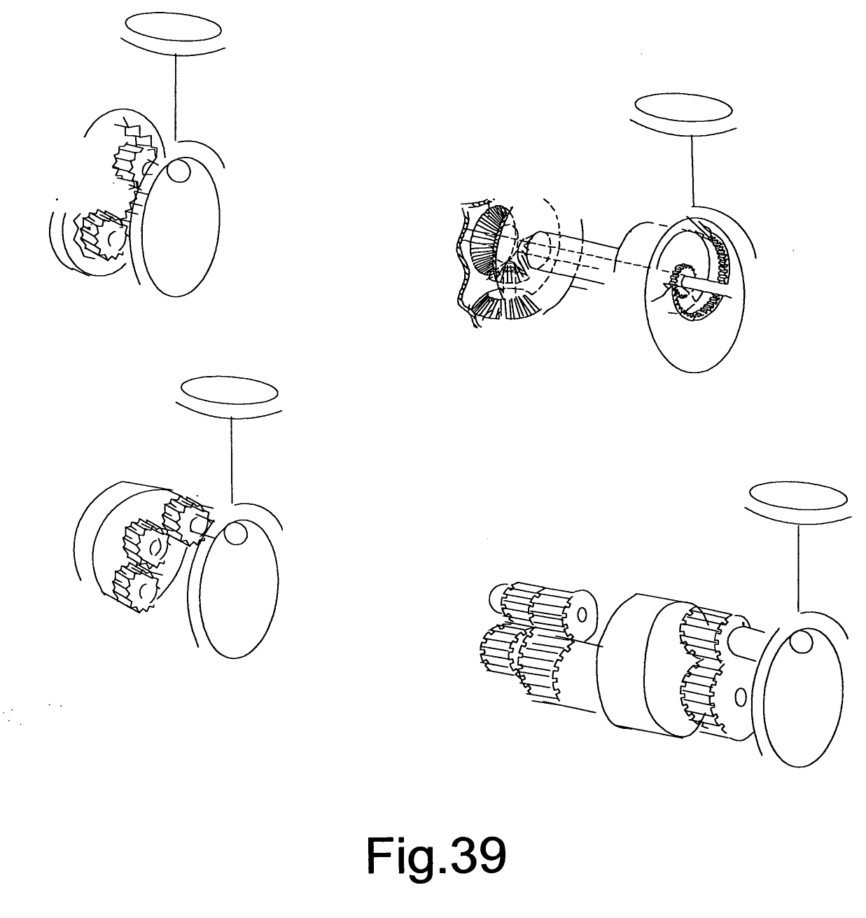

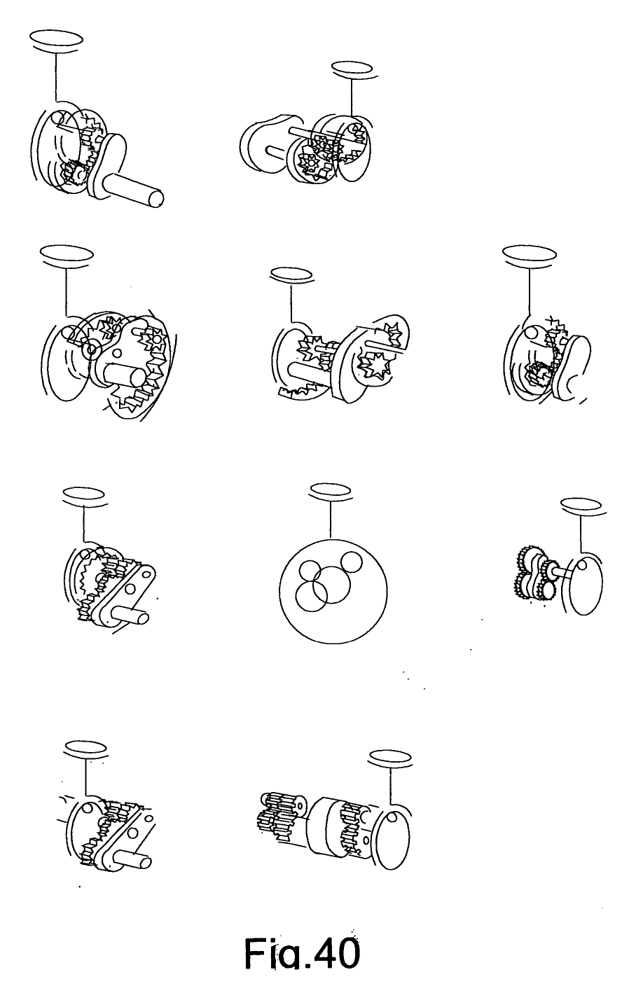

FIG. 39 shows that all the previously commented supports, more specifically here, under their retro mechanical forms, can in addition be applied to piston engines, which demonstrates well that the mechanico inductive nature of these machines answer to the general definition given during the introduction. These applications show as clearly that the usual fabrication methods of these machines are simply happy and generalized since the equal push on the piston allows control methods for the position and orientation which allows phi, exceptionally of mechanical support methods, which doesn't restrict anything however their structure deepens in this sense. The rod ligature method, although generalized on their realization level isn't any less exceptional from their conceptual point of view, and would have mask the reality to effect that, as the paddle machines, the piston machines are mechanico inductive machines. As we have repeated, although all the methods are applicable, we show at this figure, for concision preoccupations, but four methods, in a) by hoop gear, in b), by semi transmission, in c) by post active gear. We'll note that in all these figures, the piston support eccentric can be replaced by a rod, connected to the pistons.

In a), the crankshaft 320 receives in a rotary manner the hoop gear 321, this gear being coupled in its lower part to the support gear 322, set up rigidly inside the machine. On the crankshaft's crankpin 323, there's an eccentric set up in a rotary manner 324, provided with an induction gear 325, in such a manner so that this induction gear is coupled to the superior part 326 of the hoop gear.

The correct gear calibration and the side of the eccentric of radius equal to the distance separating the gear centers assure a purely rectilinear trajectory of the eccentric 327, or of the crankpin, and will thus correctly support the pistons 328 without rods or even free rods.

FIG. 39b) shows the application of the method by semi transmission. In this method, an eccentric 329 is set up in a rotary manner in the machine and is provided with a semi transmission gear 331. A second eccentric 330, double the size is set up on the first and is provided with an induction gear 332. A dynamic support gear 333 is coupled to it and is by means of an axe 334 provided with a semi transmission gear 335. The two semi transmission gears being indirectly coupled by resorting to an inversion gear 336, set up in a rotary manner inside the machine. The pistons are connected directly or by rod to the superior eccentric 337 which realizes a perfectly rectilinear movement.

FIG. 39c) shows the realization of a rectilinear engine from the method said by intermediate gear.

In this method, the crankshaft 340 is set up in a rotary manner inside the machine and on its crankpin, there's an eccentric 341 is set up in a rotary manner and is provided with an induction gear 342. The support gears 343 and the induction gear 342 are coupled by means of a third gear, being the intermediate gear 344. The pistons are directly, or by means of fixed rods connected to the induction eccentric 341.

FIG. 39d) shows the support method said by central most active gear. In this method, a first eccentric 350, provided with a crankpin is set up in a rotary manner inside the machine, and is provided with an axe finished by a semi transmission gear. A post active centered gear is set up on an axe crossing that of the main eccentric, and is provided as well with a semi transmission gear. The two semi transmission gears are coupled by linking accelerator gears 355.

On the crankshaft's crankpin 356 is then set up in a rotary manner an induction eccentric 357, which is provided with an induction gear 358 coupled to a dynamic, post active support gear.

The piston 359 will thus be coupled directly or by means of a fixed rod to the induction eccentric which realizes a perfectly rectilinear alternative.

We can deduce from the previous explanations that the piston machines are also mechanical induction machines and that consequentially, of all other support methods of the mechanical corpus previously exposed will be correctly applicable in such a manner to realize a support for mechanical pistonnated parts. In all cases, it'll suffice that, as we have shown, the paddle be replaced by an eccentric or even by a secondary crankshaft, which is provided with a crankpin, these two last pieces receiving in a fixed way the induction gears, and consequentially being motivated not only positionally, but also orientationally by the mechanical group.

The pistons 359 will thus be directly coupled or by means of a fixed rod to the induction eccentric.

FIG. 40 shows the application of the other methods, which allows to generalize this machine. Here, we have installed on each mechanic rods in place of gears. The extremity of each of these will traverse an alternative, rectilinear course which allows a total control of the position of the piston.

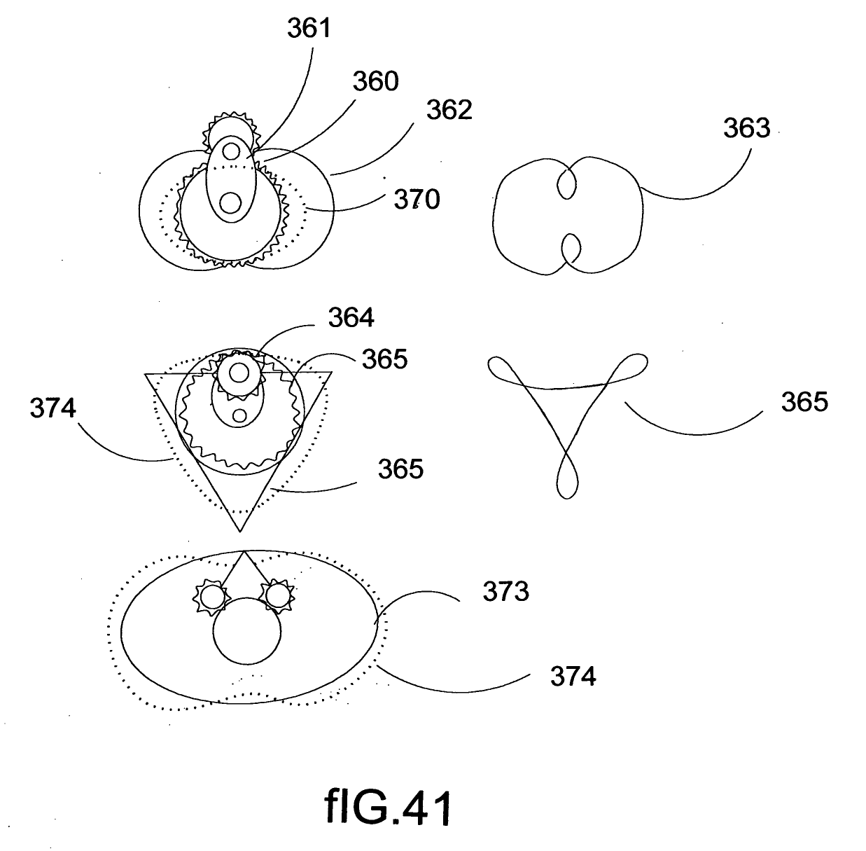

FIG. 41 shows the main differences of the three types of geometries being realized with mechanical inductions previously presented, and corrections to be brought. By using the planetary gear mechanic, post or retro rotary, we grasp the figure types better. In a) we suppose a precise point 360 took on a planetary gear 361, of one half of the size of the support gear. The rotation of the planetary gear will realize the rounded double arc course 362. A one to three gear ratio will lead the form into triple arcs, and so forth. The realized forms are said to be post rotary. We'll observe an increase in the radius of rotation of the point's course will produce an increase in rounding 363 of the basic shape.

In b), the planetary gear 364 is one third of the size of the support gear 365 which is of internal type this time around. The realized shape is said to be of retro rotary geometry. We'll note that an increase of the distance between the point of rotation and its center 366 will produce an increase of the flattening of the triangular shape realized 365b).

In c) we see the course realized by a point connected to two planetaries turning in opposite direction, the form realized being bi rotary. We'll return to this subject later on, but lets enounce now that the bi rotary forms are also those which mechanically, allow geometrically the oscillatory movement realization, which we'll comment in detail during our statements relative to poly turbines.

For the moment, we'll note more precisely that when these figures represent paddle machine cylinders, they appear non-ideal and must be corrected to respect the optimal compression ratio of internal combustion machines.

Relatively to post rotary machines, the rounding is too ample and realizes a compression rate which is much too important. This is why it is an art to cut off a certain quantity of material on the paddle surface to deaden this compression excess. The following matters will have for object to show that a compression reduction by a cylinder transformation will allow, to not only obtain corrective results relatively to this element, but also, in reason of the new support mechanics elaborated, simultaneously increase the machine coupling. We'll thus aim to realize compression drops by realizing cylinders which the amplitude of its width will be reduced 370.

Contrarily, in what concerns retro rotary figures, we'll need to give them amplitude by reducing the corners of the figures which are their own 371 and by increasing the rounding of the sides 372.

As well as for bi rotary machines, particularly the poly turbine, we'll need to give them a post rotation, if we want to express ourselves in this manner, and to enlarge the amplitude 373 and to reduce the height 374.

We'll need to imagine the form corrections and their basic mechanics to allow the realization of new cylinders.

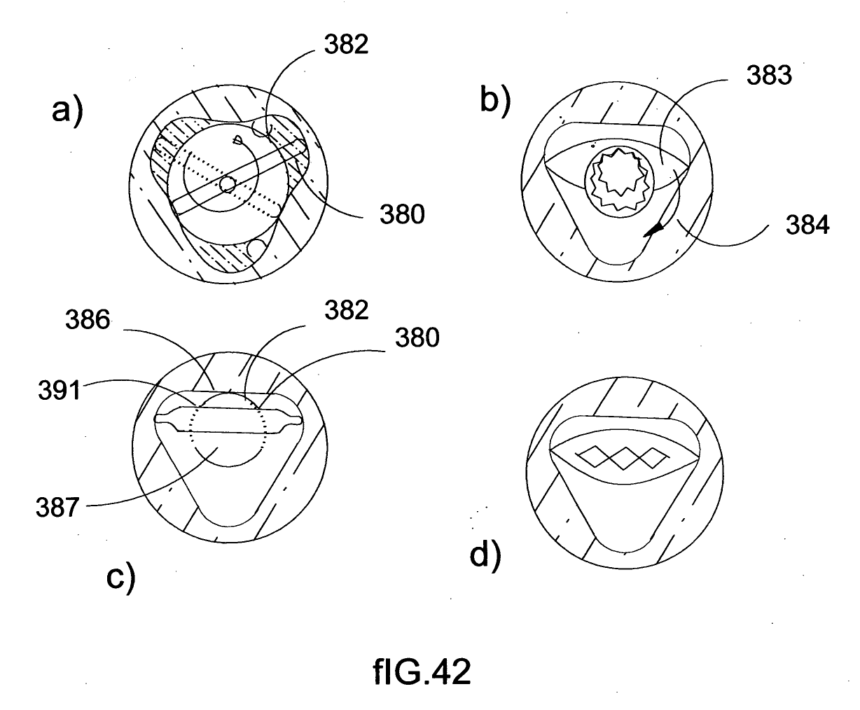

FIG. 42 shows that the runner is not only a correctional, first level ligature method, but it can also be used to a second level. In fact, we have shown in our first figures that a running paddle 380 can be installed in a rotor 382, of a motor machine in a). In b), we see a realization of the previous figure, this time set up by mono induction and allowing to the center of the paddle's rotation 383 this time on itself, realizing itself on an off centered, yet circular, course 384. In c), we see that the rotor itself 386 is itself eccentrically 387 and rotarily set up. The running displacement of the paddle 388 will absorb the modification of the imperfect base form, by shortening the corners and rounding the sides. The compression will thus be higher during the explosion 391.

We'll note that this type of realization reiterates the fault of the first, although this time on a second level since the cylinder eccentrics complete the mechanical action and is necessary to the paddle movement.

We'll note that all the previously exposed realizations allow the production of an rectilinear alternative movement, can be used in a layered manner to control the alternative aspect of the paddle displacement.

In d) the lateral displacement of the paddle during these positional and orientational rotations is produced with the use of rods.

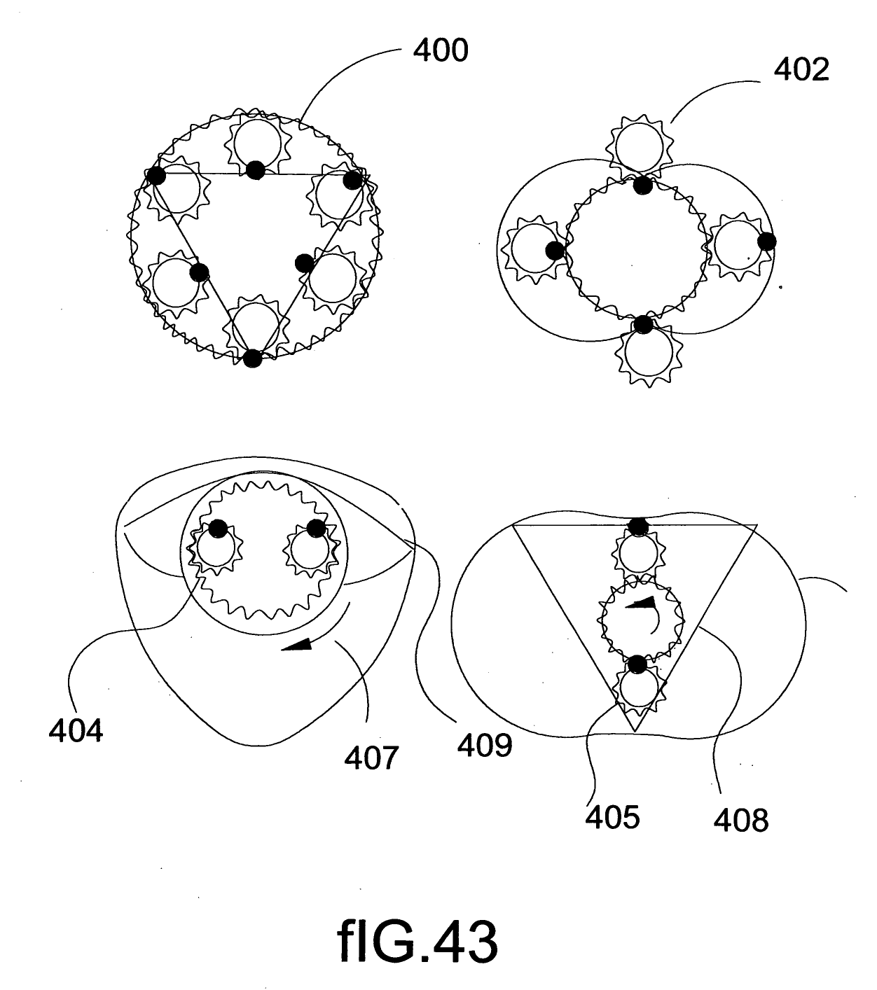

FIG. 43 shows how to correct the forms by use of the dynamic support gear. We know that in the two limit cases, when set up in a post and retro rotary poly inductive manner, we realize triangular engines in a)Wankle geometry and in b) in a standard manner, with gears at a one to three ratio 400 with an internal support gear for the boomerang engine, and with gears at a one to two ratio 402 with an external support gear 403 for the Wankle geometry engine.

Ideally to increase the compression of Boomerang engines and to diminish that of post rotary Wankle geometry engines, we'll need to round off the cylinders of one and to attenuate the width of the other.

To do this, we'll falsify the dimensional relation of the gears. We'll use, for example, for triangular engines a ratio of one on four 404, and the ratio of that of Wankle engines, established, for example, at on to one 405. To compensate for these changes, we'll activate post actively the support gear 407 of the triangular engine, and we'll activate retro actively that of the post rotary engines 408. We'll thus conserve, in lack of modification of gear size ratio, the same number of incidences of one on the others, and consequentially the same number of revolutions per rotation of the planetary gears.

The number of induction gear revolutions and consequentially that of the paddles will be identical, and this independently of their distance in a) or of their closeness to the center in b).

The obtained cylinder form will thus be less inserted into the corners 409, for triangular engines, and weaker in the rounding of post rotary machines.

The post action or retro action of the support gear commented, could be obtained from small accelerative semi transmissions or inversive already commented, or by another means. We'll note that the corrected retro rotary engine takes, so to speak, a certain post rotary connotation, whereas the post rotary engine, for its part, conversely a retro rotary connotation. We'll note in addition that the motorization exits could be produced by use of accelerative or inversive gear axes, which will allow it to realize both post and retro rotary forces.

FIG. 44 shows a correction method of the figures which will be said by hoop gear 420, by intermediate gear 423, or by intermediate hoop gear 425. We have already commented these methods, as paddle or piston support methods. The current figure rather has for object to show the versatility of these methods, which can also be used to modify the original geometric relations of the figures. In fact, these methods are much freer on the geometric level than the basic mono induction and poly induction, since they can, so to speak, bring closer or further the planetary gears without modifying their rotation ratio. A same figure, needing for example two complete planetary rotations per turn, as for example, the poly inductive mechanics necessary to wankle geometry engines, could, with the help of planetaries controlled by hoop gears be constructed with planetaries closer to the center, without as much as to modify the number of revolutions per turn and consequentially the number of sides or arcs in the cylinder.

With these methods, it is in fact possible to falsify voluntarily the distance ratios between the gears without falsifying the turning ratio. A second example of these qualities will be that which allows the contrary, to elongate the width of the cylinder of a poly turbine type of machine, here with the help of an intermediate hoop gear.

FIG. 44 shows that we can realize similar modifications of distances from the intermediate or even intermediate hoop gears. As the case with the hoop gear corrections, we can note that the change in size of the intermediate gear will not incident on the support and induction gear ratio, but however, they'll modify the geometric relations of figures realized by the paddles.

In a), the intermediate gear is reduced 423.

FIG. 45 shows a third method of form correction which we'll say is by geometric addition, or by geometric rod. This method is particularly useful since it allows for example to transform the retro rotary movement of a planetary gear in a)430, which when brought to its limit, in other words, on the circumference of the gear itself, realized, as we have already commented, a perfect rectilinear 431.

In c), the geometric addition allows to pass from the retro rotary form 432 to the bi rotary form 443.

In fact, we'll state that the geometric addition realized on a mono inductive retro rotary mechanic produces exactly the same form of that realized by a mechanic in opposite double inductions, which we have said, bi rotary, or bi inductive 433. We'll show more specifically further how we'll be able to generalize this type of correction to all basic mechanics to support poly turbine type machines.

FIG. 46 shows schematically that one of the most mechanical ways to realize changes of cylinder form consists of layering the mechanical inductions. In these types of corrections, we'll introduce changes of the positional movement of the paddle for a rotation, and this while conserving its intact orientational aspect.

Here in a), we suppose the realization of a Boomerang machine, which the movement govern of the paddle center will be realized by a planetary retro induction of triangular type.

In b1) and b2), we imagine on the obtained movement 450,451 a second, smaller circular action 452,453 in extent and here, in opposite direction.

We can state that this correction corrects the basic form and renders is much more appropriate 454,455.

FIG. 47 shows another way to understand the corrections to be brought. We know that in the triangular engine, we need to increase the compression whereas in the rotary engine, we need to diminish it.

The way to realize these objectives will be to renounce to realize a positional course of the paddle center which will be circular. In the case of the triangular engine, the central course could be in tri-points 460 whereas in the post rotary engine, it could be oval and vertical 461.

We can resume the two current figures by saying that we can effectuate an additional superposed correction mechanic of the initial form, or even that we can correct the form of its central evolution which, sums everything, will be realized in the same type of superposed mechanics.

FIG. 48.1 and the following show the rule of which we can layer two types of support methods in such a manner as to synchronize the positional and orientational control of the paddles allowing the realization of the researched forms.

It is very important to note that all support method of compressive parts already commented by ourselves, comprised within the mechanical corpus of motor machines, either by mono induction, poly induction, by hoop, intermediate gears, and so forth, can be used in combination with all method of this same corpus to realize the machine. In these combination methods, one will be produced to control the specific positional course of the machine and the other to realize its orientational course.

In fact, a machine could thus be produced in positional control from a mono induction and produces an orientational control by,hoop gear. In another manner, another machine could use a first level positional control by hoop gear, and a second, for orientational control, by mono induction.

We thus realize that the possibilities of mechanical variants are of approximately four hundred for a single machine, since each corpus method can be combined to another to produce a positional and orientational control of the paddle. We'll comment but two combinatory possibilities here. We'll find many other combination possibilities in our two patent applications to this matter, serving as priority to the current which we'll annex the figures at the end of the present one.

In the current figure, we've modified the exterior course of the paddle by modifying the central course of it. To do this, we have used two mono inductions, one retro rotary, and the other post rotary. In fact, we've set up in a rotary manner, inside the machine, a crankshaft 800. On it's crankpin we have set up, also rotarily, an eccentric 801, provided with a positional induction gear 802. This gear is coupled to an internal type support gear 804. This set forms the first induction, that which will result in the triangular movement 805 of the positional eccentric.

The second induction, this time of post rotary type, will be constituted of the following elements. On the crankshaft will be fixed rigidly, at the crankpin's height, an internal type gear, which we'll name orientational, or layered, support 806. On the paddle will be set up rigidly the orientational, or layered, induction gear 807, here of internal type and which will be coupled to the orientational support gear.

This second set will assure the retro rotation of the paddle during the realization of it's triangular course, which will produce the desired form.

FIG. 48.2 shows that in a), that we produce a Wankle geometry engine with a less large cylinder, and with a realization similar to the previous, rendering however the central course of the eccentric elliptical 805b).

FIG. 48.3 shows two other method combination possibilities. Here we have produced the wankle type geometry machine, this time with an improved cylinder curve, resorting to, on the positional level, to the method said by hoop gear a1), and on the orientational level, the method by mono induction a2).

In 48.3b), the two combined method are rather, on the first level, in b1) the method by mono induction, and in b2), that by poly induction.

FIG. 48.4 shows that the mechanics can also be realized in an inversed manner. We could for example realize, at the layered induction level, a retro rotary induction. In this case, we'll set up on the paddle an external orientational induction gear 810, and on the crankshaft, an internal support gear 811, which the center will be equivalent to that of the crankpin.

FIG. 49 shows that during the use of an internal orientational induction gear, the paddle gear 813 can be controlled by a linking gear 814 itself activated by one or the other induction methods, here by retro rotary mono induction, which the linking gears are 814b) and of support 815.

FIG. 50.1 shows the case of paddle control in combination, in which the layered induction support gear would be set up rigidly in the side of the machine. In this case, either the induction gear, either the support gear would be irregular, which we'll name polycammed gear. Here, it is the orientational support 900 which will be irregular. In fact, it'll remain coupled to the paddle's induction gear 901, in lack of its irregular source. This is what we'll call the method by semi polycammed layer.

FIG. 50.2 shows the hypothesis where the deformation is rather carried on the paddle gear 909, whereas the support gear is regular. In fact, the paddle gear, irregular here, will remain coupled to the paddle gear, even if the center of it has an elliptical displacement.

FIG. 50.3 shows a transverse section of these gear ratios. We see that the round gears 911 remain coupled to irregular gears 912, which the courses are also irregular.

FIG. 51.1 shows the paddle movement corrections and of cylinder form brough with a single induction level, and by also using irregular gears. In these cases, these irregular gears will be coupled to other irregular gears which will allow us to realize the coupling in a permanent manner, in spite of these irregularities. Here, the gear couplings are realized for a triangular type of machine.

FIG. 51.2 shows the opposite gear ratios to that of the previous figure, applied to a Wankle geometry engine.

FIG. 52 and the follow give more ample explanations allowing us to understand the incidence and the application possibilities of eccentric and polycammed gears. We show in a), the regular and irregular gear ratios, either eccentric or polycammed. In b), c), d), we show the irregular gear ratio between themselves, having fixed rotation axes.

FIG. 53 shows the eccentric or polycammed gear relations shown in a planetary manner, and notably that the center of the eccentric's rotation remains always of equal distance of the center of the support gear 920.

FIG. 54 shows other equidistance parameters which produce these planetary gears. Firstly, their center is always the same distance away from the surface of the support gear 930. We can deduce from this statement that the figure real from the centers is the figural reproduction of the polycammed support gear 931.

FIG. 55 shows the incidence of the use of this type of gear used during a method by mono induction, applied to Wankle geometry machines in a), and Boomerang geometry machines in b).

FIG. 56 shows the application of this type of gear to differential semi turbines, which allows us'to cut off the interstice or ligature means. According to the rule of invariability of the rotation points of planetaries in the center of support gears, we can now cut off these paddles at these points 940, without need to add rods, runners or other ligature means.

FIG. 57 shows the rules of equidistance of the center of the planetary gears to the successive planetary gears 941.

FIG. 58 shows the possible support and ease of the paddles 942 which the course is complex with the aid of such gears.

FIG. 59 shows three examples which prove that the use of eccentric and polycammed gears can be used in all location where we could normally use a standard gear. In a), we find a method by semi transmission used in a polycammed manner. Here, the dynamic 950 and inductive 951 support gears have been polycammed. In b), we have produced a method by polycammed hoop gears, in which the hoop gear 952 and support gear 953 and in c), a method by intermediate polycammed gears, in which the intermediate gear 944 and the induction gear 955 have been polycammed.

FIG. 60 shows a polyturbine realized by mono induction 959 corrected by geometric addition 960 in a), and then by hoop gear 961 added with geometric rods 960 in b), then by intermediate gear 962 added of geometric rods 960c). We can thus deduce the same conclusions for poly turbines as for all machines. In fact, all the other methods of the corpus would thus be adequate, with the addition of geometric rod to support the parts of the paddle structure or even of the paddle structure used as meta turbine support structure.

FIG. 61 shows that if we follow the displacement of the piston in a rotor cylinder machine, we'll state that the piston pursues the exact course of the extremities of the support placements of paddle structures of poly turbines. In fact, in a, we can see that the course of the pistons, when their support axe is invariable, is circular. However, if this axe turns in opposite direction of the paddle, with a one to one ratio, the course of the pistons will be elliptical such as in b). By alternating the relations, we'll obtain a semi triangular sinusoidal course, such as in c). It emanates from this important statement that not only this machine can be produced with all mechanicsation methods comprised within the corpus, with a geometric correction, which gives us more than four hundred support methods for this machine, but also that all the methods comprised within the corpus can simply add a geometric rod to thus allow the support of the pistons without free rods.

The figure shows thus that we can consider to just title the rotor cylinder machine, already under Canadian patent with a fixed axe, as a mechanico inductive machine, in the measure where we consider the action inferior of the rod, not as attached to a fixed point, but rather motivated my a ligature means, which the methods by mechanical induction. We can at this point conceive retro rotary or post rotary mechanics, with the help of semi transmission, will activate the crankshaft in opposite or same direction, but at accelerated rotor speed. The first and second series of figures a) and b) show in I these cases, the rotor and crankshaft displacement in opposite direction or in accelerated post rotation.

In c), we can observe that the piston displacement is elliptical 504 which has as consequence that we can consider the machine as bi rotary, and thus, realize a set of mechanics, and especially, allow the piston support by mechanics identical to that of poly turbines and consequentially without rods.

In this case, the mechanization shows that this type of machine is, if we intend to make the rotor turn in a regular way, bi rotarily, thus of the same type as paddle structured poly turbines. In fact, if we observe attentively the displacement of the piston, we notice that they follow an elliptical trajectory, identical to that of the points of the paddles of poly turbine paddle structures.

FIG. 62 in a), a construction, since this, as we have seen, is of bi rotary nature, a bi mechanical construction of the machine.

In b), the machine is constructed with each piston supported by a retro rotary mechanic, provided with a geometric rod 514.

In c), we show that in the case where we would want to realize the machine with a post rotary mono induction, we must first polycam it 515 to obtain a correct governing of the piston without a rod.

In d), we show that if we want to proceed to the use of a standard post rotary mechanic, we'll need to polycam the rotary action of the rotor 516 in a manner to render it irregular, we could without geometric addition, or polycammation of the support structure, realize the machine without any rod, whether by post or retro induction.

FIG. 63.1 shows that we could realize the machine with a rotor cylinder, here, in a manner to ease its comprehension, with a single piston, set up in a running manner inside the cylinder of a rotor cylinder, and that the action of this piston be submitted to mechanical inductions such as disclosed above, which allows to confirm the belonging of this variant to the general machine described at the beginning of this disclosure.

FIG. 63.2 is a three dimensional view of these mechanizations.

In a), we find the piston governed by retro rotary mono induction, added with a geometric rod. In b) we find the piston activated by a hoop gear mechanic, added with a geometric rod. In c) we find an intermediate gear mechanic added with a geometric rod. All these mechanics could thus be used by adding to them certain corrections, here, for example with the geometric rod.

FIG. 64 shows the meta turbine as being a third degree machine, this machine being realized by three layered mono inductions, or even a corrected mono induction with two recoveries. In c), we see that the two corrections carried out simultaneously realize a machine with a superior complexity level, being of third level, producing irregular cylinders. This is the case with meta turbines. Here in fact, the machine is realized by retro rotary mono induction 1000, added with geometric rods 1001, and corrected by polycammed gears 1002.

We can say that all method allowing the realization of poly turbines, could constitute the first two levels of meta turbine realization, upon which we 'll carry out another correction. We thus have more than a thousand mechanical support possibilities.

As for piston machines, retro rotary, post rotary, rotor cylinder machines, poly turbines, and meta turbines could thus have their compressive parts motivated by all mechanics indexed in the present corpus, and are thus, for this reason an integral part of machines extended to the general definition given above.

FIG. 65 shows that we can un-axe intentionally the natural machine courses, as for example by rectilinear rod in a, and by elliptical course in b), or post and retro rotary in c, to then recorrect them by some means, such as runners, free rods, or preferably, polycammed gears. This final correction will allow to domesticate the speed variability of the compressive parts, which will be a major advantage in certain situations.

FIG. 66 shows that if we intend on directing the piston of a machine as much positionally as orienationally, we must use mechanics of a superior degree. Here, to do this, we support the doubled piston in a) and double crossed in b, which shows the realistic complexity, when we want to direct totally, positionally and orientaionally, the pison.

FIG. 67 shows that all machine can be made standardly, can also have its central compressive parts, and its mechanics in periphery. As the previous, all these machines can be produced with the mechanical corpus indexed and are consequential part of variants of the current general machine. We thus have in a) a central explosion machine in its simplest version, such as demonstrated in our Canadian patent to this effect. In b), we suppose this configuration created by post rotary poly induction, in c), by retro rotary poly induction. In d), in its paddle structure rotary version, which illustrates the rule according to which what is made of a standard manner, comprises what is made peripherally, and what it made in the center.

FIG. 68 shows the cylinder machine with transversal mono piston, named Slinky rotor cylinder machine in a).

In this machine, a rotor 520 provided with a transversal cylinder 521 is set up rotarily 522 in the machine's cylinder. A piston 523 is set up in a running manner in the cylinder and will have, during to rotation of the rotor, a rectilinear alternative acton 524a) depending on the number of return trips of the piston, here for example, three, we'll see that the real resulting shape of course of the piston will be quasi triangular 524b), belonging to that realized by a retro rotary mono inductive mechanic.

There are two main ways of realizing this movement. We can firstly realize an alternative rectilinear secondary movement, subordinated to the rotary movement of the rotor. We'll note that we can also realize machines by treating interiorly the rectilinear alternative movement of the piston, for example by a mini mono inductive mechanic, rectilinear in course of rotation, the secondary crankshaft in this manner could for example, retro activate by hoop gear 531. We'll note that in this case, all the rectilinear mechanics realizations of the mechanical corpus exposed before hand could be used in layeres and thus allows us to adequately realize the machine, and the cylinder forms when it is necessary. In this case, we could realize the rectilinear alternative movement by all the previously demonstrated means, and synchronize this movement, by means such as gears with the rotation of the rotor cylinder.

A second way will be to produce an exterior induction, exactly producing the desired movement with a single induction.

To do this, we must beforehand however notice that the induction's course must pass by the machine's center. We must thus add to the retro rotary mono inductive mechanic a geometric rod 526 to realize this aspect of its course. In addition, we'll notice that the addition of this rod forces the enlargement of the obtained petal shape 257, at the top of the course. We must thus aim for the thinning of this superior rounding to allow the adequacy of the piston movement and that of the rotor. We'll thus need to produce the mono induction with polycammed gears which will slow down the speed of the mechanics in these parts in such a manner so they become adequate, in its width at the rotation of the rotor.

In another manner, we could contrarily accelerate and slow alternatively the action of the rotor 528 to hold in account this geometry. In this case, it's rather the speed of the rotor's rotation which we'll need to make irregular, in c). We'll thus need to realize its movement with a mechanical induction, fabricated with eccentric and polycammed gears.

Wee thus see that these types of machines, of very simple belonging, are in fact third degree machines, in other words, needing a first induction and to levels of corrections afterwards.

FIG. 69.1 shows standard or differential peripheral piston machines. The figure poses the hypothesis of a rotor machine geometry in which the cylinders would be set up horizontally rather than vertically. The following matters will show that it is also the case in machines for which the previously exposed mechanical corpus can be applied adequately, and for this reason, this type of machine must be considered integral part of the general definition relative to basic motor machines.

In this type of machine, the rotor cylinder 540 is set up rotarliy in the main cylinder of the machine, and is provided with cylinders horizontally set up 541 which the number is variable. Pistons 542 are introduced in these cylinders 541 and will have in course of rotation of the rotor an alternative rectilinear action. We can connect these pistons by diverse ligature means exposed, free rods 544, runners, mono inductions 543 set up in a planetary manner. However, we can also study more attentively the alternative piston movement in course of the rotor cylinder's rotation and observe the phenomenon that the pistons produce a form which reminds of that of the paddle points of retro rotary figures. We can realize that the action of the pistons can, as in all machines described, be introduced by the diverse means consisting of the mechanical corpus of general motor machines. In fact, we could state that we can proceed to a direct piston support by retro mechanical mono induction 557, as for example here, a mono induction realizing a triangular form As before, we could synchronize the movement of the rotor with the aid of eccentric and polycammed gears if it is necessary.

In another manner, we could, if we desire a more characterized action of the piston, add to the mono induction, to a first degree induction added with a geometric rod 556, and afterwards, of a certain manner, an anti correction by polycammed gear, which will guarantee the amplitude of the piston movement but also it's correct triangular FIG. 563.

FIG. 69.2 shows that the number of cylinders and pistons is variable here, as well as the number of alternative movements for each rotation of each, which could result in a more square like course, or octagonal, and so forth

In all these cases, the piston passes alternatively to the center of the cylinder 558, and then at its extremities 559.

We'll note that the machine can be realized conventionally, in other words pushed on the compressive parts in support on the cylinder, 564, we could thus realize the power in a differential manner, using the power developed by a posterior piston, in differential support on the anterior piston 565.

FIG. 70 shows that we can generalize the use of polycammed gears for example to differential semi turbines, which will allow to change the initial ligature means of the paddle to the eccentric which was initially by runner.

In fact, here we use an eccentric polycammed gear to realize the paddle support and this with result that we could cut off ligature means of the machine and realize it with paddles directly coupled to the crankpins of the induction gears. These possibilities are issued from the report that we make turn the eccentric gears 570, or polycammed, in a planetary manner, a support gear 571, external or internal also polycammed, 572, the distance connecting the center of the support gear, or even of the support crankshafts, and the eccentric center of rotation of the induction gear 575 is invariable.

The eccentric deformities have an accelerative incidence 576 decelerative 577, on the eccentrics at the same time as decelerative 578 accelerative on the crankshaft 579.

Consequentially, these crankshafts can be replaced by paddles 580 which will go through accelerations and decelerations complementary to one another which will produce their distance fluctuation and by consequence, the compression and expansion of the gasses between them.

FIG. 71 shows that we could produce in a geometrically inversed manner the compressive parts of differential semi turbines, or their common appellation of anti turbines. In this version, the paddles 590, are rather all attached in an oscillatory manner 591, by their exterior part in a rotor 592, set up rotarily inside the machine.

Induction means, such as those previously enounced, in the general mechanical corpus of the current work, support each of the interior paddle extremities 593 in course of rotation. This movement will cause folding 594 and the alternative rectification of the paddle 595, which will cause alternatively the bringing together 596 and taking away 596 between themselves, creating gas compressions and expansions.

FIG. 72 proposes a type of differential semi turbine in which the action of the paddles wouldn't be circular, but rather of a figure similar to retro and post rotary machines. We suppose in fact an irregular exterior cylinder surface 610. Many successive paddles 611 which the action would be similar to that of paddle machine paddles, and which consequentially would be supported by methods and means such as those exposed in the mechanical corpus, will act by taking away 612 and bringing together between them, and will produce a differential action.

FIG. 73 shows that the compressive parts of machines, consisting a rotor cylinder, will not necessarily be pistons. They can also be paddles. In addition, we show once again, what can be made in the center, and what can be made peripherally. In fact, in this figure, we suppose a rotor cylinder 620 set up rotarily in the machine, this rotor being provided with many cylinders of paddle machine type cylinders 621. A retro rotary paddle 622 is set up in each cylinder and is motivated in a layered manner by one or many ways enounced in the mechanical corpus of support methods previously disclosed.

FIG. 74 shows that we can also, by combining techniques, realize piston-piston machines. Two pistons are in fact set up in successive and communicating chambers 650, but with a same support means 652. The lifting of the rear piston 653 compensates the start of the decent of the front piston 654, and consequentially the compression is kept maximal up to the simultaneous decent of both pistons.

A common explosion chamber 655 will allow the explosion to, especially on the exterior piston, break 656 the high dead time of the front piston. In b), the combination is done with two piston parts assembled.

FIG. 75 shows that we can also build machines in combination, which represents, since the compressive parts will be supported by the same mechanics comprising the mechanical corpus of the current work. In figure a), we've assimilated the rotary paddle 630 of a machine post in a) and retro rotary 631 to the rotor cylinder of the previous machines an we have provided this element that we have named paddle cylinder 632.

In both these machines, here shown post rotarily mono inductively 633 and retro rotarily mono inductively 634, we have extruded the original eccentric 635, by keeping on each side an eccentric part 636, each of these parts being connected to the other by intermediate of a crankpin. We know that the eccentrics of post rotary machines, turn three times faster than the paddles 638, whereas eccentrics of retro rotary machines turn in opposite direction of their own paddles 639.

We can thus set up in the paddle cylinders pistons 640, ligatured by some means, such as a rod, to the eccentrics'crankpins. The differential actions of the paddles and crankpins will produce the alternative rectilinear actions of the pistons in their respective cylinder, during the rotation of the said cylinders.

We'll thus produce an increase and diminishing of compression depending on the positioning of the crankpins.

We could for example set up the crankpins in such a manner so that the top of the ascent of the pistons be in advance or retarded on that of the paddle, and consequentially, produces a compensation of pressure of one of the parts during the start of the other, annihilating the dead time of one of the parts, without loss of compression during its start of descent.

FIG. 76 shows that the differential semi turbines and the meta turbines can also give binder to generations of paddles and cylinders. As for semi turbines, in a) the paddle number is variable.

As for meta turbines, the cylinders can be generated, always by keeping a rectangular aspect, giving space for alterations in the domain of the length of the sides. Their cylinders are characterized by an irregular cylinder of rectangular form 660, rectangulo-triangaloid 661, and rectangulo-squaroid 662, etc

FIG. 77.1 shows an example of pure hybrid machine said as balloon cylinder 670. As before, although of trivial belonging, the machines require third level mechanics.

We could simple use a positional mechanic of oval course 671 and leave the surface of the cylinder, as in a piston machine, effectuate the orientational work of the piston displacement. The advantage of these machines will be the possibility to set up the spark plug in the side which would allow an explosion outside of the mechanical dead time.

FIG. 77.2 shows that we can also combine rotor piston machines and semi turbines.

FIG. 78.1 shows a machine classification depending on their degrees. We find here rectilinear rod machines in a), oblique rectilinear rod machines in b), post rotary machines in c) (additional to Wankle machines with mono induction triangular paddles) the post rotary machine with elliptical course in d), the polycammed post rotary engine in e), the triangular engine in f), the second level triangular engine in g), the triangular polycammed engine in h), the corrected retro rotary poly turbine in i), the bi rotary poly turbine in j), the third level poly turbine in k) and the meta turbine in l).

FIG. 78.2 follows the main forms of machines in m), with the simple rotor cylinder machine in n), the retro rotary poly induction rotor cylinder machine in p), the rotor cylinder machine in q), the polycammed post rotary poly induction r), the differential semi turbine runner q), the differential polycammed semi turbine in r), the Slinky engine in s), the anti turbine in t), and the central explosion engine in u).

FIG. 79 shows diverse compression modes, by push in a), by traction in b), differential in c).

FIG. 80 shows gears named overlapped gears. As we have noticed, we base our conception of engines on the idea that with a single paddle and a cylinder, we can replace an important enough number of pistons and individual cylinders. The price to pay for these economies of parts consists generally in a number restrained enough of gears constituting the mechanical parts of the machines. As the pushes on the paddles and paddle structures are, as we have already mentioned more unequal than the pushes of piston machines, the orientational effort on the mechanical parts is generally larger, and this more in other areas it is demultiplied under the form of a lever. This is why we have conceived the type of gears said overlapped gears. The overlapped gears are either gears, either an assembly method of gears which consists of assembling in a fixed manner, two or more gears, in such a manner so that the teeth 1010 of one correspond to the hollows of the other 1011 and so forth This association will allow the realization of gears in whish the dentification of each of the gears constituting the overlapped gear will be large and powerful 1012, but which the group of teeth will form a fine definition gear 1013, which will assure the precision in the same way that if it was a micro gear 1014.

FIG. 81 shows that we can indirectly yet rigidly couple the compressive parts of the motor parts 980, and produce between these parts a circular isolation plaque 981 of these parts which could serve as a valve 982.

FIG. 82, shows that we can decompose and divide the repartition of the movement, when it possesses many degrees. We can for example imagine that the cylinder of a post rotary machine, or retro rotary will be rotary 983, whereas the movement of its paddle will be rectilinear 984, the sum of these movements are equivalent to the initial movement produced by the paddle. This version allows notably to serve of the cylinder face to realize an electric part to the engine.

FIG. 83 shows, starting from the observations of the previous figure, that we can even combine post and retro rotary machines in such a manner so that one be the pump of the other, which would be motor.

FIG. 84 shows that the paddles could also be drawn in such a manner as to realize hydraulic machines.

FIG. 85 are all reproductions of our patent application, in priority here, which give other realization possibilities of machines by method combination.

FIG. 85.1 show a combination of retro rotary mono induction of first degree and a layered method by poly induction of second degree.

FIG. 85.2 shows a method by mono induction of first level and by paddle hoop gear of level two.

FIG. 85.3 shows a retro rotary mono induction of first level and of the same type of retro rotation of second level.

FIG. 85.4 shows a method by post rotary mono induction of first level and retro rotary of second level.

FIG. 85.5 shows a method by hoop gear of first level and post rotary of second level

FIG. 85.6 shows a method by hoop gear of first level and post rotary of second level.

FIG. 85.7 shows a mono induction added of geometric rods of first level and an induction by polycammed gear of second level

FIG. 85.8 shows two inductions by hoop gear.

FIG. 85.9.1 shows two layered induction which the non-polycammed support gear is for each of them in the side of the machine. We'll thus say that they're layered in juxtaposition. To do this, we'll use an internal paddle gear and we use linking gears to couple it to the support gear.

FIG. 85.9.2 shows a mechanic of first level of poly inductive type, and the second of mono inductive type.

FIG. 85.9.3 shows two layered poly inductive mechanics

FIG. 85.9.4 shows a mechanic by semi transmission combined to a mechanic by paddle hoop gear.

FIG. 85.9.5 shows two layered juxtaposed retro rotary mechanics

FIG. 85.9.6 shows two layered juxtaposed retro rotary mechanics

FIG. 85.9.7 shows two layered juxtaposed retro rotary mechanics

Here, the support gear is fixed firmly on the eccentric and of centered manner, which creates the same geometry that if it was, like in the other versions, centered with the crankpin.

FIG. 86 shows accelerative mechanics variations.

1.
A driving machine, for which the movement of the compressive parts is irregular and the one of the driving parts is circular and regular, this definition excluding the machines known in the prior art, such as the conventional piston engines, the orbital piston engines, mechanized in a standard way with a linking connecting rod, the post rotative engines, with paddles having three or four sides when they are mechanized in a mono inductive fashion.

1. A motor machine, that can be realize under different degrees of rotativity, which we'll say bi rotary motor machine, or rotary machine of second, or superior degree, this degree being assured by a composed movement of its compressive parts, by a composed movement of its mechanical inductive parts, by support insuring a positive push on the anterior and posterior parts, or both at once.

2. A machine such as the one defined in 1, when compressive figures remain standard, but the mechanics, bi inductive, by the following mechanics
By hoop gear, realized by internal gear or by chain
By post or retro rotary poly induction from the
By semi transmission of all support gear
By secondary mechanical combination by subtractive layering
By secondary mechanical combination by relocation of the center of rotation
By paddle hoop gear method—post rotary mono induction
retro rotary mono induction
by hoop gears
anterior hoop gears
posterior hoop gears
internal juxtaposed gears
internal superposed gears
posterior intermediate gears
intermediate hoop gears
central active gears
hoop paddle gears
gear like structures
by eccentric gears

3. A machine in which the bi rotarity is realized as the form of the cylinder obtained from a composed movement of the compressive parts, these compressive parts being thus supported to realize this form bi mechanically, either by a master induction in which the resulting trajectory is modified by one of the following modifications of the basic induction:
By free rod
By runner
By flexible rod
By dynamic oscillating cylinder
By secondary combinatory layered mechanical induction
By polycammed gears
By dynamization, by semi transmission of the support
By intermediate gear, hoop gear, or intermediate hoop gear
By addition of geometric rod
By mechanical combination
By eccentric and/or polycammed gears

4. A machine which the composed movement allows the realisation of one of the following composed movement machines:
Machines respecting the standard side rule, but with a rounded shape
Machines respecting the standard side rule, but with a rectancularised shape
Machines of the poly turbine type
Differential semi turbines
Slinky piston machines
Machines with planetary rotor cylinder and poly
Anti turbines
Meta turbines
Peripheral piston machines
Multi rotary peripheral machines

5. A machines in which one of the main or secondary inductions, before modification or composition is:
Post rotary mono induction
Retro rotary mono induction
Post rotary poly induction
Retro rotary poly induction
semi transmission
by hoop gear
anterior hoop gear
posterior hoop gear
internal juxtaposed gears
internal superposed gears
intermediate gears
intermediate posterior gear
intermediate hoop gear
spur gear
central active gear
pale hoop gear
gear structure
by eccentric gears
by centralo-peripheral support

6. A machine such as the one defined in 1 and 3, which at least one of the inductions main or secondary is of semi tranmsittive type, rendering its support gear dynamic.

7. A machine such as the one defined in 4, which the induction gear of the main mechanic is the dynamic support gear of the other induction.

8. A machines such as the one defined in 1, 4, 5, which one of the inductions has a peripheral dynamic and rotational induction support gear, or dynamic but fixed to the main crankshaft's crankpin.

9. A machine such as defined in 1, 4, 5 which one of the inductions has a central dynamic support gear

10. A machine in which the bi rotary, bi mechanical propensity is obtained by the birotary push on one paddle in clockwise movement, orientationally invariable when observed from the exterior, this machine receiving a dynamic redistribution, when the paddle's pure clockwise birotary movement is combined to that of a rotational cylinder, or itself planetary, regular, or accelero-decelerative.

11. A machine such as defined in 10, in witch the planetary or rotational speed of the cylinder est of one on its one number of sides, this process being complementary to the clokwise movement of the palled.

12. A machine, as defined in 5, in witch the circular rotations of the cylinder is the same of the inferior number composing the fraction of the rotational turning of the paddle for one turn of the crank shaft, when the machine is realized in a standard way.

13. A machine, as defined in 4, an 5, in witch the compressive parts are moving in a contrario way or motion or have an opposite movement.

14. A bi compressive and bi mechanical type of machine such as the one defined in 1, which the birotivity is realized by the action of the pistons inside the planetary cylinder, or in a cylinder-paddle, this action being conducted away from the two different centers of mechanical rotations of the paddle and piston rods.

15. A machine such as the one defined in 1 and 4 which the number of paddle sides is reunited in paddle structure and is of double of that of the cylinders, these machines being named poly turbines.

16. A machine such as the one defined in 1, e 4, which the motor parts, when observed from an exterior observer, are motivated simultaneously in the same direction and in the opposite direction of the motor parts, the motricity of the machine being assured by both at once, from where the bi mechanical name.

17. A machine such as the one defined in 1 and 4, which the sides of the cylinders are successively unequal and alternatively equal, these machines forming a generation of machines named meta turbines.

18. Un machine, such defined in I, this machine having a paddle on witch are fixed axes, these axes being mounted in an eccentric and an rotary way to gears that are mounted in a rotary way on a master gear that is disposed in the center of the machine.

19. A machine such as defined 1, comprising, in composition, many successive paddles, each paddle being supported by one of the method previously exposed.

20. A machine such as the one defined in 1, which the support method of the compressive parts is said by poly induction, and which all the inductions are in the sides of the paddles.

21. A machine, such as defined in I and 2, in witch, when the paddle is supported by the hoop gear method, the hoop gear is replaced by a chain.

22. A machine such as the one defined in 1 and 7, which the poly induction is realised in such a manner so that the master crankshaft is fixed, the paddle activated by the subsidiary crankshafts, and the rotary cylinder, allowing the support of compressive parts that have a positional turning without orientational motion, that movement being called clockwise movement of paddle.

23. A machine such as defined in one, called cylinder rotor machine, in witch the piston is realizing non successive compressions and expansion, and this, in an accelerative and decelerative way, this dynamic being called Slinky dynamic.

24. A machine in which the secondary induction controls the superior induction gear of the paddle hoop gear mechanic.

26. A machine, such as the one defined in 1 comprising a secondary induction in which the support gear is rigidly fixed at the height of the crankshaft's crankpin.

27. A machine, such as the one defined in 1, which the master or secondary induction has one or many polycammed, accelero decelerative gears.

28. A machine, such as the one defined in 1, 39, 40 which the gear uniting the induction and support gears is a composition of internal and external gears, said intermediate hoop gear.

29. A machine, such as the one defined in 1, 39, 40 in which the hoop gear, is not linked directly to the induction gear but rather to a linking gear, this gear being connected to the paddle's induction gear, interiorly or posterior.

30. A machine, such as the one defined in 1, which the support gear is instigated by the crankshaft, indirectly by means of a semi transmission, this method of realisation being nammed support method by semi transmission, this support gear also activating simultaneously a rotor cylinder

31. A machine such as the one defined in 1 which the support and induction gears are of internal type and connected indirectly by means of a linking gear, these induction and support gears being set up in a juxtaposed or superposed manner, from where the naming of these methods ; by internal juxtaposed gears, by internal superposed gears

32. A machine such as the one defined in 1, whicht he paddl is controlled on its positional level by an eccentric set up in a rotary manner in its center, and on its orientation level, by a second eccentric, these eccentrics being motivated coorinatively by one of the methods exposed, this method being named here method by centralo peripheral support.

33. A machine such as the one defined in 1, which the support and induction gears are external, are coupled by a single or double gears set up in the spur of the crankshaft, from where the name of this support, method by spur gear support.

34. A machine such as the one defined in 1, which the paddle induction gear is external, is coupled to a central active support gear, motivated indirectly by means of an accelerative semi transmission of the crankshaft, this method being nammed by central active gear.

35. A machine such as the one defined in 1, and in which the paddle is provided with an induction gear, and supported by the direct coupling of it to two or more gears, one of which is minimally motivated in its orientational aspect, this method being named by paddle hoop gear.

36. A machine such as the one defined in 1, which the paddle is supported by a paddle hoop gear, set up on a set of gears which the center of rotation is eccentric, these gears being set up on axes fixed rigidly inside the machine, this method being named method by gear structure.

37. A machine such as the one defined in 1, which the paddle is provided with fixed stems, coupled to induction gears eccentrically, these final ones being themselves coupled to a support gear, this method being named method by eccentric gears.

38. A machine such as the one defined in 1, which the paddle is controlled positionally by an eccentric set up in a rotary manner in its center, and orientationally, by a second eccentric, these eccentrics being motivated by one of the methods exposed here, this method being named method by centralo peripheral support.

39. A machine such as the one defined in 1, in which the paddle is provided with an induction gear, and supported by the direct coupling of it to two or more gears, which one minimally motivates it orientation aspect, this method being named by paddle hoop gear.

41. A machine such as the one disclosed in 1, which the paddle is supported by a paddle hoop gear, set up on a set of gears which the center of rotation is eccentric, these gears being set up on axes fixed rigidly in the machine, this method being named by gear structure.

42. A machine such as the one defined in 1 and 10, which the combinations by mechanical combinations are made
In juxtaposition
In layers
And in this final case, according to which they are made with orientational layered or fixed support gears in the side of the machine, the orientational induction gear or the orientational support gear thus being irregular, from where the name polycammed originates.

36. A machine such as the one defined in 1, using only or in combination, all method comprised within the corpus of methods, in such a manner as to couple two or more if its gears in combination with eccentric and/or polycammed gears

39. All third degree machines, which the compressive parts are supported on second degree parts undergoing a correction, or on the first degree methods undergoing to levels of corrections according to the corpus of correction rules indexed beforehand.

40. A machine such as the one defined in 1 and 14, which the mechanics are naturally of third degree, as for example the Slinky type, the meta turbine type, post inductive rotor cylinder machine, and balloon cylinder machines

41. A machine such as the one disclosed in 1 and 14 in which the third degree is artificial, such as rounded cylinder poly turbine machines, oblique rectilinear rod machines, mono inductive machines, or even bi induction with oblique courses, which we have corrected.

42. All machine commented here, making intervene a combination of two machines commented here, such as for example, post or retro rotary rotor cylinder machines, successive piston machines, imbricate post and retro rotary combination machines

43. All machine claimed here, using redoubled overlapping gears.

44. All machine commented here, used as a pump, compressor, caption motor machine, or hydraulic machine.

45. A machine such as the one defined in 1 and submitted to the commented mechanical corpus, which the compressive parts act, in push, in traction, and in differential push

46. A machine which the compressive parts are motivated by methods submitted to the corpus, with or without correction methods and which the compressive parts are:
Standard piston
Paddle
Paddle structure
These elements being set up
standard
centered
peripherally
the cylinders of these pistonnated parts are
static
dynamic
engines
the action of these compressive parts acting by
push
traction
differential push or traction
these compressive parts being
single
in combination with others
each and every one of these combinations being motivated by the rules of the mechanical corpus and correction rules indexed previously

47. A machine such as the one defined in 1, 2, 8, which the paddle attachment points are peripheral and which the motor motivation points is realised inductively in the center of the machine, this machine is said as Antitrubine

48. A machine such as the one defined in 1, 2 which the mono inductive cylinder form has been corrected once or twice, or even which the natural cylinder form and the parts course, needs two or three support means, such as a meta turbine, one or the other of these machines being described as being a third degree machine

49. A machine such as defined in 1, 2 using to support its gear axe a crankshaft sleeve which ends in a selector fork.

50. A machine such as the one defined in 1, 2 which the compressive and mechanical parts are separated by a sealing wall, for example circular and rotary, and being able to serve as a rotary valve.

51. A machine such as the one defined in 1 and 2, using overlapped gears

52. A machine, in which the layered mechanics and the support gears are exterior polycammed, if the paddle gear is irregular and vice versa.

57. A machine, such as the one defined in 1, which the support method of the compressive parts is said by poly induction, this type of induction defined by two planetary inductions in which the compressive part is coupled to each of its parts.

58. A machine such as the one defined in 1, which the support method is said by hoop gear, this gear being an internal gear coupling the induction and support gears.

59.

60. A machine such as the one defined in 1, 39, 40 which the gear uniting the induction and support gears are of internal land external gear composition, said intermediate hoop gear.

61. A machine such as the one defined in 1, 39, 40, which the hoop gear isn't linked directly to the induction gear but to a linking gear, itself connected to the paddle's induction gear, anterior or posterior

62. A machine such as the one defined in 1, which the support gear is instigated by the crankshaft, indirectly by means of a semi transmission, this realization method named support method by semi transmission.

63. A machine such as the one defined in 1 which the support and induction gears are internal and connected indirectly by means of a linking gear, these induction and support gears being set up in a juxtaposed or superposed manner, from where the naming of these methods, by internal juxtaposed gears, by internal superposed gears.

64. A machine such as the one defined in 1 which the support and induction gears are external, and coupled by a single or double gear set up in the spur of the crankshaft, from where the name of this support method by spur gear originates

65. A machine such as the one defined in 1, which the paddle induction gear is external, and coupled to a central active support gear, motivated indirectly by means of an accelerative semi transmission by the crankshaft, this method being named by central active gear.

66. A machine such as the one defined in 1, in which the paddle is provided with an induction gear, and supported by the direct coupling of it to two or more gears, which one motivates minimally its orientation, this method being named by paddle hoop gear.

67. A machine such as the one disclosed in 1, which the paddle is supported by a paddle hoop gear, set up on a set of gears which the center of rotation is eccentric, these gears being set up on axes fixed rigidly in the machine, this method being named by gear structure.

68. A machine such as the one defined in 1, which the paddle is provided with fixed stems, coupled to induction gears eccentrically, these being coupled to a support gear, this method being named by eccentric gears.

69. A machine such as the one defined in 1, which the paddle's position is controlled by an eccentric set up in a rotary manner in its center, and its orientation is controlled by means of a second eccentric, these eccentrics being motivated in coordination by one of the methods exposed here, this method being named by centralo peripheral support
